(19) United States
(12) Patent Application Publication
(10) Pub. No.: US 2014/0348423 A1
(43) Pub. Date: Nov. 27, 2014

(54) IMAGE SORTING METHOD

(71) Applicant: Kenichi Ishiga, Yokohama-shi (JP)

(72) Inventor: Kenichi Ishiga, Yokohama-shi (JP)

(73) Assignee: NIKON CORPORATION, Toyko (JP)

(21) Appl. No.: 14/130,188

(22) PCT Filed: Jun. 12, 2012
(86) PCT No.: PCT/JP2012/064975

§ 371 Date: Jun. 13, 2014

(30) Foreign Application Priority Data
Jul. 8, 2011 (JP) 2011-151622

(51) Int. Cl. G06F 17/30; G06T 7/40

(52) U.S. Cl. CPC G06F 17/30256; G06T 7/408; G06T 7/403; G06F 17/3025; G06F 17/30262
USPC 382/165

(57) ABSTRACT

An image sorting method includes: inputting a two-dimensional distribution function of a color plane image; sequentially generating a high-frequency subband image from plural resolutions by filtering the color plane image, generating a high-frequency image by sequentially combining the high-frequency subband images from low resolution, preparing a two-dimensional distribution function of an edge plane image that's defined by raising each pixel value of the high-frequency image to a second power; expanding the two-dimensional distribution functions of the color plane image and edge plane image into a two-dimensional Legendre series and two-dimensional Fourier series, respectively, describing the two-dimensional color distributions of the color plane image and edge plane image by a Legendre expansion coefficient and a Fourier expansion coefficient, respectively; evaluating the distribution of the color plane image based on the Legendre and Fourier expansion coefficients; and sorting the color plane image into images of multiple categories based on the evaluation.

### TECHNICAL FIELD

The present invention relates to an image sorting method.

### BACKGROUND ART

In the past, there has been the technical field referred to as “similar image retrieval” for retrieving similar images for one model image presented by a user. NPLT 1 discloses the technique of using color histograms and evenly combining their bins for rough quantification, using those values themselves as features, and measuring a distance of degree of similarity in a feature space to thereby extract similar images. NPLT 2 proposes a system of retrieving similar images from the aspects of color, texture, and shape and defines features similar to those of NPLT 1 for the color, but defines quite different features for the other aspects. NPLT 3 shows a method of similar image retrieval using texture features. Here, an image is transformed into Gabor wavelets, and the set of the mean value of produced high frequency subband values and standard deviation is defined as a feature vector. Then, a technique of extracting an image resembling a texture shown in the Brodatz texture database by a distance comparison in a feature space is disclosed.

On the other hand, unlike similar image retrieval, the technique which can be referred to as “perceptual retrieval” for sorting photos by perceptual adjectives is disclosed in PLT 1. Here, the perception of a photo is described by approximating the photo by three representative colors and comparing this with a database prepared in advance for color designers producing clothing, interiors, and city landscapes and describing relationships between a triadic model and adjective-based verbal impressions. That is, instead of further roughly describing the relationship in the method of NPLT 1 to determine representative colors, a plurality of one to 10 or so pattern models are prepared for one word.

Further, NPLT 4 clarifies the relationship between an image and glossiness. That is, it points out the existence of a deep connection between the asymmetry of a luminance histogram of an image and the mechanism of human perception and judgment of glossiness. Specifically, this clarifies the relationship between the skewness of a luminance histogram and glossiness. In order to form simulation images for a psychological experiment for this purpose, a beta function enabling establishment of correspondence with the skewness is postulated as the model of the histogram, and parameters of that are changed to thereby perform the psychological experiment.

### CITATION LIST

### Patent Literature

{PLT 1} Publication of Japanese Patent No. 3020887

### Non Patent Literature

{NPLT 1} Y. Gong, C. H. Chuan, and G. Xiaoyi, “Image Indexing and Retrieval Based on Color Histograms,” Multimedia Tools and Applications 2, 133-156 (1996).
{NPLT 2} W. Niblack, R. Barber, W. Equitz, M. Flickner, E. Glasman, D. Petkovic, P. Ynaker, C. Faloutsos, and G. Taubin, “The QBIC Project: Querying Images By Content Using Color, Texture, and Shape,” SPIE Vol. 1908, 173-187 (1993).
{NPLT 3} B. S. Manjunath and W. Y. Ma, “Texture Features for Browsing and Retrieval of Image Data,” IEEE Transactions on Pattern Analysis and Machine Intelligence, Vol. 18, No. 8, August 1996.
{NPLT 4} I. Motoyoshi, S. Nishida, L. Sharan, and E. H. Adelson, “Image Statistics and the Perception of Surface Qualities,” Nature, 2007, May 10; Vol. 447 (7141), pp. 206-209.

### SUMMARY OF INVENTION

### Technical Problem

The techniques of the above NPLTs 1 to 3 had the problem that while these had the capability of collecting similar images of a scene extremely accurately matching a color histogram or texture pattern of a proposed image or proposed pattern, these did not have the capability of determining features common to images calling up the same perception even in scenes of different color or texture. On the other hand, the idea of representative three color approximation of PLT 1 may be applicable in certain respects, but cannot be said to accurately describe the overall perception of a photo. Further, NPLT 4 is extremely noteworthy, however, this stops at pointing out of the relationship between skewness and glossiness. The relationships with a variety of perceptions are not known at all.

A main object of the present invention is to provide an image sorting method for sorting images according to adjectives. Further, another object is to introduce a hypothesis for the mechanism of perception and perform mathematical modeling so as to throw light on the relationship between measured quantities of images and psychological quantities and to introduce a method of quantitative description of quantities characterizing perception in an advanced form better suited to the mechanism of perception.

### Solution to Problem

In accordance with one aspect of the present invention, an image sorting method includes: a two-dimensional color distribution function input step of inputting a two-dimensional distribution function of a color plane image; a two-dimensional edge distribution function preparation step of sequentially generating a high-frequency subband image from plural resolutions by filtering the color plane image, generating a single combined high-frequency image by sequentially combining the high-frequency subband images from the low resolution, and preparing a two-dimensional distribution function of an edge plane image, the edge plane image being defined as a distribution of values of at least zero by raising each pixel value of the single combined high-frequency image to a second power; a description step of expanding the two-dimensional distribution function of the color plane image into a two-dimensional Legendre series, in which an associated Legendre function is used as an orthogonal base function in an x-direction and a y-direction, describing the two-dimensional color distribution of the color plane image by a Legendre expansion coefficient, expanding the two-dimensional distribution function of the edge plane image into a two-dimensional Fourier series in which a cosine function and a sine function are used as the orthogonal base function in the x-direction and the y-direction, and describing the two-dimensional edge distribution of the edge plane image by a Fourier expansion coefficient; an evaluation step of evaluating a feature of the distribution of the color plane image based on the Legendre expansion coefficient and the Fourier expansion coefficient; and a sorting step of sorting the color plane image into images of at least two categories based on the evaluation result.

### Advantageous Effects of Invention

According to the present invention, the projection to the uniform recognition space, which shows a linear behavior with respect to the human shape recognition, can be expressed by performing the series expansion of the two-dimensional distribution function using the orthogonal base function suitable for the character of the signal distribution of the two-dimensional distribution function. Therefore, the present invention can provide the space where the features common to the images generating the identical perception or the images producing the identical recognition can extremely easy to be dealt with and linearly described.

### BRIEF DESCRIPTION OF DRAWINGS

FIG. 1 A graph of T₁(x), T₂(x), and T₃(x) in a Chebyshev polynomial Tₙ(x).

FIG. 2 A graph of base functions n=1 to 5 concerning a root of a spherical Bessel function.

FIG. 3 A graph of spherical Bessel functions j₀(x), j₁(x), and j₂(x).

FIG. 4 A graph of spherical Bessel functions j₀(x) to j₅(x) defined to spread to a negative region.

FIG. 5 A block diagram showing an image sorting apparatus according to an embodiment.

FIG. 6 A flow chart showing processing in the image sorting apparatus according to the embodiment.

FIG. 7 A waveform diagram of composite waves T₁T₃ and T₂T₄ in a symmetric state as one component of a target taking a trace of Fm=2 (α)(α)+.

FIG. 8 A diagram showing color histogram shapes of HVC planes of a “static” image and a “dynamic” image.

FIG. 9 A diagram showing color histogram shapes of HVC planes of a “closed” image and an “open” image.

FIG. 10 A diagram showing a situation of subband division by a four-stage wavelet transform.

FIG. 11 An example showing what shape of distribution function corresponds to the two extreme ends of an ordered image group distribution when the order of expansion N is 100 and a quantum number difference m is shifted in a case where a predetermined additive mean is taken for perceptual invariants Gz,m (α)(α)+.

FIG. 12 A diagram showing color histogram shapes of HVC planes of a “homey” image and a “grand” image.

FIG. 13 A diagram showing distribution functions of color and texture.

FIG. 14 A conceptual diagram showing a high order momentum space in a case applying a Fourier transform.

FIG. 15 A diagram showing a perceptual group in a phase space.

FIG. 16 A diagram explaining a relationship in which the relationship between a position and momentum is uncertain.

FIG. 17 A matrix diagram expressing a situation of constructing four extended traces.

FIG. 18 A distribution diagram of energy values in a model image of an adjective.

FIG. 19 A conceptual view of a hierarchical structure of a pyramid.

FIG. 20 An energy band diagram in color and texture.

FIG. 21 An energy band diagram in a conduction band of nickel.

FIG. 22 A view illustrating a state of a projection expression and a linear model of perception.

FIG. 23 A view illustrating a state of mapping to a uniform recognition space by a frequency description.

FIG. 24 A view illustrating a state in which a psychological structure is visualized as an energy band structure by the projection expression.

FIG. 25 A view illustrating a relation of an element related to a construction of a low-order invariant of a composition.

FIG. 26 A Graph of P₂(x), P₃(x), P₄(x), and P₅(x) in a Legendre polynomial.

FIG. 27 A view illustrating types of a way to rearrange a two-dimensional coefficient in a one-dimensional array.

FIG. 28 A view illustrating a conceptual state of an energy dispersion relationship.

FIG. 29 A view illustrating a state in which an energy characteristic on special point and line is investigated on a k-space.

FIG. 30 A view illustrating a relationship among a two-dimensional expansion coefficient, momentum, angular momentum, and energy.

### DESCRIPTION OF EMBODIMENTS

Before a concrete explanation of the embodiments of the present invention, the principle leading up to it will be explained.

[1] Discoveries of the Applicant Up to Now by Experiments

The attempts made by the applicant up to now so as to deal with the above problems will be summarized here. Much of this is disclosed in Japanese Patent Application No. 2008-23469 (First Filed Application 1) and Japanese Patent Application No. 2008-235578 (First Filed Application 2).

First, in order to prepare the experimental environment, adjectives expressing perceptions received from images were given to about 200 images. Those images were transformed to a Munsell HVC color space, then correspondences of color histograms and texture PDF with the attached adjectives were investigated by comparison for all experimental images. Here, “texture PDF” designates the histogram of an edge image. “PDF” is abbreviation of “probability density function”. That term was used since a high frequency band is extracted from an image and the histogram thereof is called a PDF as common practice.

Note that, a texture PDF does not relate to the conventionally existing single high frequency subband, but is a histogram of a combined edge image obtained by combining high frequency subbands extracted by a uniquely introduced multiplex resolution in order to imitate a recognition mechanism visually instantaneously judging an image. That histogram reflects the correlation of the spatial arrangement of contrast, so a variety of shapes which are different from a generalized Gaussian function taken by a PDF shape of the usual single high frequency band end up appearing.

<Regarding Importance of Vague Descriptions in Perceptual Sorting>

The point which became clear when naming the adjectives describing perceptions of the images used for the experiments is that the phenomenon where even with images which are different in mean or representative hue, value, and chroma, the same perception will be caused, while even when the mean or representative hue, value, and chroma are the same, if other elements are strong, completely different perceptions will be caused is a very common phenomenon. Further, when seen from another side, this is also connected with the fact that adjectives have a hierarchical structure and only the ones close to the highest concept mainly remain as the adjectives given to the image. The concept of a hierarchical nature of adjectives matches with the facts known in the fields of neuropsychology etc. and shows that the description of features of adjectives are not any simpler compared with the cases handled in similar image retrieval.

The applicant investigated the relationship between adjectives and color histograms and texture PDFs explained above and as a result became convinced that there was a good possibility that the features relating to similar shapes which can be vaguely read from these distribution functions are directly linked with perceptions. Accordingly, in perceptual image retrieval, measurement of the similarity of absolute shapes of the histograms like in similar image retrieval is not important. The important point is how the similarity of features concerning the shapes of certain parts which stand out relative to other parts should be grasped as a vague feature so as to match with human senses.

The above First-Filed Application 1 pointed out the importance of simultaneous description of trends in overall shape difference patterns in combinations of the V plane and C plane particularly in color histograms. The First-Filed Application 2 points out the importance of evaluation of asymmetry and the difference of shapes of the lower slopes in texture PDFs. Among these, the measure provisionally employed for vague shape extraction was the evaluation of statistical quantities concerning the kurtosis and skewness of histograms of the V plane and C plane in the case of color histograms. Due to that, it was judged whether one of the V and C planes had a two-band structure and the other had a one-band structure. Whether the state of the axis of the shape gradually transiting between those can be evaluated is one important element. In the case of a texture PDF, the asymmetry of the histogram shape was evaluated by using two parameters of the skewness and the uniquely defined sharpness (eboshi degree). In this, the conclusion was also reached that in evaluation of the same feature of asymmetry, use of two parameters, that is, a parameter sensitive to the lower slopes and a parameter insensitive to them, for evaluating one feature from two sides is important in order to obtain linkage with an adjective having a property of duality. The “duality” of an adjective means that the meaning of a single adjective is simultaneously provided with both of a major main sorting element and a fine sorting element for discriminating meaning from other adjectives included in that.

[2] Problems and Direction of Countermeasures

<Diversification and Quantification of Shape Recognition of Distribution Function>

1) Problems

The statistical quantities of kurtosis, skewness, etc. explained above involve the following problems in practice:

a) With single statistical quantities, the direct linkage with adjectives is weak.

b) There is no linear quantitative relationship with a psychological quantity concerning perception.

c) There is a limit to coping with diversification in histogram shape recognition.

Specifically explaining this, the statistical quantities of kurtosis and skewness enable discussion of shapes relating to asymmetry and kurtosis as parameters expressing deviation from the Gaussian distribution, but basically are not provided with a capability more than that. Accordingly, unless using kurtosis, skewness, standard deviation, mean value, etc. together, it is difficult to determine the features of the shape of a histogram and link it with adjectives. Further, even when combining these, for example, in the value of the kurtosis, there is no ability to distinguish between two band structures and a uniform distribution structure. In addition, the range of adjectives which can be explained is extremely limited.

Further, even if these statistical quantities are normalized by standard deviation from their definitions, not only values close to ±1 near zero, but also extreme values such as +20 in for example kurtosis will be derived depending on the image. The applicant tried to experimentally verify color histograms. As a result, with a single parameter alone, direct linkage with a higher order adjective is difficult. Not only this, the result is also far off from the psychological scale.

2) Plan of Countermeasures

In order to solve the above problems, the applicant introduces a completely new idea. That is, the applicant obtains a grasp of perception from the standpoint of physics and discusses the mechanics to try to describe perception cleanly in mathematical terms. Below, to make the term “histogram” more generalized so as to cover any quantity which can be observed from an image, the applicant will call this by the term “distribution function” in statistical physics. As clearly shown in the next section, the meaning indicated by “distribution function” does not stop at the range of a histogram.

In order to diversify and quantify shape recognition of a distribution function, the applicant introduces quantum mechanics techniques. Here, the applicant will describe the reasoning behind this.
Photons and electrons in image formation and an exposure process of a photo obey quantum theory.
The human visual system is also the same. Further, the neuronical circuits in the brain are also a quantum phenomenon.

As evidence of the matter explained second, the fact is that perception changes. Even if viewing an outside object in the same field of vision or an image forming a photograph, the impression will often differ depending on the day. When considering this fact together, if it were possible to quantumly describe perception, linear correspondence might arise between perception and the features of an image.

[3] Mode of Description of Perception Targeted

<Hierarchical Property of Adjective Structure>

In general, it is known that the mechanism of recognition of adjectives in the brain has a pyramidal hierarchical property. In the face of this fact, when trying to perform a content-based adjective search from an image signal, the question becomes what features concerning an image should be captured and what sort of structure they should have. It is only natural to presume that the features relating to an image also have a pyramidal hierarchical property.

Here, the applicant will describe the perceptual features which it envisions and their hierarchical structure. First, as the perceptual features of the lowest level of the lowest dimension, elements of the property of a scalar quantity concerning color such as a “representative hue, representative value, and representative chroma” of a photo image can be considered. That is, when representing a photo by the hue, value, and chroma having the largest area ratio, there are extremely low order features creating impressions such as overall “reddish” or “green” images or overall “dark” images due to insufficient exposure.

Next in position, elements of the property of a vector quantity concerning color, described by the “distribution structure of colors of HVC”, may be considered. That is, when an HVC histogram is in a certain inherent feature state, it is presumed that a somewhat higher order perception is induced. Adjectives corresponding to this level may be for example “refreshing” or “restful”. The impressions provided by these images strongly act on perception much earlier than the lower order impressions described before. Note, the lower order impressions do not vanish, their properties continuously persist as well. Next in position is considered to be features concerning “edge, texture, and contrast”. At the present point of time, it is presumed that elements of the property of vectors of structural factors condensed one-dimensionally relating to texture correspond to these. It is considered that impressions such as “bold” images or “harsh” images are given due to a large number of edges and textures and strength of contrast.

Positioned above that is presumed to be the “composition”, that is, the “spatial distribution”. This is because the previously explained “color” and “texture” can be discussed by extracting one-dimensional information from HVC color planes, but spatial distribution must be discussed by extracting two-dimensional information from the planes. Further, it is considered that discrimination of adjectives such as “leisurely” and “heavy” from among these becomes possible. Positioned further above that may be considered structures such as universal aesthetic senses. However, it is presumed that individual perception also plays a large part in this. It is presumed that discrimination of adjectives such as “beautiful” from among these becomes possible.

<Mode of Description of Features Inherent in Perception: Additivity>

As a special feature of the hierarchical structure explained above, it can be said that the perception at a lower order level does not disappear, but continuously persists, but when there is a further higher order perception, this remains as the impression concept for that image with greater priority. Further, if thinking of intentionally excluding the higher order concepts and rating features at the lower order level, this actually can be said to be possible. Features having such a property are shown by studies to be able to magnificently describe images if the features have an additive property between them. This is because an additive property permits addition of higher order factors at all times and provides a mechanism enabling previous lower order factors to be superseded through substitution.

Further, experiments for the case of features having non-additive properties explained later provide evidence of the clear superiority of the additive property. That is, between features of different properties, the features have to be handled independently in Euclidean terms. With features having synergistic properties, unlike an additive property, what kind of situation will occur has to be studied. Accordingly, as the mode of description enabling the hierarchical property of adjectives to be reflected in combination of principal axes, the conclusion is that the perceptual features must have an additive property.

When performing linear combination between additive perceptual features, if adding features attaching importance to the highest order feature factors, the mechanism of human emotion, where the words of the highest concepts among the adjectives are derived most dominantly while the balance of lower order factors is reflected to a certain extent, is reproduced. For this reason, even when the principal axes of perception are different, perceptual features provided with exactly the same quality of additivity must be created. In other words, the perceptual features must be described by the quantities of the same dimension provided with additivity. This is the condition which must be equally satisfied within a principal axis of perception and between principal axes.

<Linear Model of Perception>

The higher order perceptual feature which can be read from a distribution function f is defined as follows. That is, it is assumed that there are a plurality of features of the shapes of distribution functions commonly appearing among image groups having the same perception even when the distribution functions change in the distribution functions of different types and levels. The number i takes values of 1, 2, . . . .

Color histogram distribution . . . Fᵢ

Texture PDF distribution . . . Gᵢ

Spatial distribution of pixel values . . . Hᵢ

It is postulated that linear models of perception stand as follows.

$$\begin{matrix}Adjective = {α}_{1} {F}_{1} + {α}_{2} {F}_{2} + … + \\ {β}_{1} {G}_{1} + {β}_{2} {G}_{2} + … + \\ {γ}_{1} {H}_{1} + {γ}_{2} {H}_{2} + …\end{matrix}$$

A method of constructing features having such an additive property will be specifically explained for Fᵢ and Gᵢ in the following description and in the embodiments. In the perceptual invariants defined in the embodiments explained later, the fact that the additive property functions well is proved also from the fact that more stable experimental results are obtained by producing the same kind of invariants in hue, value, and chroma and taking the additive mean among those.

<Comparison with Other Non-Additive Methods>

1) Expression by Euclidean Distance of Feature Vectors

In the conventional similar image retrieval technique, the color, texture, and shape are individually handled, and comparison of the distance of similarity is carried out in each feature space. For example, the method of Document 2 will be taken as an example. As features of the different axes, completely different kinds of features are defined among the axes. There is no clear description of the method of combination of principal axes. However, in a case of performing similar image retrieval by using features of color, texture, and shape together, ordinarily, all features of the three principal axes are combined to one vector, the Euclidean distance in the feature space is measured, and images which are close in all of color, texture, and shape as much as possible are searched through.

When such a Euclidean distance is used, the sorting indicator will have the following property. Assume that a certain feature does not have similarity for example for color. At that time, even if there is similarity in texture and shape, if the feature not having similarity acts and ends up being placed once a certain distance away in the Euclidean distance, it can no longer be approached more. That is, there is no dominance relationship between features. All features are handled with the same rank. Accordingly, a higher order feature cannot overturn the results of a lower order feature. Accordingly, this property is not applicable to the hierarchical property of adjectives.

2) Expression by Synergistic Features

Assume that each feature is expressed with a synergistic property. In such a case, the sorting indicator ends up having the following property. Assume that a certain feature is very similar and values of the model of the feature and the retrieval target image match. The difference of the degree of similarity of the feature becomes zero, the result of the geometric mean is zero even when there is no similarity in the other features at all, and finally these become extremely similar. That is, when even one feature having a synergistic property coincides, all of the other judgments no longer act. In the sense of one feature standing out, this has a property of replacement by a higher order factor. However, the fact that the other lower order features no longer act does not match with the property of adjectives. That is, the feature is not a type which is judged by only a lower order average color, for example, a judgment of “green image”, but that property remains no matter how low the order.

[4] Quantum Mechanics Description of Distribution Function

<Hilbelt Space Expression>

Base functions satisfying linear differential equations are used for series expansion on a distribution function. Note, assume that these base functions are orthogonal to each other and are provided with completeness in the sense that the original distribution function can be completely reproduced.

Series Expansion of Distribution Function

$$f ( x ) = {\sum }_{i = 0}^{∞} {c}_{i} {ψ}_{i} ( x ) \qquad \{ Math . 1 \}$$

Orthogonality of Base Functions

∫ψᵢ(x)ψₖ(x)w(x)dx=δᵢₖ {Math. 2}

Here, the idea at the bottom of this will be explained. In order for a perceptual feature readable from a distribution function to satisfy the additive property, first, the components of the distribution function must satisfy a linear differential equation. This linear differential equation is positioned as a motion equation satisfied by the components. This stands on the hypothesis that a motion equation is closer to a physical phenomenon occurring in the brain the closer to differential equations satisfied by many physical phenomena in the fields of mechanics, magneto-electronics, and quantum mechanics.

The weight function defining the orthogonality must be determined by selecting the optimum base functions in accordance with the special features of the distribution function so that it becomes as close to the human recognition process as possible. Functions having orthogonality by integration are generally called “special functions”. Many of those are defined by linear differential equations of hypergeometric equations or confluent hypergeometric equations. Further, in order to enable series expansion, it must have completeness in the sense of enabling equivalent expression of the original function. Such a special function forming orthogonality does not necessarily have completeness, therefore there is a limited choice of special functions provided with both the selection condition of the weight function and completeness. The first standard of the selection is the judgment of whether the base function group resembles the shape of the distribution function which is the target at present and a match of the interval area.

A solution y of a second-order homogeneous differential equation:

P(y)=y″+p(x)y′+q(x)y=0

has linearity with respect to any constant C:

P(Cy)=CP(y),P(C₁y₁+C₂y₂)=C₁P(y₁)+C₂P(y₂)

Accordingly, in a motion equation expressed by this type of linear differential equation, the principle of superposition stands. Therefore, the general solution is expressed by the series expansion.

Both of a hypergeometric equation and confluent hypergeometric equation are expressed by the above type of second-order differential equations. A hypergeometric equation has a regular singularity at x=0,1,∞, and a confluent hypergeometric equation has a regular singularity at x=0 and has an irregular singularity at x=∞. Various such equations are described (see Document B2).

x(1−x)y″(x)+[c−(a+b+1)x]y′(x)−aby(x)=0 Hypergeometric equation

xy″(x)+[c−x]y′(x)−ay(x)=0 Confluent hypergeometric equation

By the function system having orthogonality and completeness, the mode of description for series expansion of a solution of a motion equation satisfied by state functions is positioned the same as expression by Hilbelt space. In quantum mechanics, by Hilbelt space expression, the description of the motion equation shifts to a matrix form. Therefore, for construction of a Hilbelt space, expansion by special functions having complete orthogonality is needed (see Document B1).

In mechanically describing perception, it is considered that base functions constructing the distribution function satisfy at least the differential equations selected below as motion equations, that is, express one aspect of perception by equations. That is, it is considered that they satisfy hypergeometric equations on the projection surface of the distribution function of the color and confluent hypergeometric equations on the projection surface of the distribution function of the texture. These linear differential equations are general terms for differential equations and are positioned as different types. With respect to these, by introducing the method of establishment of parameters and variable transforms, differential equations of types encompassing many equations can be derived. For example, the solution of a hypergeometric equation, that is, a hypergeometric function, can handle Chebyshev functions, Legendre functions, and so on as special cases of parameters. Further, the solution of a confluent hypergeometric equation, that is, a confluent hypergeometric function, can give a Bessel function or modified Bessel function, Hermite function, Laguerre function, and so on as special cases. Further, by a variable transform of a Bessel differential equation, a spherical Bessel function and modified spherical Bessel function are derived (see Document B2).

In actuality, suitably a Chebyshev function is used for a one-dimensional distribution function of color, and a spherical Bessel function is used for a one-dimensional distribution function of texture. Accordingly, if there is a differential equation of perception in the brain, the linear differential equation is satisfied. From the aspect of the hypergeometric function describing a Chebyshev polynomial function at one of these, that is, the projection surface of color, and from the aspect of the confluent hypergeometric function describing a Spherical Bessel function at the projection surface of the edge and texture of another, this may be said to correspond to description on two different projection surfaces. Further, the base functions of the differential equation which must be satisfied by a distribution function play a role of quasi definition of coordinates of a wave type signal processing system such as the brain by the Hilbelt space.
[Document B1] Schiff “Quantum Mechanics” (Third Edition, 1970), Chapter 6 “Matrix Formulation of Quantum Mechanics”
[Document B2] George Arfken, Mathematical Methods for Physicists, Vol. 3 “Special Functions and Integration Equations” (Second Edition, 1970; Japanese translation, 1978), Chapter 1 “Bessel Functions” and Chapter 3 “Special Functions”

<Hilbelt Space Expression of Distribution Functions>

1) Case of Color Histogram

Base Function

ψₙ(x)=Tₙ(x) {Math. 3}

Weight Function of Orthogonality

$$w ( x ) = \frac{1}{\sqrt{1 - {x}^{2}}} \qquad \{ Math . 4 \}$$

Here, Chebyshev polynomials can be described analytically. They take values of n=0, 1, 2, . . . .

$${T}_{n} ( x ) = cos ( n {cos}^{- 1} x ) \\ {T}_{0} ( x ) = 1 \\ {T}_{1} ( x ) = x \\ {T}_{2} ( x ) = 2 {x}^{2} - 1 \\ {T}_{3} ( x ) = 4 {x}^{3} - 3 x \\ {T}_{4} ( x ) = 8 {x}^{4} - 8 {x}^{2} + 1 \\ … \\ {T}_{n + 1} ( x ) = 2 {xT}_{n} ( x ) - {T}_{n - 1} ( x ) , n \geq 1 \qquad \{ Math . 5 \}$$

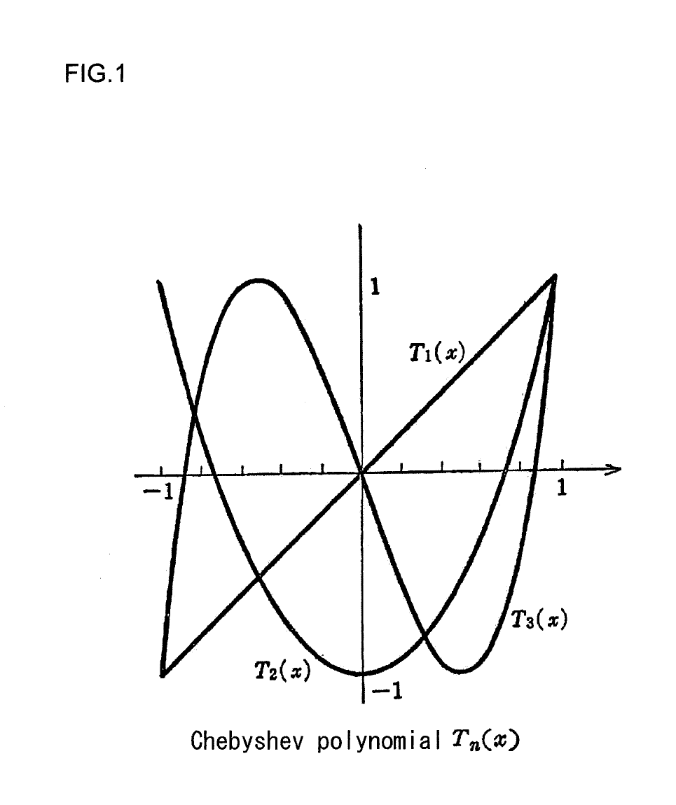

Here, FIG. 1 is a graph of T₁(x), T₂(x), T₃(x) in a Chebyshev polynomial Tₙ(x).

The precise relationship of orthogonality including normalization conditions is given below:

$${\int }_{- 1}^{1} \frac{{T}_{m} ( x ) {T}_{n} ( x )}{\sqrt{1 - {x}^{2}}} d x = \{ \begin{matrix}0 , & m \neq n \\ \frac{π}{2} , & m = n \neq 0 \\ π , & m = n = 0\end{matrix} \qquad \{ Math . 6 \}$$

The orthogonality of a Chebyshev polynomial function stresses a rising portion and a falling portion of a distribution function with extremely high density. That is, when handling a function system having the property of an event abruptly occurring and that event abruptly ending in a finite interval as in a histogram, the rising portion and falling portion have a very important property as the shape of that function, so unless that is correctly described, approximation is not possible in the true sense.

2) Case of Texture PDF

When a spherical Bessel function is extracted for one order, a function group scaled from the low frequency to high frequency according to the number of roots present in an interval of [0,a] exhibits orthogonality and forms a complete system concerning the roots. It is the 0-th order function that has a peak at the origin, therefore a single series expansion according to the root of the 0-th order function is carried out. At that time, the distribution function of the texture PDF must be spread separately to a right interval and a left interval of the peak.

2-1) Case of Single Series Expansion

Base Function

$${ψ}_{n} ( x ) = {j}_{0} ( {α}_{0 n} \frac{x}{a} ) \qquad \{ Math . 7 \}$$

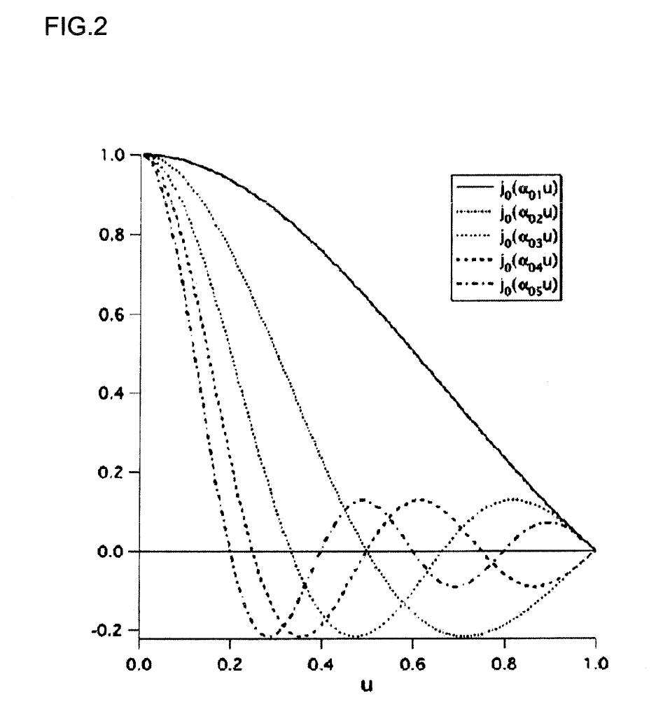

Here, FIG. 2 shows a graph of n=1 to 5.

Weight Function of Orthogonality

w(x)=x² {Math. 8}

Here, spherical Bessel functions can be described analytically.

$$\begin{matrix}{j}_{0} ( x ) = \frac{sin x}{x} & 0 \text{-} th order function \\ {j}_{1} ( x ) = \frac{sin x}{{x}^{2}} - \frac{cos x}{x} & 1 st order function \\ {j}_{2} ( x ) = ( \frac{3}{{x}^{3}} - \frac{1}{x} ) sin x - \frac{3}{{x}^{2}} cos x & 2 nd order function \\ {j}_{n} ( x ) = {( - 1 )}^{n} {{x}^{n} ( \frac{d}{xdx} )}^{n} ( \frac{sin x}{x} ) & n \text{-} th order function\end{matrix} \qquad \{ Math . 9 \}$$

αₙₖ indicates the value of the root of the n-th function, and takes a value of k=1, 2, . . . .

jₙ(αₙₖ)=0 {Math. 10}

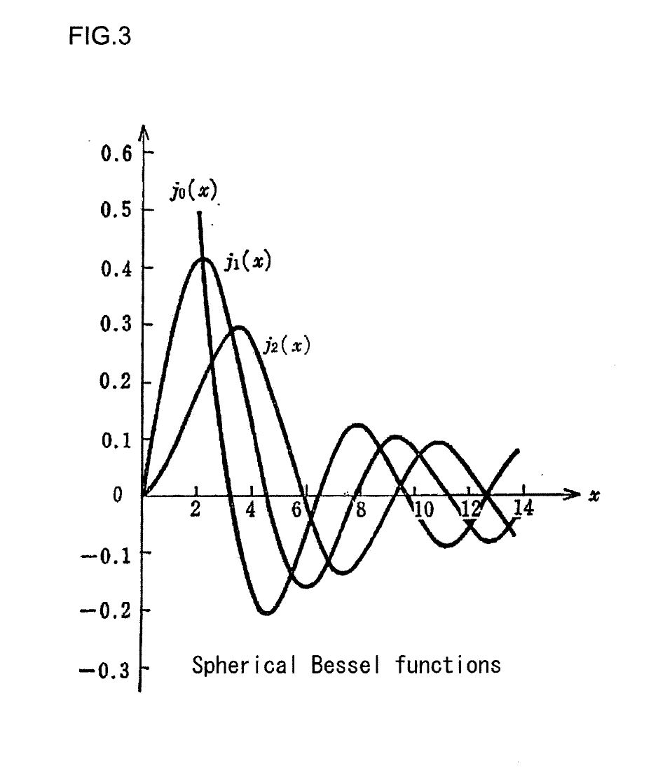

Here, FIG. 3 shows a graph of j₀(x), j₁(x), and j₂(x) of a spherical Bessel function. The precise relationship of the orthogonality concerning the roots including the normalization conditions is given below.

$${\int }_{0}^{a} {j}_{n} ( {α}_{np} \frac{ρ}{a} ) {j}_{n} ( {α}_{nq} \frac{ρ}{a} ) {ρ}^{2} d ρ = {\frac{{a}^{3}}{2} [ {j}_{n + 1} ( {α}_{np} ) ]}^{2} {δ}_{pq} \qquad \{ Math . 11 \}$$

When the spherical Bessel function is an 0-th order function, this is a function having the maximum strength at the origin. Therefore, when approximating a distribution function having the maximum degree at the origin, the weight of the origin is always removed, and importance is attached to the shape of the lower slopes.

In this regard, the various Bessel functions are functions suitable for description in a case where light and waves diffuse from the origin toward the periphery or there is a singularity such as a light source at the origin. A spherical Bessel function is suitable for describing the wave motion of the radial component in a spherical coordinate system. In comparison with a Bessel function of a cylindrical coordinate system, the further from the origin, the faster the fall of its strength. The one-dimensional distribution function of the edge image to be handled now is close to the property of a spherical Bessel function in view of the rapid speed of the fall of its strength. This is because, even if considering a focusing process in which a photo is taken through a lens, light coming down from a semi-spherical surface is a spherical wave. The radial component of that is described by a Spherical Bessel function. No particular reason of anisotropy for using cylindrical coordinates is found.

In a spherical Bessel function, when using the 0-th function, there is always a peak at the origin. Therefore, in order to evaluate the shape of a distribution function having the property of a peak always appearing at the origin as in a histogram of an edge image, eliminating the weight of the origin and focusing on the properties of the lower slopes is a very fitting method. That achieves a role of forming the base for creating a linear relationship with the essence of the event.

2-2) Case of Double Series Expansion

A spherical Bessel function is usually a function describing motion in a radial direction, therefore is ordinarily defined in a positive region. However, by expanded definition to a negative region, orthogonality appear even between functions having different orders. This is because a spherical Bessel function has the property that an even number order becomes an even function and an odd number order becomes an odd function.

jₙ(X)=(−1)ⁿjₙ(−x) {Math. 12}

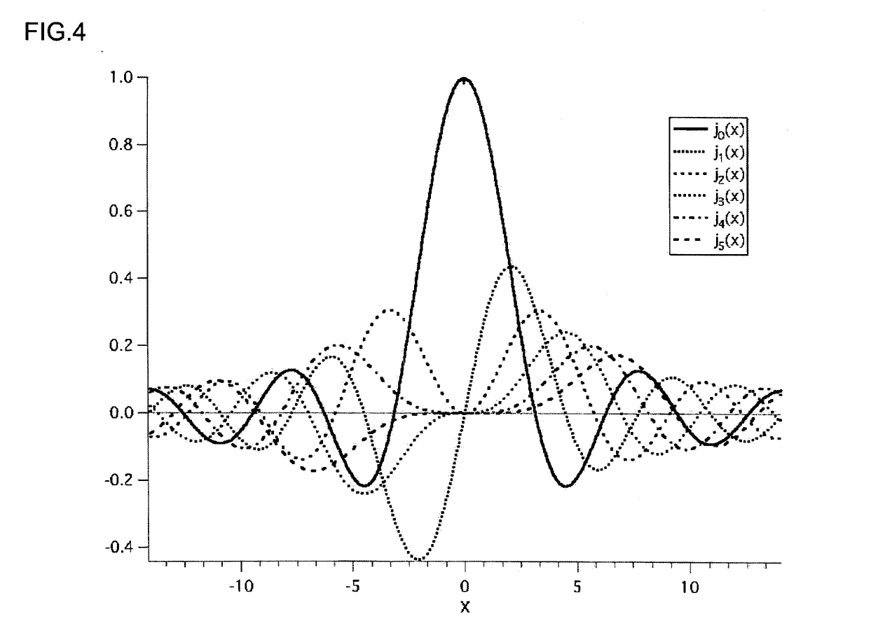

Here, FIG. 4 shows a graph of spherical Bessel functions j₀(x) to j₅(x) by expanded definition to a negative region.

Orthogonality Concerning Order of Spherical Bessel Function

$${\int }_{- ∞}^{∞} {j}_{m} ( x ) {j}_{n} ( x ) d x = \frac{π}{2 n + 1} {δ}_{mn} , \\ m , n \geq 0. \qquad \{ Math . 13 \}$$

If considering the orthogonality concerning the order and the orthogonality concerning the root together, the positive region and negative region of a distribution function can be simultaneously expanded. Root expansion always has completeness, therefore a double series expansion of the order and root is carried out. For the present, one odd function extracting the component of asymmetry is satisfactory, therefore root expansion using two functions of the 0-th even function and the first order odd function is satisfactory.

$$f ( x ) = {\sum }_{n = 0}^{1} {\sum }_{k = 0}^{∞} {c}_{nk} {j}_{n} ( {α}_{nk} \frac{x}{a} ) \qquad \{ Math . 14 \}$$

[5] Correspondence Between Expansion Coefficients and Mechanics

<Posing of Problem>

An expansion coefficient means that, among distribution functions, there are many components having waveforms and frequencies corresponding to the base functions. Here, there is the problem that “is an expansion coefficient cᵢ itself suitable for a perceptual feature?”

<Tendency of Expansion Coefficients in Real Data>

The value of a coefficient cᵢ obtained by actual expansion of a distribution function is easily directly affected by the absolute shape of the individual distribution function. Accordingly, as the value, the fluctuation due to the image is extremely large. When directly comparing expansion coefficients for the distribution functions of images giving the same adjectives with each other, a small correlation tendency is recognized, but the tendency of variation is stronger. Even if conducting learning by taking a statistical mean of the expansion coefficients among images given the same adjectives in order to use the expansion coefficients as models corresponding to the adjectives, in this tendency, most expansion coefficients vanish to zero, or even the other adjectives are converged to a common meaningless certain constant.

<Construction of Correspondence with Mechanics>

Here, the applicant sets the following hypothesis linking mechanics and an image system.

Mechanical System:

“Even when the motion state of each particle (momentum pᵢ) changes, there is a conserved quantity (energy E) characterizing the entire motion system.”

Image System:

“Even when the pixel value distribution of each image (state component cᵢ) changes, there should be an invariant (I) characterizing the perception of the entire image.”

$$\begin{matrix}Mechanical system & & & Image system & \\ Coordinate & {q}_{i} & ⇔ & {ψ}_{i} ( x ) & Hilbelt space \\ Momentum & {p}_{i} & ⇔ & {c}_{i} & \begin{matrix}State component of \\ pixel value or edge\end{matrix} \\ Energy & E = {\sum }_{i} \frac{{p}_{i}^{2}}{2 m} & ⇔ & I = {\sum }_{i , k} {c}_{i} {c}_{k} & Invariant of perception\end{matrix} \qquad \{ Math . 15 \}$$

This hypothesis includes, as the model, the mechanism that, when a human perceives a signal distribution of an image or an image reflected in the visual field of the outside world, he senses a certain kind of “field” energy of perception there, a neuronical state in the brain corresponding to that kind of field energy is instantaneously activated, and an adjective is called up.

The sum of the quadratic forms of the expansion coefficients means a possibility of extraction of features commonly provided among distribution functions of an image group calling up the same perception even when the distribution functions change in various ways. An operation taking this sum eases the demands on strict similarity of individual elements and enables groups of features which are similar as a whole to be combined. Therefore, the function of comparison of features which vaguely resemble each other in shape is derived.

<Regarding Quadratic Form and Additivity>

The reason for concluding that a perceptual invariant must take the quadratic form is deeply related to the theoretical background in the process of deriving a motion equation from action functions based on the principle of minimum action in theoretical physics and the process of construction of a hamiltonian. That is, when assuming that one side of the motion equation of the field of perception satisfies a linear differential equation, the integrand of that action function, that is, the Lagrangian, is required to provide a second order expression for the field of perception. This is because, a motion equation is derived by assuming that a total derivative of the first order of the action integral are equal to zero based on the variational principle, and the principle of superposition is kept by decrementing the order by 1 at that time (see Document A1). The mechanical invariant which is the first integral of the motion equation is called the integral of motion and maintains a constant value during motion. In the case of perception, this is considered to correspond to the same perception being continuously given even when the signal distribution of an image changes.

The integrals of motion include energy, momentum, and angular momentum. It is clarified by mechanics that all of these have the important property of additivity (see Document A2). Further, the signal distribution of an image which perception takes up deals with an image comprised of a number of pixels of the 10⁶ to 10⁸ order and a statistical group comprised of a group of hundreds or thousands of images, so statistical physics must be used.

According to statistical physics, in the integrals of additive motions, the conclusion is derived that after statistical averaging, the statistical nature of the entire system, that is, the statistical distribution of the system, is determined only by the energy. The momentum and the angular momentum are simply returned to only translation and uniform rotation of the system as a whole and are useless for description of the system (see Document A3). This situation matches with the fact that the expansion coefficients cᵢ corresponding to the momentum derived from the distribution functions for describing perception, when the statistical mean is taken for an image group giving the same perception, tend to converge to a meaningless constant.

When summarizing the correspondence between distribution functions f and mechanical invariants, that is, quantities of the quadratic form having a dimension of energy in the same way as described above,

$$\begin{matrix}Mechanical system & & Image system \\ f = f ( E ) & <= > & I = I ( f )\end{matrix}$$

Here, a perceptual invariant is derived from the observed quantity, that is, the distribution function, therefore the expression becomes inverse to that of the mechanical system. Further, by an expanded definition of the perceptual invariant of the quadratic form as will be explained in the next section, various perceptions can be handled.

In this way, all perceptual invariants are provided with additivity and end up satisfying the requirement of additivity of the linear model of perception, so color, texture, and composition can all be handled on a common footing. That is, it becomes possible to additively handle all different features of the principal axis of perception. Note that, it is assumed that the perceptual invariants derived from composition are constructed by the same guidelines based on the same parameters.

Note that, in the process of reaching the conclusion of the necessity of making the perceptual invariants the quadratic form as explained above, a process of experimental trial and error was undergone, then it was judged that the above-explained theoretical background was involved. That is, even when experimentally preparing and testing out many possible conceivable indicators such as the absolute values and ratios of expansion coefficients, no array of images completely matching in sense with perception can be obtained. After repeated failure, an array with a high match with perception was first obtained by an expression of a sum of the quadratic form.
[Document A1] Landau and Lifshitz, Course of Theoretical Physics, Volume 2 “The Classical Theory of Fields” (Original Sixth Edition, 1973), Chapter 4 “The electromagnetic Field Equations”, Section 27 “The action function of the electromagnetic field”
[Document A2] Landau and Lifshitz, Course of Theoretical Physics, Volume 1 “Mechanics” (Third Revised Edition, 1973), Chapter 1 “The Equations of Motion” and Chapter 2 “Conservation Laws”
[Document A3] Landau and Lifshitz, Course of Theoretical Physics, Volume 5 “Statistical Physics, Part 1” (Third Edition, 1976), Chapter 1 “The Fundamental Principles of Statistical Physics”, Section 4 “The significance of energy”

[6] Quadratic Form Expression of Perceptual Invariants

<Combination of Two Base States>

In order to form a perceptual invariant of the quadratic form, returning to the viewpoint of shape recognition of a distribution function, the shape of a distribution function f is extracted according to a combined system of two base states ψᵢ and ψₖ. In general, it is assumed that any function f^{(α)} is expressed by expansion by n number of base functions.

f^{(α)}=c₁^{(α)}ψ₁^{(α)}+c₂^{(α)}ψ₂^{(α)}+ . . . +cₙ^{(α)}ψₙ^{(α)}

According to group theory, n*n number of base states ψᵢψₖ expressed by a direct product of a combined system are reducible expressions and can be decomposed into two base states expressed by n(n+1)/2 number of symmetric products and n(n−1)/2 number of antisymmetric products (see Document A4).

symmetric ψᵢ^{(α)}ψₖ^{(β)}+ψₖ^{(α)}ψᵢ^{(β)}

Antisymmetric ψᵢ^{(α)}ψₖ^{(β)}−ψₖ^{(α)}ψᵢ^{(α)}ψᵢ^{(β)}(i≠k,α≠β)(α),(β)=H,V,C {Math. 16}

If performing series expansion on distribution functions of the hue plane (H), value plane (V), and chroma plane (C) by using the same base functions, the features of the shapes of the distribution functions in the same color planes can be measured by the expansion coefficients of waveform formed by the base functions of the symmetric products and can be measured also by the expansion coefficients of waveforms formed by the base functions of the antisymmetric products. These expansion coefficients based on the waveforms of the combined system are guaranteed to have mutual orthogonality of base states before combination, therefore the expansion coefficients based on the base states of the combined system can be expressed as matrix elements in the form of symmetric products and antisymmetric products.

A perceptual invariant is defined by taking a trace of the matrix. Note, usually, the trace indicates only a sum of diagonal elements. However, here, a new extension type trace taking a sum of non-diagonal elements in an oblique direction maintaining only a quantum number difference having constant row and column positions is defined. Due to this, at what kind of ratio the components of combined waveforms due to two base states maintaining a constant quantum number difference are present in distribution functions can be detected in a state taking the total sum over all possible combined waveforms. Between two distribution functions of different color planes, by what kind of ratio the combination of different base states having constant quantum numbers is present is evaluated by the two kinds of combined waveforms in the symmetric state and antisymmetric state of that combination.

$$\begin{matrix}{I}_{m - k - i}^{( α ) ( β ) +} = {\sum }_{{i , k}_{m - k - i}} ( {c}_{i}^{( α )} {c}_{k}^{( β )} + {c}_{k}^{( α )} {c}_{i}^{( β )} ) \\ {I}_{m = k - i}^{( α ) ( β ) -} = {\sum }_{{m = k - i}^{i , k}} ( {c}_{i}^{( α )} {c}_{k}^{( β )} - {c}_{k}^{( α )} {c}_{i}^{( β )} )\end{matrix} \qquad \{ Math . 17 \}$$

Here, when taking cᵢ in a Chebyshev expansion coefficient of the color histogram, Iᵢ becomes equal to Fᵢ. When taking cᵢ in a spherical Bessel expansion coefficient of the texture PDF, Iᵢ becomes equal to Gᵢ. Note, the numbers i are assigned in order to the plurality of found invariant elements irrespective of symmetry or antisymmetry.

Here, the applicant will try and compare a perceptual invariant of the above definition with an invariant of a field in an electromagnetic field. According to the Document A5, as the invariants with respect to the Lorentz transformation of an electrical field E and a magnetic field H, there are the two types of a true scalar type and a false scalar type.

FᵢₖF^{ik}=H²−E²=inv.

e^{iklm}FᵢₖFₗₘ=\vec{E}·\vec{H}=inv. {Math. 18}

These two are found by a trace of a quadratic form of a four-dimensional electromagnetic field tensor F^{ik}. The latter is accompanied with the completely antisymmetric unit tensor e^{iklm}, but the former is not accompanied with that. Note, the notation of the sum concerning the tensor is omitted by the Einstein Summation Convention.

Accordingly, even when shifting from one image to another image, the perceptual invariants giving the same perception become extremely similar to the invariants of the field at the time of conversion from one reference system to another reference system in an electromagnetic field. In the former section, the discussion was made by linking perceptual invariants with mechanical energy. However, rather, it is franker to consider that there are several kinds of “perceptual fields” not limited to two kinds and that the energy of the field is propagated through them. Further, the components of an electromagnetic field are the four dimensions of time and space. However, it is presumed that the components of perception include at least the order of elements necessary for describing a distribution function. However, naturally, it may be thought that, in learning in the process of growth of neuronical circuits in the human brain, an electrical signal circuit activated by the fields is constructed with respect to these perceptual fields or an energy level of a neuronical circuit which is instantaneously activated in terms of energy is acquired.
[Document A4] Landau and Lifshitz, Course of Theoretical Physics, Volume 3 “Quantum Mechanics (Non-Relativistic Theory),” (Third Revised Edition, 1977), Chapter 12 “The Theory of Symmetry,” Section 94 “Representations of groups.”
[Document A5] Landau and Lifshitz, Course of Theoretical Physics, Volume 2, “The Classical Theory of Fields” (Original Sixth Edition, 1973), Chapter 3 “Charges in Electromagnetic Fields”, Section 23 “The electromagnetic field tensor”, Section 24 “Lorentz transformation of the field”, and Section 25 “Invariants of the field”

### First Embodiment

### Hilbelt Space Expression of Color Histogram and Linear Sum of Perceptual Invariants

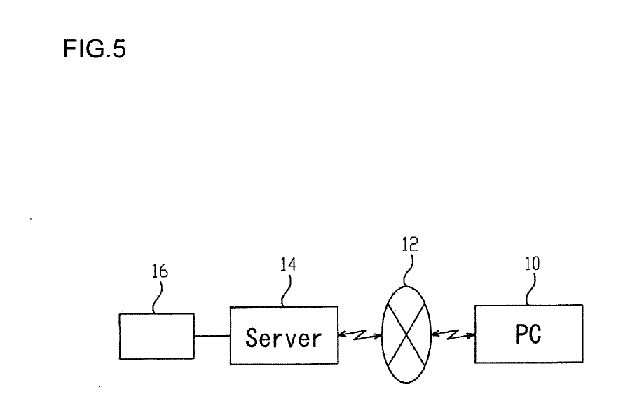

Below, an explanation will be given of an image sorting apparatus according to a first embodiment with reference to the drawings. FIG. 5 is a block diagram showing an image sorting apparatus according to the embodiment. Here, the image sorting apparatus is realized by a personal computer 10. The personal computer 10 is connected to a digital camera or other computer, receives image data from the digital camera or other computer or receives image data from a memory card mounted in a memory card slot, and stores the data in a hard disk device (not shown). The personal computer 10 performs image sorting processing, explained below, on the stored image data.

An image sorting program may be loaded to the personal computer 10 from a CD-ROM or other storage medium storing the program or through a network 12 etc.

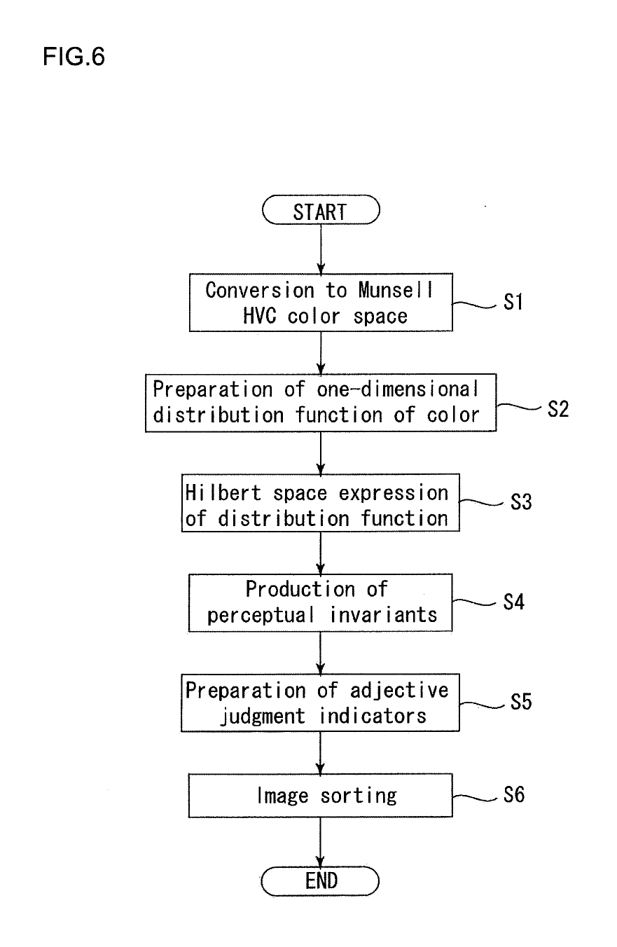

When it is loaded through the network 12, a program read out from a hard disk device 16 connected to a server 14 is loaded. The personal computer 10 is configured by a CPU and peripheral circuits controlled by the CPU. The CPU performs the image sorting processing shown in the flow chart of FIG. 6 based on the program which the CPU installs.

<Processing of Searched Image>

1. Conversion to Munsell HVC Color Space (FIG. 6, Step S1)

An input image is converted to a Munsell color space in which the human perceptual color uniformity is high. The Munsell color space is a color space indexed so that the hue H is divided into 100 degrees in a circle, the value V is distributed at levels from 0 to 10, and the chroma C is distributed at levels from 0 to about 25. It is color space designed so as to satisfy a perceptual uniformity such that a human perceives the color difference 2 of C as the equivalent color difference with respect to the color difference of V. In that, a region having a value of C not more than 1 and a region in which the value of V is 0.5 or less and 9.5 or more are defined as N (neutral hue). It is possible to convert from a color space expressed by an RGB space to an HVC color space by a numerical equation on an approximate basis through transformation to an XYZ space. This is realized by introducing an equation for correcting an insufficient color uniformity by utilizing the definition of the uniform color space L*a*b* or L*C*H*.

When an input image is for example an image expressed by an sRGB color space to which an output gamma characteristic is applied, first, it is returned back to linear tones, then is converted to an XYZ space according to the sRGB standard.

$$1 \text{-} 1. Conversion to linear tones RGB \\ {R}_{sRGB}^{linear} = {γ}^{- 1} ( {R}_{sRGB} ) \\ {G}_{sRGB}^{linear} = {γ}^{- 1} ( {G}_{sRGB} ) \\ {B}_{sRGB}^{linear} = {γ}^{- 1} ( {B}_{sRGB} ) \\ 1 \text{-} 2. Conversion to XYZ space \\ ( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}{R}_{sRGB}^{linear} \\ {G}_{sRGB}^{linear} \\ {B}_{sRGB}^{linear}\end{matrix} ) \\ 1 \text{-} 3. Conversion to Mi , M 2 , M 3 spaces \\ {H}_{1} = 11.6 \{ {( \frac{X}{{X}_{0}} )}^{1 \text{/} 3} - {( \frac{Y}{{Y}_{0}} )}^{1 \text{/} 3} \} \\ {H}_{2} = 11.6 \{ {( \frac{Y}{{Y}_{0}} )}^{1 \text{/} 3} - {( \frac{Z}{{Z}_{0}} )}^{1 \text{/} 3} \} \\ {H}_{3} = 11.6 {( \frac{Y}{{Y}_{0}} )}^{1 \text{/} 3} - 1.6 \\ {M}_{1} = {H}_{1} \\ {M}_{2} = 0.4 * {H}_{2} \\ {M}_{3} = 0.23 * {H}_{3} \\ 1 \text{-} 4. Conversion to HVC space \\ \overline{H} = arctan ( {M}_{2} \text{/} {M}_{1} ) \\ {S}_{1} = \{ 8.88 + 0.966 * cos ( \overline{H} ) \} * {M}_{1} \\ {S}_{2} = \{ 8.025 + 2.558 * sin ( \overline{H} ) \} * {M}_{2} \\ H = arctan ( {S}_{2} \text{/} {S}_{1} ) \\ V = 11.6 {( \frac{Y}{{Y}_{0}} )}^{1 \text{/} 3} - 1.6 \\ C = \sqrt{{S}_{1}^{2} + {S}_{2}^{2}} \qquad \{ Math . 19 \}$$

In the first embodiment, for the hue plane, a plane from which N (neutral) is separated is prepared.

2. Preparation of One-Dimensional Distribution Function of Color (FIG. 6, Step S2)

A histogram of each of the HVC planes is prepared. The bin number of the histograms may be set to about 200 for all of H, V, and C. At this time, as the hue plane, use is made of a plane from which N is separated. Accordingly, even when the histogram of the H plane is integrated by a hue circle, an area ratio classified to N is not included. N is usually distributed at random in the hue circle, therefore a disorderly uniform offset state distribution will be excluded from the histogram of the hue plane, and the original chromatic color histogram shape will remain. For convenience, when the value of the histogram is normalized by the pixel number, the histogram becomes a one-dimensional distribution function expressing the probability density of the pixel values. The schematically prepared distribution function is expressed as follows.

f(H),f(V),f(C)

3. Hilbelt Space Expression of Distribution Function (FIG. 6, Step S3)

3-1. Variable Transform

When the distribution area of the abscissa of the histogram is [a,b] and the distribution area of the ordinate is [fa,fb], variable transform is carried out for intervals in which the abscissa is contained in [−1,1] and in which the ordinate is contained in [−1,1]. For convenience only in this section, when expressed converting the variable of the abscissa from x to y and converting the variable of the ordinate from fx to fy, the transform equations become as follows.

Variable transform of abscissa: y={x−(b+a)/2}/{(b−a)/2}

Variable transform of ordinate: fy={fx−(fb+fa)/2}/{(fb−fa)/2}

The distribution area of the histogram of the hue plane is a hue circle, therefore a starting break point is set, and a distribution area making one circle from that and returning back to the same point is set. The starting point “a” is not a fixed point. The point at which the density of the distribution function becomes the minimum is searched for each of the images, and the break point is set there.

According to the method of definition of the variable transform of the ordinate, a certain constant factor is added to the series expansion coefficients shown below. If considering that the expansion coefficients correspond to momentum as explained in the outline, this corresponds to the constant factor remaining by the statistical mean of the image group being left as uniform translation of the entire system according to the method of selection of the Hilbelt space coordinate system of the entire image group system.

3-2. Series Expansion by Chebyshev Polynomials

The distribution area of the abscissa subjected to the variable transform explained above is expressed by x irrespective of H, V, and C. The distribution functions of HVC are expanded by the N number order of Chebyshev functions.

$$f ( x ) = {\sum }_{n = 0}^{N - 1} {c}_{n} {T}_{n} ( x ) \qquad \{ Math . 20 \}$$

The expansion coefficients cₙ are found by the following equation by utilizing the orthogonality of the base functions.

$${c}_{n} = \frac{2}{π} {\int }_{- 1}^{1} \frac{f ( x ) {T}_{n} ( x )}{\sqrt{1 - {x}^{2}}} d x \qquad \{ Math . 21 \}$$

Note, when n=0, specially, c₀ is made equal to c₀/2.

Here, the variable transform will be introduced.

$${x}_{k} = cos ( \frac{π ( k - \frac{1}{2} )}{N} ) , \\ k = 1 , 2 , … , N \qquad \{ Math . 22 \}$$

When performing this, the expansion coefficients are simply found as follows.

$${c}_{n} = \frac{2}{N} {\sum }_{k = 1}^{N} f ( {x}_{k} ) {T}_{n} ( {x}_{k} ) \qquad \{ Math . 23 \}$$

When the number of bins of the color histogram is about 200, the order of expansion may be set so that N becomes equal to about 50.

2. Production of Perceptual Invariants (FIG. 6, Step S4)

A combined system of two Chebyshev base functions is used to extract the shapes of the distribution functions of the H, V, and C histograms. That is, the perception appearing due to structures taken by the HVC distribution functions is extracted as the feature.

With respect to the matrix elements formed by the quadratic form of expansion coefficients, the perceptual invariants are defined by the trace of the matrix elements having a constant quantum number difference. The quantum number difference “m” can be defined up to m=0, 1, 2, . . . , N/2 in the case of a symmetric state, while can be defined up to m=0, 1, 2, . . . , N/2−1 in the case of an antisymmetric state. An example of preparation where the quantum number difference is 0, 1, and 2 is shown. Here, with one exception, the definition is made after normalization so that all of the values of the invariants are contained in [−1,1]. Further, when the range of the sum exceeds the range of k=0, 1, . . . , N−1, the result is handled regarding that k=0 is annularly connected next to k=N−1.

Evaluation According to Combined System of Base Functions in the Same Color Plane

$${F}_{m = 0}^{( α ) ( α ) +} = {\sum }_{k = 0}^{N - 1} {( {c}_{k}^{( α )} )}^{2} \\ {F}_{m = 1}^{( α ) ( α ) +} = \frac{{\sum }_{k = 0}^{N - 1} {c}_{k}^{( α )} {c}_{k + i}^{( α )}}{{\sum }_{k = 0}^{N - 1} {( {c}_{k}^{( α )} )}^{2}} \\ {F}_{m = 2}^{( α ) ( α ) +} = \frac{{\sum }_{k = 0}^{N - 1} {c}_{k}^{( α )} {c}_{k + 2}^{( α )}}{{\sum }_{k = 0}^{N - 1} {( {c}_{k}^{( α )} )}^{2}} \qquad \{ Math . 24 \}$$

Evaluation According to Combined System of Base Functions Between Different Color Planes

$${F}_{m = 0}^{( α ) ( β )} = \frac{{\sum }_{k = 0}^{N - 1} \frac{1}{2} ( {c}_{k}^{( α )} {c}_{k}^{( β )} + {c}_{k}^{( α )} {c}_{k}^{( β )} )}{\sqrt{{\sum }_{k = 0}^{N - 1} {( {c}_{k}^{( α )} )}^{2}} \sqrt{{\sum }_{k = 0}^{N - 1} {( {c}_{k}^{( β )} )}^{2}}} \\ \text{?} = \frac{{\sum }_{k = 0}^{N - 1} \frac{1}{2} ( {c}_{k}^{( α )} {c}_{k + 1}^{( β )} + {c}_{k + 1}^{( α )} {c}_{k}^{( β )} )}{\sqrt{\text{?} {( {c}_{k}^{( α )} )}^{2}} \sqrt{{\sum }_{k = 0}^{N - 1} {( {c}_{k}^{( β )} )}^{2}}} , \\ {F}_{m = 1}^{( α ) ( β ) -} = \frac{{\sum }_{k = 0}^{N - 1} \frac{1}{2} ( {c}_{k}^{( α )} {c}_{k + 1}^{( β )} - {c}_{k + 1}^{( α )} {c}_{k}^{( β )} )}{\sqrt{{\sum }_{k = 0}^{N - 1} {( {c}_{k}^{( α )} )}^{2}} \sqrt{{\sum }_{k = 0}^{N - 1} {( {c}_{k}^{( β )} )}^{2}}} \\ {F}_{m = 2}^{( α ) ( β ) +} = \frac{{\sum }_{k = 0}^{N - 1} \frac{1}{2} ( {c}_{k}^{( α )} {c}_{k + 2}^{( β )} + {c}_{k + 2}^{( α )} {c}_{k}^{( β )} )}{\sqrt{{\sum }_{k = 0}^{N - 1} {( {c}_{k}^{( α )} )}^{2}} \sqrt{{\sum }_{k = 0}^{N - 1} {( {c}_{k}^{( β )} )}^{2}}} , \\ {F}_{m = 2}^{( α ) ( β )} = \frac{{\sum }_{k = 0}^{N - 1} \frac{1}{2} ( {c}_{k}^{( α )} {c}_{k - 2}^{( β )} - {c}_{k - 2}^{( α )} {c}_{k}^{( β )} )}{\sqrt{{\sum }_{k = 0}^{N - 1} {( {c}_{k}^{( α )} )}^{2}} \sqrt{{\sum }_{k = 0}^{N - 1} {( {c}_{k}^{( β )} )}^{2}}} \\ \text{?} \text{indicates text missing or illegible when filed} \qquad \{ Math . 25 \}$$

An invariant with a plus sign indicates a ratio of existence of signs of waveforms according to the symmetric state of the combined system occupied in the distribution functions of the image, while an invariant with a minus sign indicates a ratio of existence of signs of waveforms according to the antisymmetric state of the combined system occupied in distribution functions of the image.

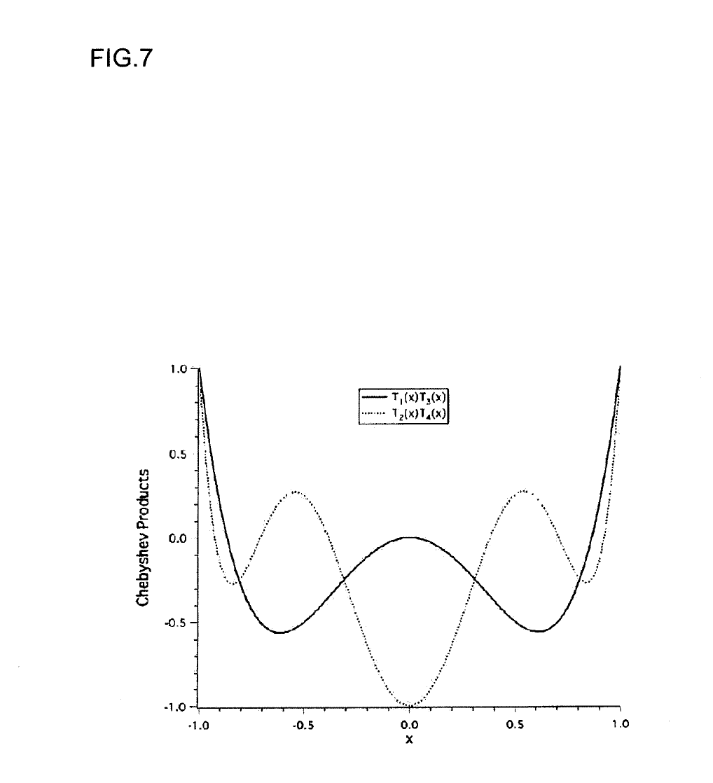

A case where the value of an invariant is close to zero means that there is no component of that combined waveform at all, a case where it is close to +1 means that there many components in the form of that combined waveform as it is, and a case where it is close to −1 means that there are many components having waveforms obtained by inverting the signs of the combined waveforms. As an example, waveform diagrams of the combined waves T₁T₃ and T₂T₄ in the symmetric state (see FIG. 7), components covered when forming a trace of Fm=2 (α)(α)+, are shown.

When a perceptual invariant having a quantum number difference different from zero between different color planes shows a significant value, the distribution function of a certain color plane and the distribution function of another color plane will always be accompanied with some sort of unique shape difference. Contrary to this, when a perceptual invariant having a quantum number difference of zero between different color planes shows a significant value, the shapes of the distribution functions of the two color planes will be extremely similar.

Only Fm=0(α)(α)+ cannot be normalized. The interval of the value of the distribution function is converted by variable transform to [−1,1], therefore the actual value becomes a value close to zero or a value from about 0.4 to about 1.5. The content meant by this value shows that the larger the value, the higher the ratio of expression by over-concentration to a certain base state among distribution functions, and the smaller the value, the higher the ratio of expression by dispersion to a variety of base states. For Fm≠0(α)(α)+ as well, in the same way, when the absolute value of the value is large, this means that the degree of over-concentration to a certain one combined waveform among base states of the combined system is high, and when the absolute value of the value is small, the expression is carried out with dispersion to many base states of the combined system or there are not many waveform components expressed by base states of this combined system.

The symmetric state and the antisymmetric state are in a conjugated relationship. When investigating the degree of alignment of an image group concerning invariants for perceptual invariants of the symmetric product and antisymmetric product having the same quantum number difference, it is unclear what perception the image groups have because the values distribute around zero in the symmetric product, but the values appear at both end portions in the distribution of indicators in the antisymmetric product. Further, the reverse to that is true as well. The image groups are unclear in the indicators of the antisymmetric product, but the values appear at both end portions in the distribution of indicators in the symmetric product. This fact is a natural conclusion when thinking in terms of equations as follows. That is, when the value of the symmetric product is zero, cᵢ^{(α)}cₖ^{(β)}=−cₖ^{(α)}cᵢ^{(β)}, therefore the result becomes the value of the antisymmetric product:

cᵢ^{(α)}cₖ^{(β)}−cₖ^{(α)}cᵢ^{(β)}=2cᵢ^{(α)}cₖ^{(β)}=−2cₖ^{(α)}cᵢ^{(β)}

The largest value is easily taken either at the plus or minus side.

5. Preparation of Adjective Judgment Indicators (FIG. 6, Step S5)

5-1. Linear Combination of Perceptual Invariants

As the indicator for searching for a certain perceptual adjective (i), a new indicator Qᵢ obtained by linear combination of perceptual invariants is prepared by utilizing the property of additivity of the perceptual invariants. The adjectives which can be expressed by the indicator Qᵢ are not only single adjectives, but also pairs of adjectives provided with adjectives having exact opposite natures.

Qᵢ=α₁F₁+α₂F₂+ . . .

Here, the value of the linear combination parameter αᵢ is normalized so that Qᵢ becomes the indicator in the range of [−1,1] again.

5-2. Setting of Parameters of Searched Adjectives

Linear combination parameters corresponding to predetermined adjectives are learned in advance, and model parameters thereof are set.

6. Image Sorting Processing (FIG. 6, Step S6)

Images are sorted based on an adjective judgment indicator. The adjective judgment indicator Qᵢ is computed for each of the images of an input image database group. The images are then rearranged in the order of magnitude of the value of Qᵢ. The power distribution of the image group takes the form of a Gaussian distribution or Poisson distribution with respect to the judgment indicator Qᵢ, therefore an image showing specificity with respect to that adjective judgment indicator is proposed at both ends at a statistically significant level more than the other image groups.

A concrete example of what perception an extracted image actually gives is shown. The simplest linear combination is a case where the coefficient parameter is finite with respect to only one perceptual invariant, but all of the others become zero. Only the properties of these are shown. The method of determination when a plurality of coefficient parameters remain will be explained in the section of model learning explained later.

It was actually confirmed experimentally that perceptual invariants of the quadratic form projected to a Hilbelt space in which physical phenomena can be easily described in this way, continuing to act unwaveringly with respect to the change of the signal distribution of the image, and provided with an additive property exhibit an extremely deep connection and linearity with higher order adjective pairs of a general nature in color psychology (see Document C1). In order to show that deep connection, examples of terms of adjective pairs which can be obtained from the perceptual invariants will be described below.

A state of gradual transition of the perception axis was experimentally confirmed between images having the same type of perceptual invariants, but varied in the value of the quantum number difference. This becomes a method of description which is very fitting for the duality of adjectives. That is, among adjectives, with respect to rough class of “lively”, there are the same order expressions of a finer class such as “flowery”, “showy”, and “noisy”. That fine sorting capability becomes indispensable for perceptual retrieval.

In the effective quantum number difference range, when the non-diagonal components of the matrix elements become relatively small with respect to the values which can be taken by the diagonal components, that is, in comparison with 1±, it is appropriate to think that there would no longer be any meaningful perceptual sorting capability. That is, when the distribution range of values of perceptual invariants of the trace of the matrix elements is wide, an array having high correspondence with perception is obtained. However, when that distribution range becomes small, the correspondence is no longer seen. This is confirmed experimentally as well.
[Document C1] The Color Science Association of Japan ed., Course of Color Science, vol. 1, “Color Science” (Asakura Publishing Co., Ltd., 2004), Chapter 3 “Psychology of Color”, Section 3.2 “Measurement Method of Sense, Perception, Recognition”, Table 3.4 “Adjective Pairs Frequently Used for Image Measurement of Color” and Section 3.4 “Recognition of Color”, Table 3.13 “Comparison of Factor Analysis With Respect to Colors by Students of Japan and USA.”

A concrete example will be shown below.

Fm=0(α)(α)+(α)(α)=HH⊕VV⊕CC Static-Dynamic {Math. 26}

This is an additive mean of perceptual invariants produced in the three color planes. From the perceptual invariants, an array of perceptual images of the adjective pair “static-dynamic” is obtained. As “static” images, photos of distant scenery where it seems as if time has stopped for an instant cluster. As “dynamic” images, photos of many persons dancing in a festival and photos in which the bustling nature of a city is conveyed cluster.

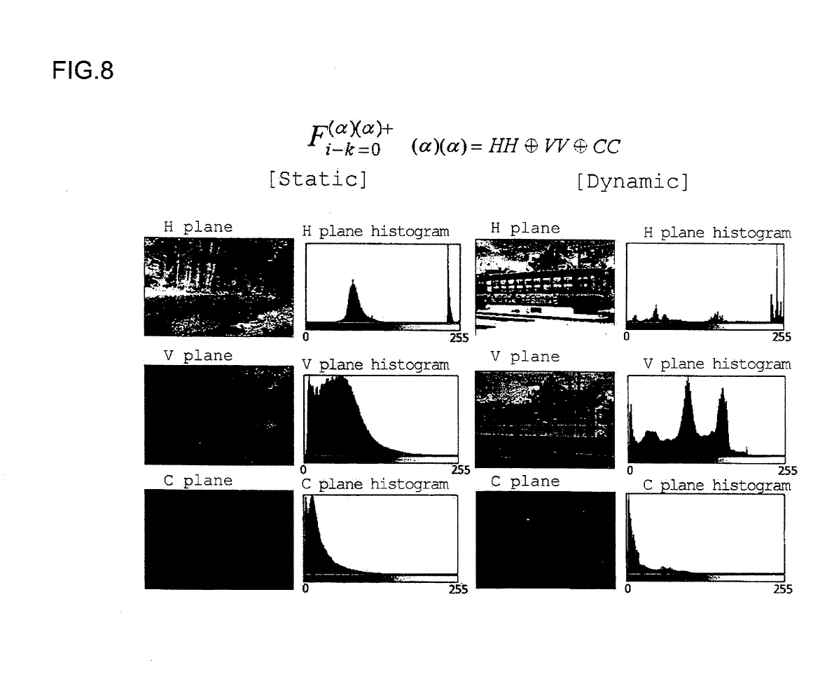

FIG. 8 shows an example of color histogram shapes of the HVC planes of images located near two ends of an image distribution. In the color histograms of a “static” image, all of the H, V, and C planes form groups exhibiting a shape like a single band structure bunched at the state component of one base function. In contrast, in a “dynamic” image, each of H, V, and C planes has many complex peak shapes and has a histogram structure which cannot be described by a simple waveform, so are dispersed.

Fm=0(α)(β)+(α)(β)=VC “Closed-Open” {Math. 27}

From the perceptual invariants, an array of perceptual images having an adjective pair of “closed-open” is obtained. Images having much shade are clustered as “closed” images. As the other “open” images, many images having a little more brightness and spatial spread as a whole are clustered.

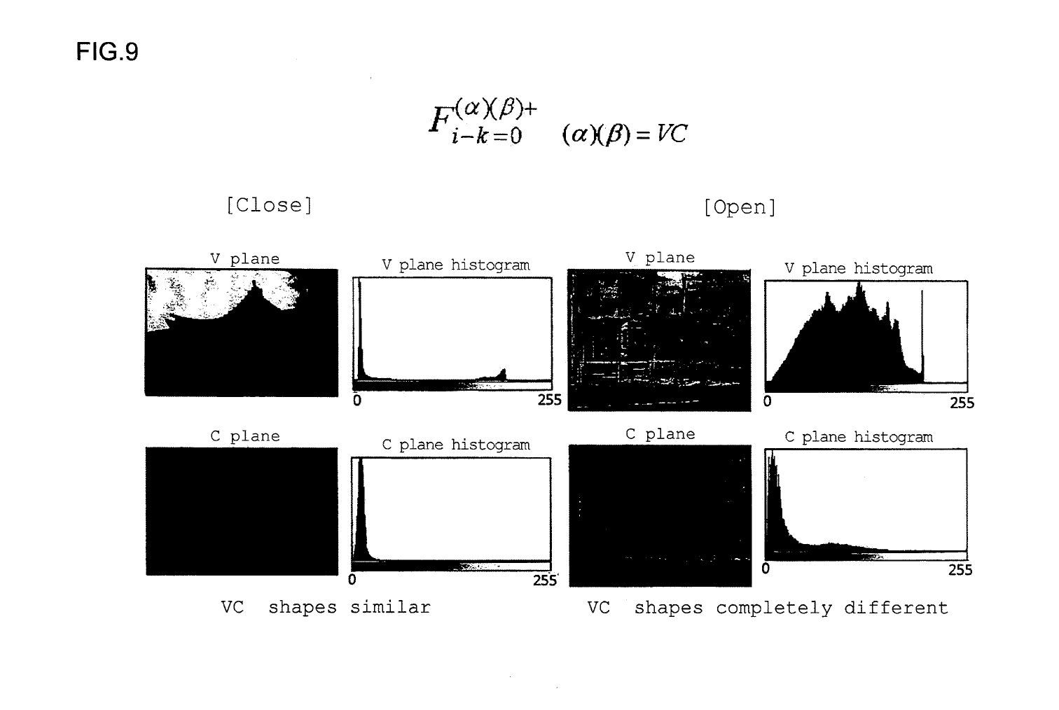

FIG. 9 shows an example of color histogram shapes of the HVC planes of images located near the two ends of the image distribution. In the color histograms of the “closed” image, the similarity of shapes is extremely high between V and C. The color histograms of the other “open” image exhibit completely different shapes at the V plane and the C plane.

Fm=0(α)(β)−(α)(β)=VC “Excited-Calm” {Math. 28}

From the perceptual invariants, an array of perceptual images having an adjective pair of “excited-calm” is obtained. This adjective pair is positioned as having a conjugated relationship with the adjective pair of “closed-open” derived from the symmetric product. As “excited” images, many photos of autumn leaves comprised of colorful ginkgo trees and maple trees, photos of scenery catching the instant of the pink flash of the evening, and photos catching the instant of motion of clouds gathering cluster. As the other “calm” images, photos catching the instant when motion completely stops and further provided with deep colors cluster.

<Model Learning of Perceptual Adjectives>

The value of a perceptual invariant is uniquely determined from observed quantities of distribution functions of the image. To obtain correspondence with adjectives by learning in advance, it is necessary to determine the linear combination parameters for each adjective.

1) Least Square Method

One or more persons select images provided with an impression corresponding to certain adjective from a group of images for learning data. The function of square error for measuring the reproducibility of that is introduced, the linear combination parameters are assumed to be unknown, and each parameter is partially differentiated to find the local minimum point. In this way, each combination parameter is determined. This is fitting of coefficients by the least square method.

2) Determination from Positional Relationship in Gamut of Image Distribution

When a plurality of perceptual invariants are produced from distribution functions of a certain image, what position that image occupied among the perceptual invariants found also for all images of the image database group expresses the perception generated from that image. That is, a borderline at the end of the distribution of the image group with respect to each perceptual invariant can be regarded as the gamut which can be taken by a signal distribution of a natural image. An image located at the end of this gamut can be considered to generate an extremely important signal with respect to that invariant, while an image located at the center may have a property not related to that invariant. Accordingly, numerical values in the range of [−1,1] may be set by using the position in the gamut at which that image exists as it is as the value of the linear combination parameter. Note that normalization among all linear combination parameters is carried out at the end.

As explained before, when a plurality of images are selected for learning with respect to one adjective, for the selected image group, the simply statistically averaged coordinate position in the gamut of each perceptual invariant may be made the learning result of the linear combination parameter with respect to that adjective. If image groups selected with respect to a certain perceptual invariant are dispersed and scattered, the value of the parameter αᵢ approaches zero by the statistical average. This means that the perceptual invariant is not connected with that adjective. Contrary to this, in a case where selected image groups gather in the same direction, even when these are statistically averaged, a value having meaning remains as the parameter αᵢ, so that perceptual invariant is very important for that adjective. In this way, the perceptual invariant specially acting for a certain adjective is extremely simply derived. Note that, the method of model learning explained above can be commonly used in all embodiments which will be explained below.

### Second Embodiment

### Hilbelt Space Expression of Texture PDF and Linear Sum of Perceptual Invariants

Next, an explanation will be given of production of perceptual invariants according to a second embodiment. Note that, in the second embodiment, the method of production of the perceptual invariants in the first embodiment was modified to the following method.

<Processing for Searched Image>

1. Transformation to Munsell HVC Color Space

As the hue plane, a plane where N is not separated is prepared. The hue plane in an N region will behave like random noise in the hue plane. However, in the following edge extraction process, that plays a role as being detected as a feature different from the other chromatic hue.

In the method of obtaining one-dimensional coordinates in a hue circle, it is possible to use the origin of the Munsell color circle, that is, red, as the start point, go around once, and make the end point red again after passing through purple. However, more desirably, in the same way as the first embodiment, it is possible to make a cut at the point at which the degree of distribution of hue becomes the minimum in each image and set the start point and end point there. This is because, by performing this, the hue circle is split and therefore the signal strength fluctuates at the two ends and the adverse influence due to excessive evaluation of an edge component when extracting an edge in a color plane is suppressed to the lowest limit.

2. Preparation of Edge Image

2-1. Multiplex Resolution Transform and Edge Extraction

1) Wavelet Transform

A wavelet transform is used to project an image to a frequency space expressed by multiplex resolution, and high frequency edge components of the H, V, and C color planes are extracted. Here, as the edge components, use is made of the wavelet decomposed high frequency subbands LH, HL, and HH as they are. When schematically describing this situation, when decomposed to a resolution of M stages, the result becomes as follows:

$${V}_{ij} ( \vec{x} ) = {Wavelet}_{( i , j )} \{ S ( \vec{x} ) \} \begin{matrix}i = 1 , 2 , … , M ( resolution ) \\ j = LL , LH , HL , HH\end{matrix} \qquad \{ Math . 29 \}$$

Note that, the LL component is sequentially decomposed to high frequency subbands having a low resolution, therefore the finally remaining LL component becomes only the lowest resolution one. As the wavelet transform, use is made of for example the following 5/3 filter.

<Wavelet Transform: Analysis/Decomposition Process>

High pass component: d[n]=x[2n+1]−(x[2n+2]+x[2n])/2

Low pass component: s[n]=x[2n]+(d[n]+d[n−1])/4

The one-dimensional wavelet transform as defined above is performed by independently performing two-dimensional separation type filter processing in the horizontal direction and vertical direction for wavelet decomposition. The coefficients “s” are collected at the L plane, and the coefficients “d” are collected at the H plane.

2) Laplacian Pyramid

Further, as another method of multiplex resolution transformation, other than wavelet transform, there is also the method of using a Laplacian pyramid. When forming a Laplacian pyramid, a vertical and horizontal (½)*(½) reduced image is formed once and returned back to an image having the original size by bilinear scaling, then the difference between this and the image before the reduction is taken to thereby obtain a high frequency image (Laplacian component) having that resolution. Note that, smoothening for preventing aliasing may be performed before forming the reduced image as well. When successively repeating this, a Laplacian pyramid in which high frequency images are linked can be formed. In the same way as the case of the wavelet transform, only one low frequency image (Gaussian component) remains at the lowest resolution.

It is disclosed in Document D1 that a histogram of signal values of a high frequency band produced by multiplex resolution transformation in this way (called a probability density function and abbreviated as PDF) exhibits a Gaussian distribution or Laplacian distribution. In general, the distribution shape of a PDF can be approximated by a symmetric generalized Gaussian.

The value of the stage number M of the multiplex resolution transformation may be decomposed up to one giving a pixel number of an extent where the histogram of the PDF of each band does not become rough. For example, it may be decomposed to about five stages for an image of the Quad VGA size (1280×960), may be decomposed to about three stages for an image of the QVGA size (320×240), and may be decomposed to about seven stages for an image of 20,000,000 pixels.

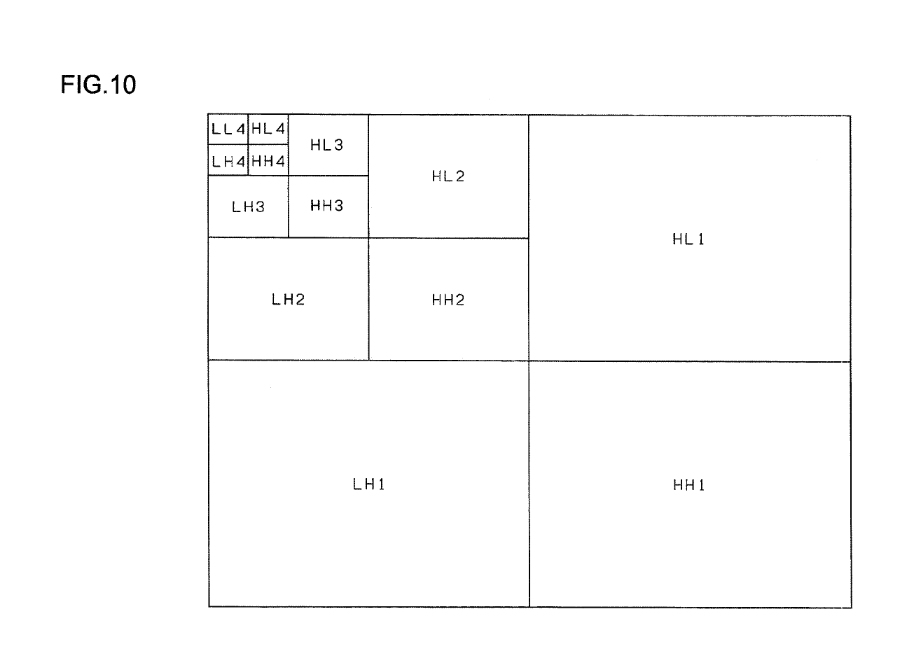

Note that, FIG. 10 is a diagram showing the situation of subband decomposition by a four-stage wavelet transform. For example, in the first-stage wavelet transform, data of the high pass component and low pass component are extracted for all rows in the horizontal direction first for image data in real space. As a result, data of the high pass component and low pass component of half the number of images is extracted in the horizontal direction. For those, for example, the high pass component is stored at the right side of a memory region in which the image data of the real space was stored, and the low pass component is stored at the left side.

Next, for the data of the high pass component stored at the right side of the memory region and data of the low pass component stored at the left side, the data of the high pass component and the low pass component are extracted for all columns in the vertical direction. As a result, from the high pass component at the right side of the memory region and the low pass component at the left side, data of the high pass component and low pass component are further extracted. Among those, the high pass component is stored at the lower side of the memory region where the data was stored and the low pass component is stored at the upper side.

As a result, the data extracted as the high pass component in the vertical direction from the data extracted as the high pass component in the horizontal direction is expressed as HH, the data extracted as the low pass component in the vertical direction from the data extracted as the high pass component in the horizontal direction is expressed as HL, the data extracted as the high pass component in the vertical direction from the data extracted as the low pass component in the horizontal direction is expressed as LH, and the data extracted as the low pass component in the vertical direction from the data extracted as the low pass component in the horizontal direction is expressed as LL. Note, the vertical direction and horizontal direction are independent. Therefore, even when the order of extraction is changed, the results are equivalent.

Next, in the second-stage wavelet transform, the high pass component and low pass component are extracted in the same way for the data LL extracted as the low pass component in the vertical direction from the data extracted as the low pass component in the horizontal direction by the first-stage wavelet transform. By repeatedly performing this up to the fourth stage, the result becomes as shown in FIG. 10.

[Document D1] Michael Gormish, “Source coding with channel, distortion, and complexity constraints,” Doctor thesis, Stanford Univ., March 1994, Chapter 5: “Quantifization and Computation-Rate-Distortion”.

2-2. Multiplex Resolution Synthesis

The high frequency subbands extracted as explained above express information concerning edge, texture, and contrast at each resolution scale. In order to comprehensively handle this information, multiplex resolution inverse transformation by only high frequency subbands is carried out and edge synthesis is carried out. Namely, the low frequency subband LLM with the lowest resolution is excluded and the values are all set to zero, then the remaining subbands are sequentially processed by an inverse wavelet transform. When schematically describing this situation, the following equation stands where a synthesized edge component having the same resolution as that of the input image is E:

$$E ( \overline{x} ) = {\sum }_{{i = LH , HL , HH}_{j = M , M - 1 , … , 2 , 1}} {Wavelet}^{- 1} \{ {V}_{ij} ( \vec{x} ) \} \qquad \{ Math . 30 \}$$

In this synthesis stage, the information of edge, texture, and contrast of different levels will be propagated to the other levels by taking the spatial position relationships into account. Note that, when a Laplacian pyramid is used, the Gaussian plane with the lowest resolution is set to zero, and the remaining Laplacian images are combined one after another.

3. Preparation of One-Dimensional Distribution Function of Synthesized Edges

Histograms (PDF) of the synthesized edge images extracted from HVC color planes are prepared. The bin numbers of the histograms may be set to about −128 to 128 while straddling the origin for all of H, V, and C. Note, assume that each of the HVC color planes is expressed by tones of about 200 bins.

A PDF is a histogram of the edge strength, therefore a distribution having approximately the same degree integration area on the positive and negative sides and exhibiting the peak at the origin is obtained. In general, in the case of a memoryless source having no correlation between resolutions, the edges exhibiting symmetric PDF distribution shapes at each level are combined while keeping their symmetric PDF distribution shapes as they are even when combined. However, in a case where there is correlation between resolutions, the situation of that correlation may be projected in the form of a PDF distribution shape.

In this way, the PDF of each high frequency subband surface can usually be approximated to the generalized Gaussian: exp(−|x|^{α}). However, the correlation of spatial contrast is reflected in the successively synthesized edge planes, so the PDF changes to a variety of shapes including asymmetry.

It was experimentally confirmed that such a characteristic shape of the PDF distribution of the synthesized edges appeared in substantially that shape when synthesizing about three stages' worth of edge components from the lowest resolution. Accordingly, when desiring to keep things simple, even without performing the synthesis down to the last real resolution, the PDF distribution shape at the middle stage of synthesis may be evaluated.

For convenience, when normalizing values of histograms by the pixel number, the result becomes a one-dimensional distribution function expressing the probability density of the pixel values. The diagrammatically prepared distribution function is expressed as follows. The reason for use of the Laplacian notation Δ is that the synthesis edge image describes the aspect of the second order differentiation of the pixel values of the original image.

f(ΔH),f(ΔV),f(ΔC)

4. Hilbelt Space Expression of Distribution Function

The distribution function of the synthesized edge image is processed by series expansion by spherical Bessel functions to make it possible to evaluate the shape by the expansion coefficients. In the second embodiment, the right expansion and the left expansion are individually carried out. However, left and right simultaneous expansion is carried out in a third embodiment which will be explained later. At that time, in the second embodiment, expansion by the root of the 0-th order spherical Bessel function is carried out. The outermost point of the expansion zone may be fixed and the number of roots included in that may be increased so as to deal with the formation of base functions having high frequency components.

4-1. Variable Transform

For the portion at the right side from the peak of a histogram, the distribution area of the abscissa is defined as [a,b](a<b), and the distribution area of the ordinate is defined as [fa,fb]. The variable transform is carried out for the intervals containing the abscissa in [0,1] and containing the ordinate in [0,1]. For the portion on the left side from the peak of the histogram, in the same way, the distribution area of the abscissa is defined as [b,a](b<a), the distribution area of the ordinate is defined as [fa,fb], and the same transform is carried out. Usually, the values of a to 0 and fa to 0 are taken. For convenience only in this section, when expressing the transformation of the variable of the abscissa from x to y and the variable of the ordinate from fx to fy, the transform equations become as follows.

Variable transform of abscissa: y=|x−a|/|b−a|

Variable transform of ordinate: fy=(fx−fa)/(fb−fa)

4-2. Series Expansion by Root of Spherical Bessel Functions

The distribution area of the abscissa subjected to the variable transform explained above is expressed by x irrespective of ΔH, ΔV, and ΔC. The distribution functions of the HVC color planes are expanded by base functions according to the roots of N number of 0-th order spherical Bessel functions. The notation “a” used here means the outermost point which becomes the expansion target of the distribution area unlike the explanation hitherto.

$$f ( x ) = {\sum }_{n = 1}^{N} {c}_{n} {j}_{0} ( {α}_{0 n} \frac{x}{a} ) \qquad \{ Math . 31 \}$$

The expansion coefficients cₙ are found by the following equation by utilizing the orthogonality of the base functions.

$${c}_{n} = \frac{2}{{{a}^{3} [ {j}_{1} ( {α}_{0 n} ) ]}^{2}} {\int }_{0}^{a} f ( x ) {j}_{0} ( {α}_{0 n} \frac{x}{a} ) {x}^{2} d x \qquad \{ Math . 32 \}$$

Here, αₙₘ means the value of the m-th zero point of the n-th order function.

jₙ(αₙₘ)=0 {Math. 33}

The root of the 0-th order function can be given analytically.

α₀ₘ=πm, m=1,2,3, . . .

Accordingly, at the m-th base function of the 0-th order function used for the series expansion, there are m number of zero points (roots) in an interval of [0,a]. That is, the base function obtained by setting “a” at the position of the first zero point of the 0-th order spherical Bessel function is used as the base function having the lowest frequency in that order. That function is reduced toward the direction of the origin. This is stopped when the second zero point reaches the position of “a”. The result is defined as the base function having the second lowest frequency in that order. This is successively repeated to produce base functions of high frequency in the interval in the distribution area [0,a] and thereby form a complete set. This is exactly the same for the case of an n-th order function as well.

The spherical Bessel functions form a complete set concerning root expansion. Therefore, when a value of N with a sufficient size is taken, the original function can be completely reproduced. When the number of bins of the histogram is about 128 at one side, the order of the expansion may be set to about 100.

5. Production of Perceptual Invariants

A combined system of two base functions is used to extract the shapes of the distribution functions of the texture PDFs of the HVC planes. That is, the perception appearing due to the structure taken by the distribution functions of the HVC combined edge image is extracted as the feature.

Right expansion and left expansion were carried out on one distribution function obtained from the edge components in the same color plane by using the same base functions. Therefore, in the method of formation of invariants of the quadratic form, the number of types increased to about two times or more than the case of the first embodiment. Below, an example of the method of formation of the invariants when the quantum number difference is 0 and 1 in the case of the symmetric product and the method of formation when the quantum number difference is 1 in the case of the antisymmetric product will be shown. By the same production method, the symmetric product can be defined up to when the quantum number difference is m=0, 1, . . . , N/2, and the antisymmetric product can be defined up to when the quantum number difference is m=1, 2, . . . , N/2−1.

When considering the right interval and left interval of the distribution function as different quadrants, a combined system can be formed from a combination of two base functions of same quadrant of the three planes H, V, and C in the same way as the first embodiment. Further, a combined system can be formed from the combination of two base functions between two quadrants as well. The former handles only the radial direction, therefore is given notation “r”. The latter is given the notation “z” in the meaning of straddling zero. The expansion coefficient on the right side is defined as cₖ^{(α+)}, and the left side expansion coefficient is defined as cₖ^{(α-)}.

Here, with one exception, the definition is made after normalization so that all of the values of the invariants are contained in [−1,1]. Further, when the range of the sum exceeds the range of k=1, . . . , N, the result is handled while regarding that k=1 is annularly connected next to k=N. The color planes are defined as (α), (β)=H, V, C.

Evaluation According to Combined System of Base Functions in the Same Color Plane

1) Combination in Same Quadrant

$${G}_{r , m - 0}^{( α ) ( α ) +} = {\sum }_{k = 1}^{N} \frac{1}{2} [ {( {c}_{k}^{( α + )} )}^{2} + {( {c}_{k}^{( α - )} )}^{2} ] \\ {G}_{r , m = 1}^{( α ) ( α ) +} = \frac{{\sum }_{k = 1}^{N} \frac{1}{2} [ {c}_{k}^{( α + )} {c}_{k + 1}^{( α + )} + {c}_{k}^{( α - )} \text{?} ]}{{\sum }_{k = 1}^{N} \frac{1}{2} [ {( {c}_{k}^{( α + )} )}^{2} + {( {c}_{k}^{( α - )} )}^{2} ]} \\ \text{?} \text{indicates text missing or illegible when filed} \qquad \{ Math . 34 \}$$

2) Combination of Different Quadrants

$${G}_{z , m = 0}^{( α ) ( α ) +} = \frac{{\sum }_{k = 1}^{N} {c}_{k}^{( α + )} {c}_{k}^{( α - )}}{\sqrt{{\sum }_{k = 1}^{N} {( {c}_{k}^{( α + )} )}^{2}} \sqrt{{\sum }_{k = 1}^{N} {( {c}_{k}^{( α - )} )}^{2}}} \\ {G}_{z , m = 1}^{( α ) ( α ) +} = \frac{{\sum }_{k = 1}^{N} \frac{1}{2} [ {c}_{k}^{( α + )} {c}_{k + 1}^{( α - )} + {c}_{k + 1}^{( α + )} {c}_{k}^{( α - )} ]}{\sqrt{{\sum }_{k = 1}^{N} {( {c}_{k}^{( α + )} )}^{2}} \sqrt{\text{?} {( {c}_{k}^{( α - )} )}^{2}}} , \\ {G}_{z , m = 1}^{( α ) ( α ) -} = \frac{{\sum }_{k = 1}^{N} \frac{1}{2} [ {c}_{k}^{( α + )} {c}_{k + 1}^{( α - )} - {c}_{k + 1}^{( α + )} \text{?} ]}{\sqrt{{\sum }_{k = 1}^{N} {( {c}_{k}^{( α + )} )}^{2}} \sqrt{\text{?} {( {c}_{k}^{( α - 1 )} )}^{2}}} \\ \text{?} \text{indicates text missing or illegible when filed} \qquad \{ Math . 35 \}$$

Evaluation according to combined system of base functions between different color planes

1) Combination in Same Quadrant

$${G}_{r , m = 0}^{( α ) ( β ) +} = \frac{\frac{1}{2} {\sum }_{k = 1}^{N} [ {c}_{k}^{( α + )} {c}_{k}^{( β + )} + {c}_{k}^{( α - )} {c}_{k}^{( β - )} ]}{\frac{1}{2} [ \begin{matrix}\sqrt{\text{?} {( {c}_{k}^{( α + )} )}^{2}} \sqrt{{\sum }_{k = 1}^{N} {( {c}_{k}^{( β + )} )}^{2}} + \\ \sqrt{{\sum }_{k = 1}^{N} {( {c}_{k}^{( α - )} )}^{2}} \sqrt{\text{?} {( {c}_{k}^{( β - )} )}^{2}}\end{matrix} ]} \\ {G}_{r , m = 1}^{( α ) ( β ) -} = \frac{\begin{matrix}\frac{1}{4} \text{?} [ {c}_{k}^{( α + )} {c}_{k + 1}^{( β + )} + {c}_{k + 1}^{( α + )} {c}_{k}^{( β + )} ] + \\ {\sum }_{k = 1}^{N} [ {c}_{k}^{( α - )} {c}_{k - 1}^{( β - )} + {c}_{k + 1}^{( α - )} {c}_{k}^{( β - )} ]\end{matrix}}{\frac{1}{2} [ \begin{matrix}\sqrt{\text{?} {( {c}_{k}^{( α - )} )}^{2}} \sqrt{{\sum }_{k = 1}^{N} {( {c}_{k}^{( β - )} )}^{2}} + \\ \sqrt{{\sum }_{k = 1}^{N} {( \text{?} )}^{2}} \sqrt{{\sum }_{k = 1}^{N} {( {c}_{k}^{( β - )} )}^{2}}\end{matrix} ]} , \\ {G}_{r , m = 1}^{( α ) ( β ) -} = \frac{\begin{matrix}\frac{1}{4} [ \text{?} [ {c}_{k}^{( α + )} {c}_{k + 1}^{( β + )} - {c}_{k + 1}^{( α + )} {c}_{k}^{( β + )} ] + \\ {\sum }_{k = 1}^{N} [ {c}_{k}^{( α - )} \text{?} - {c}_{k + 1}^{( α - )} {c}_{k}^{( β - )} ] ]\end{matrix}}{\frac{1}{2} [ \begin{matrix}\sqrt{\text{?} {( {c}_{k}^{( α - )} )}^{2}} \sqrt{{\sum }_{k = 1}^{N} {( {c}_{k}^{( β + )} )}^{2}} + \\ \sqrt{{\sum }_{k = 1}^{N} {( {c}_{k}^{( α - )} )}^{2}} \sqrt{{\sum }_{k = 1}^{N} {( \text{?} )}^{2}}\end{matrix} ]} , \\ \text{?} \text{indicates text missing or illegible when filed} \qquad \{ Math . 36 \}$$

2) Combination of Different Quadrants

$${G}_{r , m = 0}^{( α ) ( β ) +} = \frac{\frac{1}{2} {\sum }_{k = 1}^{N} [ {c}_{k}^{( α + )} {c}_{k}^{( β - )} + {c}_{k}^{( α + )} \text{?} ]}{\frac{1}{2} [ \begin{matrix}\sqrt{\text{?} {( {c}_{k}^{( α + )} )}^{2}} \sqrt{{\sum }_{k = 1}^{N} {( {c}_{k}^{( β - )} )}^{2}} + \\ \sqrt{{\sum }_{k = 1}^{N} {( {c}_{k}^{( α + )} )}^{2}} \sqrt{{\sum }_{k = 1}^{N} {( {c}_{k}^{( β - )} )}^{2}}\end{matrix} ]} \\ \text{?} = \frac{\begin{matrix}\frac{1}{4} \text{?} [ {c}_{k}^{( α + )} {c}_{k + 1}^{( β - )} + {c}_{k + 1}^{( α + )} {c}_{k}^{( β - )} ] + \\ {\sum }_{k = 1}^{N} [ {c}_{k}^{( α - )} {c}_{k + 1}^{( β + )} + {c}_{k + 1}^{( α - )} {c}_{k}^{( β + )} ]\end{matrix}}{\frac{1}{2} [ \begin{matrix}\sqrt{{\sum }_{k = 1}^{N} {( {c}_{k}^{( α + )} )}^{2}} \sqrt{{\sum }_{k = 1}^{N} {( {c}_{k}^{( β - )} )}^{2}} + \\ \sqrt{{\sum }_{k = 1}^{N} {( {c}_{k}^{( α + )} )}^{2}} \sqrt{{\sum }_{k = 1}^{N} {( {c}_{k}^{( β - )} )}^{2}}\end{matrix} ]} , \\ \text{?} = \frac{\begin{matrix}\frac{1}{4} [ {\sum }_{k = 1}^{N} [ {c}_{k}^{( α + )} {c}_{k + 1}^{( β - )} - {c}_{k + 1}^{( α + )} {c}_{k}^{( β - )} ] + \\ {\sum }_{k = 1}^{N} [ {c}_{k}^{( α - )} {c}^{( \text{?}} - {c}_{k + 1}^{( α - )} \text{?} ] ]\end{matrix}}{\frac{1}{2} [ \begin{matrix}\sqrt{{\sum }_{k = 1}^{N} {( {c}_{k}^{( α + )} )}^{2}} \sqrt{{\sum }_{k = 1}^{N} {( {c}_{k}^{( β - )} )}^{2}} + \\ \sqrt{{\sum }_{k = 1}^{N} {( {c}_{k}^{( α + )} )}^{2}} \sqrt{{\sum }_{k = 1}^{N} {( {c}_{k}^{( β - )} )}^{2}}\end{matrix} ]} \\ \text{?} \text{indicates text missing or illegible when filed} \qquad \{ Math . 37 \}$$

The values which can be taken by the invariants and their properties are exactly the same as the content explained in the first embodiment, so are omitted here.

6. Preparation of Adjective Judgment Indicators

6-1. Linear Combination of Perceptual Invariants

As the indicator for searching for a certain perceptual adjective (i), a new indicator Qᵢ obtained by linear combination of perceptual invariants is prepared by utilizing the property of additivity of the perceptual invariants. The adjectives which can be expressed by the indicator Qᵢ are not only single adjectives, but also pairs of adjectives provided with adjectives having exact opposite natures.

Qᵢ=β₁G₁+β₂G₂+ . . .

Here, the value of the linear combination parameter βᵢ is normalized so that the Qᵢ becomes the indicator in the range of [−1,1] again.

6-2. Setting of Parameters of Searched Adjectives

Linear combination parameters corresponding to predetermined adjectives are learned in advance, and model parameters thereof are set.

7. Image Sorting Process

Based on the adjective judgment indicator, images are sorted in the same way as the first embodiment. Below, what perception the extracted image actually gives will be shown by mentioning a concrete example. In the same way as the first embodiment, in the case of the texture as well, from this perceptual invariant, an array of images which are deeply related to the higher order adjective pair used in color psychology and having linearity could be obtained.

If observing the properties of perceptual invariants as a whole, by combining the base functions of different quadrants, invariants including antisymmetric elements of distribution functions include considerably strong emotional elements. On the other hand, when combining the base functions in the same quadrant, separation such as with the multiplicity or singularity of the object structure of images is possible, but the considerably neutral aspects are also strong. Below, adjectives will be assigned and examples given mainly for the case of combining different quadrants.

The situation differs slightly from the time of the distribution function of color of the first embodiment in that at the time of an edge distribution function, a large value remains even when the elements of the nondiagonal components are separated from the diagonal regions. In the former case, when the elements are separated from the diagonal regions, the strength rapidly falls as a short distance correlation. Compared with this, the latter has the property of a long distance correlation. This can be interpreted as showing that the number of emotions induced by the distribution structure of the texture is greater than the number of emotions induced by the distribution structure of color.

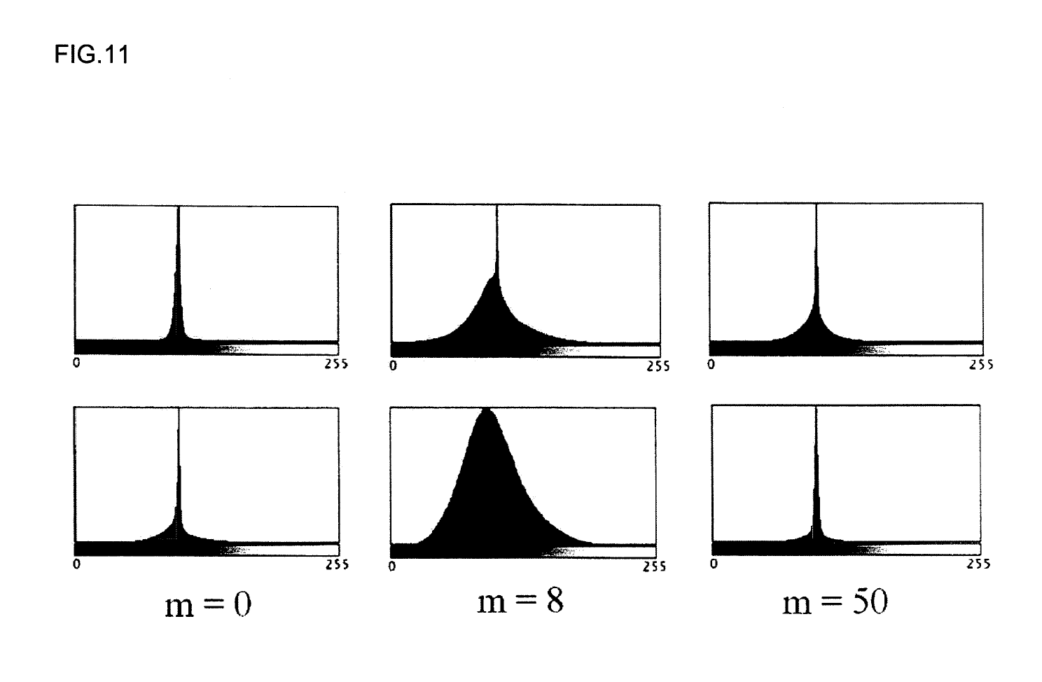

FIG. 11 is an example showing what kind of shape of distribution function corresponds to the two extreme ends of the arrayed image group distribution in the case of taking the additive mean

For the perceptual invariant Gz,m(α)(α)+(α)(α)=VV⊕CC {Math. 38}

in the case of taking the additive mean when the order of the expansion is N=100 and the quantum number difference “m” is shifted to m=0, 8, and 50. The top row shows the states of the distribution functions of the edge images of the V planes of the images positioned at first ends, while the bottom row shows the similar states of the images positioned at the other ends.

As the trend in the image group corresponding to FIG. 11, at the top level of m=0, images having largish elements in the images and giving a “rich” impression tend to cluster, while at the bottom level, images giving a “mysterious” impression tend to cluster. Further, from m=8, at the top level, complex images where two objects are superposed front and back and there are two elements of the background and a main subject cluster, while at the bottom level, integrated images of fine texture structures such as the leaves of trees and grass captured over the entire surface cluster.

Gz,m=0(α)(β)+(α)(β)=VC “Bustling, flowery-lonely, tidy” {Math. 39}

From this perceptual invariant, perceptual images combining two adjective pairs of “bustling-lonely” and “flowery-tidy” are sorted. “Bustling and flowery” images include images of scenes in which many large size structures and small size structure are contained. On the other hand, “lonely, tidy” images include many images in which blackish colored structure or dark shaded scenes are contained with a specific weight of area with a certain extent of visual impact.

Gz,m=4(α)(β)−(α)(β)=VC “Homey-grand” {Math. 40}

From this perceptual invariant, perceptual images of the adjective pair “homey-grand” are sorted. For “homey” images, many images accompanied with trees and shade are clustered. For “grand” images, photos of grand, distinctive scenery bathed in pink color, orange color, yellow color, etc., images accompanied with strings of strange clouds, images with steam or mist rising etc. are clustered.

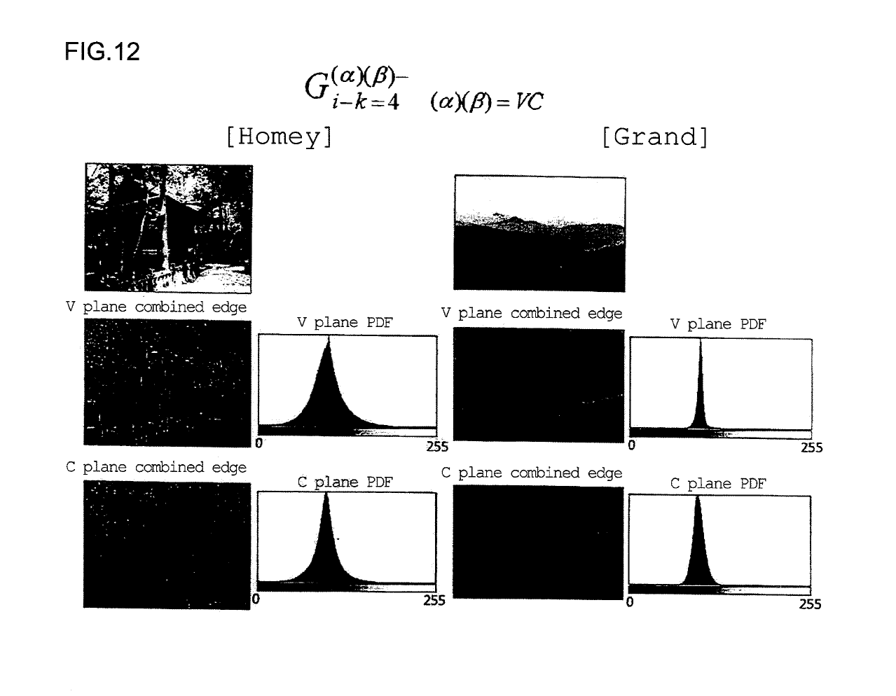

FIG. 12 shows the edge images and distribution functions of typical examples of images selected at the two ends. If explaining the shapes of the distribution functions, as shown at the left side of FIG. 12, if both the V plane and C plane have many edges or texture, a “homey” impression is given. On the other hand, as shown at the right side of FIG. 12, if the distribution function of the V plane edge image exhibits a strong value at a slight frequency, that is, if the distribution function has low lower slopes, the original picture was accompanied with image structures distinctively split by for example ridgelines of mountains etc. and with changes in the chroma plane woven into this along with a bold contrast of at least the change in contrast of the value component to thereby give a grand impression.

$$\\ \begin{matrix}Gz . m = 0 ( α ) ( α ) + & ( α ) ( α ) = HH & \begin{matrix}{}^{″} Summer and daytime scenes - \\ autumn \text{/} spring and evening \\ {scenes}^{″}\end{matrix}\end{matrix} \qquad \{ Math . 41 \}$$

From this perceptual invariant, adjective pairs are difficult to apply, but images are clearly divided into pairs of images of “summer and daytime scenes” and “autumn/spring and evening scenes”. Images of “summer and daytime scenes” have large areas of green and blue and are strong in contrast. Images of “autumn/spring and evening scenes” mostly include warm colors and are somewhat poor in change.

### Third Embodiment

### Hilbelt Space Expression of Texture PDF and Linear Sum of Perceptual Invariants

Next, a third embodiment will be explained. In the second embodiment, the histogram of the overall edge image was expanded divided into the right side and left side, but simultaneous left-right expansion facilitates discussion of symmetry and is therefore preferable, so below just the points to change will be explained. The perceptual invariants obtained from this are more easily linked with perception than in the second embodiment and are believed to be more orderly.

4. Hilbelt Space Expression of Distribution Function

The double series of root expansion by the even function of the 0th order spherical Bessel function and root expansion by the odd function of the 1st order spherical Bessell function is used for expression of the distribution function by Hilbelt space expression. This being the case, the symmetrical components of the distribution function shape are all clustered at the expansion coefficients of the 0th order function, while the antisymmetric components are all clustered at the expansion coefficients of the 1st order function. Note that it is also possible to develop this further and perform double series expansion to an infinite order.

4-1. Variable Transform

The distance from the peak position “p” of the histogram to the final point of the distribution region broadened to the furthest ends of the right side and left side is made “r”. The distribution region of the abscissa becomes [−r+p, r+p]. This abscissa is converted in the interval of [−1,1] by a variable transform.

Variable transform of abscissa: y=(x−p)/r

The ordinate is similar to that in the second embodiment.

4-2. Double Series Expansion by Root and Order of Spherical Bessell Functions

The distribution functions of the HVC color planes are expanded by the base functions using the roots of n number of 0th and 1st order spherical Bessell functions. The symbol “a” used here, in the same way as the second embodiment, means the outermost contour point covered by expansion of the distribution region.

$$f ( x ) = {\sum }_{n = 0}^{1} {\sum }_{k = 1}^{N} {c}_{nk} {j}_{n} ( {α}_{nk} \frac{x}{a} ) \qquad \{ Math . 42 \}$$

The expansion coefficients cₙₖ are found by the following equation utilizing the orthogonality of base functions.

$${c}_{nk} = \frac{1}{{{a}^{3} [ {j}_{n + 1} ( {α}_{nk} ) ]}^{2}} {\int }_{- a}^{a} f ( x ) {j}_{n} ( {α}_{nk} \frac{x}{a} ) {x}^{2} d x \qquad \{ Math . 43 \}$$

Here, in deriving the equation for calculation of the expansion coefficients, the product of the 0-th order and 1st order functions is an odd function no matter how much the internal variables are scaled, so use is made of the property that if considering the even function nature of ρ² and integrating this at the left-right symmetric intervals, the integrated value becomes zero. That is, the relationship of orthogonality relating to the order, only in relation to the definition between even order and odd order functions, stands not only when the weight function is 1, but also when the weight of any even function is added. However, the constant factors of normalization change, but in the case of ρ², are already given by the relationship using the roots (described in part explaining general theory).

5. Production of Perceptual Invariants

If using double expansion coefficients cₙₖ as single vectors and treating them the same as single expansion coefficients, it is possible to construct perceptual invariants Gᵢ of forms exactly the same as the perceptual invariants Fᵢ of color of the first embodiment. Therefore, it is enough to replace F with G. However, the range taken by the sum becomes double so k=1, 2, . . . , N, N+1, . . . , 2N is changed to. It is possible to use the thus found perceptual invariants to sort an image in the same way as the first and second embodiments.

### Fourth Embodiment

### Linear Sum of Perceptual Invariants of Color and Texture

Next, a fourth embodiment will be explained. The perceptual invariants Fᵢ derived from one-dimensional distribution functions relating to the color signal distribution of images shown in the first embodiment and the perceptual invariants Gᵢ derived from one-dimensional distribution functions relating to the color signal distribution of edge images shown in the second and third embodiments are quantities of exactly the same dimensions and have additive properties, so linear combination enables the two to be treated on the same footing. This is not limited to one-dimensional distribution functions. For two-dimensional distribution functions of the color signal distribution itself of images including elements of composition and further higher order perception elements as well, if constructing perceptual invariants by the same guidelines, a completely common footing is established and it becomes possible to explain the property of the higher concepts remaining strongest in the hierarchical structure of adjectives by utilizing a linear model of perception.

<Processing for Searched Image>

1. Conversion to Munsell HVC Color Space

In this fourth embodiment, two hue planes are prepared: a plane from which N is separated and a plane where it isn't. The rest of the processing is similar to the first to third embodiments.

5. Preparation of Adjective Judgment Indicators

Qᵢ=α₁G₁+α₂G₂+ . . . +β₁G₁+β₂G₂+ . . .

<Learning of Perceptual Adjective Model>

The exact same technique as in the first embodiment was used to determine the linear combination parameters.

Here, the applicant will once more summarize the explanation given up to here and further explain overall the theory for the derivation of the new concept. After that, the applicant will explain fifth to seventh embodiments for realizing this.

[1] Picture of Formulation of Perception

<Basic Concept>

The picture of formulation of perception can be considered as follows: Every image emits common energy elements for a certain perception. This is perceived by the brain.

<Shape Characteristics of Distribution Function>

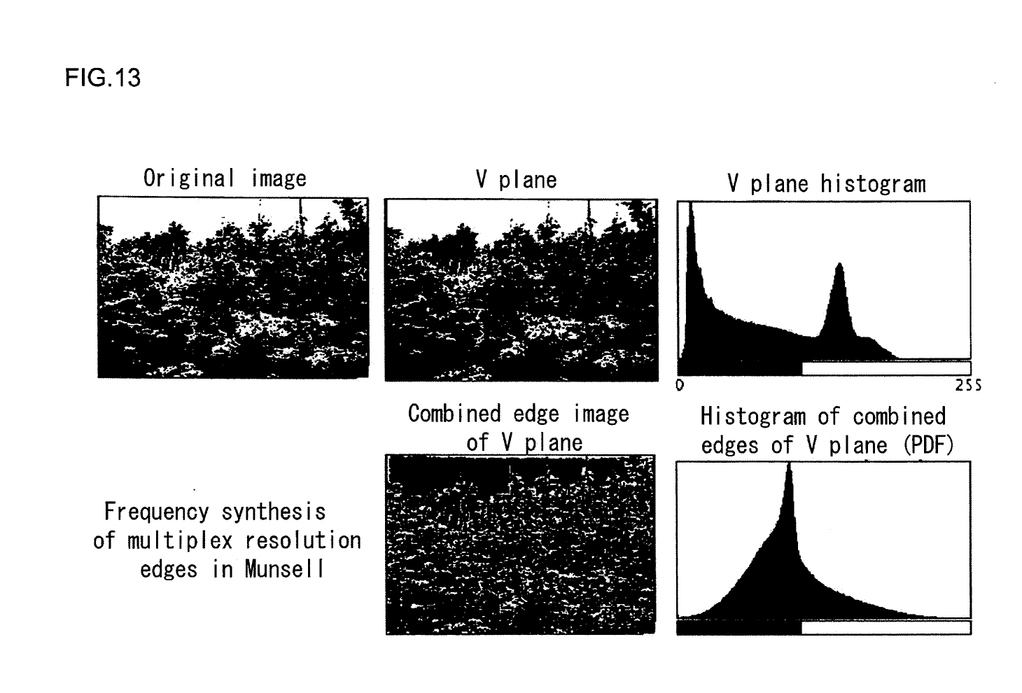

FIG. 13 is a view showing the distribution functions of color and texture. As explained up to here, the perception of an image and the shapes of the distribution functions are very deeply correlated. Vaguely similar shapes tend to give rise to the same perception. The applicant introduced physical techniques to quantify the shape recognition of these distribution functions.

<Quantum Mechanics Techniques>

The content explained up to here used quantum mechanics to attempt description. That is, it can be summarized as follows:

1) The distribution function f is projected into Hilbelt space to express the momentum p.

2) Group theory is used to construct additive energy Eₙ of the quadratic form

The method taken here actually also includes the introduction of concepts of quantum mechanics and description of the state taken by a many-body system of an image having a large number of pixels and a large number of levels by statistical mechanics through a distribution function f.

<Meaning in Statistical Physics>

The meaning of the above method of description is the transformation from a quantity of a microscopic property of the signal value S(x,y) of an image to a quantity of a macroscopic property of perception. That is, by obtaining the statistical mean of the microscopic quantities, only the mechanical invariants of momentum, angular momentum, and energy remain as effective components. Among these in particular, by obtaining the statistical mean of the image group, only energy plays a role in characterizing the valid image system. Due to the action of the statistical group, the image system is summarized in information to the form of the structure of an energy band. By reducing the information volume of the image system in this way, microscopic properties are converted to macroscopic properties. The method of description of statistical mechanics plays a bridging role for description of the statistical properties.

Below, the state of reduction of information will be shown. The composition system is incomplete, but is described including predictions.

$$\begin{matrix}Image & signal & Subsystem & information & Energy \\ S ( x , y ) & & f ( p , q ) & & information \\ \sim {10}^{\hat{}} 23 & & Color \text{:} & {( 256 )}^{\hat{}} 3 \sim {10}^{\hat{}} 7 & \sim 2000 \\ & & Texture \text{:} & {( \pm 256 )}^{\hat{}} 3 & \sim \sim 2000 \\ & & {10}^{\hat{}} 8 & & \\ & & Composition \text{:} & pixel & ( \sim 2000 ) \\ & & number about {10}^{\hat{}} 7 & & \end{matrix}$$

Here, even if the variables p and q are comprised of the independent variables p1, p2, . . . , pi, . . . , q1, q2, . . . , qi, . . . , these are used as symbols representing the same.

<Description by Density Matrix of Quantum Statistics>

In mechanical description, it is necessary to consider what corresponds to the position coordinate q and the momentum p for an image signal S(x,y). Before that, the applicant will explain the relation between an image system and quantum statistics.

Perception is an unknown hamiltonian system and handles a mechanical system formed by a statistical ensemble. As is known in statistical mechanics, there is no such thing as a wave function describing a macroscopic system as a whole (see Document E1). An image system also describes a macroscopic system.

A quantum mechanics-like description based on a set of incomplete data relating to a system is performed using a density matrix. A density matrix may be used to calculate the expected value of any quantity. The density matrix relating to the coordinates is expressed by

ρ(q,q′)=Σ_{m,n}w_{m,n}ψₘ*(q′)ψₙ(q)

If assuming that a subsystem relating to a certain aspect of an image is in a state completely described by a wave function ψ, the wave function ψ can be expanded by a function ψₙ(q) creating a complete system.

ψ=Σₙcₙψₙ

If inserting this into the formula of the density matrix, it is possible to derive a density matrix in an energy expression:

cₘ*cₙ→wₘₙ

The diagonal components of the density matrix expressed by the energy express the stationary state. The nondiagonal components express the nonstationary state. An image captures the dynamism of a certain instant. This is not always limited to a stationary state. Therefore, the energy level derived from a density matrix has to consider the nondiagonal components as well. This means that the description of the nondiagonal components is dependent on the method of selection of the wave functions describing the density matrix. Selection of the wave function system in which the stationary state of the diagonal components is described as compactly as possible is a suitable selection in describing perception. In statistical physics, usually the stationary state is considered, therefore the probability in the n-th stationary state is written as wₙ=wₙₙ.

The statistical mean also calculates the expected value due to the stationary state. However, for the perception of an image, it is necessary to consider not only the stationary state, but also the nonstationary state. Therefore, the statistical mean must also calculate the expected value considering both the stationary state and the nonstationary state.

In dealing with the vagueness of perception of several image groups giving the same perception, in the description of perception, there is the method of obtaining the diagonal sum of all stationary states to thereby treat the stationary states as a single energy level state (E₀) and, further, for the nonstationary states as well, similarly obtaining the slanted sum of the nondiagonal components and thereby utilizing the energy level (Eₙ) of the extent of the distance from the stationary state to the nonstationary state for the description. The statistical distribution of the excitation probability to the energy level is expressed by wₙ=w(Eₙ). From a physical meaning, if the value of n becomes larger, it can be said that a more dynamic state of motion in the image system, that is, an image state in the process of change with a large energy transition width, is described. This discussion applies as is for definition in the process of constructing an energy matrix.

Note that if defining energy and expressing the density of states distribution by ρ(Eₙ), together with the excitation probability w(Eₙ) to the energy level, the actual probability distribution of the energy is expressed by ρ(Eₙ)w(Eₙ).
[Document E] Landau and Lifshitz, Course of Theoretical Physics, Volume 5, “Statistical Physics Part 1” (Third Revised Edition, 1976), Chapter 1 “Fundamental Principles of Statistics”, Chapter 2 “Thermodynamic Quantities”, and Chapter 3 “The Gibbs Distribution”
[Document E1] Landau and Lifshitz, Course of Theoretical Physics, Volume 5, “Statistical Physics Part 1” (Third Revised Edition, 1976), Chapter 1 “Fundamental Principles of Statistical Physics”, Section 5 “The statistical matrix”

[2] Regarding Relation Between Distribution Functions and Perception

<Subsystems and Distribution Functions>

In describing perception, it is important to find the statistical distribution for subsystems. The mechanical variables q of coordinates and p of momenta in perception are not limited to just single ones such as defined in mechanics. As a subsystem of perception, this is positioned as a system wherein, when projecting a certain aspect of an image to describe the property of the image, considerably highly independent aspects are captured.

As a major class of these aspects, the three axes of color, texture, and composition may be considered. However, the same image is used as the basis for projection, so these are not completely independent. However, in defining information of an image, if the distribution functions of these three aspects are defined, enough information is provided for description of the statistical properties.

Here, the applicant will stop at a simple description of the mechanical system, Furthermore, the applicant will consider a not completely independent method of description for when advanced description becomes necessary. In a certain sense, this is closely related to the relation between nonrelativistic descriptions and relativistic descriptions in physics. That is, in nonrelativistic descriptions, the position coordinate system and the spin coordinate system are described as completely independent systems, but in relativistic descriptions, differentiation is impossible. It is necessary to shift to a spinor description of a coordinate system of a mix of position coordinates and spin coordinates. The situation resembles this. These subsystems are individually described, then combined to describe the perception of the image system as a whole.

<Description of Distribution Functions and Mechanical Variables of Subsystems>

For each subsystem, the image variables corresponding to the mechanical variables of the position coordinate q and the momentum p are defined differently. Color expresses the distribution of signal values having an interval width of “zero to a positive finite value” and describes the distribution of the original signal itself, so a function satisfying the linear differential equation suitable for that description is any function included in hypergeometric functions. Texture expresses the distribution of the signal values having an interval width distance of a “negative finite value to a positive finite value” extracting the edge components and describes the distribution of another aspect minus one of the types of information of the original signal, so a function satisfying the linear differential equation suitable for that description is any function included in confluent hypergeometric functions. The composition expresses the distribution of the two-dimensional signal values having an interval width of a “zero to a positive finite value” and describes the distribution of the original signal itself, so a function satisfying the linear differential equation suitable for that description is any function included in hypergeometric functions.

A system described by a hypergeometric function and confluent hypergeometric function can be considered to obtain a grasp of subsystems with different aspects. That is, a hypergeometric function, which is expressed by a differential equation having three singular points, is suitable for expressing the distribution of the signal values of an image. As image signals arriving at the argument of the distribution function, image signals comprised of values of zero or more like pixel values are suitable for description of properties which may be homogeneously distributed. On the other hand, a confluent hypergeometric function, which is expressed by a differential equation having two singular points among these converged to one point and thereby having a total of two singular points, is suitable for describing aspects where the amount of information relating to a signal of an image is reduced by one. As image signals arriving at the argument of the distribution function, image signals straddling positive and negative values such as edge signal values where one piece of information is dropped by a differentiation operation are suitable for description of properties localized near zero.

<Picture of Variable Separation of Mechanical Variables>

The aspects of a subsystem of an image are described by drawing a picture corresponding to a coordinate system with variable separation in the description of physical particles in physics. One hypergeometric function suitable for description of the one-dimensional distribution function of color is a Chebyshev function. This function forms a complete system by a single series of an even function and an odd function, so if grasping the even function as the angular momentum 0 and the odd function as the angular momentum 1, it is possible to consider that it describes the spin coordinate of a spin 1 of the same Bose particles as light. Therefore, the one-dimensional distribution function of color can be considered to describe a spin-type wave function among the wave functions.

One confluent hypergeometric function suitable for description of the one-dimensional distribution function of texture is the spherical Bessell function. Among the radial direction wave functions normally defined in a positive region, a spherical Bessell function is the only function among Bessell functions which enable expanded definition to the negative region. Therefore, the one-dimensional distribution function of texture can be grasped as describing a radial direction wave function among the wave functions. A radial direction wave function can be described by the double series of two series relating to the order and root of even functions and odd functions, so it is possible to assign angular momentums 0, 1, 2, 3, . . . from the smaller ones up. These can be linked with what are called the s, p, d, f, . . . orbits in atomic orbits.

As hypergeometric functions suitable for description of the two-dimensional distribution functions of composition, associated Legendre functions or the composite products of these with Fourier functions, that is, spherical harmonics, may be considered. Therefore, the two-dimensional distribution function of the composition can be considered to describe a wave function corresponding to the two-dimensional coordinates of the zenith angle and azimuth angle in a spherical coordinate representation.

<Set of Observation Data and Distribution Functions>

A certain aspect of the image information is described by the distribution function f(p,q). The relationship between the data observed as image information and distribution functions is as follows. That is, the relationship is like color: a distribution function taking the histogram and eliminating information relating to the pixel positions, texture: a distribution function taking the histogram of the aspects of the edges and eliminating information relating to the pixel positions, and composition: a distribution function taking the area mean and reducing the number of pixels, that is, information relating to the pixel positions. If combining these three distribution functions, the statistical nature of the image S(x,y) is substantially accurately reflected. The probability of separate images differing in impression being expressed by the same values is low. Here, it cannot be said across the board that what are called pixel positions correspond to the position coordinates q of the mechanical variables p and q. The fact that correspondence can be defined for two spaces each for color and texture will be explained below.

<Coordinate Space and Momentum Space>

(A) Aspects of Lower Order Space

(A-1) Color

The Munsell color space can be viewed as a momentum space expressing the strength distribution of color.

Color histogram=f₁(p)

(A-2) Texture

The color space of HVC color planes of an edge image synthesizing multiplex resolution edges can be viewed as a momentum space expressing the strength distribution of the edges.

Texture PDF=f₃(p)

(B) Aspects of Higher Order Space

(B-1) Color

When converting a color histogram by Chebyshev conversion, the original color histogram side can be viewed as the position coordinate q and the Chebyshev expansion coefficient side can be viewed as the momentum p. It is necessary to express the probability density as the distribution function projected in a higher order momentum space. A negative value will not be taken, so the expansion coefficient side becomes a power spectrum of the coefficient multiplied by itself.

Color histogram=f₂(q)=f₁(p)

Chebyshev spectrum=f₂(p)

(B-2) Texture

When converting a texture PDF by spherical Bessell conversion, the original PDF side can be viewed as the position coordinate q, while the spherical Bessell expansion coefficient side can be viewed as the momentum p. As a distribution function of the higher order momentum space, a power spectrum is taken.

Texture PDF=f₄(q)=f₃(p)

Spherical Bessell spectrum=f₄(p)

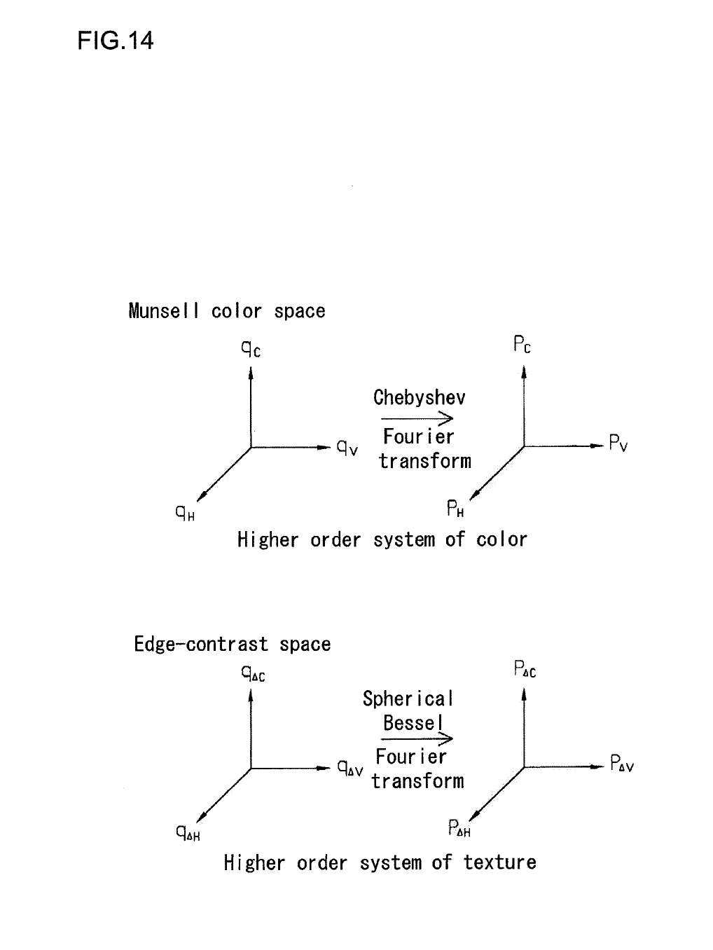

FIG. 14 is a conceptual view for facilitating the understanding of the relationship among these. These distribution functions are used for calculation of the entropy of the subsystems defined later. Note that when creating a quadratic form by energy construction, unlike the description of mechanical energy at the usual Cartesian coordinates (x,y,z) ((pₓ̂2+p_{y}̂2+p_{z}̂2)/(2m)), in addition to the correlation inside the color planes corresponding to this, there is meaning in creating elements of correlation between color planes for evaluation. This is because Munsell HVC are not completely independent components. However, the Munsell HVC color space is designed as a uniform color space becoming uniform for psychological quantities, so there is no need for coefficients between second order terms of these.

<Two Meanings Relating to Statistical Mean>

There are two meanings to the statistical mean for deriving the statistic properties of an image system. That is, one is the point of the vast amount of information on the color, texture, and composition becoming reduced to a macroscopic quantity by the statistical mean. Further, another is that in the sense that a large number of model image groups give the same perception, obtaining the image group mean gives a definite value.

The former simultaneously includes a quantum mechanics-like averaging operation and a statistics-like averaging operation accompanying the process of conversion from a microscopic quantity to a macroscopic quantity. The latter is positioned as including a statistics-like averaging operation which determines a quantity corresponding to the mean value of the fluctuation of a macroscopic quantity so as to finally determine the statistical property. Therefore, the former creates signals working macroscopically on the brain through the visual system, while the latter performs the role of determining the average-like elements of distribution of actions in the brain of the sensation received by a person.

[3] Description of Perception and Gibb's Distribution

<Fluctuations in Energy Due to Image Ensemble>

The method of finding the statistical properties of common perceptions of a large number of image ensembles corresponds to the Gibb's distribution (canonical distribution) of statistical physics. That is, this is a method of description of a system considering the fluctuation of energy. On the other hand, the method of describing the statistical properties of one image corresponds to a micro-canonical distribution. This is a method of description of a system ignoring the fluctuation of energy.

The momentum and angular momentum of a closed system (single image) is related to uniform translation and uniform rotation of the system as a whole. They do not describe the statistical properties of the system. However, they have meaning in the sense of differentiation from the uniform translation and rotation of another image. That is, if adopting a coordinate system in which the translation and rotation of the closed system of one image are at rest, then what determines the statistical properties of one image would be only the energy. When described by a common coordinate system with other images, these image groups will differ in momentum and angular momentum as well, so they will be recognized as different images. However, when describing the macroscopic property, that is, perception, common to a large number of images, the momentum and the angular momentum are information disappearing to a mean zero or constant value when the amount taken by the statistical mean of the image ensemble increases.

<Description of Vagueness of Perception and Phase Space>

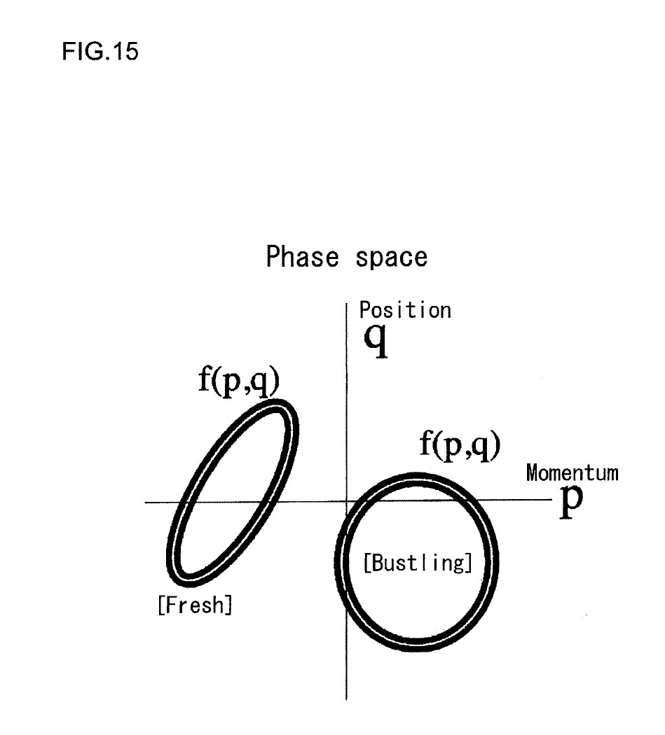

FIG. 15 is a picture showing perception groups in a phase space. The description of perception is also an issue of how to quantitatively describe vagueness. As a picture of a statistical physics-like method of description, it is considered that the orbit of a phase space where a distribution function satisfies certain conditions describes a state distribution calling up the same perception. The “certain conditions” express the orbit on the phase space where the condition of the mechanical invariant of energy being constrained to a certain value is satisfied. The vagueness of perception is described as a set of images with distribution functions which can take various states, but which are on orbits in a blurred range on the same phase space. That is, even if the individual energy elements derived from distribution functions are not the same, if the sum of these satisfy the same condition, it is considered that the same perception is called up. Further, this has fluctuation of energy, so corresponds to a group of perceptions with the same trajectories of constant widths on the phase space. This state is drawn so as to spread by the bold lines in FIG. 15.

In general, the log of a distribution function is the integral of the mechanical invariant of motion. It is described by the integral of additive motion. That is, a distribution function of a composite system expressing the probability of the distribution function of one subsystem and the distribution function of another subsystem simultaneously taking that state is expressed by a product of the distribution function of the subsystem and the log of that has an additive property. The integral of such additive motion, as known in mechanics, corresponds to only energy, momentum, and angular momentum. Therefore, the log of a distribution function can be described by a linear combination of the constant term a and the constant coefficients β, γ, and δ relating to the same (see Document E2=Document A3).
[Document E2] Landau and Lifshitz, Course of Theoretical Physics, Volume 5, “Statistical Physics Part 1” (Third Revised Edition, 1976), Chapter 1 “Fundamental Principles of Statistical Physics”, Section 4 “The significance of energy”

<Phase Space Orbit of Small-Number Model>

When the population images of an image ensemble calling up the same perception are statistically sufficiently large in number, the constraining condition becomes only energy. This is derived from the fact that in the description of statistical properties, only energy remains as the only additive motion integral (see Document E2=Document A3).

However, when these are small in number, as the impressions of the corresponding perception, a further stronger constraining condition matching the fine distribution state of these small number of models becomes necessary. The factors playing a role as additional constraining conditions for this are the other mechanical invariants of momentum and angular momentum. The orbits on a phase space where, in addition to energy, momentum and angular momentum also satisfy certain conditions become the range of distribution having a perceptual action common to these small-number model images. As the extreme of a small-number model, there is a single image similar image retrieval.

<Representation of Momentum and Uncertainty Principle>

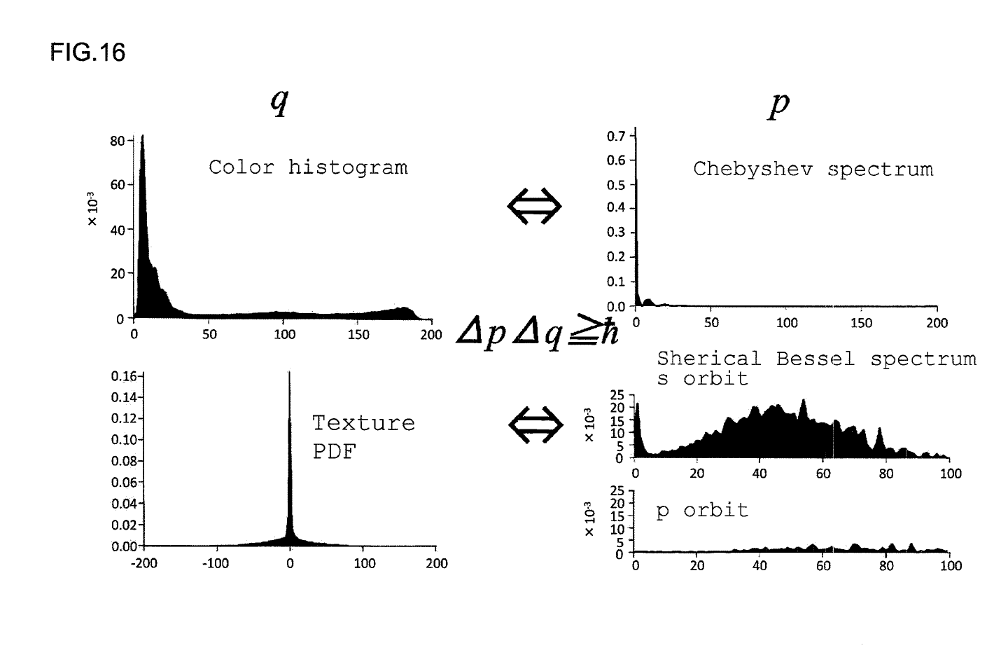

FIG. 16 is a view for explaining the state where the relationship between position and momentum satisfies the uncertainty principle by projection into the higher order space relating to the color and texture of an image system. That is, as in the case of the texture PDF illustrated in FIG. 16, if there is a sharp peak relating to the position and the certainty precision of the position coordinates is high, if trying to realize that waveform in a momentum space transformed by a spherical Bessell Fourier transform, this cannot be achieved unless broadly superposing all sorts of frequencies in large numbers, so momentum becomes uncertain and an extremely broad distribution. On the other hand, as in the case of the color histogram illustrated in FIG. 16, when the momentum space of the Chebyshev Fourier spectrum is expressed extremely concentratedly, if expressing this in real space, the wave of a certain frequency, in this case, a low frequency wave, will be spread broadly over the entire space in the distribution expressed. Therefore, the position will become uncertain and the spread large. That is, it can be said that the relationship describes the fact that even in an image system, if attempting frequency analysis, so long as no waveform of a sufficient interval width is found in real space, the frequency component contained there will no longer be able to identified.

The uncertainty relation that it is not possible to simultaneously realize by certain widths or more a wave function at position and a wave function at momentum through the concept of a Fourier transform extended between position and momentum is none other than the principle of uncertainty discussed in quantum mechanics. This principle of quantum mechanics is explained in for example Document F1.

The value of the Planck's constant h, in an image system, is related to the concepts of a bin of a histogram defining the tone width in relation to the quantization of the tone direction and of 1 pixel defining the pixel interval in relation to the quantization of the space direction. Therefore, if reducing the number of tones of the image system and generating a reduced image, the value of Planck's constant has to be changed to match with the method of quantization of the system and changes depending on the situation considered. This point differs from the situation of handling uniformly for the entire system regardless of the subsystem such as with physical constants. However, the Planck's constant in an image system is treated as an intrinsic value in the subsystem with the defined quantization width projecting a certain aspect.
[Document F1] Landau and Lifshitz, Course of Theoretical Physics, Volume 3 “Quantum Mechanics (Non-Relativistic Theory),” (Third Revised Edition, 1977), Chapter 2 “Energy and Momentum,” Section 16 “Uncertainty relations.”

<Phase Space and Quantum Statistics>

The orbit in a phase space, a basic concept in statistical physics, enables the introduction of the concept of the number of states as a quantum mechanical approach. Image perception can be quantified by the number of states of a quantity observed from an image or the density of states defining these and expressing the density.

In quantum theory, in a phase space, if it becomes possible to define the number of quantum states of the amounts of uncertainty of both momentum and coordinates divided by the Planck's constant, as a macroscopic property, the concept of entropy, which is an additive quantity expressed by its log, inevitably statistically appears. Through this concept of entropy, the level density of the energy spectrum of a macroscopic system is determined. This is theoretically grounded in statistical physics. The fact that, along with the increase in the number of particles (here, in an image system, corresponding to the number of pixels or the number of tones), the level interval exponentially declines and a continuous energy band structure results, can be explained (see Document E3).

The applicant engaged in actual experiments to calculate the continuous energy levels Eₙ. As a result, an image array relating to energy elements exhibiting almost similar properties was found with the adjoining energy levels. For images of certain properties among these, a switch in order began which reached far distances in the distribution of the energy elements. If looking at the state of this property in order from one end to another of the energy level, at the high energy level, an image array of completely different properties from the low energy level is obtained. This shows the property of an energy band structure of the states between levels not being able to be differentiated as the energy level density is made higher. Note that relating to the Boltzmann constant linked with the relationship of entropy and the Planck's constant as well, this can be treated as an intrinsic value in a subsystem projecting a certain aspect, but in general the definition differs between different subsystems.
[Document E3] Landau and Lifshitz, Course of Theoretical Physics, Volume 5, “Statistical Physics Part 1” (Third Revised Edition, 1976), Chapter 1 “Fundamental Principles of Statistical Physics”, Section 7 “Entropy”

<Statistical Ensembles and Band Structure of Energy Levels>

This is attributable to the abnormal fineness of the level distribution in a spectrum of energy eigenvalues of a macroscopic body (here, an image) (see Document E1). Therefore, an image system is reduced in information in the form of the structure of an energy band.

Here, the similarity between the theoretical structures of physicality and perception will be explained. The difference of the properties of pure iron and iron alloys is expressed as a difference of the electron energy band structures (see Documents G1, G2, and G3). Alternatively, how the differences in properties of the ferromagnetic materials of iron, nickel, and cobalt arise can be described by elucidating the electron structures. The same applies for the differences between paramagnetic metals and ferromagnetic metals and the differences in properties of the paramagnetic metals of aluminum, copper, etc. Further, the types of substances includes 118 types of elements when alone and also their compounds and alloys etc. The number ranges from the thousands to ten thousand or more in order. For example, if calculating the number of combinations of two to three elements among these 118 elements, this order of a number is obtained. The number of elements and the basis of their properties are defined by the radial direction wave function s, p, d, f orbits which can exist as atomic orbits and the degeneracy number of the states.

Similarly, there are 473 representative perceptual adjectives in Japanese expressing color emotions. It may be considered that there are similarly thousands to ten thousand or more classes of feelings in the mind which cannot be classified by these words but are slightly different. The meanings of these 473 representative words do not always clearly differ in meanings. There are many expressions which express fine differences. For example, for “bustling”, there are the different expressions “busy”, “flowery”, and “flourishing”. On the other hand, there are also groups of adjectives which are considerably different in main class such as “refreshing” and “bustling”. In this way, adjectives have a duality of main classes and fine classes.

Such a property of duality also exists in the properties of substances. For example, if looking at the Periodic Table of Elements, at the top in the vertical axial direction, there are light electron systems with radial direction wave functions packed in the order of the “s” orbit and “p” orbit, at the middle region, there are transition metal systems with “d” orbits packed, and at the bottom, there are heavy electron systems with “f” orbits packed, while in the horizontal direction, elements with degeneracy number of electrons of these orbits differing by one each are arranged. As the properties of the substances, elements present in the same column in the vertical direction exhibit extremely similar properties chemically. Elements exhibit close properties even when present adjoining in the horizontal direction. When these substances aggregate as a large ensemble extending as solids to the Avogadro's Number (˜10̂23), they statistically take an energy band structure. Large differences in properties and small differences in properties can be expressed as the differences in the density of states distribution.

Therefore, for perception as well, description by such an energy band model is the optimum method of expression. Note that if expressing the duality of adjectives on a phase space, perceptions which differ in major classes are considered to express differences in state distributions between ones which largely differ in orbit, while perceptions which differ only in fine classes are considered to express difference in state distributions between ones which are considerably close in orbits.
[Document G1] Masako Akai, Hisazumi Akai and Junjiro Kanamori, “Electronic Structure of Impurities in Ferromagnetic Iron. I. s, p Valence Impurities,” Journal of Physical Society of Japan, Vol. 54, No. 11, November, 1985, pp. 4246-4256.
[Document G2] Masako Akai, Hisazumi Akai and Junjiro Kanamori, “Electronic Structure of Impurities in Ferromagnetic Iron. II. 3d and 4d Impurities,” Journal of Physical Society of Japan, Vol. 54, No. 11, November, 1985, pp. 4257-4264.
[Document G3] Masako Akai, Hisazumi Akai and Junjiro Kanamori, “Electronic Structure of Impurities in Ferromagnetic Iron. III. Light Interstitials,” Journal of Physical Society of Japan, Vol. 56, No. 3, November, 1987, pp. 1064-1077.

[4] Description of Macroscopic Quantities

<Picture Model of Energy Level>

It is possible to define energy based on the definitions of momentum and position in respective subspaces defined by projections into subsystems. Further, it is also possible to define the other mechanical invariant of angular momentum. As the methods of construction of energy, the case of projection into a lower order subspace and the case of projection into a higher order subspace are introduced for the principal axes of perception. In the case of projection to a lower order subspace, the method is adopted of proposing a model Hamiltonian of energy. In the case of projection to a higher subspace, the method is adopted of constructing an energy matrix and defining energy eigenvalues form the stationary state to the nonstationary state.

The energy level in a lower order subspace captures the energy of the field created by the mean field approximation of statistical physics as a discrete energy level. That is, discrete scalar invariants are constructed. The energy level in a higher order subspace captures the process of gradual separation from the stationary state of diagonal components of an energy matrix to the nonstationary state of nondiagonal components as a continuous energy level. That is, continuous vector invariants are constructed.

<Lower Order Invariants of Color>

Consider that the Munsell H, V, and C values themselves express momentum.

The model hamiltonian is constructed as follows.

H=(H+V+C)̂2

This expresses the mechanical energy expressing the strength of the value of color. Alternatively, it expresses the energy of the field.

For the equation

Hlψₙ>=Eₙlψₙ>

the energy eigenvalues Eₙ are found.

In calculating the energy eigenvalues, mean field approximation of statistical physicals is used.

Momenta are broken down into the mean terms and the fluctuation terms. The fluctuation terms are also described by the mean fluctuation. That is, as the fluctuation terms, the standard deviations are taken. They has the same dimension of momentum p as the mean values.

√<(H−<H>)̂2>˜=σ_{H}

√<(V−<V>)̂2>˜=σ_{V}

√<(C−<C>)̂2>˜=σ_{C}

The mean values and standard deviation values of these momenta are found from the distribution function f(p) expressing the momentum distribution. That is, they are found from the color histograms f(H), f(V), and f(C) of H, V, and C.

$$\begin{matrix}H = {( H + V + C )}^{\hat{}} 2 \\ = ( ( < H > + ( H - < H > ) + ( < V > + ( V - < V > ) + < C > + \\ { ( C - < C > ) )}^{\hat{}} 2 \\ \sim = {( ( < H > + {σ}_{H} ) + ( < V > + {σ}_{V} ) + ( < C > + {σ}_{C} ) \}}^{\hat{}} 2 \\ = ( < H > < H > + < V > < V > + < C > < C > ) + \\ 2 ( < H > < V > + < V > < C > + < C > < H > ) + \\ 2 ( < H > {σ}_{H} + < V > {σ}_{V} + < C > {σ}_{C} ) + \\ 2 ( < H > {σ}_{V} + < V > {σ}_{C} + < C > {σ}_{H} ) + \\ 2 ( {σ}_{H} < V > + {σ}_{V} < C > + {σ}_{C} < H > ) + \\ ( {σ}_{H} {σ}_{H} + {σ}_{V} {σ}_{V} + {σ}_{C} {σ}_{C} ) + \\ 2 ( {σ}_{H} {σ}_{V} + {σ}_{V} {σ}_{V} + {σ}_{C} {σ}_{H} )\end{matrix}$$

In this way, elements derived as quadratic forms resembling a hamiltonian in mean field and fluctuation field correspond to the energy elements one to one and create discrete energy levels. Depending on the individual image, the values taken by these energy elements will differ, but between image groups having a certain perception, certain energy elements act as factors acting strongly in common. This can be seen if investigating the distribution of image groups.

In general, as will be understood if obtaining the color histogram of an image, the distribution of momentum has a strong fluctuating nature of changing extremely randomly depending on the image. Even if taking the statistical mean for an image group having the same perception, elements of common factors will not remain much at all. However, if observing the distribution in the state of the form of energy of the quadratic form, factors acting in common in an image group having the same perception easily remain. For example, the image of “killer scenery” has a high probability of having a mean value <V> and mean chroma <C> of simultaneously small values. The mechanical energy of <V><C> often exhibits a small value. However, in a certain case, sometimes the value of <V> appears large. At this time, the <C> side exhibits a smaller value resulting in a balance. At this time, if separately obtaining the statistical means for <V> and <C>, the momentum means of these will easily end up disappearing as information in the mean values of general images. This state is shown below.

$$\begin{matrix}Momentum p & & Energy {E}_{n} \\ Histogram H & Statistical mean & < V > < C > \\ Value V & = > & < V > < V > \\ Chroma C & Residual information & < H > {σ}_{V} \\ & & {σ}_{C} {σ}_{C} \\ & & … \\ ( Random distribution ) & & ( Stimultaneous sorting )\end{matrix}$$

1) Momentum

As the elements pₙ of momentum, the following may be mentioned.

<H>, <V>, <C>, σ_{H}, σ_{V}, σ_{C}

Note that the parts of σ may also be treated as elements Mₙ of angular momentum.

2) Energy

As the elements Eₙ of energy, the following may be mentioned. Regarding the energy elements Eₙ, different types of energy elements are calculated, so as symbols for differentiating these, the following abbreviation symbols are used to express their states. For the α-plane, the symbol “a” is used, for the β-plane, the symbol “b” is used, for the mean value, the symbol “m” is used, and for the standard deviation value, the symbol “s” is used.

(α)(α)

amam:<H><H>,<V><V>,<C><C>,

amas:<H>σ_{H},<V>σ_{V},<C>σ_{C},

asas:σ_{H}σ_{H},σ_{V}σ_{V},σ_{C}σ_{C},

(α) (β)

ambm:<H><V>,<V><C>,<C><H>,

ambs:<H>σ_{V},<V>σ_{C},<C>σ_{H},

asbm:σ_{H}<V>,σ_{V}<C>,σ_{C}<H>,

asbs:σ_{H}σ_{V},σ_{V}σ_{C},σ_{C}σ_{H}

Regarding the lower order invariants of color, if considering the points to watch described below, the term accompanying <H> is separated into two elements. Therefore, as the energy elements of the lower order invariants of color, 21+5=26 types of scalar invariants are derived. These respectively correspond to the discrete energy levels Eₙ and express the values of Eₙ themselves. These are macroscopic quantities reduced by the lower order subsystem of color.

3) Special Matters in Case of Lower Order Invariants of Color

The hue H is expressed by the neutral N and other hue circle H (≠N) when converted to a Munsell color space. The distribution function f(H), as explained in the first embodiment, uses histograms divided into hue circle histogram bins and N histogram bins. Further, when calculating the mean value by the hue circle, in the same way as defining the starting point of the hue circle at the time of the Chebyshev expansion in the first embodiment, a cut is made at the point in the hue circle where the distribution function becomes smallest. In the region smaller than that value, the value is extended large to secure the region in the form of adding the value of the 2π angular component to the end up at the largest value side of the angle of the hue circle and the mean Munsell hue value is calculated on that axis. When that value exceeds the range of original Munsell hue values, a value corresponding to the 2π angular component is subtracted to restore the original.

To express the hue circle, <H> is divided into two components by complex number expression so as realize the description. Further, at this time, the neutral part remaining in the hue circle expresses the ratio after subtracting the neutral component remaining at the hue circle due to the size of the absolute value of the complex number.

<H>=(1−pop(N))exp(2πi<H(≠N)>/100)

σ_{H} is the spread width for only the distribution functions in the hue circle. Therefore, it remains a single component. These strengths are also linked with the size of the absolute value of <H> and are evaluated by multiplication of the frequency ratio remaining at the hue circle. That is, when all flow into neutral, it is defined that σ_{H} becomes zero in all cases.

σ_{H}=(1−pop(N))σ_{H(≠N)}

<Lower Order Invariants of Texture>

As the edge plane expressing texture, the synthesized edge plane explained in the second embodiment obtained by converting the Munsell HVC planes by a multiplex resolution transform and synthesizing just the high frequency subband images by inverse transform is utilized. The edge strengths of the edge plane edges are expressed schematically as ΔH, ΔV, ΔC using the Laplacian symbol Δ.

This time, consider that the values of the edge strengths ΔH, ΔV, and ΔC of the HVC planes express momentum.

The model Hamiltonian is constructed as follows:

H=(ΔH+ΔV+ΔC)̂2

This expresses the mechanical energy expressing the strength of the value of the edge components of color or the energy of the field.

The energy eigen values Eₙ are found by mean field approximation in the same way as the time of the lower order invariants of color. The mean value and standard deviation value of momentum are found from the distribution function f(p) expressing the momentum distribution. That is, they are found from the histograms f(ΔH), f(ΔV), and f(ΔC) of the edge strengths of ΔH, ΔV, and ΔC. The lower order invariants of texture are found by a similar procedure as with the lower order invariants of color.

1) Momentum

As the elements pₙ of momentum, the following may be mentioned.

<ΔH>, <ΔV>, <ΔC>, σ_{ΔH}, σ_{ΔV}, σ_{ΔC}

Note that the parts of σ may also be treated as elements Mₙ of angular momentum.

2) Energy

As the elements Eₙ of energy, the following may be mentioned. Regarding the energy elements Eₙ, different types of energy elements are derived, so as symbols for differentiating these, the following abbreviation symbols are used to express their states. For the α-plane, the symbol “a” is used, for the β-plane, the symbol “b” is used, for the mean value, the symbol “m” is used, and for the standard deviation value, the symbol “s” is used.

amam:<ΔH><ΔH>,<ΔH><ΔV>,<ΔC><ΔC>,

amas:<ΔH>σ_{ΔH},<ΔV>σ_{ΔV},<ΔC>σ_{ΔC},

asas:σ_{ΔH}σ_{ΔH},<ΔV>σ_{ΔV},<ΔC>σ_{ΔC},

(α)(β)

ambm:<ΔH><ΔV>,<ΔV><ΔC>,<ΔC><ΔH>,

ambs:<ΔH>σ_{ΔV},<ΔV>σ_{ΔC},<ΔC>σ_{ΔH},

asbm:σ_{ΔH}<ΔV>,σ_{ΔV}<ΔC>,σ_{ΔC}<ΔH>,

asbs:σ_{ΔH}σ_{ΔV},σ_{ΔV}σ_{ΔC},σ_{ΔC}σ_{ΔH},

As the energy elements of the lower order invariants of texture, 21 types of scalar invariants are derived. These respectively correspond to the discrete energy levels Eₙ and express the values of Eₙ themselves. These are macroscopic quantities reduced by the lower order subsystem of texture.

3) Special Matters in Case of Lower Order Invariants of Texture

The edge components of a hue plane are assumed to take the edges of the color plane expressed by a Munsell value taking the 0 point as the origin of the hue circle at all times. The reason is that, experimentally, it was learned that rather than changing the cut point of the hue circle to the point where the distribution function becomes smallest for each image, fixed observation at the origin of the Munsell value the same as the spectrum distribution of a rainbow color is preferable for the edges of the hue plane. Further, neutral is not treated separately. It is made the hue plane distributed at any point of the hue circle. Accordingly, the neutral component acts like random noise on the hue plane.

<Higher Order Invariants of Color>

The distribution function of color is expanded by Chebyshev expansion. The variable x takes values of H, V, and C.

$${f}^{( α )} ( x ) = {\sum }_{n = 0}^{2 N - 1} {c}_{n}^{( α )} {T}_{n} ( x ) \\ ( α ) = H , V , {C}_{o} \qquad \{ Math . 44 \}$$

In deriving the mechanical invariants of momentum, angular momentum, and energy from a distribution function, the components enabling independent evaluation of shape are drawn out as much as possible for describing the shape of the distribution function. That is, in constructing the energy and angular momentum, the distribution function f(x) inverted axially to f(−x) is added to the consideration. In the case of color, the physical meaning of axial inversion corresponds to tone inversion. For this reason, the concept of angular momentum is introduced. That is, the base function group is divided into subgroups by the difference in properties of even functions and odd functions. The respective subgroups are assigned angular momentum quantum numbers.

In Chebyshev bases, the even number bases are even functions which satisfy the relationship of ψ(−x)=ψ(x), while the odd number bases are odd functions which satisfy the relationship of ψ(−x)=−ψ(x). Therefore, the even function group is assigned the angular momentum quantum number l=0, while the odd function group is assigned the angular momentum quantum number l=1. By axial inversion x→−x, the odd number angular momentum quantum number base functions invert in sign, while the even number angular momentum quantum number base functions do not change in sign. Such a property relating to axial inversion of wave functions in angular momentum units is called “parity” in quantum mechanics. The base functions of the even functions have even parity and remain unchanged for axial inversion, while the base functions of the odd functions have odd parity and invert in sign for axial inversion.

If considering that this angular momentum quantum number describes a spin system, color describes a system of a spin angular momentum quantum number s=1. A Chebyshev function is defined by only a single series expansion. The even functions and the odd functions respectively describe the states of spin 0 and spin 1. By axial inversion, it is possible to create a state where the parity of the state of the spin 1 inverts. A Chebyshev function is suitable for description of the system of the Bose particles “spin 1”.

When considering independent components, first the elements pₙ of momentum, the elements Mₙ of angular momentum, and the elements Eₙ of energy when not axially inverting the angular momentum describing the system are constructed, then approximately double the elements obtained by axially inverting the angular momentum are derived. At this time, when linearly combining all elements, the linear combination coefficients are derived from the viewpoint of whether they describe meaningful independent components. That is, when only the sign of an element changes, if changing the sign of the linear combination coefficient, the same system is described, so this is meaningless. In general, momentum falls under this category, but for angular momentum and energy, separate independent components can be derived. Giving a specific example, the number 2N of the expansion coefficients is made 2N. That is, N is made 100.

1) Momentum

As the elements pₙ of momentum, the following may be mentioned.

cₙ^{(α)}

where, (α)=H, V, C.

When 2N=200, the number of elements of momentum, since there are three planes worth, becomes 200×3=600

2) Angular Momentum

Below, when considering cₙ divided into subgroups of angular momentum units, the expansion coefficients of the angular momentum quantum number l=0 are expressed as c₀ₙ and the expansion coefficients of the angular momentum quantum number l=1 are expressed as cᵢₙ. Therefore, the number of elements of the expansion coefficients are divided into halves of N number of elements each. The numbers of the elements of the subgroup are assumed to be counted as n=1, 2, . . . , N. As the elements Mₙ of the angular momentum, the following may be mentioned.

0*(c₀₁^{(α)}+c₀₂^{(α)}+ . . . +c_{0N}^{(α)})+1*(c₁₁^{(α)}+c₁₂^{(α)}+ . . . +c_{1N}^{(α)})=(c₁₁^{(α)}+c₁₂^{(α)}+ . . . +c_{1N}^{(α)})

where, (α)=H, V, C.

When the angular momentum only exists up to l=1, the independent component becomes just the above mentioned “1”. The reason is that the axis of angular momentum is inverted. This is because it only describes the same system as

0*(c₀₁^{(α)}+c₀₂^{(α)}+ . . . +c_{0N}^{(α)})−1*(c₁₁^{(α)}+c₁₂^{(α)}+ . . . +c_{1N}^{(α)})=−(c₁₁^{(α)}+c₁₂^{(α)}+ . . . +c_{1N}^{(α)})

In this way, the first order sum of the odd function expansion coefficients can become a macroscopic parameter for evaluating the asymmetry of a distribution function. The classical definition of angular momentum is M=rxp. If compared with this, the above definition obtains the product of the subsums of momentum in the coordinate space having the angular momentum quantum number of the Hilbert space coordinates as the distance from the origin to thereby describe the moment of the distribution function. The number of elements of angular momentum, since there are three planes' worth, becomes 1×3=3.

3) Energy

The product of the α plane and β plane momenta is taken to construct the mechanical energy. The product cₘ*cₙ of momentum, in group theory, creates a matrix called a direct product or Kronecker product. Two systems of product matrices expressed by the same base functions can be broken down into two smaller dimension expressions by reducible expressions. That is, they can be broken down into symmetric product and antisymmetric product matrix expressions. A symmetric product energy matrix (i, k) can be constructed from the product of the (α) plane and (α) plane.

cᵢ^{(α)}cₖ^{(α)}+cₖ^{(α)}cᵢ^{(α)}

Further, symmetric product and antisymmetric product energy matrices (i, k) can be constructed from the product of the (α) plane and (β) plane.

cᵢ^{(α)}cₖ^{(β)}+cₖ^{(α)}cᵢ^{(β)}

cᵢ^{(α)}cₖ^{(β)}−cₖ^{(α)}cᵢ^{(β)}

Note that these are all square matrices with exactly the number of base functions arranged vertically and horizontally.

To calculate the eigenvalues of the energy, the diagonal sum, that is, the trace, is taken. The stationary state energy eigenvalue is a pure diagonal sum. This is the energy element Eₙ in the case where n=0, that is, i=k. To calculate the nonstationary state energy eigenvalues, an expanded trace obtaining the sum of the matrix elements separated from the diagonal components by exactly n=i−k is defined. This differs from a normal trace, so the symbol Sp′ is used. At this time, the number of elements taken by a trace is always defined to become the same as the number of elements of the diagonal sum. The group of base functions used for one of the products necessarily constructs base functions forming a complete system at one time. This is a requirement set as a rule when decomposing this to a symmetric product and antisymmetric product. For this reason, when performing an operation obtaining the sum for a group of matrix elements satisfying n=i−k, for the elements ending up sticking out at the ends of the matrix, if defining the size of the matrices or submatrices being considered as “N”, the slanted sum is taken for exactly the remaining number of elements in the opposite region across the diagonal components in the matrices so that n+N=i−k. In this way, the energy elements Eₙ are successively calculated. Note that specific examples were already given in the first embodiment and the third embodiment.

The number of energy elements is exactly the number corresponding to half of the expansion coefficients of the base functions for one energy matrix. The reason for making it half is that the components sticking out from the matrix are shifted by exactly a number equal to the matrix width and incorporated once more, so when these are successively smoothed, the result is a double definition, so it is effective to reduce them to half. That is, by obtaining an expanded trace, the two-dimensional matrix elements are reduced to numbers of energy elements of half of the number of one-dimensional elements forming the rows and columns.

Next, consider the state of inversion of the axis of angular momentum. The definitions of the above three energy matrices draw a picture of the front by the product of the front surface and front surface of the (α) plane and (α) plane and the (α) plane and (β) plane. As opposed to this, by axially inverting one distribution function for this, it is possible to construct a back surface (−α) plane or (−β) plane. By making one the front surface and the other the back surface when preparing a matrix product, it becomes possible to draw a picture of the back. Due to this, it becomes possible to derive the independent energy elements. That is, the concept of parity is introduced to construct the base functions of an independent combined system. Note that parity is a concept which does not appear in classical mechanics.

Here, from the product of the (α) plane and (−α) plane, symmetric product and antisymmetric product energy matrices (i,k) can be constructed.

cᵢ^{(α)}cₖ^{(-α)}+cₖ^{(α)}cᵢ^{(-α)}

cᵢ^{(α)}cₖ^{(-α)}−cₖ^{(α)}cᵢ^{(-α)}

Further, from the product of the (α) plane and (−β) plane, symmetric product and antisymmetric product energy matrices (i,k) can be constructed.

cᵢ^{(α)}cₖ^{(-β)}+cₖ^{(α)}cᵢ^{(-β)}

cᵢ^{(α)}cₖ^{(-β)}−cₖ^{(α)}cᵢ^{(-β)}

The elements of these energy matrices construct energy matrices where the sign inverts like cₖ^{(-α)}=−cₖ^{(α)} only when the k in cₖ^{(-α)} corresponds to an odd function, while construct ones where the sign does not change like when cₖ^{(-α)}=cₖ^{(α)} when the k corresponds to an even function. In this way, in taking a similar expanded trace as the matrix of the picture of the front in the matrix of the picture of the back inverted in sign at some of the elements, the independent components can be derived as individually appearing energy elements.

In obtaining the expanded trace of the energy matrix of the picture of the front and the expanded trace of the energy matrix of the picture of the back, two ways may be considered for the arrangement of the base functions when a subgroup can be defined by angular momentum. That is, the first is the method of arranging them in the order of the lowest angular momentum quantum number first.

ψ̅=(ψ₀₁,ψ₀₂,ψ₀₃, . . . ,ψ_{0N},ψ₁₁,ψ₁₂,ψ₁₃, . . . ,ψ_{1N})=(ψ₁,ψ₂, . . . ,ψᵢ, . . . ,ψ_{2N}) {Math. 45}

The second is the method of arranging them in the order of the lowest principal quantum number first.

ψ̅=(ψ₀₁,ψ₁₁,ψ₀₂,ψ₁₂,ψ₀₃,ψ₁₃, . . . ,ψ_{0N},ψ_{1N})=(ψ₁,ψ₂, . . . ,ψᵢ, . . . ,ψ_{2N}) {Math. 46}

If successively giving the ψᵢ one-dimensional indicator and creating a symmetric product and antisymmetric product ψᵢψₖ±ψₖψᵢ as the two-dimensional matrix products, the i and k of the first term and the second term are switched across the diagonal components. If arranging these energy matrices one more time divided into submatrices in angular momentum units, the result becomes equivalent to obtain an expanded trace satisfying n=i−k in a submatrix. However, when expressing i and k using the two indicators of the angular momentum quantum number and the principal quantum number, in the case of the first method of arrangement, the i and k of the principal quantum numbers are expressed switched in the submatrix of the combination of the same angular momentum quantum number, but when employing the second method of arrangement, the expression becomes slightly different from that, so caution is required. That is, when exchanging i and k with elements of a submatrix present at a nondiagonal position of the same distance, when the ψᵢ side of the ψᵢψₖ of the first term is an angular momentum quantum number larger than the ψₖ side, the principal quantum number of ψ coming at the right side by exactly n=i−k has to be expressed as k+1 incremented by “1” from the principal quantum number at the ψᵢ side. After this, no matter with which method of rearrangement, an operation is performed for combining the elements in submatrix units between two submatrices with switched elements so as to obtain the submatrix expression.

It was learned experimentally that when creating the product of the (α) plane and (α) plane, the first method of arrangement is superior, while when creating the product of the (α) plane and (β) plane, the second method of arrangement is superior. This assumes that the first method of arrangement treats different angular momentum quantum numbers as completely independent systems and means that in the same plane, this is satisfied by expansion of base functions of completely orthogonal systems. The other second method of arrangement expresses that even with different angular momentum quantum numbers, description by base functions of close principal quantum numbers can describe a state where these are closely interrelated. This is believed due to the fact that HVC planes do not describe completely independent systems.

As the method of combining such submatrices, it is necessary to take the sum among the submatrices so that the expanded trace smooths all base functions forming a complete system. That is, when the elements of momentum are divided into two subgroups of angular momentum quantum numbers comprised of a 0 and 1 system, the energy matrix can be considered divided into two submatrices expressing inherent states of angular momentum and two submatrices expressing mixed states of angular momentum. At this time, as the method of obtaining the expanded trace smoothing these for forming a complete system, there are the case of connecting the traces of two diagonal submatrices and the case of connecting the traces of two nondiagonal submatrices. Thinking about energy matrices in angular momentum units in this way clarifies the physical meaning. This situation can be shown schematically below:

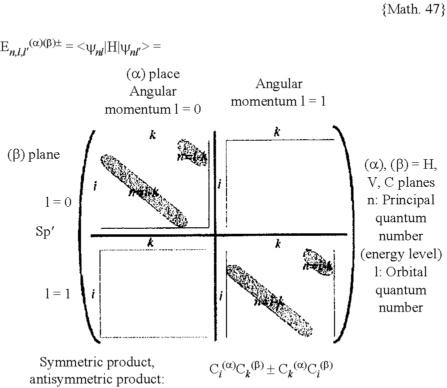

When the same suffix appears, the sum is taken for these. A specific example of the submatrix sum for actually dividing an energy matrix into angular momentum submatrices and combining the expanded traces will be shown. Below, this will be shown in the form of a combined system of two base functions forming a submatrix. The sum of one submatrix and another submatrix is also simultaneously shown. These submatrices are obtained by just replacing these base functions ψᵢₖ with cᵢₖ. Therefore, if each submatrix is defined by (i,k), to calculate the energy elements Eₙ, a trace is obtained for the matrix elements satisfying n=i−k in the respective submatrices.

Different types of energy elements are calculated in subgroup units executing traces for the energy elements Eₙ, so their states are expressed by the following abbreviated symbols as symbols for differentiating these. For the α plane, the symbol “a” is used, for the β plane, “b”, for a combination of angular momentum of the inherent state of (1,1′)=(0,0)+(1,1) the symbol 00, for the combination of angular momentum of the mixed state of (1,1′)=(0,1)+(1,0), the symbol 01, for a symmetric matrix, the plus “p” symbol, for an antisymmetric matrix, the minus “m” symbol, for the standard state of the coordinate axis of the angular momentum, the “e” symbol, and for the inverted state of the coordinate axis of the angular momentum, the “i” symbol. For the coordinate axes of angular momentum, the standard state and inverted state are simultaneously described using the ± symbol. The axial inversion operation for angular momentum for describing the picture of the back is performed only on one base function forming the matrix, so only the odd functions at one color plane side are inverted in sign.

The components which end up disappearing through these operations are not described

(α)(α)

a0a0p,e/i:ψ₀ᵢ^{(α)}ψ₀ₖ^{(α)}+ψ₀ₖ^{(α)}ψ₀ᵢ^{(α)})±(ψ₁ᵢ^{(α)}ψ₁ₖ^{(α)}+ψ₁ₖ^{(α)}ψ₁ᵢ^{(α)})

a0a1p,e:(ψ₀ᵢ^{(α)}ψ₁ₖ^{(α)}+ψ₀ₖ^{(α)}ψ₁ᵢ^{(α)})+(ψ₁ᵢ^{(α)}ψ₀ₖ^{(α)}+ψ₁ₖ^{(α)}ψ₀ᵢ^{(α)})

a0a1m,i:−(ψ₀ᵢ^{(α)}ψ₁ₖ^{(α)}−ψ₀ₖ^{(α)}ψ₁ᵢ^{(α)})+(ψ₁ᵢ^{(α)}ψ₀ₖ^{(α)}+ψ₁ₖ^{(α)}ψ₀ᵢ^{(α)})(i≠k)

(α)(β)

a0b0p,e/i:(ψ₀ᵢ^{(α)}ψ₀ₖ^{(β)}+ψ₀ₖ^{(α)}ψ₀ᵢ^{(β)})±(ψ₁ᵢ^{(α)}ψ₁ₖ^{(β)}+ψ₁ₖ^{(α)}ψ₁ᵢ^{(β)})

a0b0m,e/i:(ψ₀ᵢ^{(α)}ψ₀ₖ^{(β)}−ψ₀ₖ^{(α)}ψ₀ᵢ^{(β)})±(ψ₁ᵢ^{(α)}ψ₁ₖ^{(β)}+ψ₁ₖ^{(α)}ψ₁ᵢ^{(β)})(i≠k)

a0b1p,e/i:(ψ₀ᵢ^{(α)}ψ₁ₖ^{(β)}+ψ_{0,k+1}^{(α)}ψ₁ᵢ^{(β)})+(ψ₁ᵢ^{(α)}ψ_{0,k+1}^{(β)}+ψ₁ₖ^{(α)}ψ₀ᵢ^{(β)})

a0b1m,e/i:±(ψ₀ᵢ^{(α)}ψ₁ₖ^{(β)}−ψ_{0,k+1}^{(α)}ψ₁ᵢ^{(β)})+(ψ₁ᵢ^{(α)}ψ_{0,k+1}^{(β)}−ψ₁ₖ^{(α)}ψ₀ᵢ^{(β)})

When 2N=200, the submatrices surrounded by parentheses are comprised of 100×100, so from these types, the number of energy elements Eₙ defined by the traces becomes 50. The number of types defined above are four types for products between the same color planes and eight types for products between different color planes. Furthermore, as the methods of obtaining (α)(α), since there are HH, VV, and CC, there are the three types, while as the methods of obtaining (α)(β), there are the three types of HV, VC, and CH. Therefore, the number of energy elements of the system where angular momentum is described by “0” and “1” becomes (3×4+3×8)×50=36×50=1800. As the energy band, for 36 types, diagrams are drawn having 50 energy levels for each.

The applicant performed actual experiments on this using images. As a result, by expressing an energy matrix by submatrices in units of angular momentum and making the submatrices of an inherent state having the same angular momentum quantum numbers appear at the diagonal positions and making submatrices of a mixed state having different angular momentum quantum numbers (hybridization terms) appear at the nondiagonal positions, it was possible to obtain results consistent with the physical meaning. That is, if comparing the state of image array relating to energy elements produced from the diagonal submatrix and the state of image array relating to energy elements produced from the nondiagonal submatrix, it was learned that with the mixed state of nondiagonal components, there is the ability to capture extremely dynamic photos such as scenes of clouds gushing forth from mountain ranges.

<Higher Order Invariants of Texture>

The distribution function of texture is expanded by spherical Bessell expansion. A spherical Bessell function is defined expanded to the negative region as well and is expanded to a double series of the root and order forming a complete system. A spherical Bessell function expresses the radial direction wave function, the expansion relating to the root corresponds to the principal quantum number n, while the expansion relating to the order corresponds to the orbital quantum number (orbital angular momentum quantum number) 1. Consider two cases, one where the expansion coefficient of the orbital quantum number is l=0, 1 and one where it is l=0, 1, 2, 3. In atomic physics, the orbits corresponding to l=0, 1, 2, and 3 are separately named the s orbit, p orbit, d orbit, and f orbit in that order. Further, these orbits create the Periodic Table of Elements. The d orbit corresponds to the transition metals, while the f orbit corresponds to description of the electron systems of the lanthanides and actinides. If considering the correspondence with the electron systems describing physical properties, even with an image system describing perception, it is considered sufficient to expand to the f orbit. The variable x takes values of ΔH, ΔV, and ΔC.

Case of expansion by s and p orbits

$${f}^{( α )} ( x ) = {\sum }_{i = 0}^{1} {\sum }_{n = 1}^{N} {c}_{ln}^{( α )} {j}_{l} ( {α}_{ln} \frac{x}{a} ) \\ ( α ) = H , V , {C}_{o} \qquad \{ Math . 48 \}$$

Case of expansion by s, p, d, and f orbits

$${f}^{( α )} ( x ) = {\sum }_{i = 0}^{3} {\sum }_{n = 1}^{N} {c}_{ln}^{( α )} {j}_{l} ( {α}_{ln} \frac{x}{a} ) \\ ( α ) = H , V , {C}_{o} \qquad \{ Math . 49 \}$$

Note that here, (α) is used for expressing the difference of the color planes, but the αₗₙ in a spherical Bessell function is used for expressing the position of the root. The position of the zero point generally cannot be expressed analytically, but Smirnov “A Course of Higher Mathematics” describes an equation for approximation of the zero point of a Bessell function. If starting from this, modifying the approximation equation to one for expressing the zero point of a spherical Bessell function, leaving the first term as it is, and introducing a ½ correction coefficient for the second term, it is leaned that approximation of all zero points is possible with an error of within 3%, so the following equation is used for calculating the p orbit and higher expansion coefficients.

$${α}_{ln} = π ( \frac{l}{2} + n ) - \frac{l ( l + 1 )}{π ( l + 2 n )} \qquad \{ Math . 50 \}$$

In deriving the mechanical invariants of momentum, angular momentum, and energy from the distribution function, the components enabling independent shape evaluation are derived to the possible extent for describing the shape of the distribution function. That is, in the same way as the case of color, when constructing the energy or angular momentum, the distribution function f(x) inverted axially to f(−x) is added to the consideration. In the case of texture, the physical meaning of axial inversion corresponds to the inversion of signs of the edges. An axial inversion operation corresponds to an operation inverting the parity of angular momentum. In a spherical Bessell function, the angular momentum quantum numbers are classified into subgroups by the difference in properties of the even functions and odd functions of the group of base functions. Orbital quantum numbers are assigned to the respective subgroups.

In spherical Bessell base functions, base functions having even number orbital quantum numbers are even functions and satisfy the relation ψ(−x)=ψ(x), while base functions having odd number orbital quantum numbers are odd functions and satisfy the relation ψ(−x)=−ψ(x). By axial inversion x→−x, the base functions of the odd number orbital quantum numbers invert in sign, while the base functions of the even number orbital quantum numbers remain unchanged in sign.

Accordingly, the wave functions of the s and d orbits have even parity, while the wave functions of the p and f orbits have odd parity. In general, the group of base functions expressed by spherical Bessell functions have parity, expressed by (−1)̂1, using the angular momentum quantum number 1 with respect to the inversion of the coordinate axis.

In the same way as the above, when considering independent components, first, the elements pₙ of momentum, the elements Mₙ of angular momentum, and the elements Eₙ of energy in the case of not inverting the axis of angular momentum describing the system, then the approximately double elements after axial inversion of angular momentum of these are derived. Giving a specific example, the number N of expansion coefficients is made 100.

1) Momentum

As the elements pₙ of momentum, the following may be mentioned.

cₗₙ^{(α)}

where, (α)=H, V, and C

In the case of expansion by the s and p orbits, when N=100, the number of elements of momentum, since there are three planes' worth, becomes 2×100×3=600. In the case of expansion by the s, p, d, and f orbits, when N=100, the number of elements of momentum, since there are three planes' worth, becomes 4×100×3=1200.

2) Angular Momentum

As the elements Mₙ of angular momentum, the following may be mentioned.

(Case of Expansion of s and p Orbits)

This is exactly the same as the case of Chebyshev expansion of color. That is,

(c₁₁^{(α)}+c₁₂^{(α)}+ . . . +c_{1N}^{(α)})

where, (α)=H,V,C.

The number of elements of angular momentum, since there are three planes' worth, becomes 1×3=3.

(Case of Expansion by s, p, d, and f Orbits)

1(c₁₁^{(α)}+c₁₂^{(α)}+ . . . +c_{1N}^{(α)})+2(c₂₁^{(α)}+c₂₂^{(α)}+ . . . +c_{2N}^{(α)})+3(c₃₁^{(α)}+c₃₂^{(α)}+ . . . c_{3N}^{(α)})

If inverting the axis of angular momentum, another independent component appears.

−1(c₁₁^{(α)}+c₁₂^{(α)}+ . . . +c_{1N}^{(α)})+2(c₂₁^{(α)}+c₂₂^{(α)}+ . . . +c_{2N}^{(α)})−3(c₃₁^{(α)}+c₃₂^{(α)}+ . . . c_{3N}^{(α)})

The number of elements of angular momentum, since there are three planes' worth, becomes 2×3=6.

In this way, the linear sum of expansion coefficients of odd functions gives a macroscopic indicator for evaluating how much the asymmetry of a distribution function spreads to the outside and if it shows that property. Furthermore, the linear sum of expansion coefficients of even functions gives a macroscopic indicator for evaluating how much a distribution function pulls in its tail at the outside. These overall properties of spread can become macroscopic quantities stored as angular momentum.

3) Energy

As the elements Eₙ of the energy, the following may be mentioned.

(Case of Expansion by s and p Orbits)

This is exactly the same as the case of Chebyshev expansion of color. Therefore, when N=100, the submatrices enclosed by the parentheses are comprised of 100×100, so from these types, the number of energy elements Eₙ defined by the traces becomes 50. Therefore, in exactly the same way as the case of color, the number of energy elements of the system where angular momentum is described by “0” and “1” becomes (3×4+3×8)×50=36×50=1800. As the energy band, for 36 types, diagrams are drawn having 50 energy levels for each.

(Case of Expansion by s, p, d, and f Orbits)

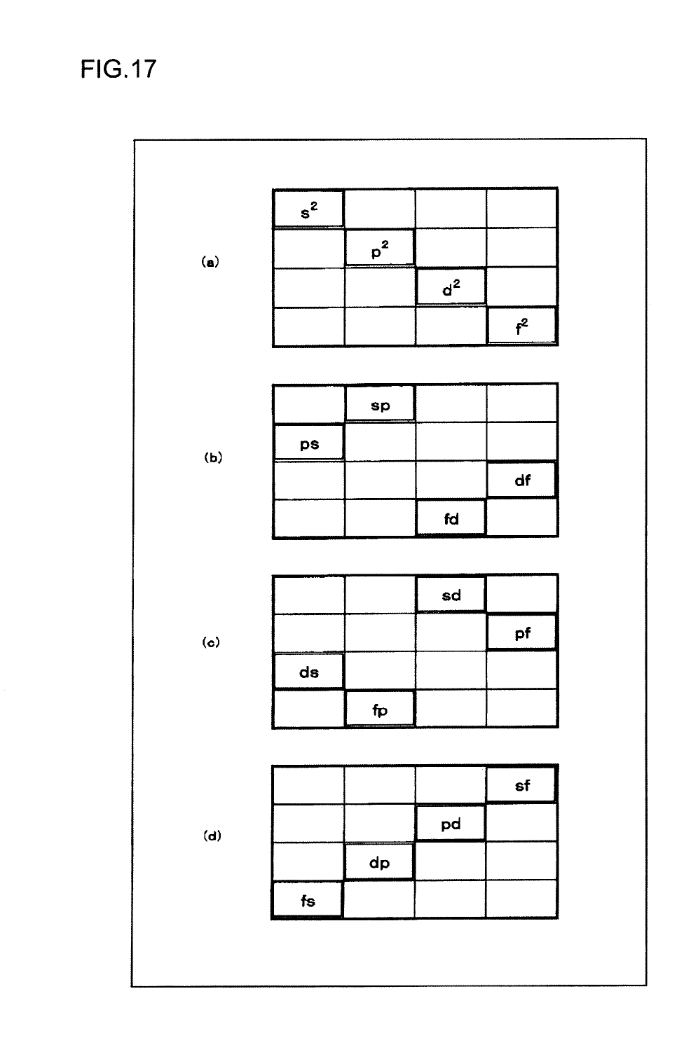

There are the following four methods for connecting the energy submatrices of the angular momentum units to form a complete system. The first bundling method expresses the inherent state of angular momentum. The second to fourth bundling methods express the mixed state of angular momentum. The “mixed state” is the state where the angular momentum forms a mixed orbit. For example, between sd, a subgroup called sd hybridization is formed. The matrix diagrams expressing the state forming the following four expansion traces are shown in FIGS. 17(a) to (d). These are defined as encompassing the case of only the s and p orbits. That is, when eliminating expansion by the d, f orbits, the equations become the same as expansion by the s, p orbits.

s²+p²+d²+f²

sp+ps+df+fd

sd+ds+pf+fp

sf+fs+pd+dp

A specific example of the submatrix sum for actually dividing an energy matrix into angular momentum submatrices and combining the expanded traces will be shown. For a combination of angular momentum of the inherent state of a (1,1′)=(0,0)+(1,1)+(2,2)+(3,3), the symbol 00 is used, for the combination of angular momentum of the mixed state of (1,1′)=(0,1)+(1,0)+(2,3)+(3,2), the symbol 01 is used, for the combination of angular momentum of the mixed state of (1,1′)=(0,2)+(2,0)+(1,3)+(3,1), the symbol 02 is used, and for the combination of angular momentum of the mixed state of (1,1′)=(0,3)+(3,0)+(1,2)+(2,1), the symbol 03 is used.

(α)(α)

a0a0p,e/i:(ψ₀ᵢ^{(α)}ψ₀ₖ^{(α)}+ψ₀ₖ^{(α)}ψ₀ᵢ^{(α)})±(ψ₁ᵢ^{(α)}ψ₁ₖ^{(α)}+ψ₁ₖ^{(α)}ψ₁ᵢ^{(α)})+(ψ₂ᵢ^{(α)}ψ₂ₖ^{(α)}+ψ₂ₖ^{(α)}ψ₂ᵢ^{(α)})±(ψ₃ᵢ^{(α)}ψ₃ᵢ^{(α)}+ψ₃ₖ^{(α)}ψ₃ᵢ^{(α)})

a0a1p,e:(ψ₀ᵢ^{(α)}ψ₁ₖ^{(α)}+ψ₀ₖ^{(α)}ψ₁ᵢ^{(α)})+(ψ₁ᵢ^{(α)}ψ₀ₖ^{(α)}+ψ₁ₖ^{(α)}ψ₀ᵢ^{(α)})+(ψ₂ᵢ^{(α)}ψ₃ₖ^{(α)}+ψ₂ₖ^{(α)}ψ₃ᵢ^{(α)})+(ψ₃ᵢ^{(α)}ψ₂ₖ^{(α)}+ψ₃ₖ^{(α)}ψ₂ᵢ^{(α)})

a0a1m,i:−(ψ₀ᵢ^{(α)}ψ₁ₖ^{(α)}−ψ₀ₖ^{(α)}ψ₁ᵢ^{(α)})+(ψ₁ᵢ^{(α)}ψ₀ₖ^{(α)}+ψ₁ₖ^{(α)}ψ₀ᵢ^{(α)})+(ψ₂ᵢ^{(α)}ψ₃ₖ^{(α)}−ψ₂ₖ^{(α)}ψ₃ᵢ^{(α)})+(ψ₃ᵢ^{(α)}ψ₂ₖ^{(α)}−ψ₃ₖ^{(α)}ψ₂ᵢ^{(α)})(i≠k)

a0a2p,e/i:(ψ₀ᵢ^{(α)}ψ₂ₖ^{(α)}+ψ₀ₖ^{(α)}ψ₂ᵢ^{(α)})+(ψ₂ᵢ^{(α)}ψ₀ₖ^{(α)}+ψ₂ₖ^{(α)}ψ₀ᵢ^{(α)})±(ψ₁ᵢ^{(α)}ψ₃ₖ^{(α)}+ψ₁ₖ^{(α)}ψ₃ᵢ^{(α)})±(ψ₃ᵢ^{(α)}ψ₁ₖ^{(α)}+ψ₃ₖ^{(α)}ψ₁ᵢ^{(α)})

a0a3p,e:(ψ₀ᵢ^{(α)}ψ₃ₖ^{(α)}−ψ₀ₖ^{(α)}ψ₃ᵢ^{(α)})+(ψ₃ᵢ^{(α)}ψ₀ₖ^{(α)}+ψ₃ₖ^{(α)}ψ₀ᵢ^{(α)})+(ψ₁ᵢ^{(α)}ψ₂ₖ^{(α)}+ψ₁ₖ^{(α)}ψ₂ᵢ^{(α)})+(ψ₂ᵢ^{(α)}ψ₁ₖ^{(α)}+ψ₂ₖ^{(α)}ψ₁ᵢ^{(α)})

a0a3m,i:−(ψ₀ᵢ^{(α)}ψ₃ₖ^{(α)}−ψ₀ₖ^{(α)}ψ₃ᵢ^{(α)})+(ψ₃ᵢ^{(α)}ψ₀ₖ^{(α)}−ψ₃ₖ^{(α)}ψ₀ᵢ^{(α)})+(ψ₁ᵢ^{(α)}ψ₂ₖ^{(α)}−ψ₁ₖ^{(α)}ψ₂ᵢ^{(α)})−(ψ₂ᵢ^{(α)}ψ₁ₖ^{(α)}−ψ₂ₖ^{(α)}ψ₁ᵢ^{(α)})(i≠k)

(α)(β)

a0b0p,e/i:(ψ₀ᵢ^{(α)}ψ₀ₖ^{(β)}+ψ₀ₖ^{(α)}ψ₀ᵢ^{(β)})±(ψ₁ᵢ^{(α)}ψ₁ₖ^{(β)}+ψ₁ₖ^{(α)}ψ₁ᵢ^{(β)})+(ψ₂ᵢ^{(α)}ψ₂ₖ^{(β)}+ψ₂ₖ^{(α)}ψ₂ᵢ^{(β)})±(ψ₃ᵢ^{(α)}ψ₃ₖ^{(β)}+ψ₃ₖ^{(α)}ψ₃ᵢ^{(β)})

a0b0m,e/i:(ψ₀ᵢ^{(α)}ψ₀ₖ^{(β)}−ψ₀ₖ^{(α)}ψ₀ᵢ^{(β)})±(ψ₁ᵢ^{(α)}ψ₁ₖ^{(β)}−ψ₁ₖ^{(α)}ψ₁ᵢ^{(β)})+(ψ₂ᵢ^{(α)}ψ₂ₖ^{(β)}−ψ₂ₖ^{(α)}ψ₂ᵢ^{(β)})±(ψ₃ᵢ^{(α)}ψ₃ₖ^{(β)}−ψ₃ₖ^{(α)}ψ₃ᵢ^{(β)})(i≠k)

a0b1p,e/i:±(ψ₀ᵢ^{(α)}ψ₁ₖ^{(β)}+ψ_{0,k+1}^{(α)}ψ₁ᵢ^{(β)})+(ψ₁ᵢ^{(α)}ψ_{0,k+1}^{(β)}+ψ₁ₖ^{(α)}ψ₀ᵢ^{(β)})±(ψ₂ᵢ^{(α)}ψ₃ₖ^{(β)}+ψ_{2,k+1}^{(α)}ψ₃ᵢ^{(β)})+(ψ₃ᵢ^{(α)}ψ_{2,k+1}^{(β)}+ψ₃ₖ^{(α)}ψ₂ᵢ^{(β)})

a0b1m,e/i:±(ψ₀ᵢ^{(α)}ψ₁ₖ^{(β)}−ψ_{0,k+1}^{(α)}ψ₁ᵢ^{(β)})+(ψ₁ᵢ^{(α)}ψ_{0,k+1}^{(β)}ψ₁ₖ^{(α)}ψ₀ᵢ^{(β)})±(ψ₂ᵢ^{(α)}ψ₃ₖ^{(β)}−ψ_{2,k+1}^{(α)}ψ₃ᵢ^{(β)})+(ψ₃ᵢ^{(α)}ψ_{2,k+1}^{(β)}−ψ₃ₖ^{(α)}ψ₂ᵢ^{(β)})

a0b2p,e/i:(ψ₀ᵢ^{(α)}ψ₂ₖ^{(β)}+ψ_{0,k+1}^{(α)}ψ₂ᵢ^{(β)})+(ψ₂ᵢ^{(α)}ψ_{0,k+1}^{(β)}+ψ₂ₖ^{(α)}ψ₀ᵢ^{(β)})±(ψ₁ᵢ^{(α)}ψ₃ₖ^{(β)}+ψ_{1,k+1}^{(α)}ψ₃ᵢ^{(β)})±(ψ₃ᵢ^{(α)}ψ_{1,k+1}^{(β)}+ψ₃ₖ^{(α)}ψ₁ᵢ^{(β)})

a0b2m,e/i:(ψ₀ᵢ^{(α)}ψ₂ₖ^{(β)}−ψ_{0,k+1}^{(α)}ψ₂ᵢ^{(β)})+(ψ₂ᵢ^{(α)}ψ_{0,k+1}^{(β)}−ψ₂ₖ^{(α)}ψ₀ᵢ^{(β)})±(ψ₁ᵢ^{(α)}ψ₃ₖ^{(β)}−ψ_{1,k+1}^{(α)}ψ₃ᵢ^{(β)})±(ψ₃ᵢ^{(α)}ψ_{1,k+1}^{(β)}−ψ₃ₖ^{(α)}ψ₁ᵢ^{(β)})

a0b3p,e/i:±(ψ₀ᵢ^{(α)}ψ₃ₖ^{(β)}−ψ_{0,k+1}^{(α)}ψ₃ᵢ^{(β)})+(ψ₃ᵢ^{(α)}ψ_{0,k+1}^{(β)}−ψ₃ₖ^{(α)}ψ₀ᵢ^{(β)})+(ψ₁ᵢ^{(α)}ψ₂ₖ^{(β)}−ψ_{1,k+1}^{(α)}ψ₂ᵢ^{(β)})±(ψ₂ᵢ^{(α)}ψ_{1,k+1}^{(β)}+ψ₂ₖ^{(α)}ψ₁ᵢ^{(β)})

a0b3m,e/i:±(ψ₀ᵢ^{(α)}ψ₃ₖ^{(β)}−ψ_{0,k+1}^{(α)}ψ₃ᵢ^{(β)})+(ψ₃ᵢ^{(α)}ψ_{0,k+1}^{(β)}ψ₃ₖ^{(α)}ψ₀ᵢ^{(β)})+(ψ₁ᵢ^{(α)}ψ₂ₖ^{(β)}−ψ_{1,k+1}^{(α)}ψ₂ᵢ^{(β)})±(ψ₂ᵢ^{(α)}ψ_{1,k+1}^{(β)}−ψ₂ₖ^{(α)}ψ₁ᵢ^{(β)})

When N=100, the submatrices enclosed by the parentheses are comprised of 100×100, so from these types, the number of energy elements Eₙ defined by the traces becomes 50. The number of types defined above is eight types in the case of a product between the same color planes and 16 types in the case of a product between different color planes. Furthermore, as the methods for obtaining (α)(α), there are HH, VV, and CC, so there are three types. As the methods for obtaining (α)(β), there are the three types of HV, VC, and CH. Therefore, the number of energy elements of the system where angular momentum is described by 0, 1, 2, and 3 becomes (3×8+3×16)×50=72×50=3600. As the energy band, for 72 types, diagrams are drawn having 50 energy levels for each.

<Correction of Relativistic Effect of Hamiltonian>

1) Combined Energy of Higher Order System of Color and Texture

Color is assumed to be a spin coordinate system, while texture is assumed to be a radial direction positional coordinate system. In a nonrelativistic description, the spin coordinate system and the positional coordinate system are independent and the spin angular momentum and the orbit angular momentum act individually as stored amounts, but in a relativistic description, there is no longer a distinction between the spin coordinates and positional coordinates. The effect of the relativistic effect need not be described by a spinor description. It can be incorporated to a certain extent if adding the energy of spin-orbit interaction to the hamiltonian of the nonrelativistic description (see Document F2). Therefore, it is possible to construct energy elements Eₙ by the inner product of the spin angular momentum S defined by the higher order system of color and the orbit angular momentum L defined by the higher order system of texture. However, for the angular momentum M defined by the subsystems, the symbol S is used for the higher order subsystem of color and the symbol L is used for the higher order subsystem of texture.

H=−\vec{L}·\vec{S}

\vec{S}=(S^{(H)},S^{(V)},S^{(C)})

\vec{L}=(L^{(H)},L^{(V)},L^{(C)}) {Math. 51}

The above definition in the case of assuming (α)=H, V, and C are independent is the inner product of the (α) plane and the (α) plane. The number of energy elements in the case of not considering the axial inversion of angular momentum is just one. However, HVC are not independent in certain aspects, so in general they are the inner product of the (α) plane and the (β) plane. The following three energy elements can be defined.

H₁^{(α)(α)}=−(L^{(H)}S^{(H)}+L^{(V)}S^{(V)}+L^{(C)}S^{(C)})

H₂^{(α)(β)}=−(L^{(H)}S^{(V)}+L^{(V)}S^{(C)}+L^{(C)}S^{(H)})

H₃^{(α)(β)}=−(L^{(H)}S^{(C)}+L^{(V)}S^{(H)}+L^{(C)}S^{(V)}) {Math. 52}

Even when axially inverting the angular momentum, it is sufficient to similarly define the separate L′ vector and S′ vector (=S vector) and add the next hamiltonian as well. As the number of energy elements, together with the above, the result becomes double the number, that is, six.

H=−\vec{L}′·\vec{S}′=−\vec{L}′·\vec{S} {Math. 53}

2) Combined Energy of Lower Order System of Color and Texture

The spreads σ_{H}, σ_{V}, and σ_{C} in the positional coordinate direction of momentum introduced in a lower order system of color can also be grasped as angular momentum. Similarly, the spreads σ_{ΔH}, σ_{ΔV}, σ_{ΔC} of momentum introduced in a lower order system of texture can be grasped as angular momentum. Therefore, in the same way as the case of a higher order system, the energy of spin-orbit interaction can be defined.

H=−\vec{L}·\vec{S}

\vec{S}=(σ_{H},σ_{V},σ_{C})

\vec{L}=(σ_{ΔH},σ_{ΔV},σ_{ΔC}) {Math. 54}

In a lower order system, even if inverting the axis of angular momentum, the same system as the original is just expressed, so the number of energy elements becomes three.
[Document F2] Landau and Lifshitz, Course of Theoretical Physics, Volume 3 “Quantum Mechanics (Non-Relativistic Theory),” (Third Revised Edition, 1977), Chapter 10 “The Atom,” Section 72 “Fine structure of atomic levels.”

<Addition of Internal Energy of Rotation>

1) Rotational Energy of Higher Order System of Color

In the same way as the above-mentioned spin-orbit interaction, it is possible to define a spin-spin interaction corresponding to the rotational energy of the spin system.

H=\vec{S}·\vec{S}

\vec{S}=(S^{(H)},S^{(V)},S^{(C)}) {Math. 55}

As the combinations when assuming (α)=H, V, C are not independent, the following two energy elements can be defined.

H₁^{(α)(α)}=S^{(H)}S^{(H)}+S^{(V)}S^{(V)}+S^{(C)}S^{(C)}

H₂^{(α)(β)}=S^{(H)}S^{(V)}+S^{(V)}S^{(C)}+S^{(C)}S^{(H)} {Math. 56}

2) Rotational Energy of Lower Order System of Color

The lower order system is already introduced as the quadratic form of the fluctuation term of the model hamiltonian, that is, the product of a and a.

3) Rotational Energy of Higher Order System of Texture

In the same way as the above spin-spin interaction, it is possible to define the rotational energy by the orbital angular momentum of the coordinate system.

H=\vec{L}·\vec{L}

\vec{L}=(L^{(H)},L^{(V)},L^{(C)}) {Math. 57}

As the combinations when assuming (α)=H, V, C are not independent, the following two energy elements can be defined.

H₁^{(α)(α)}=L^{(H)}L^{(H)}+L^{(V)}L^{(V)}+L^{(C)}L^{(C)}

H₂^{(α)(β)}=L^{(H)}L^{(V)}+L^{(V)}L^{(C)}+L^{(C)}L^{(H)} {Math. 58}

When expanding s, p, d, and f, an independent angular momentum L′ vector is defined for the coordinate axial inversion. As the method of combination, in addition to inversion of one angular momentum, independent energy elements result even when inverting both angular momentums. Therefore, the number of energy elements becomes the three times greater six.

H=\vec{L}·\vec{L}′

H=\vec{L}′·\vec{L}′ {Math. 59}

4) Rotational Energy of Lower Order of Texture

This was already introduced in the same way as the lower order of color.

<Linear Model of Perception>

The thus defined mechanical invariants are all provided with additive properties, so it is also possible to describe them by combining all by linear combination without dividing up the world between different dimensional spaces of projection into all subsystems. That is, by constructing mechanical invariants, it is possible to place subsystems relating to the main axes of perception and the lower order and higher order projections among the same on a common footing. The difference in the Planck's constant h and other physical constants differently defined for each subsystem are included as linear combination coefficients scaling the entirety in subsystem units. That is, perception can be described as a linear model.

The intensity Qi of the degree of impression of perception for a certain adjective “i” is expressed as a linear sum of the individual energy elements emitted by the individual images. The magnitudes and signs of the energy elements stressed differ for each adjective. This appears in the form of a linear combination coefficient as a property characterizing the adjective. That is, the feature of an image of a mechanical invariant is a quantity converted from microscopic image information to macroscopic image information. What requires modelization is concentrated in the linear combination coefficients. Prior learning of the model for determining the linear combination coefficients is also based on the base concepts of statistical physics and is basically performed by the statistical mean for the statistical ensemble of the image group.

$$Qi = {α}_{1} {F}_{1} + {α}_{2} {F}_{2} + … ( color ) + \\ {β}_{1} {G}_{1} + {β}_{2} {G}_{2} + … ( texture ) + \\ {γ}_{1} {H}_{1} + {γ}_{2} {H}_{2} + … ( composition )$$

In a pyramidal hierarchical structure, the factor structure modeled once at each level can have other factors added to it as is without change. The point that should be changed at that time is only the scaling connecting one subsystem and another subsystem. The ratio in the subsystem, that is, the factor structure, is unchanged.

Further, the important point in a linear model is that the subsystems be described by additive features, so the number of combined features when combining subsystems by combination of principal axes can be expressed by the simple sum with the highest degree of reduction. The number becomes on the order of 10,000 and becomes the same extent as the total number of perceptual adjectives.

Linear combination is not limited to energy. Linear combination for Qi is also possible for the remaining additive mechanical invariants of momentum and angular momentum. At this time, the linear combination coefficients also function for combining the energy and physical dimensions. Therefore, when using all of the mechanical invariants, at the time of model learning, it is necessary to determine the factor structure of linear combination coefficients in energy units, momentum units, and angular momentum units, then determine one more time the combination coefficients for scaling the entirety among the three. This combines the dimensions and also leads to determination of what invariants play important roles among the three. In general, if taking the statistical mean for many model images, the roles of momentum and angular momentum drop.

In the next section, to facilitate understanding of the discussion, the explanation will be given limited to the case of handling only energy.

<Density of States and Adjective Model>

If deriving the macroscopic energy from image information and giving a value by a certain energy level, this means that the energy of that energy level is emitted to exactly that amount and there is a state in the energy level. If the value of the energy element of a certain energy level is zero, the image does not emit any energy element and there is no state at that level. The value of energy may also take a negative value.

For a certain adjective “i”, when the value of the product of the value of the energy element and the linear combination coefficient acts positively, that element acts positively on the adjective i. Conversely, when the value of the product is negative, it has a negative action. When the sum of the inner products of a distribution diagram of energy elements derived from a single image, that is, a diagram showing the state of existence of states of an energy level, and the distribution diagram of the model coefficients of linear combination is a positive value, the image has an impression of the adjective i of that value. Conversely, when having a negative value, the image can be said to give an impression in an opposite direction to the impression of the adjective i by exactly the amount of that value. Therefore, the total sum Qi of the inner products of the linear combination coefficients and energy elements of the model adjectives expresses the adjective energy.

If normalizing the distribution diagram of energy elements by the number of states of the energy system as a whole, the density of states function finding the probability of existence of a state is expressed. A positive value of energy is held when the positive state ρ₊ (E) has a positive probability of existence. Conversely, a negative energy value is held when the negative state ρ₋ (E) has a positive probability of existence. The normalization is performed so that,

∫{p₊(E)+ρ₋(E)}dE=1 {Math. 60}

However, as the method of expression of the density of states when illustrating the density of states and when actually taking a linear combination between the density of states and linear combination coefficients, division into two parts is not necessary in this way. That is, if employing the sign of the energy value as it is and using as the size a value corresponding to ρ₊ (E) or ρ₋ (E) to express ρ(E), it is not necessary to divide the symbols. Further, if normalizing the linear combination coefficients, the result becomes as follows.

$${Q}_{i} = \frac{{\vec{α}}_{i} \cdot \vec{E}}{{〈 \vert {\vec{α}}_{i} \vert 〉}_{i} 〈 \vert \vec{E} \vert 〉} = α ( {E}_{n} ) ρ ( {E}_{n} ) \qquad \{ Math . 61 \}$$

Here, the < > of the denominator indicates the statistical mean of the images becoming the model of a general image, while the < >ᵢ indicates the statistical mean relating to all adjectives which the image retrieval system prepares. Regarding this n, when the same suffix appears, the sum of these is taken.

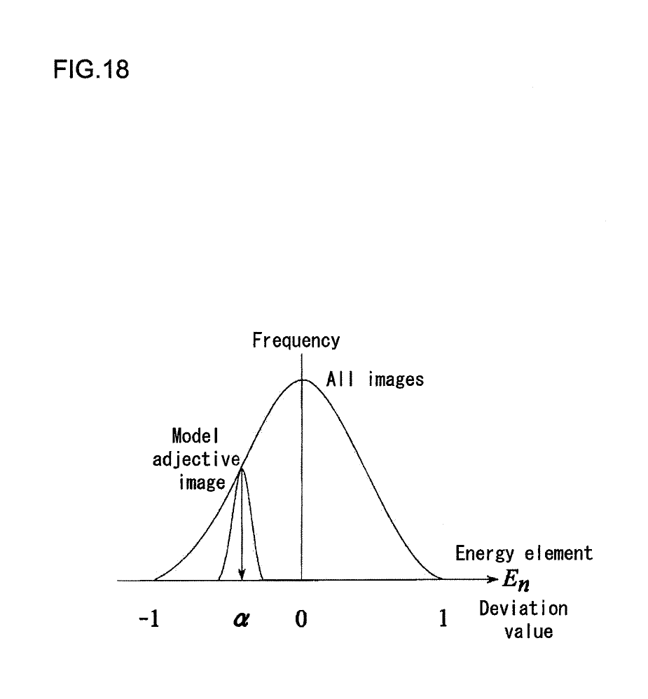

If normalizing the norm of the denominator in this way across the possible range using the statistical mean of the image group or adjective group, it is possible to numericalize by what extent of strength an adjective impression is given by a certain image with respect to a mean image using an absolute reference. Therefore, it becomes possible to evaluate the perception of an absolute impression provided with an evaluation reference of the relative magnitude between adjectives from an absolute image reference—not a relative impression evaluation closed in a single image or in a single adjective. Therefore, normalization of Qi is only normalization so as to fit in the interval of [−1,1] in the mean range. Sometimes, that range may even be exceeded.

<Method of Determination of Linear Combination Coefficients> (See FIG. 18)

If selecting a model image of an adjective i from the sufficiently many general image models and viewing the frequency distribution relating to the energy values for each and every one of the energy elements Eₙ, usually the general images are regularly distributed. The model images are also believed to be regularly distributed in them. However, distortion of the distribution conceivable statistically also is described in the range of the models of the normal distribution.

If evaluating at what position in the distribution of general images the mean value of distribution of model images is, in the form of the deviation value of the model images with respect to the distribution of general images, the deviation value itself shows the importance of the adjectives of the energy elements. At this time, if designating the mean value of the distribution of general images as zero and using deviation values with two ends expressed by intervals of [−1,1], these can be directly used as linear combination coefficients.

This deviation value is given assuming that the width becomes the normal distribution given by the standard deviation value of a general image distribution and in the form of an integral of the distribution function from the mean value of the general distribution to the mean value of the model images. Further, the error of the deviation value can also be calculated if giving the mean values and standard deviation values of the general image distribution and model image distribution.

The distribution of general images is not necessary a normal distribution in some cases, so for the method of expression of the distribution position of a model, in addition to statistics, there are also indicators defining the percentile rank using the actual distribution. Upon experimentation, it was learned that the deviation values giving an integral by an error function assuming normal distribution are superior as linear combination coefficients to the percentile rank obtained by the integral of the actual distribution from a central value of distribution, so normally these are used.

Saying that the energy value of the model images of adjectives is distributed means that the energy value fluctuates. Therefore, the method of describing perception using a large number of image groups to determine perception can be said to correspond to the Gibbs distribution of statistical physics describing the macroscopic quantity of the fluctuating distribution of the energy value (canonical distribution) (see Document E4).

On the other hand, if taking the extreme of reducing the images of the model adjectives to obtain only a single image, a description which compares macroscopic quantities of systems with no fluctuation of energy values determined to the macroscopic energy values which images have in a general image distribution is switched to. In that sense, a single similar image retrieval corresponds to microcanonical distribution of statistical physics where the macroscopic quantities of images of the energy value or the momentum and angular momentum are described by delta functions. In this sense, the method of mechanically describing the perception provides the performance of enabling seamless description of a perceptual image retrieval constructed by a large number of single similar image retrievals. The method only changes the number of model images for determining the linear combination coefficients to the number of the target image group.
[Document E4] Landau and Lifshitz, Course of Theoretical Physics, Volume 5, “Statistical Physics Part 1” (Third Revised Edition, 1976), Chapter 3 “The Gibbs Distribution”, Section 28 “The Gibbs distribution” and Section 35 “The Gibbs distribution for a variable number of particles”

<Combination of Subsystems>

For the adjective energy, expected values are determined in subsystem units as explained above, so next the method of combination has to be considered. In general, the hamiltonian describing the entire system is expressed by a linear combination of hamiltonians of the subsystems, that is, when a linear model of perception stands, the solution of the wave function of the hamiltonian of the entire system is expressed as a linear combination of wave functions of hamiltonian solutions of the subsystems. Therefore, in the same way as the eigenvalues corresponding to the wave functions, the energy eigenvalue En of the entire system is expressed by the linear combination of energy eigenvalues of the subsystems. If expressing this relationship by a formula, one gets

H=k₁H₁+k₂H₂+k₃H₃+k₄H₄+ . . .

where,

H₁: Lower order invariant of color

H₂: Higher order invariant of color

H₃: Lower order invariant of texture

H₄: Higher order invariant of texture

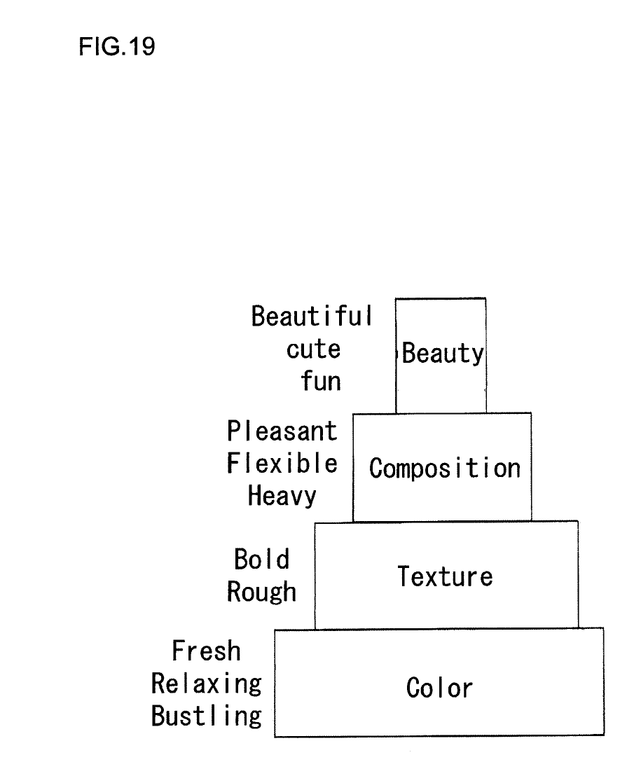

FIG. 19 is a conceptual view of the hierarchical structure of a pyramid.

The added factor of the energy elements solves the previous problem of the degeneracy of the energy level and performs the role of state separation.

That is, even minor differences in state can be continuously numericalized through expression of the energy value of real values. If adding energy relating to the composition system as a subsystem, it becomes possible to solve the energy degenerated relating to the composition up to then and differentiate differences in perception due to the composition.

<Method of Determination of Linear Combination Coefficients k>

The adjective energy Pi,j of the subsystem defined as the inner product of the density of states function ρ(Eₙ) and linear combination coefficients α(Eₙ) for each subsystem (here, symbols for differentiation with the adjective energy Qi of the entire system are introduced) can be used to determine the linear combination coefficients k for these through a process exactly the same as that performed for each of the energy elements in the subsystem up to now. That is, relating to the energy indicator taking the subsum of the linear combination, by investigating how an image group of a general image model is distributed and evaluating at what position the image group of the adjective model is distributed in that by a deviation value, the linear combination coefficients k are determined.

The thus found linear combination coefficients k lead to the elucidation of the ratio of action of subsystems showing which subsystem elements of color, texture, and composition for a certain adjective actually act strongly and determine the impression of the adjective. As the methodology, values of the range of [−1,1] can be taken for the linear combination coefficients k of the subsystem, but when actually running experiments, the result only becomes a positive value. This strangely matches with the role inherently held by the subsystem of only changing the ratio of action of the causative structure.

In this way, when subsystems all have the properties of additive energies, it is possible to divided the subsystems so as to re-determine the linear combination coefficients in subsum units and combine the subsystems. In a system handling only energy, a two-stage combination of combination with other subspaces is gone through.

By similar thinking, in a system handling all of momentum, angular momentum, and energy, there is the concept of division into subsystems among these mechanical invariants, so three-step combination is necessary. That is, the factor structure is determined between elements in the momentum, in the angular momentum, and in the energy, then which mechanical invariant among the momentum, angular momentum, and energy for which the linear sum is taken actually plays the dominant role is determined. It is determined just how important the representative energy of the subsystem expressed by their linear sum is among the subsystems.

If referring to the process of determination of the linear combination coefficients as “learning”, this can be said to be a system performing multistep learning in subsystem units.

<Energy Band Diagram>

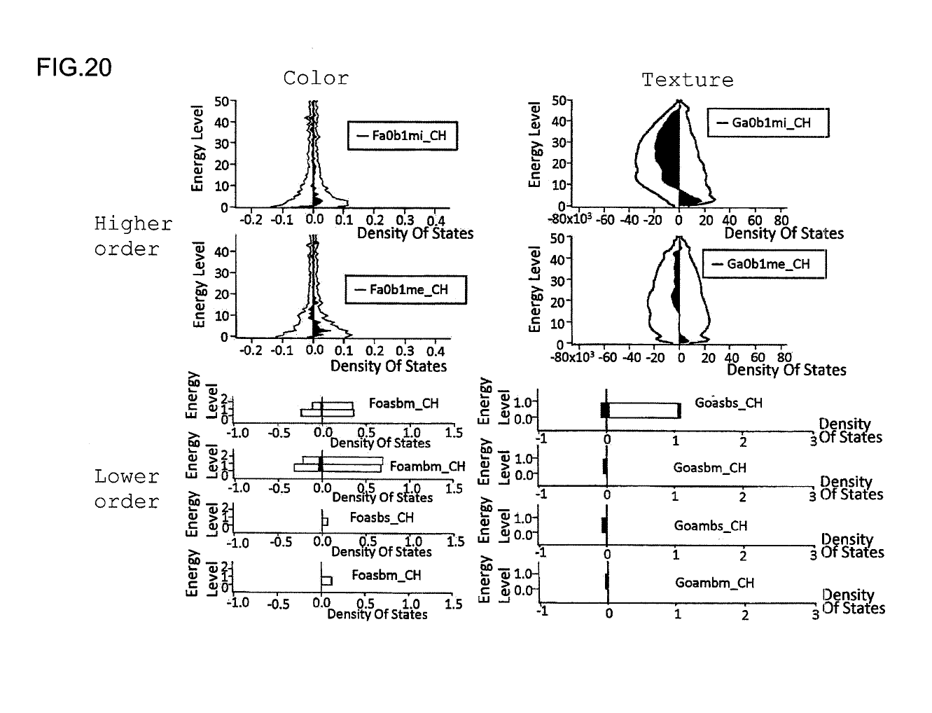

FIG. 20 is an energy band diagram of color and texture. If illustrating the density of states functions in the order of energy level, the lower order system scalar invariants become the discrete energy levels while the higher order system vector invariants become continuous energy levels. This is like a set of atoms reaching Avogadro's Number. For example, with metal substances, the result is a density of states diagram like a system having an energy band structure where the electron orbit of the inner shell is superposed over a discrete energy level close to the atomic order and the electron orbit of the outer shell is superposed over the electron orbit of the adjoining atoms to form a dense energy level conduction band.

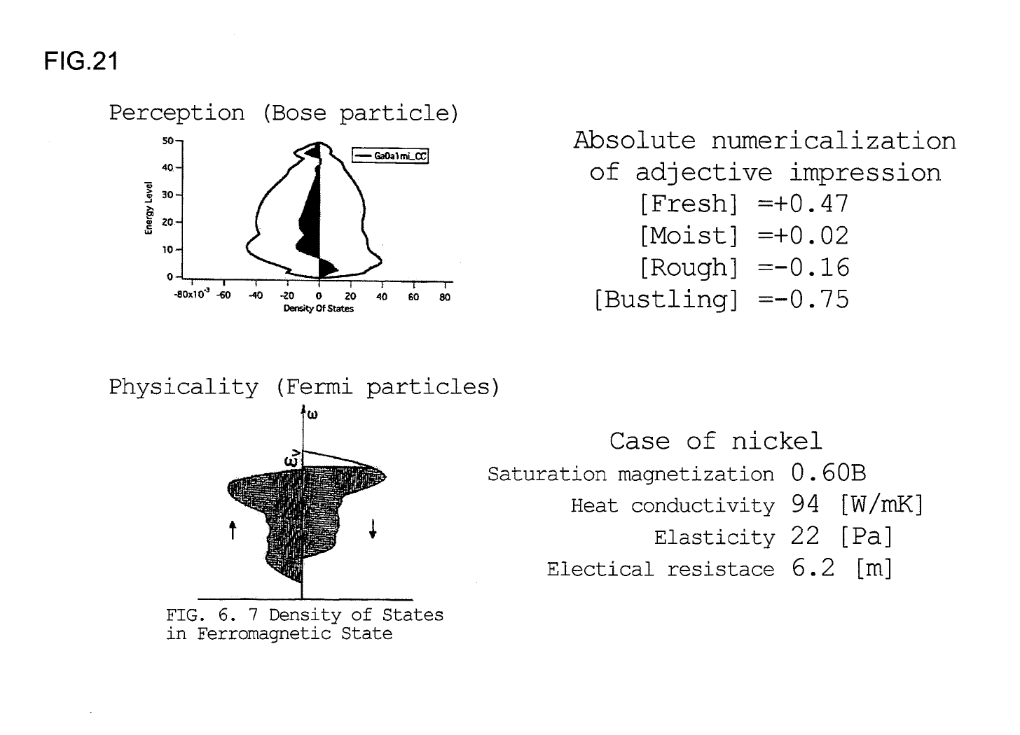

The state of the energy band diagram created from the adjective model of “fresh” selected by a certain person is illustrated. For comparison, the energy band diagram in the conductivity band of the typical transition metal nickel is shown (see FIG. 21).

What determines the electron structure of a substance is that the system of the electrons responsible for it are Fermi particles with a spin ½. Therefore, the Pauli exclusion principle acts and the upward spin and downward spin are never mixed. Therefore, the density of states diagram of the right side of FIG. 21 and the density of states diagram of the left side of FIG. 21 are never mixed. The states are packed in order from low energy level up to the Fermi energy level in the structure.

The energy band diagram describing the perception of one image differs from this. That is, the state taken by the positive energy value (density of states diagram of right side of FIG. 21) and the state taken by the negative energy value (density of states diagram of left side of FIG. 21) are allowed to go to the right or go to the left at any level. The size of the density of states can also be packed in any way. This can be interpreted as describing the properties of Bose particles in a certain sense. Therefore, as the state system of the image, concentration can occur in which the states concentrate at a certain energy level.

If assuming that color describes a spin system, a Chebyshev function optimally selected for describing the higher order invariant of color perfectly matches with being a special function which can only describe the state of the system of the angular momentum 1. The photons of the image are, by quantum mechanics, a system of a spin angular momentum of “1”. Note that from the state of the energy band diagram, the state where the spin system of color describes an extremely fine factor structure can be seen.

A texture system described using spherical Bessell functions suitable for describing one radial direction wave function reveals a state describing an extremely rough energy structure. This is very similar in relationship to the relation that when considering the energy level of atoms of a substance, the radial direction wave functions determine the large energy level, next the wave functions of the zenith angle and azimuth angle direction finely determine the energy level, and the spin system determines the further finer energy level. However, when it comes to the electronic structure of a solid or other substance, for example, with a ferromagnetic material, the spin system starts to play a large role, so the relative relationship of the separation of the energy level cannot be generally discussed by the aggregate system of the collection of atoms.

The relationship of these energy level structures, if comparing the correspondence between the pyramidal structure which it is considered an adjective system has and the pyramidal structure of the feature predicted in relation to this, the property of the additive energy in a mechanics-like method of description is in a relation very similar to the state of solution of degeneracy of the energy level of only a system considered up to now by the addition of new principal axis energy elements.

<Temperature of Image>

In an image system, the temperature of the system including both the stationary state and nonstationary state is defined. The temperature is positioned as the total sum of the number of energy states. Therefore, the norm of the vector when the quantum state Eₙ of energy is expressed by a vector for the state n is made the temperature. This corresponds to a normalization factor of the denominator when defining the density of states in the energy. The number of energy states which each individual image can take differs. The temperature also differs with each image. Therefore, the concept of the “temperature of an image” can be defined. For the temperature of an image, the method of counting the number of states must be first defined in common subsystem units. Further, the temperature of an image has the same number of dimensions as energy.

The norm of a vector takes a value of zero or more, so satisfies the condition which the temperature satisfies. Further, when there is no number of states of energy, the image system becomes the absolute zero degree. However, a conjugate space at which the uncertainty principle works is simultaneously described as a projected plane of the subsystem, so it is difficult to create an image giving the absolute zero point.

<Entropy of Image>

The entropy of an image is defined in subsystem units by counting the number of states based on the definition of the distribution function f(p,q) in the phase space of the momenta p and positions q projected in the subsystem. In this sense, the entropy S can be expressed as S=S(f)=S(p,q).

The entropies defined in subsystem units have additive properties, so the entropy of the entire system can also be defined. If defining “a” as expressing a subsystem,

$$S = {\sum }_{a} {S}_{a} \qquad \{ Math . 62 \}$$

Entropy is a dimensionless quantity.

The entropy of a subsystem “a” is calculated by the following formula. Integration is performed only for the interval where the value of the distribution function is limited. The interval where the value is zero is skipped. However, the number of states of the distribution function is made a normalized one. Therefore, a value of over zero is always obtained and the requirement of entropy is satisfied.

Sₐ=−∫∫fₐ(pₐ,qₐ)ln(fₐ(pₐ,qₐ))dpₐdqₐ

∫∫fₐ(pₐ,qₐ)dpₐdqₐ=1 {Math. 63}

When the distribution function f(p,q) of a subsystem is projected in a function of only the momenta p, the following formula is used. The method of integration is similar. However, the number of states of the distribution function is made a normalized one.

Sₐ=−∫fₐ(pₐ)ln(fₐ(pₐ))dpₐ

∫fₐ(pₐ)dpₐ=1 {Math. 64}

Similar definition is possible even when the distribution function f(p,q) of a subsystem is projected in a function of only the positions q. When the distribution functions of all of the subsystems gather at a single state, the entropy becomes zero. However, as the distribution functions, both conjugated distribution functions in an uncertainty relationship are viewed, so an image satisfying this condition will not easily exist. Entropy is a quantity expressing the degree of disorder of an image.

If conducting an experiment preparing the thermodynamic invariant of the quantity of heat Q=TS together with the entropy S, for example, in a subsystem handling only the energy of the lower order invariant of color, the images will be divided into images of a cool impression close to a monochromic image in a low temperature system and into images which are overall colorful and, if having reddish colors, gives a hot impression such as that of the scene of a plateau in high summer. Further, in another subsystem, for example, a subsystem handling higher order invariants of texture, images where uniform texture is packed together tightly cluster at a low temperature system, while abstract-like images accompanied with suitable composition and main subjects cluster at a high temperature system. If explaining this briefly for another subsystem as well, impressions are divided into the featureless, quiet impression in the subsystem of the lower order invariants of texture and a high temperature system of a large number or objects or people jumbled together in high emotions. In the higher order invariants of color, impressions are divided into a low temperature system of sharp impressions such as often seen in Japanese buildings, vacation clothes, etc. and a high low temperature system of deep colors. In this way, a TS invariant plays an important role both in viewing the properties of a subsystem and in verifying if an independent subsystem is being handled.

<Free Energy>

The value of energy Eₙ is expressed as a vector of n dimensions of the energy level n. Furthermore, a scalar invariant TS is added to define the free energy F.

$$\vec{F} = ( \vec{E} , - \vert \vec{E} \vert \frac{S}{〈 S 〉} ) \qquad \{ Math . 65 \}$$

This is a thermodynamic quantity expressing a macroscopic property of an image system itself. From the macroscopic property of an image, how much a property of a certain adjective is emitted can be measured by obtaining the inner product with the linear combination coefficient α vector forming a model of an adjective.

$$Model adjective vector {\vec{α}}_{i} = ( {\vec{α}}^{( E )} , {\vec{α}}^{( TS )} ) \\ {Q}_{i} = {\vec{α}}_{i} \cdot \vec{F} = \frac{{\vec{α}}_{i} \cdot \vec{F}}{{〈 \vert {\vec{α}}_{i} \vert 〉}_{i} 〈 \vert \vec{E} \vert 〉} \qquad \{ Math . 66 \}$$

Therefore, a definition somewhat changing the definition of the adjective energy Qi when explaining the density of states of the energy band is used.

1/<S> expresses the Boltzmann constant k defined in subsystem units. The reason is that the method of measuring the Planck's constant h for counting the number of states in subsystem units differs, so when combining subsystems, this plays an important role for matching the scales of the two. In this way, when combining subsystems, the method of normalization of the denominator plays an extremely important role. As the basic thinking for this, the fact that as much as possible a statistical mean should be carried to the denominator is experimentally shown. If the objective is just to keep the inner product in the [−1,1] interval, it may also be considered to carry the maximum value of the absolute value of the molecules to the denominator, but if actually trying to do this, measurement of energy as a whole fails.

The first reason for making such a change is that the form of the inner product operation when finding the adjective energy is very similar to the form of the argument of the Gibbs distribution. That is, the excitation probability with respect to the energy state Eₙ of Gibbs distribution is expressed as

$$w ( {E}_{n} ) = exp ( \frac{F - {E}_{n}}{T} ) \qquad \{ Math . 67 \}$$

Free energy plays the role of a normalization factor for the probability distribution (see Document E5). Further, the macroscopic property of the image system called perception is believed to be in a correspondence described by the density of states distribution in the energy ρ(Eₙ) through entropy S(p,q)=S(E) of the number of states in phase space in the distribution of fluctuation of the constraining condition E=E(p,q) of the energy function.

The second reason is that free energy F=E−TS means thermodynamic work performed through these (see Document E6). This is interpreted as follows. The microscopic state of an image system (distribution of pixel values) induces perception as thermodynamic work F in the human brain in the form of the quantities of energy E and the quantity of heat TS expressing the macroscopic state. Therefore, the energy band diagram calculated from only the signal value distribution of the image system expresses the macroscopic properties of the image itself, while the state distribution diagram multiplying this with the linear combination coefficient α vector is positioned as a visual quantification of the distribution diagram of perception in the human brain.

In reality, if looking such a picture, an interesting factor of visual psychology can also be explained. That is, the difference in the impressions given by a photograph in a frame of a snow white background color and in a frame of a pitch black background color can be explained by the difference of the free energy. The values of the free energy of a snow white background color and pitch black background color can be calculated. These values differ. A perception corresponding to the amount of change of free energy from the background color to showing a picture in a frame is induced. The amounts of change differ between the former and latter, so the perceptions induced also differ.

The adjective energy measured by free energy, if performing actual experiments with visual psychological quantities, is confirmed to be of a nature of images ordered in an extremely linear relationship. As one interpretation of this, it may be considered that human visual psychological quantities have a logarithmic response characteristic to the amount of light. It is believed that a linear scalar impression is received for the argument of the excitation probability of the Gibbs distribution.
[Document E5] Landau and Lifshitz, Course of Theoretical Physics, Volume 5, “Statistical Physics Part 1” (Third Revised Edition, 1976), Chapter 3 “The Gibbs Distribution”, Section 28 “The Gibbs Distribution” and Section 31 “The free energy in the Gibbs distribution”
[Document E6] Landau and Lifshitz, Course of Theoretical Physics, Volume 5, “Statistical Physics Part 1” (Third Revised Edition, 1976), Chapter 2 “Thermodynamic Quantities”, Section 13 “Work and Quantity of Heat”, Section 15 “The free energy and the thermodynamic potential”, and Section 20 “Maximum work done by a body in an external medium”

[5] Evaluation and Performance of Descriptive Model

<Output of Absolute Impression of Adjectives>

An example will be shown expressing a certain image and numerically evaluating the absolute impression by an adjective model of a certain person based on an energy band diagram. The adjectives are described rearranged in the order of the largest value, for example, “fresh”=+0.47, “moist”=+0.02, “rough”=−0.16, “bustling”=−0.75.

<Correlation Matrix of Adjectives>

An example of the correspondence matrix wᵢⱼ of adjectives for elucidating the correspondence between one adjective and another adjective based on a certain person defined in the fifth embodiment will be shown. This is a value in the range handling the subsystems of color and texture. i and j assign adjective numbers in the order of “fresh”, “bustling”, “rough, and “moist”.

$${w}_{ij} = ( \begin{matrix}0.81 & - 0.58 & 0.50 & 0.34 \\ - 0.54 & 0.75 & - 0.51 & - 0.61 \\ 0.42 & - 0.45 & 0.93 & 0.27 \\ 0.24 & - 0.41 & 0.21 & 0.68\end{matrix} ) \qquad \{ Math . 68 \}$$

<Reproducibility>

If preparing a list evaluating the degree of psychological impression in for example five ranks for a population image forming a model of general images and an image group of an adjective model selected from that, this can also be used for determining the linear combination coefficients for constructing an adjective model for the individual invariants. Furthermore, it is possible to determine the linear combination coefficients of the subsystem of the subsum. If going further with this thinking, even for the sum Qi of the entire system, it is possible to measure at what position the mean value of the distribution of Qi of the model adjective image group can be extracted in the higher group for the distribution of the value of Qi of a general image. This can become an indicator for viewing the objective reproduction rate.

As the method of selection of the model image, there is the technique of 0, 1 judgment of correspondence and noncorrespondence and the method of evaluation by ranking the degree of psychological impression. In the case of five-stage evaluation, the psychological technique of the SD method (semantic differential method) is followed in which 0 expresses noncorrespondence and the integers of 1 to 5 express the level of the degree of correspondence.

When calculating the mean value, deviation value, and other statistical data, in the case of a 0-1 judgment, the mean is calculated by an even weight for the model image. On the other hand, in the case of a five-stage evaluation, in the case of a model mean, rankings of a psychological degree of 1 are deemed correspondence with a weight of 0.2, rankings of a psychological degree of 2 are deemed correspondence with a weight of 0.4, . . . and rankings of a psychological degree of 5 are deemed correspondence with a weight in evaluation of 1 in the calculation.

If calculated in this way, if evaluating the mean value of the model image and the spread of its distribution by standard deviation, the error of the mean value can also be evaluated. That is, in the process of combining this value with the mean value of a general image and its standard deviation to calculate the deviation value showing the position of the mean value of the model image with respect to the distribution of the general image, if also evaluating the error of the deviation value based on the definition, it is possible to give data matched in reliability of evaluation of the deviation value as well.

The reproduction rate in the results of selection of four adjective models of “fresh”, “bustling”, “rough”, and “moist” for testers from among 254 models of general images is shown. In the case of the method of the fifth embodiment, the results of the statistical mean of several persons become deviation values as shown next in order. This means that an extremely high reproduction rate is realized. With the deviation values of 0-100% definition, the values become 85±12%, 86±7%, 98±2%, and 84±12%. Regarding the linearity as well, numericalization is possible if investigating the relationship between the psychological evaluation value and the Qi value.

First, in the fifth embodiment, a stable perceptual retrieval system in the case where there are a large number of images in the adjective model will be described. Next, in the sixth embodiment, a perceptual retrieval system able to handle even the case where there are a small number of adjective model images will be explained. Next, in the seventh embodiment, a single image similar image retrieval system will be explained.

### Fifth Embodiment

### Perceptual Retrieval: Two-Stage Combination of Only “Energy”

1. Conversion to Munsell HVC Color Space

In the same way as the first to fourth embodiments, as the method for preparing the hue planes, as described in the fourth embodiment, a plane from which neutral is separated and a plane from which it is not separated are prepared, the plane from which it is separated is used for describing the aspects of color, while the plane from which it is not separated is used for describing the aspects of texture.

As the method of handling when deeming a hue circle to be a one-dimensional axis, as explained at the start before this embodiment, in the case of color, a cut is made at the point where the power of the histogram becomes the smallest to make the circle one-dimensional. In the case of texture, a cut is made fixed at the origin of the Munsell value. Due to this, the edge planes of the next HVC planes are prepared. The first to fourth embodiments also based on this.

2. Preparation of Edge Images of HVC Planes

Same as explained in second to third embodiments.

3. Preparation of Lower Order Invariants of Color

As the symbols for differentiating this subsystem, sometimes the symbol of Fo is used for the invariants.

3-1. Preparation of Distribution Function of Lower Order System

In the same way as the first embodiment, assume that there are 200 bins of a histogram. A distribution function is quantized in units of bins and cannot be described in any greater accuracy. The distribution function is expressed similarly as follows:

f(H),f(V),f(C)

Assume that the value of the variable x=H, V, C of the distribution function f(x) is defined by the Munsell value regardless of the number of bins and is normalized to [0,1] using the standard maximum value of the Munsell value so as to satisfy uniformity among HVC. However, there is no upper limit to the value of C, so while unusual, the value of 1 is sometimes exceeded. That is,

H≡H/100,

V≡V/10,

C≡C/20.

Further, the distribution function satisfies the conditions of normalization. Therefore, the probability density is described.

∫f(x)dx=1 {Math. 69}

Regarding f(H), assume that the probability density of the neutral hue is described in the single bin of f(N).

3-2. Calculation of Entropy

The entropy S is calculated from the distribution function f(x). The case where the value of the distribution function is 0, in the sense of not taking that state, is excluded from the integration interval. If expressing the color planes of the distribution function differentiated by (α), entropies are calculated from the distribution functions of the H, V, and C planes. The sum of these expresses the entropy of the subsystem projected into the lower order system of color.

S^{(α)}=−∫_{f}_{^{(α)}}_{(x)≠0}f^{(α)}(x)ln(f^{(α)}(x))dx

S=S^{(H)}+S^{(V)}+S^{(C)} {Math. 70}

This value is made S_{Fo}.

3-3. Calculation of Elements pₙ of Momentum

The mean value <x> and the standard deviation value σₓ are calculated from the distribution function f(x).

[symbol]

x [symbol] =∫xf(x)dx

σₓ²=∫(x− [symbol] x [symbol] )²f(x)dx {Math. 71}

At the hue plane as well, a distribution function from which the neutral component has been removed is used and the mean value and deviation value are calculated on the axis of the hue circle made one-dimensional. However, the mean value <H> of hue is expressed by two components on a hue circle of a radius 1 by a complex number exp(2πi<H_{≠N}>) of a magnitude satisfying l<H_{≠N}>l=1 at all times. At this time, it is assumed that the effect of removal of neutral acts on the radius showing the magnitude of the hue. For this reason, the neutral ratio pop(N) is calculated. That is,

[symbol]

H_{≠N} [symbol] =∫_{H≠N}Hf(H)dH

σ_{H≠N}²=∫_{H≠N}(H− [symbol] H_{≠N} [symbol] )²f(H)dH

pop(N)=∫_{H=N}f(H)dH {Math. 72}

x=H, V, C, so these are linked as elements pₙ of momentum.

<H>, <V>, <C>, σ_{H}, σ_{V}, σ_{C}

The parts relating to hue have to be defined as follows: The components separated into two are assigned other element numbers n.

$$〈 H 〉 = \{ \begin{matrix}( 1 - pop ( N ) ) \vert 〈 {H}_{\neq N} 〉 \vert cos ( 2 π 〈 {H}_{\neq N} 〉 ) \\ ( 1 - pop ( N ) ) \vert 〈 {H}_{\neq N} 〉 \vert sin ( 2 π 〈 {H}_{\neq N} 〉 )\end{matrix} \\ {σ}_{H} = ( 1 - pop ( N ) ) {σ}_{H \neq N} \qquad \{ Math . 73 \}$$

Note that the values of the elements of momentum are all described in the range of [0,1].

3-4. Calculation of Elements Eₙ of Energy

As the energy elements Eₙ, the following are defined.

$$\{ Math . 74 \}$$

$$( α ) ( α )$$

$$amam \text{:}$$

$$〈 H 〉 〈 H 〉 = {( 1 - pop ( N ) )}^{2} {\vert 〈 {H}_{\neq N} 〉 \vert}^{2}$$

$$〈 V 〉 〈 V 〉$$

$$〈 C 〉 〈 C 〉$$

$$amas \text{:}$$

$$〈 H 〉 {σ}_{H} = \{ \begin{matrix}( 1 - pop ( N ) ) \vert 〈 {H}_{\neq N} 〉 \vert cos ( 2 π 〈 {H}_{\neq N} 〉 ) \cdot ( 1 - pop ( N ) ) {σ}_{H \neq N} \\ ( 1 - pop ( N ) ) \vert 〈 {H}_{\neq N} 〉 \vert sin ( 2 π 〈 {H}_{\neq N} 〉 ) \cdot ( 1 - pop ( N ) ) {σ}_{H \neq N}\end{matrix} \\ 〈 V 〉 {σ}_{V} \\ 〈 C 〉 {σ}_{C} \\ asas \text{:} \\ {σ}_{H} {σ}_{H} = {( 1 - pop ( N ) )}^{2} {σ}_{H \neq N}^{2} \\ {σ}_{V} {σ}_{V} \\ {σ}_{C} {σ}_{C} \\ ( β ) ( β ) \\ ambm \text{:} \\ 〈 H 〉 〈 V 〉 = \{ \begin{matrix}( 1 - pop ( N ) ) \vert 〈 {H}_{\neq N} 〉 \vert cos ( 2 π 〈 {H}_{\neq N} 〉 ) \cdot 〈 V 〉 \\ ( 1 - pop ( N ) ) \vert 〈 {H}_{\neq N} 〉 \vert sin ( 2 π 〈 {H}_{\neq N} 〉 ) \cdot 〈 V 〉\end{matrix} \\ 〈 V 〉 〈 C 〉 \\ 〈 C 〉 〈 H 〉 = \{ \begin{matrix}〈 C 〉 \cdot ( 1 - pop ( N ) ) \vert 〈 {H}_{\neq N} 〉 \vert cos ( 2 π 〈 {H}_{\neq N} 〉 ) \\ 〈 C 〉 \cdot ( 1 - pop ( N ) ) \vert 〈 {H}_{\neq N} 〉 \vert sin ( 2 π 〈 {H}_{\neq N} 〉 )\end{matrix} \\ ambs \text{:} \\ 〈 H 〉 {σ}_{V} = \{ \begin{matrix}( 1 - pop ( N ) ) \vert 〈 {H}_{\neq N} 〉 \vert cos ( 2 π 〈 {H}_{\neq N} 〉 ) \cdot {σ}_{V} \\ ( 1 - pop ( N ) ) \vert 〈 {H}_{\neq N} 〉 \vert sin ( 2 π 〈 {H}_{\neq N} 〉 ) \cdot {σ}_{V}\end{matrix} \\ 〈 V 〉 {σ}_{C} \\ 〈 C 〉 {σ}_{H} = 〈 C 〉 ( 1 - pop ( N ) ) {σ}_{H \neq N} \\ asbm \text{:} \\ {σ}_{H} 〈 V 〉 = ( 1 - pop ( N ) ) {σ}_{H \neq N} 〈 V 〉 \\ {σ}_{V} 〈 C 〉 \\ \begin{matrix}{σ}_{C} 〈 H 〉 = & \{ \begin{matrix}{σ}_{C} \cdot ( 1 - pop ( N ) ) \vert 〈 {H}_{\neq N} 〉 \vert cos ( 2 π 〈 {H}_{\neq N} 〉 ) \\ {σ}_{C} \cdot ( 1 - pop ( N ) ) \vert 〈 {H}_{\neq N} 〉 \vert sin ( 2 π 〈 {H}_{\neq N} 〉 )\end{matrix}\end{matrix} \\ asbs \text{:} \\ {σ}_{H} {σ}_{V} = ( 1 - pop ( N ) ) {σ}_{H \neq N} {σ}_{V} \\ {σ}_{V} {σ}_{C} \\ {σ}_{C} {σ}_{H} = {σ}_{C} ( 1 - pop ( N ) ) {σ}_{H \neq N}$$

Note that the values of the elements of energy are all described in the range of [−1,1].

3-5. Calculation of Temperature of Subsystem

If expressing the values of the energy elements all together by a vector, the energy vector of a subsystem can be defined.

\vec{E}=(E₁,E₂, . . . ,Eₙ) {Math. 75}

If calculating the norm of the energy vector of the subsystem, it is possible to define the temperature T of the image relating to the subsystem.

T=|\vec{E}|=\sqrt{E₁²+E₂²+ . . . +Eₙ²} {Math. 76}

3-6. Calculation of Free Energy of Subsystem

The thermodynamic invariant of free energy is defined using the thus calculated vector of the energy elements Eₙ, the temperature T of the image, and the macroscopic quantity of the entropy S. The free energy is a vector of the energy vector plus one scalar quantity.

$$\vec{F} = ( \vec{E} , - \vert \vec{E} \vert \frac{S}{〈 S 〉} ) = ( \vec{E} , - T \frac{S}{〈 S 〉} ) \qquad \{ Math . 77 \}$$

Here, < > expresses the statistical mean relating to any general image. Therefore, <S> calculates the entropy of an image for any of a large number of general images prepared in advance. These mean values have to be calculated in advance. Physically, 1/<S> performs the role of the Boltzmann constant k for linking the microscopic number of states on a phase space and the macroscopic quantity of entropy based on Planck's constant defined in this subsystem. That is, regarding the number of states in the phase space

ΔΓ=ΔpΔq/(2π [symbol] )^{s} {Math. 78}

(where s is the number of freedoms of a system), entropy is linked in the relationship of S=ln ΔΓ (see Document E3). Further, to link temperature with the amount of energy, kT is used for measurement through the Boltzmann constant k. Note that usually, the Boltzmann constant defines also the entropy side. For temperature, a definition is often employed enabling description by the same size of scale as with the energy (see Document E7). That is, S=k ln ΔΓ. Regarding the quantum state of an image system, the definition of Planck's constant changes by the subsystem, so such an absolutely unchanging physical constant cannot be defined. Therefore, an operation is performed for normalization for measurement, by an absolute reference, of the number of states which each image can take based on the mean number of states which general images can take in the subsystem. This performs the same role as the Boltzmann constant. The Boltzmann constant of this subsystem can be expressed by the following equation:

$${k}_{Fo} = \frac{1}{〈 {S}_{Fo} 〉} \qquad \{ Math . 79 \}$$

[Document E7] Landau and Lifshitz, Course of Theoretical Physics, Volume 5, “Statistical Physics Part 1” (Third Revised Edition, 1977), Chapter 2 “Thermodynamic Quantities”, Section 9 “Temperature”

4. Preparation of Higher Order Invariants of Color

As the symbol for differentiating this subsystem, sometimes the symbol F will be used for the invariants.

4-0. Hilbelt Space Expression of Distribution Function of Lower Order System

The histograms of the colors of HVC planes are positioned as distribution functions of a lower order system of color. A distribution function of a lower order system can also be interpreted as a coordinate space q able to be measured by the original coordinate system. This is converted to Chebyshev functions to be expressed as frequency and projected into the momentum space p. This is an equivalent expression of viewing the original distribution function from a different aspect. As the base functions forming the Hilbelt space, the properties of distribution functions of a lower order system are added to select a function of a complete orthogonal system expressed as compactly as possible. However, due to the uncertainty principle of coordinate space and momentum space

ΔpΔq≧ [symbol] {Math. 80}

when one is expressed compactly, the other is expressed broadly. It is optimal to select a function system giving the smallest uncertainty of the two.

In the same way as the first embodiment, this is defined so that the values of the expansion coefficients fit in the range of [−1,1].

$${f}^{( α )} ( x ) = {\sum }_{n = 0}^{2 N - 1} {C}_{n}^{( α )} {T}_{n} ( x ) \\ ( α ) = H , V , {C}_{o} \qquad \{ Math . 81 \}$$

When (α) is H, x=H, when (α) is V, x=V, and when (α) is C, x=C. The value of N is made 100.

4-1. Preparation of Distribution Function of Higher Order System

The power spectrum of the coefficients expanded by Chebyshev expansion is defined as the distribution function of a higher order system relating to color. The distribution functions of higher order systems can be defined for the three H, V, and C planes. This is normalized to express the probability density.

$${f}^{( α )} ( k ) = \frac{{( {c}_{k}^{( α )} )}^{2}}{{\sum }_{k} {( {c}_{k}^{( α )} )}^{2}} \\ ( α ) = H , V , {C}_{o} \qquad \{ Math . 82 \}$$

When the distribution function of the higher order system of color has 2N=200, the value of k is quantized to 200 bins.

4-2. Calculation of Entropy

The entropy S is calculated from the distribution function f(x). The case where the value of the distribution function is 0, in the sense of not taking that state, is excluded from the integration interval. If expressing the color planes of the distribution function differentiated by (α), entropies are calculated from the distribution functions of the H, V, and C planes. The sum of these expresses the entropy of the subsystem projected into the higher order system of color

S^{(α)}=−∫_{f}_{^{(α)}}_{(k)≠0}f^{(α)}(k)ln(f^{(α)}(k))dk

S=S^{(H)}+S^{(V)}+S^{(C)} {Math. 83}

This value is made S_{F}.

4-3. Calculation of Elements pₙ of Momentum

Chebyshev expansion coefficients enable a grasp of momenta in a Hilbelt space. Therefore, the elements pₙ of momentum are the expansion coefficients themselves:

pₙ^{(α)}=cₙ^{(α)}(α)=H,V,C.

The momentums of the different color planes are expressed together in order by pₙ. These form the momentum p=(p₁, p₂, . . . , pᵢ, . . . ) of the phase space of this subsystem.

4-4. Calculation of Elements Eₙ of Energy

When constructing an energy matrix expressing mechanical energy by products of momentum, in the fifth embodiment, a submatrix is created in units of angular momentum and an expanded trace is taken to form a complete system. Due to this, the eigenvalues of the energy are found. These become the elements of the energy. Basically, energy invariants are constructed by the same procedure as in the first embodiment.

When defining the elements of energy, a relationship guaranteed by the Schwarz inequality is used and normalization is performed by the pure trace of the energy matrix, that is the sum of the diagonal elements, so that each fall in the range of [−1,1]. Therefore, only the stationary state constructed by only the pure trace cannot be normalized. The other energy elements are all normalized and the expanded trace defined. Regarding the value of the pure diagonal sum, since each of the expansion coefficients of the distribution function is defined in the range of [−1,1], even if slightly sticking out, a value of a range of about [0,1] is found.

The energy eigenvalue expresses the amount of absolute energy. Even in finally taking the linear combination, the energy eigenvalue having a finite value and the linear combination coefficients having values not zero have different meanings. The energy eigenvalue expresses the existence of energy elements emitted by an image itself. The linear combination coefficients only express if elements are important for a certain adjective. Therefore, the energy eigenvalue must be measured by an absolute reference. Regarding the problem of the above-mentioned diagonal sum sticking out slightly over the range of [0,1], it is possible to assume that the zero point energy ε₀ is added to the energy of the diagonal sum from the original and the amount corresponding to the zero point energy is subtracted for the definition. Even if introducing zero point energy, there is no effect at all on the linear combination coefficients. Here, in the case of the Chebyshev expansion coefficients of the higher order system of color, the value of ⅓=0.333 or so is introduced as the zero point energy. Further, in the case of a spherical Bessell expansion coefficient of a higher order system explained later, the diagonal sum does not exceed the range of [0,1], so there is no need to introduce the zero point energy.

Below, when considering cₙ divided into subgroups of angular momentum units, the expansion coefficients of the angular momentum quantum number l=0 are expressed as c₀ₙ and the expansion coefficients of the angular momentum quantum number l=1 are expressed as c₁ₙ. Therefore, the number of elements of the expansion coefficients is divided into N number of half each. The number of elements of the subgroups is counted by n=1, 2, . . . , N. Further, it is possible to give only one energy element expressing the pure diagonal sum by a separate definition.

$$( Separate definition ) \\ ( α ) ( α ) \\ a 0 a 0 p , e \text{:} \\ {E}_{n = j - k = 0 , i = {i}^{′} = 0}^{( α ) ( α ) +} = \{ {\sum }^{N} {( {c}_{0 i}^{( α )} )}^{2} + {\sum }^{N} {( {c}_{1 i}^{( α )} )}^{2} \} - {ɛ}_{0} i = k \\ ( General definition ) \\ ( α ) ( α ) \\ a 0 a 0 p , e \text{/} i \text{:} \\ {E}_{n = i - k , i - {i}^{′} = 0}^{( α ) ( \pm α ) +} = \frac{\frac{1}{4} \{ \begin{matrix}{\sum }_{k = i + n , i = 1}^{N} ( {c}_{0 i}^{( α )} {c}_{0 k}^{( α )} + {c}_{0 k}^{( α )} {c}_{0 i}^{( α )} ) \pm \\ {\sum }_{k = i + n , i = 1}^{N} ( {c}_{1 i}^{( α )} {c}_{1 k}^{( α )} + {c}_{1 k}^{( α )} {c}_{1 i}^{( α )} )\end{matrix} \}}{\frac{1}{2} \{ {\sum }_{i = 1}^{N} {( {c}_{0 i}^{( α )} )}^{2} + {\sum }_{i = 1}^{N} {( {c}_{1 i}^{( α )} )}^{2} \}} i \neq k \\ a 0 a 1 p , e \text{:} \\ {E}_{n = i - k , i - {i}^{′} = 1}^{( α ) ( + α ) +} = \frac{\frac{1}{4} \{ \begin{matrix}{\sum }_{k = i + n , i = 1}^{N} ( {c}_{0 i}^{( α )} {c}_{1 k}^{( α )} + {c}_{0 k}^{( α )} {c}_{1 i}^{( α )} ) + \\ {\sum }_{k = i + n , i = 1}^{N} ( {c}_{1 i}^{( α )} {c}_{0 k}^{( α )} + {c}_{1 k}^{( α )} {c}_{0 i}^{( α )} )\end{matrix} \}}{\sqrt{{\sum }_{i = 1}^{N} {( {c}_{0 i}^{( α )} )}^{2}} \sqrt{{\sum }_{i = 1}^{N} {( {c}_{1 i}^{( α )} )}^{2}}} \\ a 0 a 1 m , i \text{:} \\ {E}_{n = i - k , i - {i}^{′} = 1}^{( α ) ( - α ) -} = \frac{\frac{1}{4} \{ \begin{matrix}- {\sum }_{k = i + n , i = 1}^{N} ( {c}_{0 i}^{( α )} {c}_{1 k}^{( α )} - {c}_{0 k}^{( α )} {c}_{1 i}^{( α )} ) + \\ {\sum }_{k = i + n , i = 1}^{N} ( {c}_{1 i}^{( α )} {c}_{0 k}^{( α )} - {c}_{1 k}^{( α )} {c}_{0 i}^{( α )} )\end{matrix} \}}{\sqrt{{\sum }_{i = 1}^{N} {( {c}_{0 i}^{( α )} )}^{2}} \sqrt{{\sum }_{i = 1}^{N} {( {c}_{1 i}^{( α )} )}^{2}}} i \neq k \\ ( α ) ( β ) \\ a 0 b 0 p , e \text{/} i \text{:} \\ {E}_{n = i - k , i - {i}^{′} = 0}^{( α ) ( \pm β ) +} = \frac{\frac{1}{4} \{ \begin{matrix}{\sum }_{k = i + n , i = 1}^{N} ( {c}_{0 i}^{( α )} {c}_{0 k}^{( β )} + {c}_{0 k}^{( α )} {c}_{0 i}^{( β )} ) \pm \\ {\sum }_{k = i + n , i = 1}^{N} ( {c}_{1 i}^{( α )} {c}_{1 k}^{( β )} + {c}_{1 k}^{( α )} {c}_{1 i}^{( β )} )\end{matrix} \}}{\frac{1}{2} \{ \begin{matrix}\sqrt{{\sum }_{i = 1}^{N} {( {c}_{0 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{1 i}^{( β )} )}^{2}}\end{matrix} \}} \\ a 0 b 0 m , e \text{/} i \text{:} \\ {E}_{n = i - k , i - {i}^{′} = 0}^{( α ) ( \pm β ) -} = \frac{\frac{1}{4} \{ \begin{matrix}{\sum }_{k = i + n , i = 1}^{N} ( {c}_{0 i}^{( α )} {c}_{0 k}^{( β )} - {c}_{0 k}^{( α )} {c}_{0 i}^{( β )} ) \pm \\ {\sum }_{k = i + n , i = 1}^{N} ( {c}_{1 i}^{( α )} {c}_{1 k}^{( β )} - {c}_{1 k}^{( α )} {c}_{1 i}^{( β )} )\end{matrix} \}}{\frac{1}{2} \{ \begin{matrix}\sqrt{{\sum }_{i = 1}^{N} {( {c}_{0 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{1 i}^{( β )} )}^{2}}\end{matrix} \}} i \neq k \\ a 0 b 1 p , e \text{/} i \text{:} \\ {E}_{n = i - k , i - {i}^{′} = 1}^{( α ) ( \pm β ) +} = \frac{\frac{1}{4} \{ \begin{matrix}\pm {\sum }_{k = i + n , i = 1}^{N} ( {c}_{0 i}^{( α )} {c}_{1 k}^{( β )} + {c}_{0 k + 1}^{( α )} {c}_{1 i}^{( β )} ) + \\ {\sum }_{k = i + n , i = 1}^{N} ( {c}_{1 i}^{( α )} {c}_{0 , k + 1}^{( β )} + {c}_{1 k}^{( α )} {c}_{0 i}^{( β )} )\end{matrix} \}}{\frac{1}{2} \{ \begin{matrix}\sqrt{{\sum }_{i = 1}^{N} {( {c}_{0 i}^{( α )} )}^{2}} \sqrt{{\sum }_{i = 1}^{N} {( {c}_{1 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{0 i}^{( β )} )}^{2}}\end{matrix} \}} \\ a 0 b 1 m , e \text{/} i \text{:} \\ {E}_{n = i - k , i - {i}^{′} = 1}^{( α ) ( \pm β ) -} = \frac{\frac{1}{4} \{ \begin{matrix}\pm {\sum }_{k = i + n , i = 1}^{N} ( {c}_{0 i}^{( α )} {c}_{1 k}^{( β )} - {c}_{0 k + 1}^{( α )} {c}_{1 i}^{( β )} ) + \\ {\sum }_{k = i + n , i = 1}^{N} ( {c}_{1 i}^{( α )} {c}_{0 , k + 1}^{( β )} - {c}_{1 k}^{( α )} {c}_{0 i}^{( β )} )\end{matrix} \}}{\frac{1}{2} \{ \begin{matrix}\sqrt{{\sum }_{i = 1}^{N} {( {c}_{0 i}^{( α )} )}^{2}} \sqrt{{\sum }_{i = 1}^{N} {( {c}_{1 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{0 i}^{( β )} )}^{2}}\end{matrix} \}} \qquad \{ Math . 84 \}$$

Here, when taking a value such as c₀ₖ=c_{0,N+n}, the vector {c₀ₖ} is connected in a ring inside a subgroup of the same angular momentum such as c_{0,N+n}=C_{0,n} and the initial point is returned to for redefinition. In the same way, c_{1,N+n}=c_{1,n}. These energy elements are expressed together as Eₙ.

4-5. Calculation of Temperature of Subsystem

The energy vector of a subsystem and the temperature T of the image of a subsystem can be defined in the same way as above.

\vec{E}=(E₁,E₂, . . . ,Eₙ)

T=|\vec{E}|=\sqrt{E₁²+E₂²+ . . . +Eₙ²} {Math. 85}

4-6. Calculation of Free Energy of Subsystem

The free energy of a subsystem can be defined in the same way as above.

$$\vec{F} = ( \vec{E} , - \vert \vec{E} \vert \frac{S}{〈 S 〉} ) = ( \vec{E} , - T \frac{S}{〈 S 〉} ) \qquad \{ Math . 86 \}$$

The Boltzmann constant of this subsystem is measured by the reciprocal of the statistical mean of any image of entropy of this subsystem.

$${k}_{F} = \frac{1}{〈 {S}_{F} 〉} \qquad \{ Math . 87 \}$$

5. Preparation of Lower Order Invariants of Texture

As a symbol for differentiating this subsystem, sometimes the symbol of Go is used for the invariants.

5-1. Preparation of Distribution Function of Lower Order System

In the same way as the third embodiment, assume that there are 200 bins of a histogram. A distribution function is quantized in units of bins and cannot be described in any greater accuracy. The distribution function is expressed similarly as follows:

f(ΔH),f(ΔV),f(ΔC)

Assume that the value of the variable x=ΔH, ΔV, ΔC of the distribution function f(x) is defined by the Munsell value regardless of the number of bins and is normalized to [−1,1] as the differential so as to satisfy uniformity among HVC. That is,

ΔH≡ΔH/100,

ΔV≡ΔV/10,

ΔC≡ΔC/20.

Further, the distribution function satisfies the conditions of normalization. Therefore, the probability density is described.

∫f(x)dx=1 {Math. 88}

5-2. Calculation of Entropy

The entropy S is calculated from the distribution function f(x). The case where the value of the distribution function is 0, in the sense of not taking that state, is excluded from the integration interval. If expressing the color planes of the distribution function differentiated by (α), entropies are calculated from the distribution functions of the H, V, and C planes. The sum of these expresses the entropy of the subsystem projected into the lower order system of texture.

S^{(α)}=−∫_{f}_{^{(α)}}_{(x)≠0}f^{(α)}(x)ln(f^{(α)}(x))dx

S=S^{(H)}+S^{(V)}+S^{(C)} {Math. 89}

This value is made S_{Go}.

5-3. Calculation of Elements pₙ of Momentum

The mean value <x> and the standard deviation value σₓ are calculated from the distribution function f(x).

[symbol]

x [symbol] =∫xf(x)dx

σₓ²=∫(x− [symbol] x [symbol] )²f(x)dx {Math. 90}

Since x=ΔH, ΔV, ΔC, these correspond to the elements pₙ of momentum.

<ΔH>, <ΔV>, <ΔC>, σ_{ΔH}, σ_{ΔV}, σ_{ΔC}

Note that the values of the elements of momentum are all described in the range of [−1,1].

5-4. Calculation of Elements Eₙ of Energy

As the energy elements Eₙ, the following are defined. Their values are all defined as real values.

(α)(α)
amam:

<ΔH><ΔH>

<ΔV><ΔV>

<ΔC><ΔC>

amas:

<ΔH>σ_{ΔH}

<ΔV>σ_{ΔV}

<ΔC>σ_{ΔC}

asas:

σ_{ΔH}σ_{ΔH}

σ_{ΔV}σ_{ΔV}

σ_{ΔC}σ_{ΔC}

(β)(β):
ambm:

<ΔH><ΔV>

<ΔV><ΔC>

<ΔC><ΔH>

ambs:

<ΔH>σ_{ΔV}

<ΔV>σ_{ΔC}

<ΔC>σ_{ΔH}

asbm:

σ_{ΔH}<ΔV>

σ_{ΔC}<ΔC>

σ_{ΔC}<ΔH>

asbs:

σ_{ΔH}σ_{ΔV}

σ_{ΔV}σ_{ΔC}

σ_{ΔC}σ_{ΔH}

Note that the values of the elements of energy are all described in the range of [−1,1].

5-5. Calculation of Temperature of Subsystem

The energy vector of a subsystem and the temperature T of the image of a subsystem can be defined in the same way as above.

5-6. Calculation of Free Energy of Subsystem

The free energy of a subsystem can be defined in the same way as above.

$$\vec{F} = ( \vec{E} , - \vert \vec{E} \vert \frac{S}{〈 S 〉} ) = ( \vec{E} , - T \frac{S}{〈 S 〉} ) \qquad \{ Math . 91 \}$$

The Boltzmann constant of this subsystem is measured by the reciprocal of the statistical mean of any image of entropy of this subsystem.

$${k}_{Go} = \frac{1}{〈 {S}_{Go} 〉} \qquad \{ Math . 92 \}$$

6. Preparation of Higher Order Invariants of Texture

The letter “G” is sometimes used as a symbol for differentiating this subsystem for invariants.

6-0. Hilbelt Space Expression of Distribution Function of Lower Order System

The histograms of the edge images of HVC planes are positioned as distribution functions of a lower order system of texture. A distribution function of a lower order system can also be interpreted as a coordinate space able to be measured by the original coordinate system. This is converted by spherical Bessell conversion to a frequency expression and projected into the momentum space p. This is an equivalent expression viewing the original distribution function from a different aspect. As the base functions forming the Hilbelt space, the properties of distribution functions of a lower order system are added to select a function of a complete orthogonal system expressed as compactly as possible. However, due to the uncertainty principle of coordinate space and momentum space

ΔpΔq≧ [symbol] {Math. 93}

when one is expressed compactly, the other is expressed broadly. It is optimal to select a function system giving the smallest uncertainty of the two.

In the same way as the third embodiment, in the present embodiment, the case of expansion by the s and p orbits will be explained. Note that even in the case of expansion by the s, p, d, and f orbits, as explained in the start, similar expansion is possible.

$${f}^{( α )} ( x ) = {\sum }_{l = 0}^{1} {\sum }_{n = 1}^{N} {c}_{ln}^{( α )} {j}_{l} ( {α}_{ln} \frac{x}{a} ) ( α ) = H , V , {C}_{o} \qquad \{ Math . 94 \}$$

When (α) is H, x=ΔH, when (α) is V, x=ΔV, and when (α) is C, x=ΔC. The value of N is 100.

6-1. Preparation of Distribution Function of Higher Order System

The power spectrum of the coefficients expanded by spherical Bessell expansion is defined as the distribution function of a higher order system relating to texture. The distribution functions of higher order systems can be defined for the three H, V, and C planes. This is normalized to express the probability density.

$${f}^{( α )} ( l , k ) = \frac{{( {c}_{lk}^{( α )} )}^{2}}{{\sum }_{t}^{ } {\sum }_{k}^{ } {( {c}_{lk}^{( α )} )}^{2}} ( α ) = H , V , {C}_{o} \qquad \{ Math . 95 \}$$

When the distribution function of the higher order system of texture has N=100, for one angular momentum, the value of k is quantized to 100 bins. The value of 1 takes 0 and 1, so is quantized in total to 2×100=200 bins.

6-2. Calculation of Entropy

The entropy S is calculated from the distribution function f(1,k). When the value of the distribution function is 0, it means that that state is not taken and therefore this is excluded from the integration interval. If expressing the color planes of the distribution function differentiated by (α), entropies are calculated from the distribution functions of the edge images of the H, V, and C planes. The sum of these expresses the entropy of the subsystem projected into the higher order system of texture.

S^{(α)}=−∫∫_{f}_{^{(α)}}_{(l,k)≠0}f^{(α)}(l,k)ln(f^{(α)}(l,k))dkdl

S=S^{(H)}+S^{(V)}+S^{(C)} {Math. 96}

This value is made S_{G}.

6-3. Calculation of Elements pₙ of Momentum

Spherical Bessell expansion coefficients can be grasped as momentum in a Hilbelt space. Therefore, the elements pₙ of momentum are the expansion coefficients themselves.

pₙ^{(α)}=c₀ₙ^{(α)}

p_{N+n}^{(α)}=c₁ₙ^{(α)}(α)=H,V,C.

The momentums of the different color planes are expressed together in order by pₙ. These form the momentum p=(p₁, p₂, . . . , pᵢ, . . . ) of the phase space of this subsystem.

6-4. Calculation of Elements Eₙ of Energy

In expansion to the s and p orbits, the equation is exactly the same as that defined for the higher order system of color, that is, the Chebyshev expansion coefficients. The Chebyshev expansion coefficients are merely replaced with spherical Bessell expansion coefficients. Note that in the case of a higher order system of texture, ε₀=0 may be set for the zero point energy.

6-5. Calculation of Temperature of Subsystem

The energy vector of a subsystem and the temperature T of the image of a subsystem can be defined in the same way as above.

6-6. Calculation of Free Energy of Subsystem

The free energy of a subsystem can be defined in the same way as above.

$$\vec{F} = ( \vec{E} , - \vert \vec{E} \vert \frac{S}{〈 S 〉} ) = ( \vec{E} , - T \frac{S}{〈 S 〉} ) \qquad \{ Math . 97 \}$$

The Boltzmann constant of this subsystem is measured by the reciprocal of the statistical mean of any image of the entropy of this subsystem.

$${k}_{Go} = \frac{1}{〈 {S}_{Go} 〉} \qquad \{ Math . 98 \}$$

7. Combination of Adjective Energy of Subsystem

7-1. Setting of Adjectives

The adjectives presented by the perceptual retrieval system using adjectives as keywords are determined and i-th adjectives are assigned as symbols for differentiating them. As adjectives, for example, there are “brisk”, “busy”, “boisterous”, “moist”, etc.

7-2. Construction of General Image Models

A large number of general images are randomly collected to make a model of general images. Usually, an order of several hundred images are prepared. Furthermore, if expecting accuracy, the order becomes 10s of thousands. The greater the number, the stabler the statistics. These are used to construct a distribution function p(x) of the general model image group explained below. The distribution function p(x) expresses the image frequency which general energy can take in a unit energy interval taking the actual value Eₙ. If dividing the energy interval as bins, the result becomes a frequency distribution function.

7-3. Construction of Adjective Model Image

Each of the prepared general image models was evaluated for psychological impression of correspondence with an i-th adjective to prepare distribution data of an adjective model image. There are two methods of preparation. Either may be used. That is, in the case of simple correspondence or noncorrespondence, the integers of 1 and 0 are assigned and images assigned “1” are used as images of the same weight. Further, the image groups are used to construct a distribution function q(x) of the adjective model image groups. There is also the method of ranking the case of noncorrespondence as “0” and ranking the degree of absolute psychological impression in the case of correspondence in five levels of “1” to “5”. In this case, in building the distribution data of the model, a 5-ranked image is given a weight of 1.0, a 4-ranked image is given a weight of 0.8, a 3-ranked image is given a weight of 0.6, a 2-ranked image is given a weight of 0.4, and a 1-ranked image is given a weight of 0.2 to construct a frequency distribution q(x) explained below.

7-4. Calculation of Deviation Value in Distribution in Elements

For the individual energy elements Eₙ of each of the subsystems defined above, separately for each, the distribution of the value of Eₙ taken by the general model image and the distribution of the value of Eₙ taken by the adjective model image were investigated. When the adjective model image is distributed at a position different from the mean of the general model images, it is judged that its energy elements act specifically for that adjective and weighting is given in the form of linear combination coefficients when taking the energy sum. The extent of the specific action can be given by the deviation value of the position of the adjective model images with respect to the distribution of general model images.

The energy elements Eₙ are expressed by the variable x, the distribution function of the general model image is designated as p(x), and the distribution of the adjective model image is designated as q(x). The mean value of the energy elements Eₙ of the general model image is designated as mₚ, its standard deviation is designated as σₚ, the mean value of the energy elements Eₙ of the adjective model image is designated as m_{q}, and its standard deviation is designated as σ₄. At this time, the linear combination coefficients αᵢ(Eₙ) for the energy elements Eₙ corresponding to the i-th adjective can be expressed as follows using the error function erf(x). The linear combination coefficients are defined so as to become 0 when positioned at the same location as the mean value of a general model image and to become ±1 when positioned at the two ends. Further, the fluctuation of the deviation value of an adjective model image group, that is, the error δαᵢ(Eₙ) of the linear combination coefficients can also be evaluated.

Regarding Energy Elements Eₙ

∫p(x)dx=1

∫q(x)dx=1

mₚ=∫xp(x)dx

m_{q}=∫xq(x)dx

σₚ²∫(x−mₚ)²p(x)dx

σ_{q}²=∫(x−m_{q})²q(x)dx {Math. 99}

Deviation Value and its Error

$${α}_{i} ( {E}_{n} ) = erf ( \frac{{m}_{q} ( {E}_{n} ) - {m}_{p} ( {E}_{n} )}{\sqrt{2} {σ}_{p} ( {E}_{n} )} ) \\ δ {α}_{i} ( {E}_{n} ) = \sqrt{\frac{2}{π}} exp ( - {( \frac{{m}_{q} ( {E}_{n} ) - {m}_{p} ( {E}_{n} )}{\sqrt{2} {σ}_{p} ( {E}_{n} )} )}^{2} ) \cdot \frac{{σ}_{q} ( {E}_{n} )}{{σ}_{p} ( {E}_{n} )} \qquad ( Math . 100 )$$

Here,

$$erf ( x ) = \frac{1}{\sqrt{π}} {\int }_{0}^{x} exp ( - {t}^{2} ) d t \qquad \{ Math . 101 \}$$

erf(±∞)=±1, and inverts the value of erf(0)=0.

7-5. Calculation of Subenergy of Subsystem Units

A certain image is input and whether that provides an impression of an i-th adjective is investigated. This is done by calculating the energy elements of the subsystems for the input image and using linear combination coefficients determined by the adjective model to find the total sum of the absolute values of the adjective energies. In finding this total sum, first, the subsums are obtained in subsystem units. Here, the inner product of the free energy vector of the subsystem with the model adjective vector expressing the linear combination coefficients by vector expression is obtained to define the subsum. At this time, even if adding one scalar quantity of the quantity of heat TS as the free energy, the corresponding linear combination coefficients are defined. That is,

Free Energy Vector

$$\vec{F} = ( \vec{E} , - T \frac{S}{〈 S 〉} ) \qquad \{ Math . 102 \}$$

Model Adjective Vector

\vec{α}ᵢ=(\vec{α}ᵢ^{(E)},αᵢ^{(TS)}) {Math. 103}

The subsystems are given indicators differentiating them such as a1, a2, . . . and are found by taking the inner product of the energy sums Pi of the subsystem units. a1 corresponds to the lower order system of color, a2 to the higher order system of color, a3 to the lower order system of texture, a4 to the higher order system of texture, etc.

$$\begin{matrix}\begin{matrix}{P}_{i , a 1} = {\vec{α}}_{i , a 1} \cdot {\vec{F}}_{a 1} = {\vec{α}}_{i , a 1}^{( E )} \cdot {\vec{E}}_{a 1} - {α}_{i , a 1}^{( TS )} {T}_{a 1} \frac{{S}_{a 1}}{〈 {S}_{a 1} 〉} \\ {P}_{i , a 2} = {\vec{α}}_{i , a 2} \cdot {\vec{F}}_{a 2} = {\vec{α}}_{i , a 2}^{( E )} \cdot {\vec{E}}_{a 2} - {α}_{i , a 2}^{( TS )} {T}_{a 2} \frac{{S}_{a 2}}{〈 {S}_{a 2} 〉}\end{matrix} \\ …\end{matrix} \qquad \{ Math . 104 \}$$

However, in obtaining these linear combinations and finding the total adjective energy Qi, with the above simple inner products, the greater the number of energy elements which can be defined in a system, the larger the value of Pi ends up becoming. Subsystems describe independent aspects. At the time of combining subsystems, they have to be treated equally. For this reason, the value of the subsum Pi must be normalized to fall in the range of about [−1,1]. That is,

$${P}_{i , a 1} = \frac{{\vec{α}}_{i , a 1}^{( E )} \cdot {\vec{E}}_{a 1} - {α}_{i , a 1}^{( TS )} {T}_{a 1} \frac{{S}_{a 1}}{〈 {S}_{a 1} 〉}}{{〈 \vert {\vec{α}}_{i , a 1} \vert 〉}_{i} 〈 \vert {\vec{E}}_{a 1} \vert 〉 \sqrt{1 + {( \frac{〈 {S}_{a 1} 〉}{{〈 〈 S 〉 〉}_{a}} )}^{2}}} \\ {P}_{i , a 2} = \frac{{\vec{α}}_{i , a 2}^{( E )} \cdot {\vec{E}}_{a 2} - {α}_{i , a 2}^{( TS )} {T}_{a 2} \frac{{S}_{a 2}}{〈 {S}_{a 2} 〉}}{{〈 \vert {\vec{α}}_{i , a 2} \vert 〉}_{i} 〈 \vert {\vec{E}}_{a 2} \vert 〉 \sqrt{1 + {( \frac{〈 {S}_{a 2} 〉}{{〈 〈 S 〉 〉}_{a}} )}^{2}}} \qquad \{ Math . 105 \}$$

Here, < >ₐ indicates the statistical mean for all subsystems. That is, if the number of subsystems considered is nₐ,

$${〈 〈 S 〉 〉}_{a} = \frac{〈 {S}_{a 1} 〉 + 〈 {S}_{a 2} 〉 + …}{{n}_{a}} \qquad \{ Math . 106 \}$$

Here too, in the normalization of the denominator, the idea that the statistical mean should be taken as much as possible is applied. Due to this, the differences in number of states due to the differences in number of bins in quantification of a distribution function, defined differently depending on the subsystems, that is, the differences in entropy, can be absorbed and different subsystems can be placed on a common footing. That is, the definitions of the Planck's constant and the Boltzmann constant, which differ depending on the subsystem, are absorbed here, and an energy quantity Pi of the scale which can be treated equally is calculated. Physically, the term of the square root of the denominator can be understood as a correction term required when the physical constants differ depending on the subsystem. The norm mean of one mean temperature or adjective vector is normalization for absorbing the difference in the number of energy elements able to be defined by a subsystem. In this way, the normalization by the statistical mean of the norm for placing the subsystems on a common footing in this way plays an extremely important role in defining an absolute quantity.

For reference, the applicant prepared a large amount of general images and investigated the values of their entropies and the values of their temperatures for their subsystems by experiments. The results are shown below. If looking at these values, it will be understood how important the procedure of normalization is for combining subsystems.

Entropy

| | |
|---|---|
| 7.97 ≦ ~S_{Fo} ≦ ~14.30 | <S_{Fo}>=12.51 |

| | |
|---|---|
| 2.49 ≦ ~S_{F} ≦ ~6.05 | <S_{F}>=4.67 |

| | |
|---|---|
| 8.75 ≦ ~S_{Go} ≦ ~14.39 | <S_{Go}>=12.19 |
| 7.49 ≦ ~S_{G} ≦ ~13.82 | <S_{G}>=10.81 |

Temperature

| | |
|---|---|
| 0.18 ≦ ~T_{Fo} ≦ ~1.37 | <T_{Fo}>=0.73 |

| | |
|---|---|
| 2.68 ≦ ~T_{F} ≦ ~3.31 | <T_{F}>=2.91 |

| | |
|---|---|
| 0.003 ≦ ~T_{Go} ≦ ~0.10 | <T_{Go}>=0.03 |

| | |
|---|---|
| 5.75 ≦ ~T_{G} ≦ ~20.63 | <T_{G}>=12.31 |

Therefore, the number becomes on the order of 1/<S> to 0.1. The square root of the denominator is a value of about 1.1 to 1.6 or so.

8. Combination to Adjective Energy of Entire System

Next, the energies of the subsystems are combined. To find the adjective energies Qi of the entire system, the subsum energies Pi are combined by linear combination. The linear combination coefficients at this time determine which of the lower order system of color, the higher order system of color, the lower order system of texture, the higher order system of texture, etc. plays an important role for a certain adjective i. Furthermore, when adding composition as a subsystem, the importance of the element of composition is also taken into consideration.

The step of determining the linear combination coefficients is performed by a similar procedure as performed for determining αi for each of the above-mentioned energy elements Eₙ. That is, using the subsum Pi,j as the variable x, for the distribution of general model images, the mean value mₚ and its standard deviation σₚ are found and, for the distribution of an adjective model images, the mean value m_{q} and its standard deviation σ_{q} are found, to similarly determine the linear combination coefficients.

$${k}_{i , aj} = erf ( \frac{{m}_{q} ( {P}_{i , aj} ) - {m}_{p ( {P}_{i , aj} )}}{\sqrt{2} {σ}_{p} ( {P}_{i , aj} )} ) \\ δ {k}_{i , aj} = \sqrt{\frac{2}{π}} exp ( - {( \frac{{m}_{q} ( {P}_{i , aj} ) - {m}_{p} ( {P}_{i , aj} )}{\sqrt{2} {σ}_{p} ( {P}_{i , aj} )} )}^{2} ) \cdot \frac{{σ}_{q} ( {P}_{i , aj} )}{{σ}_{p} ( {P}_{i , aj} )} \qquad \{ Math . 107 \}$$

These linear combination coefficients are used to find the energy sum Qi of all systems relating to the adjectives i. At this time as well, normalization is performed so that this fits in the range of about [−1,1].

$${Q}_{i} = \frac{{k}_{i , a 1} {P}_{i , a 1} + {k}_{i , a 2} {P}_{i , a 2} + …}{{〈 \vert {\vec{k}}_{i} \vert 〉}_{i} {〈 〈 \vert {\vec{P}}_{i} \vert 〉 〉}_{i}} = \frac{{\vec{k}}_{i} \cdot {\vec{P}}_{i}}{{〈 \vert {\vec{k}}_{i} \vert 〉}_{i} {〈 〈 \vert {\vec{P}}_{i} \vert 〉 〉}_{i}} \qquad \{ Math . 108 \}$$

Here, < > expresses the mean relating to the general model images, while < >ᵢ expresses the mean relating to adjectives. Note that the energy band diagram shown up to here was drawn using an α(Eₙ) of a form including the weight coefficients k of this subsystem. Further, regarding the density of states, for the gamut region ρₘₐₓ (Eₙ) fluctuating the most to the plus and minus sides among the energy elements used for the general model image, the range considered largest as α(Eₙ)ρₘₐₓ(Eₙ) is filled in as the energy band model.

9. Adjective Retrieval Processing

If combining a general model and adjective model to construct an energy band model for learning use in this way, it is possible to search through images of a separate database using an i-th adjective as a keyword to retrieve images of impressions close to it based on the adjective energy Qi. If arranging the images in the order of Qi, the result becomes a form close to a regular distribution and it is possible to present a region of a high deviation value of the higher order group as the target images. Further, it is possible to present a region of a low deviation value of a lower order group as images of impressions of an opposite structure to this adjective. That is, it is possible to determine the results of sorting of perceptual images of opposite meanings to a user as well.

Furthermore, if inputting a certain single image and calculating Qi for all of the adjectives of an adjective model prepared in advance, it is possible to convert the degree of the absolute impression received from the image by a person of that model to numerical values for all of the adjective. If displaying this rearranged in order of size of the values, this image has a “freshness” of 0.8 and “repose” of a high 0.7 as well and has a “bustling” value of −0.7 or a low value in the opposite direction, so it is possible to present the result of no impression being felt at all.

As the energy band models of adjectives, it is possible to obtain a mean model common for the vast majority of people and possible to build models specific to cultures reflecting differences in countries, cultures, and languages. Alternatively, it is also possible to build individual energy band models reflecting differences in preferences on the individual level. Therefore, the models of the energy band structure employed by this image retrieval system can also be used as tools for quantitatively illuminating the structure of human perception.

The applicant tried experimentally to see if differences in individuals can be distinguished. It found that for the adjective “rough”, for a model where one person would select the scene of trees standing up sharply on a bare mountain and the sight created by the roughly churning water of a river about half of the time each, the results of perceptual retrieval capture these elements compositely and cluster at the higher order group. Further, while another person would select the sight created by the rough churning of water of a river as the main model image, the adjective energy Qi enables a clear grasp of the features of the flow of a river and shows the performance of extracting images close to the model. For this reason, the energy elements Eₙ used as features can be said to provide the ability to differentiate objects incorporated into an image as a whole.

Note that it is possible to extend the idea of using the deviation value to find the linear combination coefficients and to use the finally obtained value of Qi to confirm if the adjective model image clusters at the higher order group with respect to the general model image by finding the deviation value of the Qi of the model image group with respect to the general model one more time. Due to this, it is possible to verify the sufficiency of a feature treated as the legitimacy of a theoretical model.

$${w}_{ii} = erf ( \frac{{m}_{q} ( {Q}_{i} ) - {m}_{p} ( {Q}_{i} )}{\sqrt{2} {σ}_{p} ( {Q}_{i} )} ) \\ δ {w}_{ii} = \sqrt{\frac{2}{π}} exp ( - {( \frac{{m}_{q} ( {Q}_{i} ) - {m}_{p} ( {Q}_{i} )}{\sqrt{2} {σ}_{p} ( {Q}_{i} )} )}^{2} ) \cdot \frac{{σ}_{q} ( {Q}_{i} )}{{σ}_{p} ( {Q}_{i} )} \qquad \{ Math . 109 \}$$

By expanding on this thinking and viewing where the adjective model image distribution of the i-th adjective energy Qi is positioned with respect to the general model image distribution of the j-th adjective energy Qj for the finally found Qi of the adjective, it is learned how much of the absolute impression of the i-th adjective is included for a j-th adjective. It is possible to find a correlation matrix wᵢⱼ between the adjectives expressing whether the i-th adjective is an adjective belonging to the similar group giving impressions close to the j-th adjective or whether the i-th adjective is an adjective belonging to a far off adjective group giving an impression completely opposite to the j-th adjective. Due to this, a map of the adjective structure common to all people becomes clear and the map structure of adjectives relating to differences in cultures and differences in individuals can be elucidated.

$${w}_{ij} = erf ( \frac{{m}_{q} ( {Q}_{i} ) - {m}_{p} ( {Q}_{j} )}{\sqrt{2} {σ}_{p} ( {Q}_{j} )} ) \\ δ {w}_{ij} = \sqrt{\frac{2}{π}} exp ( - {( \frac{{m}_{q} ( {Q}_{i} ) - {m}_{p} ( {Q}_{j} )}{\sqrt{2} {σ}_{p} ( {Q}_{j} )} )}^{2} ) \cdot \frac{{σ}_{q} ( {Q}_{i} )}{{σ}_{p} ( {Q}_{j} )} \qquad \{ Math . 110 \}$$

By switching the relationship of i and j, it is possible to similarly calculate the deviation value of the adjective model distribution of a j-th adjective energy Qj over the general model distribution image of an i-th adjective energy Qi by a separate route. From the definition, a correlation matrix of an adjective is a symmetric matrix. That is,

wᵢⱼ=wⱼᵢ

However, what are calculated by going over separate routes do not always match when there is some propensity in the properties of the population image. Therefore, whether a correlation matrix of an adjective indicates a value close to the symmetric matrix gives a good indicator for verifying if an image group selected in the model building process selects random images with good generality. Further, the diagonal components preferably all become 1 as explained above. When not reaching this, it means that the features for capturing the adjective are insufficient or there are parts where the hypothesis of the theoretical model does not stand, so a good evaluation indicator is given for the construction of a retrieval system.

### Sixth Embodiment

(Perceptual retrieval: Three-stage combination of “energy+momentum+angular momentum”)

In this embodiment, it was explained that adjective retrieval reflecting individuality is possible. However, in constructing individual adjective models, it is preferable to prepare a certain large number of images. As opposed to this, when the object is to submit a smaller number of about three to five images and select images close to their image perceptions from a database, since the process of elimination of information by the statistical mean is an incomplete state, the need arises to add to the consideration the mechanical invariant omitted in the fifth embodiment. Just the steps newly added along with this will be explained below.

1. Conversion to Munsell HVC color space

2. Preparation of edge images of HVC planes

3. Preparation of lower order invariants of color

3-1. Preparation of distribution function of lower order system

3-2. Calculation of entropy

3-3. Calculation of elements pₙ of momentum

In the momenta defined in the fifth embodiment, only the mean values <H>, <V>, and <C> are made elements of the momentum.

3-4. Calculation of elements Mₙ of angular momentum

In the momentums defined in the fifth embodiment, the standard deviation values σ_{H}, σ_{V}, and σ_{C} are made elements of the angular momentum.

3-5. Calculation of elements Eₙ of energy

3-6. Calculation of temperature of subsystem

Based on the same procedure as the content described later for the higher order system of color. Details will not be explained here.

3-7. Calculation of free energy of subsystem

Based on the same procedure as the content described later for the higher order system of color. Details will not be explained here.

4. Preparation of higher order invariants of color

4-0. Hilbelt space expression of distribution function of lower order system

4-1. Preparation of distribution function of higher order system

4-2. Calculation of entropy

4-3. Calculation of elements pₙ of momentum

4-4. Calculation of elements Mₙ of angular momentum

Chebyshev expansion coefficients are divided into the angular momentum quantum number 1=0 and 1, so the product of the angular momentum quantum number and momentum is taken to calculate the angular momentum. The elements Mₙ of the angular momentum become as follows:

(c₁₁^{(α)}+c₁₂^{(α)}+ . . . +c_{1N}^{(α)})(α)=H,V,C.

4-5. Calculation of elements Eₙ of energy

4-6. Calculation of temperatures of subsystem

If expressing the values of the energy elements together in units of energy by a vector and similarly expressing the values of the elements of momentum together in units of momentum and the values of the elements of angular momentum together in units of angular momentum by vectors, the energy vector, momentum vector, and angular momentum vector of the subsystems can be defined.

\vec{E}=(E₁,E₂, . . . ,Eₙ)

\vec{p}=(p₁,p₂, . . . ,pₙ)

\vec{M}=(M₁,M₂, . . . ,Mₙ) {Math. 111}

If calculating the norms of the energy vector, momentum vector, angular momentum vector of a subsystem, the temperatures T_{E}, Tₚ, T_{M} of the images relating to subsystem can be defined in units of mechanical invariants.

T_{E}=|\vec{E}|=\sqrt{E₁²+E₂²+ . . . +Eₙ²}

Tₚ=|\vec{p}|=\sqrt{p₁²+p₂²+ . . . +pₙ²}

T_{M}=\vec{M}=\sqrt{M₁²+M₂²+ . . . +Mₙ²} {Math. 112}

4-7. Calculation of free energy of subsystem

From the similarity in the case of energy, the free energy, free momentum, and free angular momentum of a subsystem are defined.

$${\vec{F}}_{E} = ( \vec{E} , - \vert \vec{E} \vert \frac{S}{〈 S 〉} ) = ( \vec{E} , - {T}_{E} \frac{S}{〈 S 〉} ) \\ {\vec{F}}_{p} = ( \vec{p} , - \vert \vec{p} \vert \frac{S}{〈 S 〉} ) = ( \vec{p} , - {T}_{p} \frac{S}{〈 S 〉} ) \\ {\vec{F}}_{M} = ( \vec{M} , - \vert \vec{M} \vert \frac{S}{〈 S 〉} ) = ( \vec{M} , - {T}_{M} \frac{S}{〈 S 〉} ) \qquad \{ Math . 113 \}$$

5. Preparation of lower order invariants of texture

Exactly the same as the guidelines described in “3. Preparation of lower order invariants of color”.

6. Preparation of higher order invariants of texture

When performing spherical Bessell expansion by s and p orbits, the procedure is exactly the same as the guidelines explained in “4. Preparation of higher order invariants of color”, so the explanation will be omitted.

7. Combination of mechanical invariant units of subsystem

7-1. Setting of adjectives

7-2. Construction of general image model

7-3. Construction of adjective model images

7-4. Calculation of deviation values in distribution in elements

In the fifth embodiment, the deviation values and their errors were calculated for the energy elements Eₙ, but in the sixth embodiment, the same thing is performed for the elements pₙ of momentum and the elements Mₙ of angular momentum. The symbols are changed and the deviation values for the elements of energy are made βᵢ, the deviation values for the elements of momentum are made γᵢ, and the deviation values for the elements of angular momentum are made δᵢ.

$${β}_{i} ( {E}_{n} ) = erf ( \frac{{m}_{q} ( {E}_{n} ) - {m}_{p} ( {E}_{n} )}{\sqrt{2} {σ}_{p} ( {E}_{n} )} ) \\ δ {β}_{i} ( {E}_{n} ) = \sqrt{\frac{2}{π}} exp ( - {( \frac{{m}_{q} ( {E}_{n} ) - {m}_{p} ( {E}_{n} )}{\sqrt{2} {σ}_{p} ( {E}_{n} )} )}^{2} ) \cdot \frac{{σ}_{q} ( {E}_{n} )}{{σ}_{p} ( {E}_{n} )} \\ {γ}_{i} ( {p}_{n} ) = erf ( \frac{{m}_{q} ( {p}_{n} ) - {m}_{p} ( {p}_{n} )}{\sqrt{2} {σ}_{p} ( {p}_{n} )} ) \\ δ {γ}_{i} ( {p}_{n} ) = \sqrt{\frac{2}{π}} exp ( - {( \frac{{m}_{q} ( {p}_{n} ) - {m}_{p} ( {p}_{n} )}{\sqrt{2} {σ}_{p} ( {p}_{n} )} )}^{2} ) \cdot \frac{{σ}_{q} ( {p}_{n} )}{{σ}_{p} ( {p}_{n} )} \\ {δ}_{i} ( {M}_{n} ) = erf ( \frac{{m}_{q} ( {M}_{n} ) - {m}_{p} ( {M}_{n} )}{\sqrt{2} {σ}_{p} ( {M}_{n} )} ) \\ δ {δ}_{i} ( {M}_{n} ) = \sqrt{\frac{2}{π}} exp ( - {( \frac{{m}_{q} ( {M}_{n} ) - {m}_{p} ( {M}_{n} )}{\sqrt{2} {σ}_{p} ( {M}_{n} )} )}^{2} ) \cdot \frac{{σ}_{q} ( {M}_{n} )}{{σ}_{p} ( {M}_{n} )} \qquad \{ Math . 114 \}$$

7-5. Calculation of subenergy, submomentum, and subangular momentum of mechanical invariant units of subsystems

In the above way, model adjective vectors are determined for the free energy vector, free momentum vector, and free angular momentum vector. Note that it is assumed that deviation values are determined through the same process as for the TS invariants. That is,

$${\vec{F}}_{E} = ( \vec{E} , - \vert \vec{E} \vert \frac{S}{〈 S 〉} ) = ( \vec{E} , - {T}_{E} \frac{S}{〈 S 〉} ) {\vec{β}}_{i} = ( {\vec{β}}_{i}^{( E )} , {β}_{i}^{( {T}_{E} S )} ) \\ {\vec{F}}_{p} = ( \vec{p} , - \vert \vec{p} \vert \frac{S}{〈 S 〉} ) = ( \vec{p} , - {T}_{p} \frac{S}{〈 S 〉} ) {\vec{γ}}_{i} = ( {\vec{γ}}_{i}^{( p )} , {γ}_{i}^{( {T}_{p} S )} ) \\ {\vec{F}}_{M} = ( \vec{M} , - \vert \vec{M} \vert \frac{S}{〈 S 〉} ) = ( \vec{M} , - {T}_{M} \frac{S}{〈 S 〉} ) {\vec{δ}}_{i} = ( {\vec{δ}}_{i}^{( M )} , {δ}_{i}^{( {T}_{M} S )} ) \qquad \{ Math . 115 \}$$

The inner products of the two are taken and combined to the subenergy Eᵢ, submomentum pᵢ, and subangular momentum Mᵢ of the mechanical invariant units of the subsystem relating to the impression of the adjective i. Due to the normalization, the dimensions of all of the mechanical invariants are aligned.

$${E}_{i} = \frac{{\vec{β}}_{i}^{( E )} \cdot \vec{E} - {β}_{i}^{( {T}_{E} S )} {T}_{E} \frac{S}{〈 S 〉}}{{〈 \vert {\vec{β}}_{i} \vert 〉}_{i} 〈 \vert \vec{E} \vert 〉 \sqrt{1 + {( \frac{〈 S 〉}{{〈 〈 S 〉 〉}_{a}} )}^{2}}} \\ {p}_{i} = \frac{{\vec{γ}}_{i}^{( p )} \cdot \vec{p} - {γ}_{i}^{( {T}_{p} S )} {T}_{p} \frac{S}{〈 S 〉}}{{〈 \vert {\vec{γ}}_{i} \vert 〉}_{i} 〈 \vert \vec{p} \vert 〉 \sqrt{1 + {( \frac{〈 S 〉}{{〈 〈 S 〉 〉}_{a}} )}^{2}}} \\ {M}_{i} = \frac{{\vec{δ}}_{i}^{( M )} \cdot \vec{M} - {δ}_{i}^{( {T}_{M} S )} {T}_{M} \frac{S}{〈 S 〉}}{{〈 \vert {\vec{δ}}_{i} \vert 〉}_{i} 〈 \vert \vec{M} \vert 〉 \sqrt{1 + {( \frac{〈 S 〉}{{〈 〈 S 〉 〉}_{a}} )}^{2}}} \qquad \{ Math . 116 \}$$

8. Combination to adjective energy of subsystem

The three mechanical invariants found in a subsystem express the expected value of the energy, the expected value of the momentum, and the expected value of the angular momentum for which the statistical mean is taken relating to the adjectives i in the subsystem. Which among these macroscopic quantities plays an important role in the case of a small-number image model is expressed by the combination coefficients when combining three mechanical invariants by linear combination. These combination coefficients can be similarly described by deviation values from the positional relationship of the distribution functions of general model images and adjective model images. These combination coefficients are expressed by αᵢ(Eᵢ), αᵢ(pᵢ), and αᵢ(Mᵢ).

$${α}_{i} ( {E}_{i} ) = erf ( \frac{{m}_{q} ( {E}_{i} ) - {m}_{p} ( {E}_{i} )}{\sqrt{2} {σ}_{p} ( {E}_{i} )} ) \\ δ {α}_{i} ( {E}_{i} ) = \sqrt{\frac{2}{π}} exp ( - {( \frac{{m}_{q} ( {E}_{i} ) - {m}_{p} ( {E}_{i} )}{\sqrt{2} {σ}_{p} ( {E}_{i} )} )}^{2} ) \cdot \frac{{σ}_{q} ( {E}_{i} )}{{σ}_{p} ( {E}_{i} )} \\ {α}_{i} ( {p}_{i} ) = erf ( \frac{{m}_{q} ( {p}_{i} ) - {m}_{p} ( {p}_{i} )}{\sqrt{2} {σ}_{p} ( {p}_{i} )} ) \\ δ {α}_{i} ( {p}_{i} ) = \sqrt{\frac{2}{π}} exp ( - {( \frac{{m}_{q} ( {p}_{i} ) - {m}_{p} ( {p}_{i} )}{\sqrt{2} {σ}_{p} ( {p}_{i} )} )}^{2} ) \cdot \frac{{σ}_{q} ( {p}_{i} )}{{σ}_{p} ( {p}_{i} )} \\ {α}_{i} ( {M}_{i} ) = erf ( \frac{{m}_{q} ( {M}_{i} ) - {m}_{p} ( {M}_{i} )}{\sqrt{2} {σ}_{p} ( {M}_{i} )} ) \\ δ {α}_{i} ( {M}_{i} ) = \sqrt{\frac{2}{π}} exp ( - {( \frac{{m}_{q} ( {M}_{i} ) - {m}_{p} ( {M}_{i} )}{\sqrt{2} {σ}_{p} ( {M}_{i} )} )}^{2} ) \cdot \frac{{σ}_{q} ( {M}_{i} )}{{σ}_{p} ( {M}_{i} )} \qquad \{ Math . 117 \}$$

The three linear combination coefficients are expressed as vectors of αᵢ and the mechanical invariant is expressed as a vector of E′.

\vec{E}ᵢ′=(Eᵢ,pᵢ,Mᵢ)

\vec{α}i=(αᵢ(Eᵢ),αᵢ(pᵢ),αᵢ(Mᵢ)) {Math. 118}

The adjective energy Pᵢ of a subsystem is expressed by the inner product of these.

$${P}_{i , a 2} = \frac{{\vec{α}}_{i , a 2} \cdot {\vec{E}}_{i , a 2}^{′}}{〈 \vert {\vec{α}}_{i , a 2} \vert 〉 {〈 〈 \vert {\vec{E}}_{i , a 2}^{′} \vert 〉 〉}_{i}} \\ {P}_{i , a 1} = \frac{{\vec{α}}_{i , a 1} \cdot {\vec{E}}_{i , a 1}^{′}}{〈 \vert {\vec{α}}_{i , a 1} \vert 〉 {〈 〈 \vert {\vec{E}}_{i , a 1}^{′} \vert 〉 〉}_{i}} \qquad \{ Math . 119 \}$$

9. Combination to adjective energy of entire system The rest is exactly the same as the fifth embodiment.

10. Adjective retrieval processing

### Seventh Embodiment

### Similar Image Retrieval of Single Image: Three-Stage Combination of “Energy+Momentum+Angular Momentum”

In the sixth embodiment, the example of constructing an adjective model by a small-number model was shown. If bringing this to an extreme, it is possible to use this for a single image similar image retrieval. That is, it becomes possible to extract images close in overall impression with a single image given as an example through description of the macroscopic quantities of energy, momentum, and angular momentum.

The method of the sixth embodiment includes the method of the fifth embodiment. The reason is that if the number of the model images becomes large, the roles of momentum and angular momentum are decreased and automatically the statistical mean causes these linear combination coefficients to be constrained to a value close to zero. Therefore, the method of the sixth embodiment can be realized seamlessly for retrieval of a single image to perceptual retrieval of a small number of models and furthermore for perceptual retrieval of a large number of models.

<Projection to Uniform Recognition Space>

The concepts of the momentum, angular momentum, and energy, which are derived from the one-dimensional distribution functions defined in the above embodiments, will be discussed again from the viewpoint of a relation of the human recognition. The low-order system and high-order system in the above description express the real-space description expressed by the Munsell color space and the frequency-space description in which the real-space distribution function expressed by the Munsell value is projected to the frequency space using the base function, respectively.

The Munsell color space is the uniform color space where the perceptual uniformity is guaranteed. Accordingly, the Munsell value of the real-space description provides the color space where the spatial uniformity is guaranteed. On the other hand, when the human recognizes shapes such as a one-dimensional histogram, there is a constraining condition on the distribution function of the histogram, and the human recognizes the shape difference of the portion in which the degree of freedom exists in consideration of the constraining condition. When the frequency expansion is performed using the base function including the character identical to the constraining condition, the expansion coefficient can be positioned as the space where the shape difference of the portion in which the degree of freedom exists is equally recognized. That is, the base function space in the frequency-space description provides the recognition space where the uniformity of the space is guaranteed.

Accordingly, both the real space provided by the Munsell color space where the uniformity of the perceptual color recognition is guaranteed and the frequency space provided by the base-function Hilbert space where the uniformity of the distribution-function shape recognition is guaranteed can be regarded as the uniform recognition space where the uniform recognition is guaranteed. That is, the Munsell color space provides the uniform recognition space in the “color perception”, and the Hilbert space provides the uniform recognition space in the “shape recognition”.

In physics, the “conservation law of momentum” is derived from “space uniformity”. The “conservation law of angular momentum” is derived from the “space isotropy”, and the “conservation law of energy” is derived from the “time uniformity” (see Document A2-2).

When these facts are related to the image system, because the coordinate system of the Munsell value in the real-space description guarantees the space uniformity in the image recognition, the Munsell color space can be positioned as the space where the momentum conservation law holds. In the Munsell color space, the Munsell value and an appearance frequency define the momentum. Because the coordinate system of the base function in the frequency-space description also guarantees the spatial uniformity, the frequency space can be positioned as the space where the momentum conservation law holds. In the frequency space, the expansion coefficient defines the momentum. However, assuming that mass is a constant of 1, it can be considered that the momentum expresses the velocity. Accordingly, in the image recognition, the Munsell value of each image or the frequency expansion coefficient can be considered to be the momentum, and become the features in which the momentum conservation law holds between the images.

Because the space isotropy is also guaranteed in the space where the space uniformity is guaranteed, when the coordinate is defined in the space, the angular momentum is defined in the form of the product of the momentum and the coordinate, and the angular momentum conservation law also holds. Accordingly, when the physical quantity corresponding to the angular momentum is defined, the Munsell value taken by each image and the angular momentum derived from the frequency expansion coefficient can become the features in which the angular momentum conservation law holds between the images.

In the time uniformity in the image system, it can be positioned that any scene is possibly generated as the image with an equal probability. When the physical quantity such as the momentum and the energy expressed by a quadratic form of the velocity is defined, because the energy conservation law holds, the features of the image means that can become the effective features having a common value between the images that evoke the identical image recognition or the identical image sensibility.

Accordingly, the angular momentum or the energy is defined while the Munsell value in the real-space description or the expansion coefficient in the frequency space is positioned as the momentum, which means that the angular momentum, the energy, and the momentum can become the effective physical quantity retained between the images as the quantity that describes the character of the images that evoke the recognition or sensibility common to the plural image in the image recognition. The angular momentum, the energy, and the momentum are the additive physical quantity, and it can be assumed that an intensity of final image recognition or a degree of impression of perception is expressed by a linear combination of the physical quantities. This is a hypothesis of “linear model of perception”.

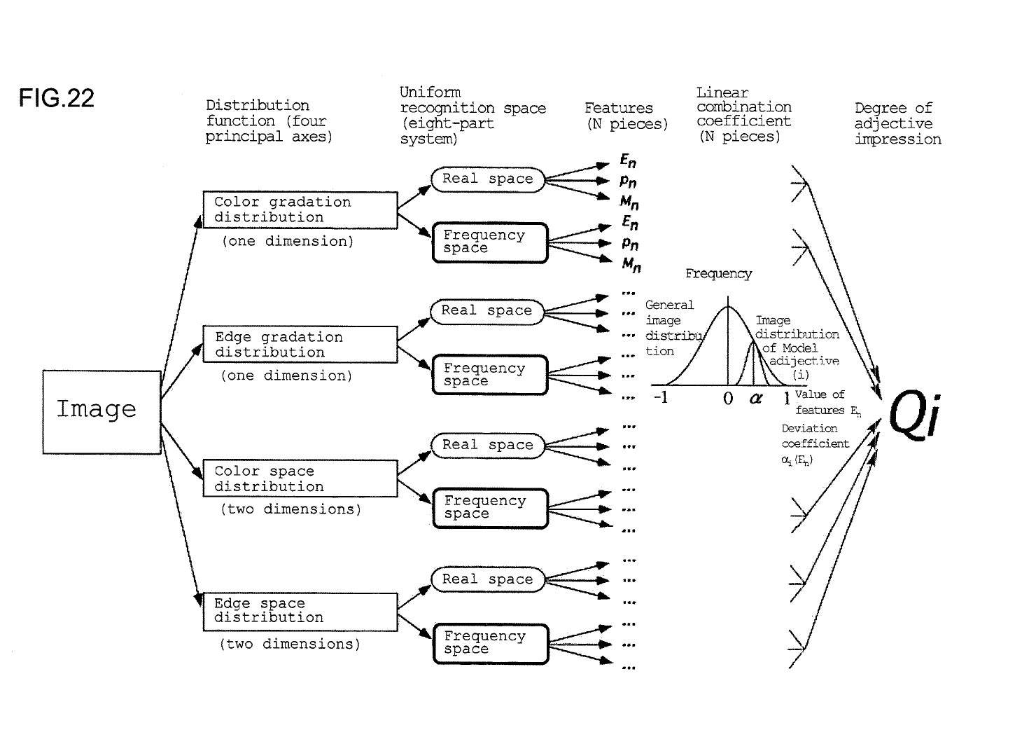

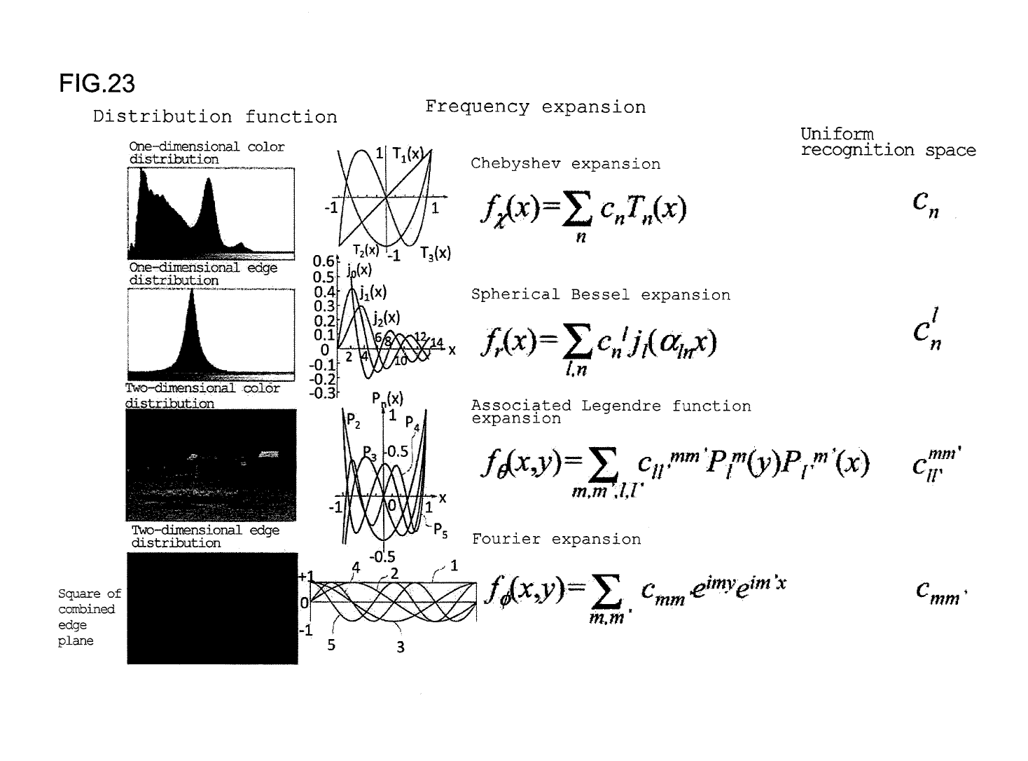

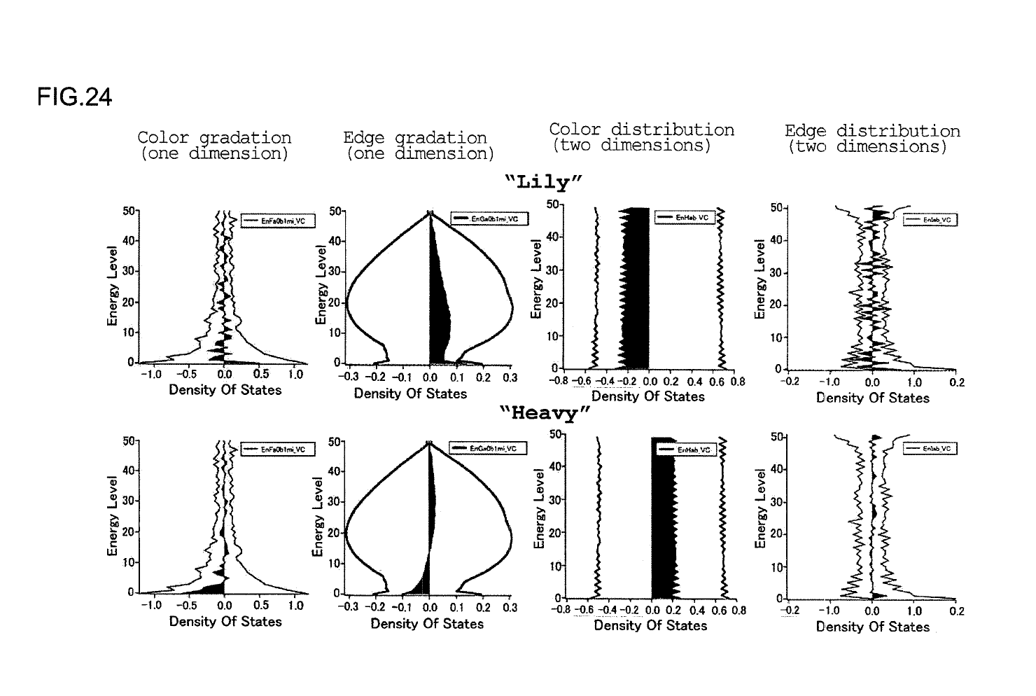

A manipulation to derive the distribution function expressing the independent subsystem such as the color and the edge from the image, project the distribution function to the uniform recognition space of the real space or frequency space, and further project the distribution function to the features including the energy, the momentum, and the angular momentum is performed to each specific image group that generates a certain common perception or a certain common object recognition at the same time as a general image group including a large quantity of general images. The projection expression is performed to the perceptual space and liner space of the image recognition to investigate how the specific image group has a bias in distribution in the general image group on the projection surface, and a degree of importance of the features that is particularly retained in the specific image group can be decided by a degree of bias. Therefore, the final degree of impression of individual image can absolutely be digitized. A feature structure that influences the psychological structure and object recognition of the human can visually be expressed in the space where the additive features is described. FIGS. 22 to 24 illustrate the feature structure together with a composition system described below.
[Document A2-2] Landau and Lifshitz, Course of Theoretical Physics, Volume 1 “Mechanics” (Third Revised Edition, 1973), Chapter 2 “Conservation Laws”

<Existence of Four Principal Axis>

The distribution functions constituting four principal axes exist as the distribution functions having individually high independence as illustrated by the example of the V plane in FIG. 13. Actually, the three color planes H, V, and C exist as the distribution function of each principal axis.

The two principal axes that are of the one-dimensional color distribution function and the one-dimensional edge distribution function, which are already addressed, exist in the gradation one-dimensional distribution. Although the two-dimensional composition distribution is addressed as the one principal axis in the first to sixth embodiments, actually the two-dimensional color and edge distribution functions exist as the principal axis in the two-dimensional composition distribution. Accordingly, the four-principal axis system including the one-dimensional gradation distribution and the two-dimensional composition distribution forms the basis. Hereinafter, the subsystem called the texture in the above description is referred to as an edge.

The color histogram and edge histogram of the one-dimensional system are defined by all the positive values because the color histogram and the edge histogram express the frequency distribution, the color histogram and the edge histogram are expressed by probability density when normalized by the sum of the frequencies, and the color histogram and the edge histogram can be called the distribution function. Because all the pixel values on the color plane of the two-dimensional system are defined by the positive values, the pixel values on the color plane becomes the distribution function when being normalized by sum of the pixel values. However, because the value on the edge plane of the two-dimensional system has the positive and negative values, the value on the edge plane does not simply become the distribution function. Therefore, in the distribution function on the edge plane of the two-dimensional system, the value on the edge plane to which multiplex resolution synthesis is performed is raised to the second power such that all the values on the edge plane are defined by the values of zero or more, and the probability density of the value on the edge plane is used as the distribution function on the edge plane. The principal axis related to the two-dimensional edge distribution is expressed by the real-space expression and the frequency space expression, and the definition is always adopted in the frequency space expression. For the real-space expression, the definition of the distribution function is adopted as needed basis, and the original pre-square combined edge plane is used when the positive and negative values of one of the original edge intensities is required.

<Roles of Real-Space Expression and Frequency Expression>

A role difference between the real-space expression and the frequency space expression with respect to the space coordinate during the description of the identical distribution function in each principal axis will be described below. The real-space description of the one-dimensional distribution function plays the role in defining the HVC value within the gradation range or an absolute value of the signal of the differential value of HVC with respect to the edge. That is, for example, for the color histogram of the V plane, even if the brightness level does not have all the Munsell values of 0 to 10 but is distributed in the range of 5 to 10, the real-space description defines the mean value or the fluctuation width in the range of 0 to 10. Therefore, the real-space description plays the role in deciding the positional relationship in an absolute scale of the distribution function.

On the other hand, in the frequency-space description of the one-dimensional distribution function, only the range where the distribution function is actually distributed as the value is initially taken out, the coordinates at the starting point and ending point are defined in the interval, and the contrast is maximized to evaluate the distribution shape. Accordingly, the frequency description plays the role in evaluating the shape of the distribution function in the relative scale.

The extension is performed from the similar standpoint when the roles of the real-space expression and frequency space expression are defined in the two-dimensional distribution function.

In the real-space description of the two-dimensional distribution function, for the coordinate setting related to the signal intensity of the brightness level, the value of the absolute signal of the gradation value is directly used similarly to the one-dimensional distribution function. For the coordinate setting related to the spatial distances of the x-axis and y-axis, the absolute length is directly defined. That is, information on a difference of an aspect ratio is defined by the real space, and can identify the position.

In the frequency description of the two-dimensional distribution function, for the coordinate setting related to the value of the distribution function, only the range of the maximum value to the minimum value is taken out to evaluate the distribution shape in the interval similarly to the one-dimensional distribution function. For the spatial position coordinates of the x-axis and y-axis, even if the real space differs from the frequency space in the aspect ratio, the numbers of expansion coefficients used in the vertical and horizontal directions in the frequency space are set to the identical number, and the two-dimensional expansion coefficient is always expressed as a square matrix. That is, the images having various aspect ratios are relatively described with a ratio of 1:1.

Accordingly, in the frequency expression, the distance is also relativized in the vertical and horizontal directions, and the contrast is also relativized in the gradation distribution region to play the role in evaluating the shape of the distribution function. In the real-space expression, the absolute positions in the vertical and horizontal directions are defined to play the role in defining the intensity of the absolute signal in the gradation region.

In the frequency expression, the value of the expansion coefficient to which the frequency expansion is performed using the base function can always fall within the range of the value of [−1,1] after the value of the expansion coefficient is relativized in the distribution region of the value of the distribution function. When the expansion coefficient in the frequency space is positioned as the velocity, the velocity range has a limiting point, and the limiting point can be considered while correlated with light velocity.

<Low-Order Invariant of Composition>

The way to combine the low-order invariants of the color composition will be discussed below. The model Hamiltonian is constructed such that the invariant related to the energy is derived from the one-dimensional color distribution function.

H(x,y), V(x,y), and C(x,y), which express the two-dimensional distribution of the Munsell value, express the distribution of the momentum value. At this point, it is assumed that the physical quantity having the dimension of (brightness intensity)×(spatial position vector) is schematically expressed using a momentum symbol indicated by

\vec{p}_{H},\vec{p}_{V},\vec{p}_{C}. {Math. 120}

The model Hamiltonian is set as follows. The model Hamiltonian formally expresses the kinetic energy.

H=(\vec{p}_{H}+\vec{p}_{V}+\vec{p}_{C})² {Math. 121}

The model Hamiltonian is divided into the mean term and the fluctuation term. For the mean term, the physical quantity having the dimension of (brightness mean intensity)×(spatial mean position vector) is schematically expressed by

[symbol]

\vec{p}_{H} [symbol] , [symbol] \vec{p}_{V} [symbol] , [symbol] p_{C} [symbol] . {Math. 122}

For the fluctuation term, the physical quantity having the dimension of (brightness fluctuation width)×(spatial spread width) is schematically expressed by

$$\begin{matrix}{σ}_{{\vec{p}}_{H}} , {σ}_{{\vec{p}}_{V}} , {σ}_{{\vec{p}}_{C}} & \{ Math . 123 \} \\ H = {( 〈 {\vec{p}}_{H} 〉 + ( {\vec{p}}_{H} - 〈 {\vec{p}}_{H} 〉 ) + 〈 {\vec{p}}_{V} 〉 + ( {\vec{p}}_{V} - 〈 {\vec{p}}_{V} 〉 ) + 〈 {\vec{p}}_{C} 〉 + ( {\vec{p}}_{C} - 〈 {\vec{p}}_{C} 〉 ) )}^{2} = {( 〈 {\vec{p}}_{H} 〉 + {σ}_{{\vec{p}}_{H}} + 〈 {\vec{p}}_{V} 〉 + {σ}_{{\vec{p}}_{V}} + 〈 {\vec{p}}_{C} 〉 + {σ}_{{\vec{p}}_{C}} )}^{2} = ( {〈 {\vec{p}}_{H} 〉}^{2} + {〈 {\vec{p}}_{V} 〉}^{2} + {〈 {\vec{p}}_{C} 〉}^{2} ) + 2 ( 〈 {\vec{p}}_{H} 〉 \cdot 〈 {\vec{p}}_{V} 〉 + 〈 {\vec{p}}_{V} 〉 \cdot 〈 {\vec{p}}_{C} 〉 + 〈 {\vec{p}}_{C} 〉 \cdot 〈 {\vec{p}}_{H} 〉 ) + ( {σ}_{{\vec{p}}_{H}} \cdot {σ}_{{\vec{p}}_{H}} + {σ}_{{\vec{p}}_{V}} \cdot {σ}_{{\vec{p}}_{V}} + {σ}_{{\vec{p}}_{C}} \cdot {σ}_{{\vec{p}}_{C}} ) + ( {σ}_{{\vec{p}}_{H}} \cdot {σ}_{{\vec{p}}_{H}} + {σ}_{{\vec{p}}_{V}} \cdot {σ}_{{\vec{p}}_{V}} + {σ}_{{\vec{p}}_{C}} \cdot {σ}_{{\vec{p}}_{C}} ) + 2 ( 〈 {\vec{p}}_{H} 〉 \cdot {σ}_{{\vec{p}}_{H}} + 〈 {\vec{p}}_{V} 〉 \cdot {σ}_{{\vec{p}}_{V}} + 〈 {\vec{p}}_{C} 〉 \cdot {σ}_{{\vec{p}}_{C}} ) + 2 ( 〈 {\vec{p}}_{H} 〉 \cdot {σ}_{{\vec{p}}_{n}} + 〈 {\vec{p}}_{V} 〉 \cdot {σ}_{{\vec{p}}_{V}} + 〈 {\vec{p}}_{C} 〉 \cdot {σ}_{{\vec{p}}_{C}} ) + 2 ( {σ}_{{\vec{p}}_{H}} \cdot 〈 {\vec{p}}_{V} 〉 + {σ}_{{\vec{p}}_{V}} \cdot 〈 {\vec{p}}_{C} 〉 + {σ}_{{\vec{p}}_{C}} \cdot 〈 {\vec{p}}_{n} 〉 ) & \{ Math . 124 \}\end{matrix}$$

is obtained when the model Hamiltonian is expanded. When an idea of mean field approximation is introduced to average the model Hamiltonian, the last equations, which are put in three parentheses while having the linear term of the fluctuation, the vector components related to the spatial spread direction of the fluctuation term cancel each other, and the expected value of the fluctuation term becomes

[symbol]

σ_{\vec{p}}_{_{H}} [symbol] =0, [symbol] σ_{\vec{p}}_{_{V}} [symbol] =0, [symbol] σ_{\vec{p}}_{_{C}} [symbol] =0. {Math. 125}

Therefore, the vector components related to the spatial spread direction of the fluctuation term are eliminated. Accordingly, only the first equations put in four parentheses remain.

$$H = ( {〈 {\vec{p}}_{H} 〉}^{2} + {〈 {\vec{p}}_{V} 〉}^{2} + {〈 {\vec{p}}_{C} 〉}^{2} ) + 2 ( 〈 {\vec{p}}_{H} 〉 \cdot 〈 {\vec{p}}_{V} 〉 + 〈 {\vec{p}}_{V} 〉 \cdot 〈 {\vec{p}}_{C} 〉 + 〈 {\vec{p}}_{C} 〉 \cdot 〈 {\vec{p}}_{H} 〉 ) + ( {σ}_{{\vec{p}}_{H}} \cdot {σ}_{{\vec{p}}_{H}} + {σ}_{{\vec{p}}_{V}} \cdot {σ}_{{\vec{p}}_{V}} + {σ}_{{\vec{p}}_{C}} \cdot {σ}_{{\vec{p}}_{C}} ) + ( {σ}_{{\vec{p}}_{H}} \cdot {σ}_{{\vec{p}}_{H}} + {σ}_{{\vec{p}}_{V}} \cdot {σ}_{{\vec{p}}_{V}} + {σ}_{{\vec{p}}_{C}} \cdot {σ}_{{\vec{p}}_{C}} ) \qquad \{ Math . 126 \}$$

Because each of the mean term and the fluctuation term is described by the product of the brightness direction and the space direction, actually the mean term is described by the vector and the fluctuation term is described by the tensor. The detail is defined in the seventh embodiment.

The motion described by the model Hamiltonian is considered while correlated with the rigid body motion on the two-dimensional plane. It is positioned that the intensity value distribution in the brightness direction has the dimension related to the rigid body motion, namely, the dimension of a rate of change per unit time. The distribution in the space direction describes the shape factor in the state in which the rigid body stands still, and it is positioned that the distribution in the space direction has the dimension related to the distance.

It is considered that the mean term describes the translation of the rigid body, and that the fluctuation term describes the rotation of the rigid body. The momentum, angular momentum, and energy related to the rigid body motion are defined in the forms having the following dimensions. That is, the momentum and the angular momentum become the linear form of the intensity in the brightness direction, and the energy becomes the quadratic form of the intensity in the brightness direction.

Momentum=(mean term)−(space centroid)×(brightness mean)

Angular momentum=(spread term)=(space spread)²×(brightness spread)

Energy=(translation energy of mean term)+(rotation energy of spread term)=(distance of space centroid)²×(brightness mean)²+(space spread)²×(brightness spread)²

When the model Hamiltonian is expanded and subjected to the mean field approximation, the remaining first terms put in the two parentheses express the translation energy, and the remaining final terms put in the two parentheses express the rotation energy. (space spread)² is described by the inertia tensor expressing the mean spread of the second moment from the centroid. Thus, the intersection term component of the mean term and the fluctuation term of the energy is eliminated when the space spread is mainly described by the centroid system. The detailed description about the rigid body motion is made in Document H1. The reason the intersection term of the combinations HV, VC, and CH emerge among H, V, and C is that HVC incompletely describes the independent component, and that the model Hamiltonian is constructed so as to have the intersection energy.

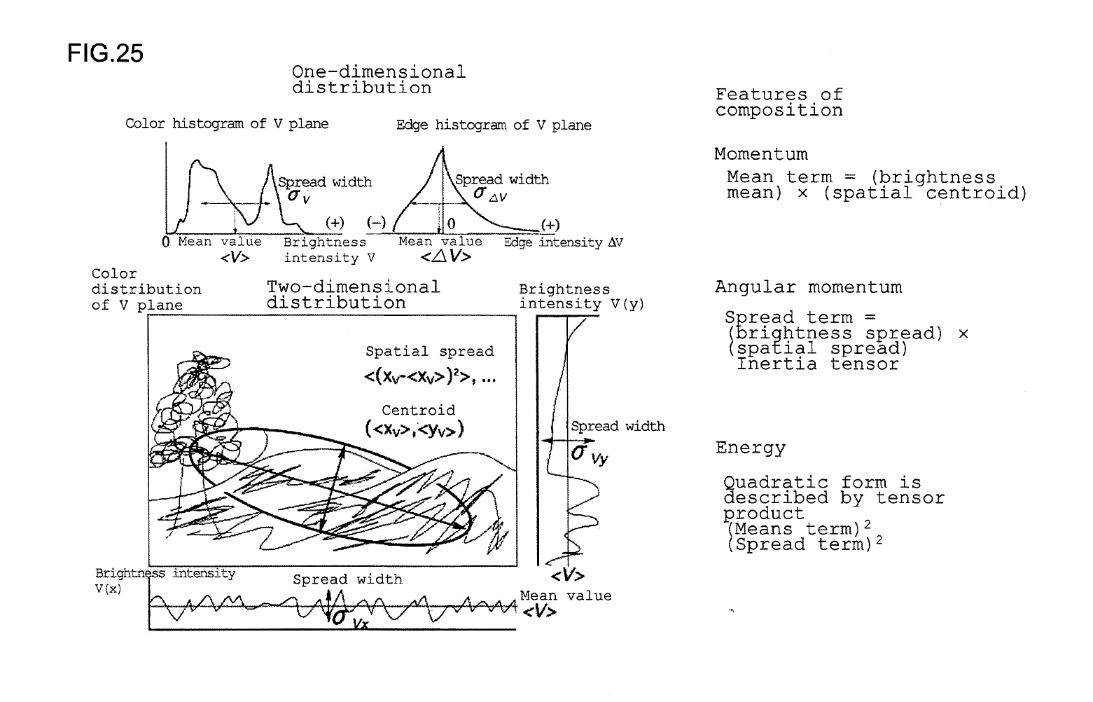

The specific expression corresponding to the term derived by the expansion of the model Hamiltonian is defined in the seventh embodiment. FIG. 25 is a view illustrating a relation of the elements related to the construction of the low-order invariants of the composition. Similarly to the definition in the one-dimensional distribution, the momentum corresponds to the mean term, and the angular momentum corresponds to the spread term or the fluctuation term in the two-dimensional distribution.

The relation between the features derived from the one-dimensional gradation distribution function and the features derived from the two-dimensional composition distribution function will be described below. The subsystems defined by the one-dimensional distribution function are described while having a correlation with each other through the brightness factor. That is, the subsystem of the one-dimensional color distribution and the subsystem of the two-dimensional color distribution derive the features that overlap each other in the brightness factor. The subsystem of the one-dimensional edge distribution and the subsystem of the two-dimensional edge distribution also derive the features that overlap each other in the brightness factor. However, the information on the space factor is newly added to the features derived from the two-dimensional distribution, and the features derived from the two-dimensional distribution describes the element independent of the features derived from the one-dimensional distribution.
[Document H1] Landau and Lifshitz, Course of Theoretical Physics, Volume 1 “Mechanics” (Third Revised Edition, 1973), Chapter 6 “The Motion of Rigid Body”, Section 31 “Angular Velocity”, Section 32 “Inertia Tensor”, and Section 33 “Angular Momentum of Rigid Body”

<Mapping to Uniform Recognition Space by Frequency Description>

In the four principal axes, the Chebyshev function is used when the one-dimensional color distribution function is projected to the Hilbert space to perform the frequency description, and the spherical Bessel function is used when the one-dimensional edge distribution function is projected to the Hilbert space to perform the frequency description. This is because the base function equalizing the shape recognition suitable for the constraining condition possibly taken by the shape of the distribution function is selected. The shape of the distribution function is described by the expansion coefficient expressing the frequency distribution of the base function, whereby the mapping is performed to the uniform recognition space. In the general rule described above, the color side is described by the special function belonging to the hypergeometric function, and the edge side is described by the special function belonging to the confluent hypergeometric function.

The general rule is applied on the selection of the base function when the two-dimensional color distribution function and the two-dimensional edge distribution function, which are of the remaining two principal axes, are expressed in the Hilbert space. Actually the associated Legendre function is selected as the base function suitable for the frequency expression of the two-dimensional color distribution function. The Fourier function is selected as the base function suitable for the frequency expression of the two-dimensional edge distribution function. The reason the associated Legendre function and the Fourier function are selected will be described below.

1) Reason Associated Legendre Function is Selected for Two-Dimensional Color Distribution Function

The associated Legendre function is a kind of the hypergeometric function, and is suitable for the description of the color distribution. An associated Legendre function P^{m}ₗ(x) is defined by two exponents of a magnetic quantum number m and an azimuthal quantum number l, and the base function has the orthogonality in which a spatial weight is homogenized between the different base functions of the azimuthal quantum number 1. A function group P⁰ₗ(x)=Pₗ(x) formed by the azimuthal quantum number l of the lowest-order magnetic quantum number m=0 is called the Legendre function. A relational expression of the orthogonality of the associated Legendre function and a specific expression on a lower-frequency side of the base function of the Legendre function are cited.

$$Orthogonality \\ {\int }_{- 1}^{1} {P}_{p}^{m} ( x ) {P}_{q}^{m} ( x ) d x = \frac{2}{2 q + 1} \cdot \frac{( q + m ) !}{( q - m ) !} {δ}_{p , q} \\ Legendre polynomial \\ {P}_{0} ( x ) = 1 \\ {P}_{1} ( x ) = x \\ {P}_{2} ( x ) = \frac{1}{2} ( 3 {x}^{2} - 1 ) \\ {P}_{3} ( x ) = \frac{1}{2} ( 5 {x}^{3} - 3 x ) \\ {P}_{4} ( x ) = \frac{1}{8} ( 35 {x}^{4} - 30 {x}^{2} + 3 ) \\ {P}_{5} ( x ) = \frac{1}{8} ( 63 {x}^{5} - 70 {x}^{3} + 15 x ) \qquad \{ Math . 127 \}$$

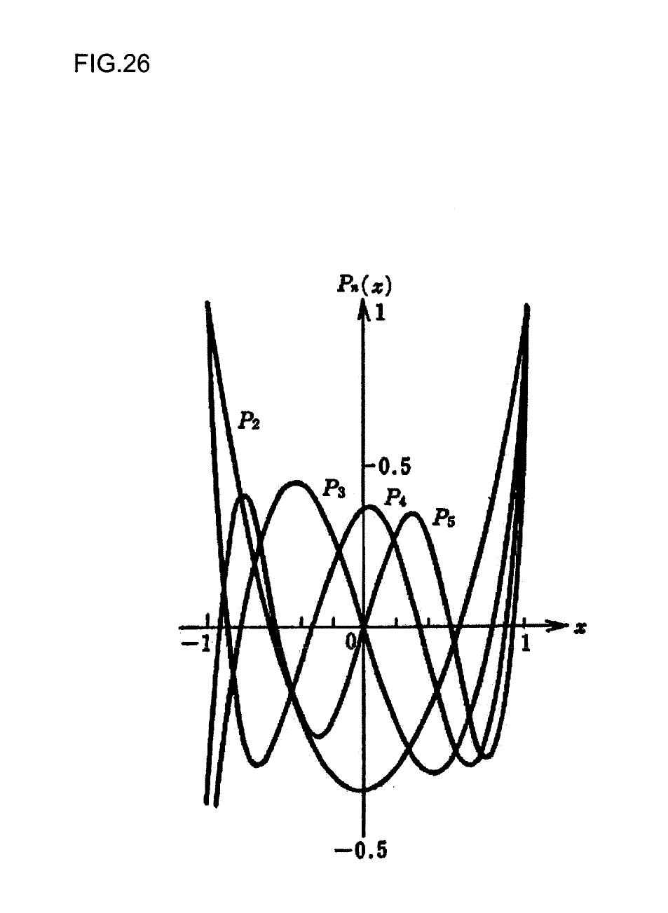

FIG. 26 is a graph of P₂(x), P₃(x), P₄(x), and P₅(x) in the Legendre polynomial. The Legendre function has singular points at both ends of x=−1 and x=1. The Legendre function is suitable for the description of the characteristic related to the distribution of the electric multipole when a charge is placed in the position of the singular point. A first-wave function on the low-frequency side of the Legendre function describes the gradation at P₁(x)=x.

When the characteristics are applied to the image, such sharpness as framing of the composition is formed in the homogeneously-distributed subject image. The point of the sharpness becomes the singular point as the image, and acts as a framing effect when the shape is recognized from the composition side of the image. In the frequency space of the space distribution, a high-order moment analysis can be performed to the shape distribution viewed from the singular point using the associated Legendre function including the concept of the multipole. The image has the singular points corresponding to a north pole and a south pole of the earth with respect to the right and left ends or the upper and lower ends, and the space between the singular points is uniformly dealt with. This is matched with the characteristic that the framing of the space is performed to cut the composition. Additionally, the color distribution has the characteristic in which the gradation emerges like blue sky. On this point, the first wave of the Legendre function includes the base function, the Legendre function is suitable to perform the frequency expression of the two-dimensional color distribution function in an extremely compact manner.

See Document B3 for the detailed characteristic of the associated Legendre function.
[Document B3] George Arfken, Mathematical Methods for Physicists, Vol. 3 “Special Functions and Integration Equations” (Second Edition, 1970; Japanese translation, 1978), Chapter 2 “Legendre Function” and Chapter 3 “Special Function”

2) Reason Fourier Function is Selected for Two-Dimensional Edge Distribution Function

The Fourier function differs from the hypergeometric function having the three singular points or the confluent hypergeometric function having the two singular points, and corresponds to the function sorted into a differential equation having no singular point. The two-dimensional edge distribution function is described by the distribution of not the direct characteristic of the edge plane having the positive and negative values but the value raised to the second power. Almost all parts of the image have the value close to zero at a stage at which the edge plane is detected from the color plane. Additionally, because the value is raised to the second power, the distribution of the value has the characteristic that becomes an extremely smooth waveform shape.

Almost all parts of the obtained image are black except the edge part having the high contrast. Even if the images at the right and left ends are connected to form a cylindrical shape, or even if the images at the upper and lower ends are connected to form a cylindrical shape, the abnormal sharpness caused by the difference of the distribution is not recognized, but the image includes the smoothly connecting characteristic. This means that the description is suitably performed by an infinitely spreading waveform having no singular point at both the end of the image. The Fourier function has no singular point, and a boundary condition that the value is zero at both the ends or the differentiation is connected with zero. Therefore, the Fourier function is extremely matched with the feature of the waveform distribution of the image. The Fourier function also includes the characteristic that the space is uniformly dealt with, and the characteristic is required to deal with the composition. The relational expression of the orthogonality of the Fourier function is expressed below using the uniform weight function.

∫_{-π}^{π}(e^{imx})*e^{inx}dx=2πδ_{m,n} {Math. 128}

<Correlation Between Subsystems in Frequency Description>

The equations of the subsystems, in which the frequency expansion is performed to the distribution functions of the four principal axes, are as follows.

$$Chebyshev expansion of one \text{-} dimensional color distribution function \\ {f}_{x} ( x ) = {\sum }_{n} {c}_{n} {T}_{n} ( x ) \\ Spherical Bessel expansion of one \text{-} dimensional edge distribution function \\ {f}_{r} ( x ) = {\sum }_{l , n} {c}_{n}^{l} {j}_{l} ( {α}_{ln} x ) \\ Associated Legendre function expansion of two \text{-} dimensional color distribution function \\ {f}_{θ} ( x , y ) = {\sum }_{m , {m}^{′} l , {l}^{′}} {b}_{{ll}^{′}}^{{mm}^{′}} {P}_{l}^{m} ( y ) {P}_{{l}^{′}}^{{m}^{′}} ( x ) \\ Fourier expansion of two \text{-} dimensional edge distribution function \\ {f}_{φ} ( x , y ) = {\sum }_{m , {m}^{′}} {a}_{{mm}^{′}} {e}^{i my} {e}^{i {m}^{′} x} \\ The distribution function of the whole image is described by the simultaneous expansion . \\ f = {f}_{x} \cdot {f}_{r} \cdot {f}_{θ} \cdot {f}_{φ} \qquad \{ Math . 129 \}$$

The variable of the image is separated by the operation of the projection to the distribution function of the principal axis, the one-dimensional color distribution function describes the characteristic related to the spin-system one independent variable, the one-dimensional edge distribution function describes the characteristic related to one independent variable in the radial direction, the two-dimensional color distribution function describes the characteristic related to two independent variables in the zenithal angle direction, and the two-dimensional edge distribution function describes the characteristic related to two independent variables in the azimuthal angle direction. There are six axes of the independent variable.

When the spherical Bessel expansion of the one-dimensional edge distribution function is performed by the double series, the orthogonality of the base function related to the quantum number l of the associated Legendre function in which the two-dimensional color distribution is expanded takes the role in the orthogonality related to the degree of l. Accordingly, the spherical Bessel expansion coefficient is singly decided so as to satisfy only the orthogonality related to the root of the quantum number n in the closed state of the subsystem.

When the associated Legendre function expansion of the two-dimensional color distribution function is performed by the double series, the orthogonality of the base function related to the quantum number m of the Fourier function in which the two-dimensional edge distribution is expanded takes the role in the orthogonality related to the degree of m. Accordingly, the expansion coefficient of the associated Legendre function is singly decided so as to satisfy only the orthogonality related to the quantum number l in the closed state of the subsystem.

In the frequency description, the correlation exists between the subsystems. That is, the distribution function is simultaneously described between the subsystem of the one-dimensional edge distribution function and the subsystem of the two-dimensional color distribution function, and between the subsystem of the two-dimensional color distribution function and the subsystem of the two-dimensional edge distribution function, the orthogonality of the base function reflects one of the both sides.

When the two-dimensional distribution functions of the color plane and edge plane are simultaneously expanded, because the product of the associated Legendre function and the Fourier function becomes the base function, the base functions constitute spherical harmonics in the x-direction and the y-direction.

<Statistical Independence of Subsystem and Split of Energy Level>

Because the distribution function of the whole image is expressed by the product of the distribution functions of the subsystems, each subsystem maintains the statistical independence. The linear differential equation relating to the energy satisfies one aspect of the perception which is the subsystem and derives an energy eigenvalue Eₙ. The energy eigenvalue is derived from the differential equation satisfied by each subsystem. At this point, the energy eigenvalue of the whole system is expressed by the sum of the energy eigenvalues derived in the subsystems. Accordingly, the energy level that is degenerated in a certain subsystem is released by the action of another subsystem to provide the divided energy levels.

For example, the two-dimensional composition distributions cannot be distinguished from each other in the case that the feature of the image is described using only the energy elements related to the color and edge of the one-dimensional system. However, when the energy element related to the composition is described by the two-dimensional system, the energy element divides the energy level of the one-dimensional system, and the two-dimensional composition distributions can be distinguished from each other.

In the case that energy eigenvalue is derived in the axial inversion, the energy eigenvalue is decided in each subsystem independently of the statistical independence of the subsystem. Accordingly, as to the characteristic of the axial invertibility, the energy element may be obtained by investigating the characteristic in the case that axial inversion is independently performed in each subsystem unit. Investigating the characteristic of the axial inversion is a unique item of the subsystem in which the frequency-space description is performed using the base function including the even function and odd function. The operation does not exist in the real-space description.

<High-Order Invariant of Composition>

The energy element En is defined from the viewpoint of the energy dispersion relationship and the irreducible expression in the frequency space (k-space). The one-dimensional array cᵢ is formed from the two-dimensional expansion coefficient cᵢⱼ projected to the frequency space by some sort of method, and the quadratic-form energy of each of the symmetric product and antisymmetric product is defined from the product of the α-plane expansion coefficient and the β-plane expansion coefficient. For the sake of easy understanding, only the case of the symmetric product is dealt with.

$$\begin{matrix}One \text{-} dimensionalize & {c}_{ij} \to {c}_{i} \\ Quadratic \text{-} form sum & {E}_{n} = {\sum }_{j = i + n , i} {c}_{i}^{( α )} {c}_{j}^{( β )} = {\sum }_{i} {c}_{i}^{( α )} {c}_{i + n}^{( β )}\end{matrix} \qquad \{ Math . 130 \}$$

Where the quadratic-form sum is calculated from the sum of the products of all the elements on the two-dimensional plane of the α plane and β plane.

That is, there is a problem that the α planes are arranged in a specific direction from a specific point as a starting point on the two-dimensional coefficient plane or that the β planes are arranged in a specific direction from a specific point as a starting point on the two-dimensional coefficient plane. This is a problem presentation whether the compact irreducible expression that efficiently expresses the characteristic of the coefficient distribution of the two-dimensional coefficient plane described by the product of the combinations of the α planes and β planes exists. The problem presentation is constructed using an analogy from the method for describing the characteristic of the energy band formed by the periodical crystal structure of the solid-state physics.

It can be considered that the two-dimensional k-space expressed by kx and ky of the wave vector is formed in the two-dimensional expansion coefficient to which the frequency expansion is performed.

$${f}^{( α )} ( x , y ) = {c}_{00}^{( α )} {ψ}_{0} ( y ) {ψ}_{0} ( x ) + … + {c}_{0 , n - 1}^{( α )} {ψ}_{0} ( y ) {ψ}_{n - 1} ( x ) + … + {c}_{n - 1 , 0}^{( α )} {ψ}_{n - 1} ( y ) {ψ}_{0} ( x ) + … + {c}_{n - 1 , n - 1}^{( α )} {ψ}_{n - 1} ( y ) {ψ}_{n - 1} ( x ) \qquad \{ Math . 131 \}$$

It is defined that the highest-frequency component in the x-axis direction is connected to the lowest-frequency component in the x-axis direction. Similarly, it is defined that the highest-frequency component in the y-axis direction is connected to the lowest-frequency component in the y-axis direction. That is, it is considered that the superhigh frequency wave is recognized equal to the superlow frequency wave as a whole because the superhigh frequency wave has too many vibrations. This is the idea that is introduced to define the energy element by the extension spur from the base function of the one-dimensional distribution function.

Therefore, the high-frequency component next to c_{0,n-1} becomes c₀₀, and it can be considered that the two components are the substantially equivalent point in which the quantum number is shifted only by 1. In the expression of n×n expansion coefficients, the characteristic related to the connection of the expansion coefficients is identical to the fact that the square Brillouin zone is formed in the k-space. c₀₀ corresponds to (kx,ky)=(0,0) in the k-space, c_{0,n-1} corresponds to (kx,ky)=(2π/a,0) in the k-space, c_{n-1,0} corresponds to (kx,ky)=(0,2π/a) in the k-space, and c_{n-1,n-1} corresponds to (2π/a,2π/a) in the k-space.

The definition that the low frequency is connected to the highest frequency is equivalent to the characteristic that the high-frequency component is folded back as the low-frequency component. For the one-dimensional k-space, in the frequency band of kx=0 to 2π/a, while the interval of kx=0 to π/a is left, the interval of kx=π/a to 2π/a is shifted to the left by −2π/a and connected as an equivalent point of kx=0=2π/a, and the interval of kx=−π/a to π/a is expressed again. This is the characteristic of the Brillouin zone. The space formed by the intervals of kx=0 to 2π/a and ky=0 to 2π/a and the half of the positive interval are expressed by the negative interval as the two-dimensional Brillouin zone, and the space is equivalent to the space formed by the intervals of kx=−π/a to π/a and ky=−π/a to π/a. That is, the n×n expansion coefficients have the characteristic identical to the square-lattice Brillouin zone in the solid-state physics.

In the solid-state physics, when the energy band characteristic of the crystal structure, namely, an energy dispersion relationship E(k) is investigated, the irreducible expression of the space group, which is an idea of the group theory, shows that the energy dispersion relationship E(k) can be sufficiently investigated without investigating the characteristics of all the points on the k-space and only by investigating the characteristics on the special point and line (see Documents H1 and H2).

According to Document H2, six points or lines of the special types exist in the square-lattice Brillouin zone. When the Brillouin zone is expressed in the ranges of |kx|≦π/a and |ky|≦π/a, a Γ point of (kx,ky)=(0,0), an M point of (kx,ky)=(π/a,π/a), an X point of (kx,ky)=(π/a,0), a Σ line connecting the Γ point and the M point, a Δ line connecting the Γ point and the X point, and a Z line connecting the M point and the X point correspond to the six points or lines.

When the one-dimensional coefficient plane is formed on the two-dimensional coefficient plane from the similar deduction,

\vec{k}^{(α)} {Math. 132}

is defined as the vector that regulates the position and direction of the starting point in rearranging the coefficient on the α plane. The ith expansion coefficient and the jth expansion coefficient are exchanged from the rearranged two coefficients, the sum of the symmetric products is calculated between the coefficients in which the relationship of j=i+n is maintained, and the energy dispersion relationship of

Eₙ₌ⱼ₋ᵢ^{(α)(β)+}(\vec{k}ᵢ^{(α)}·\vec{k}ⱼ^{(β)}) {Math. 133}

formed by the sum of the symmetric products is investigated. The same holds true for the product of the antisymmetric products.

Method for selecting an irreducible representation from countless translation vectors

The translation vector is formed by the combination of the vectors expressed in

\vec{k}^{(α)} and \vec{k}^{(β)}. {Math. 134}

It is assumed that the irreducible expression that expresses the characteristic of the quadratic-form energy formed by

\vec{k}^{(α)·}\vec{k}^{(β){Math.} 135}

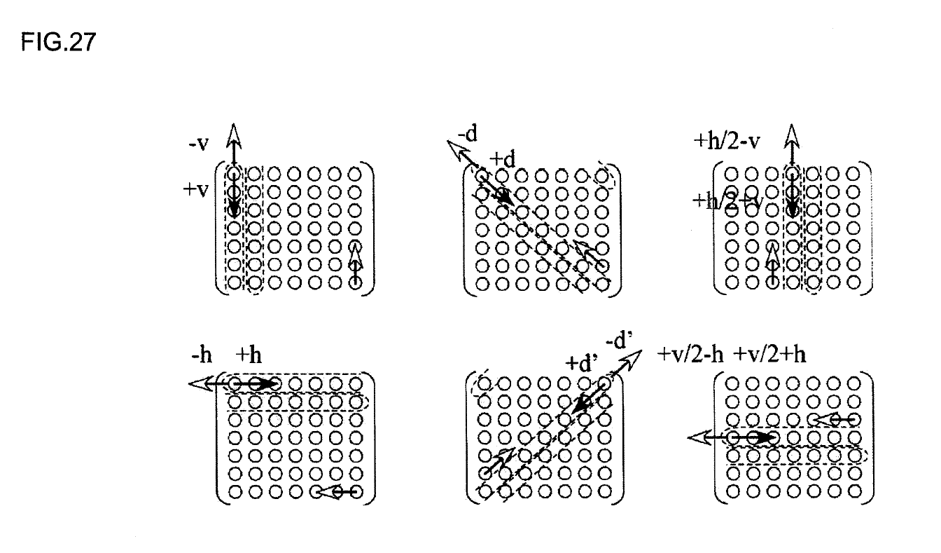

is matched with the irreducible expression of the space group possessed by the square-lattice Brillouin zone. The rearrangement method becomes 12 ways including 6 ways in FIG. 27 and the negative directions thereof. That is, the rearrangement is performed toward the extending direction of the special line from the special point of the square-lattice Brillouin zone.

The characteristic that is shifted by the point on the special line may be investigated for a shift quantity n=i−j when i and j are exchanged to form the symmetric product and the antisymmetric product from the two coefficient planes. For the n×n expansion coefficients, the energy dispersion relationship between the symmetric product and the antisymmetric product is obtained, when the energy dispersion relationship in which the n×n expansion coefficients are not shifted but only the n expansion coefficients are shifted are combined in each direction, namely, when the starting point on the β-plane side is gradually shifted along the special line from the special point while the starting point on the α-plane side is fixed with respect to each of the combinations of 12×12 ways.

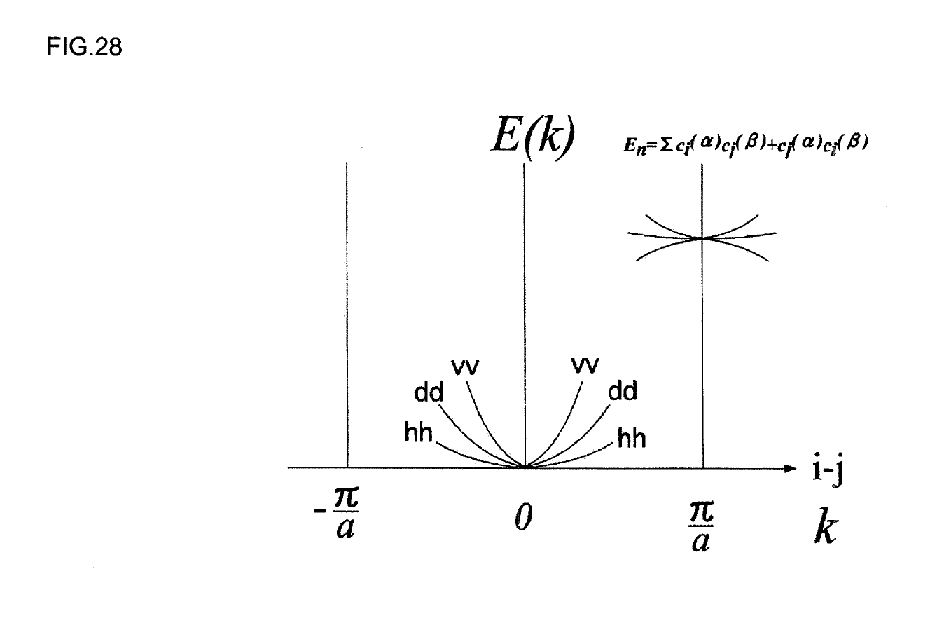

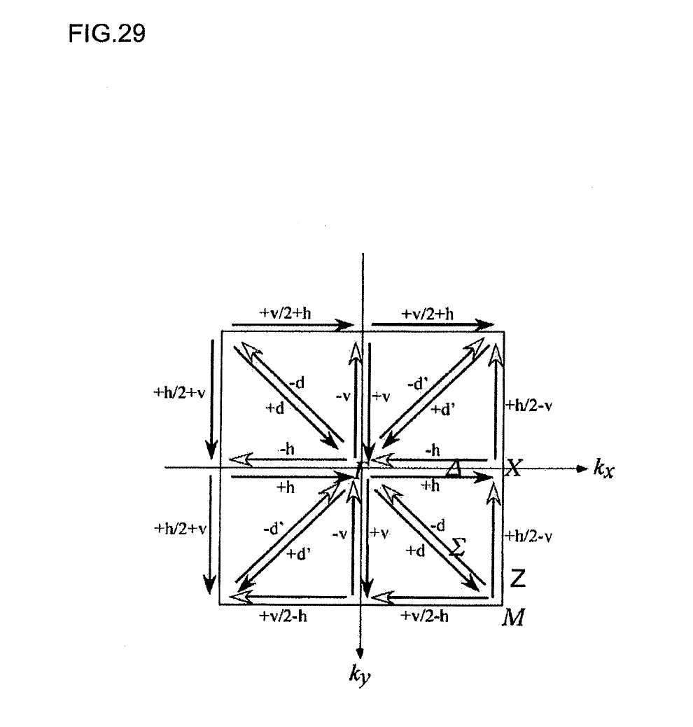

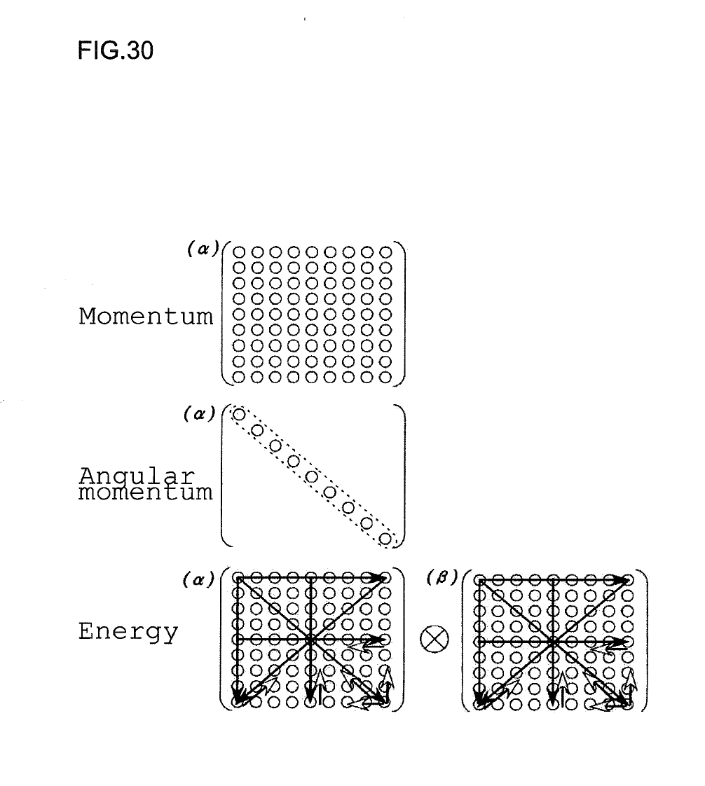

FIG. 28 is a view illustrating the conceptual state of the energy dispersion relationship. FIG. 29 is a view illustrating the state in which the energy characteristic is investigated on the special point and line on the k-space, and the states of the rearrangements in the 12 directions and the position investigated on the k-space when the i-j quantum number is shifted along the special line. At this point, ±v, ±h, ±d, ±d′, +h/2±v, and +v/2±h are used as the symbol expressing the rearrangements in the 12 directions. FIG. 30 is a view illustrating the relationship between the two-dimensional expansion coefficient and the momentum, angular momentum, and energy.

The energy dispersion relationship in which the quadratic-form sum of the expansion coefficients is calculated describes a sum set of the image distributions that provide the identical perception having the identical trajectory on the phase space when the expansion coefficient is considered to be the momentum. That is, a flat gradation zone emerges easily in the horizontal direction in the background such as the sky, and a texture zone emerges easily in mountains. Perceptual obscurity is described with the characteristic related to the frequency as a comprehensive index in which the individual frequency distributions are not matched with each other but the pieces of information on the entire frequency distribution are matched with each other.

Additionally, the characteristic of the combination of the rearrangement in which the half frequency is used as the starting point on the k-space and the rearrangement in which the lowest-order frequency or the highest-order frequency is used as the starting point is investigated. Therefore, the characteristic also expresses whether the pattern having the similar frequency structure exists even if the scale is reduced by half in the vertical direction, horizontal direction, or oblique direction. That is, the index also evaluates the existence of fractal with respect to the structure in the two-dimensional shape distribution.

The detailed rearrangement method will be described again. In the following description, the left end is set to the first row and the first column, and the right end is set to an nth row and an nth column.

In the rearrangement in the +v-direction, the n elements in the first column are sequentially taken out from the top, the n elements in the second column are sequentially taken out from the top, and the operation is repeated to the end. In the rearrangement in the −v-direction, the n elements in the nth column are sequentially taken out from the bottom, the n elements in the (n−1)th column are sequentially taken out from the bottom, and the operation is repeated to the end.

In the rearrangement in the +h-direction, the n elements in the first row are sequentially taken out from the left, the n elements in the second row are sequentially taken out from the left, and the operation is repeated to the end. In the rearrangement in the −h-direction, the n elements in the nth row are sequentially taken out from the right, the n elements in the (n−1)th row are sequentially taken out from the right, and the operation is repeated to the end.

In the rearrangement in the +h/2+v-direction, the n elements in the n/2th column are sequentially taken out from the top, and the n elements in the (n/2+1)th column are sequentially taken out from the top, the operation is performed to the first column after the nth column, and the operation is repeated to the (n/2−1)th column. In the rearrangement in the +h/2-v-direction, the n elements in the (n/2−1)th column are sequentially taken out from bottom, the n elements in the (n/2−2)th column are sequentially taken out from the bottom, the operation is performed to the nth column after the first column, and the operation is repeated to the n/2th column.

In the rearrangement in the +v/2+h-direction, the n elements in the n/2th row are sequentially taken out from the left, the n elements in the (n/2+1)th row are sequentially taken out from the left, the operation is performed to the first row after the nth row, and the operation is repeated to the (n/2−1)th row. In the rearrangement in the +h/2−v-direction, the n elements in the (n/2−1)th row are sequentially taken out from the right, and the n elements in the (n/2−2)th row are sequentially taken out from the right, the operation is performed to the nth row after the first row, and the operation is repeated to the n/2th row.

In the rearrangement in the +d-direction, the n elements are sequentially taken out in the lower right direction with the first row and the first column as the starting point, the n elements are sequentially taken out in the lower right direction with the second row and the first column as the starting point, and the operation is repeated until the n elements are taken out with the nth row and the first column as the starting point. At this point, for the row number overflown in the positive direction from the definition region, the point at which the number of the nth element is subtracted from the row number is set to the corresponding point. In the rearrangement in the −d-direction, the n elements are sequentially taken out in the upper left direction with the (n−1)th row and the nth column as the starting point, the n elements are sequentially taken out in the upper left direction with the (n−2)th row and the nth column as the starting point, the n elements are taken out with the first row and the nth column as the starting point, and the n elements are taken out with the nth row and the nth column as the starting point. At this point, for the row number overflown in the negative direction from the definition region, the point at which the number of the nth element is added to the row number is set to the corresponding point.

In the rearrangement in the +d′-direction, the n elements are sequentially taken out in the lower left direction with the first row and the nth column as the starting point, the n elements are sequentially taken out in the lower left direction with the second row and the nth column as the starting point, and the operation is repeated until the n elements are taken out with the nth row and the nth column as the starting point. At this point, for the row number overflown in the positive direction from the definition region, the point at which the number of the nth element is subtracted from the row number is set to the corresponding point. In the rearrangement in the −d′-direction, the n elements are sequentially taken out in the upper right direction with the (n−1)th row and the first column as the starting point, the n elements are sequentially taken out in the upper right direction with the (n−2)th row and the first column as the starting point, the n elements are taken out with the first row and the first column as the starting point, and the n elements are taken out with the nth row and the first column as the starting point. At this point, for the row number overflown in the negative direction from the definition region, the point at which the number of the nth element is added to the row number is set to the corresponding point.

Then the definition is performed with respect to the angular momentum. In the description of the object motion, the angular momentum can become a constant of the motion only for the central field of force expressed by a spherically symmetric potential (see Document H4). When the fact is applied to the image distribution, only the feature of the shape having a central symmetry becomes a conservative quantity with respect to the spatial isotropy. In the two-dimensional expansion coefficient, only the diagonal component exerts the centrally symmetric characteristic.

The expansion coefficient is considered to be the momentum according to the classical definition of the angular momentum, and the coordinate is correlated with the Hilbert space coordinate expressing the quantum number of the expansion coefficient. Therefore, the angular momentum can be described by the sum of the diagonal components multiplied by the quantum number.

The image group in which a circle exists in the center like a national flag or the image of photographing composition in which a main subject is disposed in the center can be cited as an example of the image in which the angular momentum can be described as a meaningful constant of the motion. In the case that the central symmetry is emphasized, the features have an effective influence on the adjective generating a certain impression. In other cases, the features are eliminated by the statistical mean with the image having no central symmetry.
[Document H2] Kittel, Quantum Theory of Solids (1963), Chapter 10 “Brillouin Zone and Crystal Symmetry”
[Document H3] Landau and Lifshitz, Course of Theoretical Physics, Volume 5 “Statistical Physics, Part 1” (Third Edition, 1976), Chapter 13 “Symmetry of Crystal”, Section 134 “Irreducible Expression of Space Group”
[Document H4] Schiff “Quantum Mechanics” (Third Edition, 1970), Chapter 4 “Discrete Eigenvalue: Bound state”, Section 14 “Three-dimensional Spherically Symmetry Potential”

<Invariability for Axial Invertibility of High-Order Invariant>

As described above, the high-order invariant, such as the quadratic-form energy, which is prepared from the expansion coefficient projected to the frequency space using the base function, is constructed by the expansion coefficients of the original two-dimensional distribution planes of (α)(x,y) and (β)(x,y). In the composition system of the two-dimensional distribution, because the independent energy element is generated in the axial inversion like the introduction of the frequency description of the one-dimensional distribution, the independent energy element is also used as the features.

Because the axial inversion methods of 4 ways exist in each of the α plane and the β plane, the independent energy elements are generated 4×4 times the case that the axial invertibility is not considered.

(α)(x,y),

(α)(x,−y)=(α′)(x,y),

(α)(−x,y)=(α″)(x,y),

(α)(−x,−y)=(α′″)(x,y),

(β)(x,y),

(β)(x,−y)=(β′)(x,y),

(β)(−x,y)=(β″)(x,y),

(β)(−x,−y)=(β′″)(x,y)

When the subsystem is described by the Hamiltonian that has all the energy elements as the eigenvalues, the image group expressing the identical perception is described with the invariability for the axial invertibility of the Hamiltonian. That is, the different coefficient distribution is generated as the expansion coefficient of the odd function when the axial inversion is performed. Therefore, even if a certain image and the axially-inverted image have the identical coefficient distribution, because the behavior difference between the pre-axial-inversion energy element and the post-axial-inversion energy element is investigated, the images can be distinguished from each other because of the different impression of the adjective.

The energy dispersion relationship formed from the axially-inverted color plane has such the description effect that the dispersion relationship between the original-state special points, which is not described by the energy dispersion relationship while the axial inversion is not performed, is filled while the special points at both the ends are shared. That is, the state is degenerated at the special points at both the ends.

The descriptions in the first to seventh embodiments are commonly supplemented.

<Method for Counting the Number of States>

As to the method for counting the number of states, the model Hamiltonian is introduced when the energy of the low-order invariant is prepared to perform the real-space description. When the model Hamiltonian is expanded, the term including the product of the (α) plane and the (β) plane of the different color planes involves a double factor of the term including the product of the (α) plane and the (β) plane of the identical color plane. This is because there are two selection methods in which (α)(β) and (β)(α) are equal to each other in the product of the (α) plane and the (β) plane when the two combination states are selected. Similarly the product of the mean term and the fluctuation term involves the double factor. Assuming that the original state exists double, when the value of the energy element is calculated, one of the two-time definition of the identical energy element and the definition of the double value of the energy element is adopted to perform the correction in consideration of the number of degenerations of the state.

The double of the energy element defined by the product of the (α) plane and the (β) plane is also applied to the high-order system invariant that performs the frequency-space description.

<Adjective Model Distribution Constructing Method>

When the impression of the image is evaluated at five stages with a psychologically linear scale to construct the adjective model distribution, the 1-time weight is multiplied by the fifth stage, the 0.8-time weight is multiplied by the fourth stage, the 0.6-time weight is multiplied by the third stage, the 0.4-time weight is multiplied by the second stage, and the 0.2-time weight is multiplied by the first stage. Alternatively, for example, the five-stage evaluation is interpreted as the value of the natural logarithm, and the weights of exp(0) time=1, exp(−1) time, exp(−2) times, exp(−3) times, and exp(−4) times may be added to the five stages in the image of the five-stage evaluation in the descending order.

### Eighth Embodiment

In the sixth embodiment, the four subsystems of the real-space expression and frequency space expression, which are produced from the one-dimensional distribution functions of color and edge, are described by the “linear model of perception”. On the other hand, a system in which the four subsystems of the real-space expression and frequency space expression, which are produced from the two-dimensional distribution functions of color and edge related to the composition, are added on the four subsystems of the sixth embodiment will be described in an eighth embodiment. Hereinafter, the subsystem called the texture in the above description is referred to as the edge.

Only a point different from the sixth embodiment will be described below. In the sixth embodiment, the title to which “one-dimensional” is not added corresponds to the title to which “one-dimensional” is added. A portion of the title to which “two-dimensional” is added is the newly-added portion.

1. Transform into Munsell HVC color space

2. Preparation of edge image on HVC plane

3. Preparation of low-order invariant of one-dimensional color distribution

4. Preparation of high-order invariant of one-dimensional color distribution

5. Preparation of low-order invariant of one-dimensional edge distribution

6. Preparation of high-order invariant of one-dimensional edge distribution

The case of spdf expansion will be described.

6-0. Hilbert space expression of distribution function of low-order system

6-0-1. Variable transform

The procedure is similar to that in 4-1 of the third embodiment.

6-0-2. Series expansion with spherical Bessel function

The one-dimensional distribution function on each of the color planes H, V, and C is equivalently expressed by performing double series expansion using the coefficient having N roots and the spherical Bessel function including the four orders.

$${f}^{( α )} ( x ) = {\sum }_{l = 0}^{3} {\sum }_{n = 1}^{N} {c}_{ln}^{( α )} {j}_{l} ( {α}_{ln} \frac{x}{a} ) = {\sum }_{l = 0}^{3} {\sum }_{n = 1}^{N} {b}_{l} {c}_{n}^{l ( α )} {j}_{l} ( {α}_{ln} \frac{x}{a} ) \\ ( α ) = H , V , C . \qquad \{ Math . 136 \}$$

Using the two quantum numbers of the even function and odd function in l=0 to 3, the azimuthal quantum number l is equivalently expressed by the double series expansion of the root related to the principal quantum number n. The combination that selects the two azimuthal quantum numbers from the four azimuthal quantum numbers has an arbitrary property under the condition that the even function and the odd function are always selected. For example, both the combination of l=0 and 1 and the combination of l=2 and 3 can equivalently express the one-dimensional distribution function. At this point, the coefficient is defined by the following equation.

$${f}^{( α )} ( x ) = {\sum }_{l = even , odd} {\sum }_{n = 1}^{N} {c}_{n}^{I ( α )} {j}_{l} ( {α}_{ln} \frac{x}{a} ) \\ l = 0 , 1 , 2 , 3 ( α ) = H , V , {C}_{∘} \qquad \{ Math . 137 \}$$

The expansion coefficient c^{l}ₙ is obtained by the following equation using the orthogonality of the base function. αₗₙ is provided by the equation indicated by [Math. 50].

$${c}_{n}^{l} = \frac{1}{{{a}^{3} [ {j}_{l + 1} ( {α}_{ln} ) ]}^{2}} {\int }_{- a}^{a} f ( x ) {j}_{l} ( {α}_{ln} \frac{x}{a} ) {x}^{2} d x \qquad \{ Math . 138 \}$$

The weight bₗ between the azimuthal quantum numbers l is equally set to 1 when the double series expansion is performed in the range of l=0 to 3. The orthogonality between the azimuthal quantum numbers l is guaranteed by the orthogonality of the associated Legendre function of the two-dimensional distribution function on the color plane when the one-dimensional distribution function of the histogram of the combined edge image of

fᵣ^{(α)}(x) {Math. 139}

and the two-dimensional distribution function on the color plane of

f_{θ}^{(α)}(x,y){Math. 140}

are simultaneously expanded by the product of the two distribution functions.

The expansion coefficient cₗₙ used to calculate the invariant of the subsystem is equal to the expansion coefficient c^{l}ₙ that is obtained by the double series expansion using one of each even function and odd function. Hereinafter, c^{l}ₙ is dealt with as cₗₙ.

6-1. Preparation of distribution function of high-order system

The procedure is similar to that in 6-1 of the fifth embodiment.

6-2. Calculation of entropy

The procedure is similar to that in 6-2 of the fifth embodiment.

6-3. Calculation of momentum element pₙ

The procedure is similar to that in 6-3 of the fifth embodiment.

6-4. Calculation of angular momentum element Mₙ

The following expression can be cited as an example of the angular momentum element Mₙ.

1(c₁₁^{(α)}+c₁₂^{(α)}+ . . . +c_{1N}^{(α)})+2(c₂₁^{(α)}+c₂₂^{(α)}+ . . . +c_{2N}^{(α)})+3(c₃₁^{(α)}+c₃₂^{(α)}+ . . . +c_{3N}^{(α)})(α)=H,V,Cₒ {Math. 141}

Independent component in the case of the axial inversion

−1(c₁₁^{(α)}+c₁₂^{(α)}+ . . . +c_{1N}^{(α)})+2(c₂₁^{(α)}+c₂₂^{(α)}+ . . . +c_{2N}^{(α)})−3(c₃₁^{(α)}+c₃₂^{(α)}+ . . . +c_{3N}^{(α)})(α)=H,V,Cₒ {Math. 142}

2×3=6 is obtained because the number of angular momentum elements is three.

6-5. Calculation of energy element Eₙ

The energy element including the normalization actually used in the spdf expansion is as follows.

$$\begin{matrix}Another definition \\ ( α ) ( α ) \\ a 0 a 0 p , e \text{:} \\ {E}_{n = k - i = 0 , l - {l}^{′} = 0}^{( α ) ( α ) +} = \frac{1}{2} \{ {\sum }_{i = 1}^{N} {( {c}_{0 i}^{( α )} )}^{2} + {\sum }_{i = 1}^{N} {( {c}_{1 i}^{( α )} )}^{2} + {\sum }_{i = 1}^{N} {( {c}_{2 i}^{( α )} )}^{2} + {\sum }_{i = 1}^{N} {( {c}_{3 i}^{( α )} )}^{2} \} i = k & \{ Math . 143 \} \\ General definition \\ ( α ) ( α ) \\ a 0 a 0 p , e \text{/} i \text{:} \\ {E}_{n = k - i , l - {l}^{′} = 0}^{( α ) ( \pm α ) +} = \frac{\frac{1}{8} \{ \begin{matrix}{\sum }_{k = i + n , i = 1}^{N} ( {c}_{0 i}^{( α )} {c}_{0 k}^{( α )} + {c}_{0 k}^{( α )} {c}_{0 i}^{( α )} ) \pm {\sum }_{k = i + n , i = 1}^{N} ( {c}_{1 i}^{( α )} {c}_{1 k}^{( α )} + {c}_{1 k}^{( α )} {c}_{1 i}^{( α )} ) + \\ {\sum }_{k = i + n , i = 1}^{N} ( {c}_{2 i}^{( α )} {c}_{2 k}^{( α )} + {c}_{2 k}^{( α )} {c}_{2 i}^{( α )} ) \pm {\sum }_{k = i + n , i = 1}^{N} ( {c}_{3 i}^{( α )} {c}_{3 k}^{( α )} + {c}_{3 k}^{( α )} {c}_{3 i}^{( α )} )\end{matrix} \}}{\frac{1}{4} \{ {\sum }_{i = 1}^{N} {( {c}_{0 i}^{( α )} )}^{2} + {\sum }_{i = 1}^{N} {( {c}_{1 i}^{( α )} )}^{2} + {\sum }_{i = 1}^{N} {( {c}_{2 i}^{( α )} )}^{2} + {\sum }_{i = 1}^{N} {( {c}_{3 i}^{( α )} )}^{2} \}} i \neq k & \\ a 0 a 1 p , e \text{:} \\ {E}_{n = k - i , l - {l}^{′} = 1}^{( α ) ( + α ) +} = \frac{\frac{1}{8} \{ \begin{matrix}{\sum }_{k = i + n , i = 1}^{N} ( {c}_{0 i}^{( α )} {c}_{1 k}^{( α )} + {c}_{0 k}^{( α )} {c}_{1 i}^{( α )} ) + {\sum }_{k = i + n , i = 1}^{N} ( {c}_{1 i}^{( α )} {c}_{0 k}^{( α )} + {c}_{1 k}^{( α )} {c}_{0 i}^{( α )} ) + \\ {\sum }_{k = i + n , i = 1}^{N} ( {c}_{2 i}^{( α )} {c}_{3 k}^{( α )} + {c}_{2 k}^{( α )} {c}_{3 i}^{( α )} ) + {\sum }_{k = i + n , i = 1}^{N} ( {c}_{3 i}^{( α )} {c}_{2 k}^{( α )} + {c}_{3 k}^{( α )} {c}_{2 i}^{( α )} )\end{matrix} \}}{\frac{1}{2} \{ \sqrt{{\sum }_{i = 1}^{N} {( {c}_{0 i}^{( α )} )}^{2}} \sqrt{{\sum }_{i = 1}^{N} {( {c}_{1 i}^{( α )} )}^{2}} + \sqrt{{\sum }_{i = 1}^{N} {( {c}_{2 i}^{( α )} )}^{2}} \sqrt{{\sum }_{i = 1}^{N} {( {c}_{3 i}^{( α )} )}^{2}} \}} & \\ a 0 a 1 m , i \text{:} \\ {E}_{n = k - i , l - {l}^{′} = 1}^{( α ) ( - α ) -} = \frac{\frac{1}{8} \{ \begin{matrix}- {\sum }_{k = i + n , i = 1}^{N} ( {c}_{0 i}^{( α )} {c}_{1 k}^{( α )} - {c}_{0 k}^{( α )} {c}_{1 i}^{( α )} ) + {\sum }_{k = i + n , i = 1}^{N} ( {c}_{1 i}^{( α )} {c}_{0 k}^{( α )} - {c}_{1 k}^{( α )} {c}_{0 i}^{( α )} ) - \\ {\sum }_{k = i + n , i = 1}^{N} ( {c}_{2 i}^{( α )} {c}_{3 k}^{( α )} - {c}_{2 k}^{( α )} {c}_{3 i}^{( α )} ) + {\sum }_{k = i + n , i = 1}^{N} ( {c}_{3 i}^{( α )} {c}_{2 k}^{( α )} - {c}_{3 k}^{( α )} {c}_{2 i}^{( α )} )\end{matrix} \}}{\frac{1}{2} \{ \sqrt{{\sum }_{i = 1}^{N} {( {c}_{0 i}^{( α )} )}^{2}} \sqrt{{\sum }_{i = 1}^{N} {( {c}_{1 i}^{( α )} )}^{2}} + \sqrt{{\sum }_{i = 1}^{N} {( {c}_{2 i}^{( α )} )}^{2}} \sqrt{{\sum }_{i = 1}^{N} {( {c}_{3 i}^{( α )} )}^{2}} \}} i \neq k & \\ a 0 a 2 p , e \text{/} i \text{:} \\ {E}_{n = k - i , l - {l}^{′} = 2}^{( α ) ( \pm α ) +} = \frac{\frac{1}{8} \{ \begin{matrix}{\sum }_{k = i + n , i = 1}^{N} ( {c}_{0 i}^{( α )} {c}_{2 k}^{( α )} + {c}_{0 k}^{( α )} {c}_{2 i}^{( α )} ) \pm {\sum }_{k = i + n , i = 1}^{N} ( {c}_{2 i}^{( α )} {c}_{0 k}^{( α )} + {c}_{2 k}^{( α )} {c}_{0 i}^{( α )} ) + \\ {\sum }_{k = i + n , i = 1}^{N} ( {c}_{1 i}^{( α )} {c}_{3 k}^{( α )} + {c}_{1 k}^{( α )} {c}_{3 i}^{( α )} ) \pm {\sum }_{k = i + n , i = 1}^{N} ( {c}_{3 i}^{( α )} {c}_{1 k}^{( α )} + {c}_{3 k}^{( α )} {c}_{1 i}^{( α )} )\end{matrix} \}}{\frac{1}{2} \{ \sqrt{{\sum }_{i = 1}^{N} {( {c}_{0 i}^{( α )} )}^{2}} \sqrt{{\sum }_{i = 1}^{N} {( {c}_{2 i}^{( α )} )}^{2}} + \sqrt{{\sum }_{i = 1}^{N} {( {c}_{1 i}^{( α )} )}^{2}} \sqrt{{\sum }_{i = 1}^{N} {( {c}_{3 i}^{( α )} )}^{2}} \}} & \{ Math . 144 \} \\ a 0 a 3 p , e \text{:} \\ {E}_{n = k - i , l - {l}^{′} = 3}^{( α ) ( + α ) +} = \frac{\frac{1}{8} \{ \begin{matrix}{\sum }_{k = i + n , i = 1}^{N} ( {c}_{0 i}^{( α )} {c}_{3 k}^{( α )} + {c}_{0 k}^{( α )} {c}_{3 i}^{( α )} ) + {\sum }_{k = i + n , i = 1}^{N} ( {c}_{3 i}^{( α )} {c}_{0 k}^{( α )} + {c}_{3 k}^{( α )} {c}_{0 i}^{( α )} ) + \\ {\sum }_{k = i + n , i = 1}^{N} ( {c}_{1 i}^{( α )} {c}_{2 k}^{( α )} + {c}_{1 k}^{( α )} {c}_{2 i}^{( α )} ) + {\sum }_{k = i + n , i = 1}^{N} ( {c}_{2 i}^{( α )} {c}_{1 k}^{( α )} + {c}_{2 k}^{( α )} {c}_{1 i}^{( α )} )\end{matrix} \}}{\frac{1}{2} \{ \sqrt{{\sum }_{i = 1}^{N} {( {c}_{0 i}^{( α )} )}^{2}} \sqrt{{\sum }_{i = 1}^{N} {( {c}_{3 i}^{( α )} )}^{2}} + \sqrt{{\sum }_{i = 1}^{N} {( {c}_{1 i}^{( α )} )}^{2}} \sqrt{{\sum }_{i = 1}^{N} {( {c}_{2 i}^{( α )} )}^{2}} \}} & \\ a 0 a 3 m , i \text{:} \\ {E}_{n = k - i , l - {l}^{′} = 3}^{( α ) ( - α ) -} = \frac{\frac{1}{8} \{ \begin{matrix}- {\sum }_{k = i + n , i = 1}^{N} ( {c}_{0 i}^{( α )} {c}_{3 k}^{( α )} - {c}_{0 k}^{( α )} {c}_{3 i}^{( α )} ) + {\sum }_{k = i + n , i = 1}^{N} ( {c}_{3 i}^{( α )} {c}_{0 k}^{( α )} - {c}_{3 k}^{( α )} {c}_{0 i}^{( α )} ) + \\ {\sum }_{k = i + n , i = 1}^{N} ( {c}_{1 i}^{( α )} {c}_{2 k}^{( α )} - {c}_{1 k}^{( α )} {c}_{2 i}^{( α )} ) - {\sum }_{k = i + n , i = 1}^{N} ( {c}_{2 i}^{( α )} {c}_{1 k}^{( α )} - {c}_{2 k}^{( α )} {c}_{1 i}^{( α )} )\end{matrix} \}}{\frac{1}{2} \{ \sqrt{{\sum }_{i = 1}^{N} {( {c}_{0 i}^{( α )} )}^{2}} \sqrt{{\sum }_{i = 1}^{N} {( {c}_{3 i}^{( α )} )}^{2}} + \sqrt{{\sum }_{i = 1}^{N} {( {c}_{1 i}^{( α )} )}^{2}} \sqrt{{\sum }_{i = 1}^{N} {( {c}_{2 i}^{( α )} )}^{2}} \}} i \neq k & \\ ( α ) ( β ) \\ a 0 b 0 p , e \text{/} i \text{:} \\ {E}_{n = k - i , l - {l}^{′} = 0}^{( α ) ( \pm β ) +} = \frac{\frac{1}{8} \{ \begin{matrix}{\sum }_{k = i + n , i = 1}^{N} ( {c}_{0 i}^{( α )} {c}_{0 k}^{( β )} + {c}_{0 k}^{( α )} {c}_{0 i}^{( β )} ) \pm {\sum }_{k = i + n , i = 1}^{N} ( {c}_{1 i}^{( α )} {c}_{1 k}^{( β )} + {c}_{1 k}^{( α )} {c}_{1 i}^{( β )} ) + \\ {\sum }_{k = i + n , i = 1}^{N} ( {c}_{2 i}^{( α )} {c}_{2 k}^{( β )} + {c}_{2 k}^{( α )} {c}_{2 i}^{( β )} ) \pm {\sum }_{k = i + n , i = 1}^{N} ( {c}_{3 i}^{( α )} {c}_{3 k}^{( β )} + {c}_{3 k}^{( α )} {c}_{3 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{0 i}^{( β )} )}^{2}} + \sqrt{{\sum }_{i = 1}^{N} {( {c}_{1 i}^{( α )} )}^{2}} \sqrt{{\sum }_{i = 1}^{N} {( {c}_{1 i}^{( β )} )}^{2}} + \\ \sqrt{{\sum }_{i = 1}^{N} {( {c}_{2 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{3 i}^{( β )} )}^{2}}\end{matrix} \}} & \{ Math . 145 \} \\ a 0 b 0 m , e \text{/} i \text{:} \\ {E}_{n = k - i , l - {l}^{′} = 0}^{( α ) ( \pm β ) -} = \frac{\frac{1}{8} \{ \begin{matrix}{\sum }_{k = i + n , i = 1}^{N} ( {c}_{0 i}^{( α )} {c}_{0 k}^{( β )} - {c}_{0 k}^{( α )} {c}_{0 i}^{( β )} ) \pm {\sum }_{k = i + n , i = 1}^{N} ( {c}_{1 i}^{( α )} {c}_{1 k}^{( β )} - {c}_{1 k}^{( α )} {c}_{1 i}^{( β )} ) + \\ {\sum }_{k = i + n , i = 1}^{N} ( {c}_{2 i}^{( α )} {c}_{2 k}^{( β )} - {c}_{2 k}^{( α )} {c}_{2 i}^{( β )} ) \pm {\sum }_{k = i + n , i = 1}^{N} ( {c}_{3 i}^{( α )} {c}_{3 k}^{( β )} - {c}_{3 k}^{( α )} {c}_{3 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{0 i}^{( β )} )}^{2}} + \sqrt{{\sum }_{i = 1}^{N} {( {c}_{1 i}^{( α )} )}^{2}} \sqrt{{\sum }_{i = 1}^{N} {( {c}_{1 i}^{( β )} )}^{2}} + \\ \sqrt{{\sum }_{i = 1}^{N} {( {c}_{2 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{3 i}^{( β )} )}^{2}}\end{matrix} \}} i \neq k & \\ a 0 b 1 p , e \text{/} i \text{:} \\ {E}_{n = k - i , l - {l}^{′} = 1}^{( α ) ( \pm β ) +} = \frac{\frac{1}{8} \{ \begin{matrix}\pm {\sum }_{k = i + n , i = 1}^{N} ( {c}_{0 i}^{( α )} {c}_{1 k}^{( β )} + {c}_{0 , k + 1}^{( α )} {c}_{1 i}^{( β )} ) + {\sum }_{k = i + n , i = 1}^{N} ( {c}_{1 i}^{( α )} {c}_{0 , k + 1}^{( β )} + {c}_{1 k}^{( α )} {c}_{0 i}^{( β )} ) \pm \\ {\sum }_{k = i + n , i = 1}^{N} ( {c}_{2 i}^{( α )} {c}_{3 k}^{( β )} + {c}_{2 , k + 1}^{( α )} {c}_{3 i}^{( β )} ) + {\sum }_{k = i + n , i = 1}^{N} ( {c}_{3 i}^{( α )} {c}_{2 , k + 1}^{( β )} + {c}_{3 k}^{( α )} {c}_{2 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{1 i}^{( β )} )}^{2}} + \sqrt{{\sum }_{i = 1}^{N} {( {c}_{1 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{2 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{2 i}^{( β )} )}^{2}}\end{matrix} \}} & \\ a 0 b 1 m , e \text{/} i \text{:} \\ {E}_{n = k - i , l - {l}^{′} = 1}^{( α ) ( + β )} = \frac{\frac{1}{8} \{ \begin{matrix}\pm {\sum }_{k = i + n , i = 1}^{N} ( {c}_{0 i}^{( α )} {c}_{1 k}^{( β )} - {c}_{0 , k + 1}^{( α )} {c}_{1 i}^{( β )} ) + {\sum }_{k = i + n , i = 1}^{N} ( {c}_{1 i}^{( α )} {c}_{0 , k + 1}^{( β )} - {c}_{1 k}^{( α )} {c}_{0 i}^{( β )} ) \pm \\ {\sum }_{k = i + n , i = 1}^{N} ( {c}_{2 i}^{( α )} {c}_{3 k}^{( β )} - {c}_{2 , k + 1}^{( α )} {c}_{3 i}^{( β )} ) + {\sum }_{k = i + n , i = 1}^{N} ( {c}_{3 i}^{( α )} {c}_{2 , k + 1}^{( β )} - {c}_{3 k}^{( α )} {c}_{2 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{1 i}^{( β )} )}^{2}} + \sqrt{{\sum }_{i = 1}^{N} {( {c}_{1 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{2 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{2 i}^{( β )} )}^{2}}\end{matrix} \}} & \\ a 0 b 2 p , e \text{/} i \text{:} \\ {E}_{n = k - i , l - {l}^{′} = 2}^{( α ) ( + β ) +} = \frac{\frac{1}{8} \{ \begin{matrix}+ {\sum }_{k = i + n , i = 1}^{N} ( {c}_{0 i}^{( α )} {c}_{2 k}^{( β )} + {c}_{0 , k + 1}^{( α )} {c}_{2 i}^{( β )} ) + {\sum }_{k = i + n , i = 1}^{N} ( {c}_{2 i}^{( α )} {c}_{0 , k + 1}^{( β )} + {c}_{2 k}^{( α )} {c}_{0 i}^{( β )} ) \pm \\ {\sum }_{k = i + n , i = 1}^{N} ( {c}_{1 i}^{( α )} {c}_{3 k}^{( β )} + {c}_{1 , k + 1}^{( α )} {c}_{3 i}^{( β )} ) \pm {\sum }_{k = i + n , i = 1}^{N} ( {c}_{3 i}^{( α )} {c}_{1 , k + 1}^{( β )} + {c}_{3 k}^{( α )} {c}_{1 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{2 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{1 i}^{( β )} )}^{2}}\end{matrix} \}} & \{ Math . 146 \} \\ a 0 b 2 m , e \text{/} i \text{:} \\ {E}_{n = k - i , l - {l}^{′} = 2}^{( α ) ( \pm β ) -} = \frac{\frac{1}{8} \{ \begin{matrix}+ {\sum }_{k = i + n , i = 1}^{N} ( {c}_{0 i}^{( α )} {c}_{2 k}^{( β )} - {c}_{0 , k + 1}^{( α )} {c}_{2 i}^{( β )} ) + {\sum }_{k = i + n , i = 1}^{N} ( {c}_{2 i}^{( α )} {c}_{0 , k + 1}^{( β )} - {c}_{2 k}^{( α )} {c}_{0 i}^{( β )} ) \pm \\ {\sum }_{k = i + n , i = 1}^{N} ( {c}_{1 i}^{( α )} {c}_{3 k}^{( β )} - {c}_{1 , k + 1}^{( α )} {c}_{3 i}^{( β )} ) \pm {\sum }_{k = i + n , i = 1}^{N} ( {c}_{3 i}^{( α )} {c}_{1 , k + 1}^{( β )} - {c}_{3 k}^{( α )} {c}_{1 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{2 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{1 i}^{( β )} )}^{2}}\end{matrix} \}} i \neq k & \\ a 0 b 3 p , e \text{/} i \text{:} \\ {E}_{n = k - i , l - {l}^{′} = 3}^{( α ) ( \pm β ) +} = \frac{\frac{1}{8} \{ \begin{matrix}\pm {\sum }_{k = i + n , i = 1}^{N} ( {c}_{0 i}^{( α )} {c}_{3 k}^{( β )} + {c}_{0 , k + 1}^{( α )} {c}_{3 i}^{( β )} ) + {\sum }_{k = i + n , i = 1}^{N} ( {c}_{3 i}^{( α )} {c}_{0 , k + 1}^{( β )} + {c}_{3 k}^{( α )} {c}_{0 i}^{( β )} ) + \\ {\sum }_{k = i + n , i = 1}^{N} ( {c}_{1 i}^{( α )} {c}_{2 k}^{( β )} + {c}_{1 , k + 1}^{( α )} {c}_{2 i}^{( β )} ) \pm {\sum }_{k = i + n , i = 1}^{N} ( {c}_{2 i}^{( α )} {c}_{1 , k + 1}^{( β )} + {c}_{2 k}^{( α )} {c}_{1 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{2 i}^{( α )} )}^{2}} \sqrt{{\sum }_{i = 1}^{N} {( {c}_{1 i}^{( β )} )}^{2}}\end{matrix} \}} & \\ a 0 b 3 m , e \text{/} i \text{:} \\ {E}_{n = k - i , l - {l}^{′} = 3}^{( α ) ( \pm β ) -} = \frac{\frac{1}{8} \{ \begin{matrix}\pm {\sum }_{k = i + n , i = 1}^{N} ( {c}_{0 i}^{( α )} {c}_{3 k}^{( β )} - {c}_{0 , k + 1}^{( α )} {c}_{3 i}^{( β )} ) + {\sum }_{k = i + n , i = 1}^{N} ( {c}_{3 i}^{( α )} {c}_{0 , k + 1}^{( β )} - {c}_{3 k}^{( α )} {c}_{0 i}^{( β )} ) \pm \\ {\sum }_{k = i + n , i = 1}^{N} ( {c}_{1 i}^{( α )} {c}_{2 k}^{( β )} - {c}_{1 , k + 1}^{( α )} {c}_{2 i}^{( β )} ) \pm {\sum }_{k = i + n , i = 1}^{N} ( {c}_{2 i}^{( α )} {c}_{1 , k + 1}^{( β )} - {c}_{2 k}^{( α )} {c}_{1 i}^{( β )} )\end{matrix} \}}{\frac{1}{4} \{ \begin{matrix}\sqrt{{\sum }_{i = 1}^{N} {( {c}_{0 i}^{( α )} )}^{2}} \sqrt{{\sum }_{i = 1}^{N} {( {c}_{3 i}^{( β )} )}^{2}} + \sqrt{{\sum }_{i = 1}^{N} {( {c}_{3 i}^{( α )} )}^{2}} \sqrt{{\sum }_{i = 1}^{N} {( {c}_{0 i}^{( β )} )}^{2}} + \\ \sqrt{{\sum }_{i = 1}^{N} {( {c}_{1 i}^{( α )} )}^{2}} \sqrt{{\sum }_{i = 1}^{N} {( {c}_{2 i}^{( β )} )}^{2}} + \sqrt{{\sum }_{i = 1}^{N} {( {c}_{2 i}^{( α )} )}^{2}} \sqrt{{\sum }_{i = 1}^{N} {( {c}_{1 i}^{( β )} )}^{2}}\end{matrix} \}} & \end{matrix}$$

The similar definition can be made by the procedure similar to the extension from the sp expansion to the spdf expansion when the expansion degree of the angular momentum quantum number is increased in the double series. The combinations of the submatrices (1,1′) of the α plane and the β plane are shown below when the expansion is performed with respect to the angular momentum quantum number 1=0, 1, . . . , 15.

00 type

(l,l′)=(0,0)+(1,1)+(2,2)+(3,3)+(4,4)+(5,5)+(6,6)+(7,7)+(8,8)+(9,9)+(10,10)+(11,11)+(12,12)+(13,13)+(14,14)+(15,15)

01 type

(l,l′)=(0,1)+(1,0)+(2,3)+(3,2)+(4,5)+(5,4)+(6,7)+(7,6)+(8,9)+(9,8)+(10,11)+(11,10)+(12,13)+(13,12)+(14,15)+(15,14)

02 type

(l,l′)=(0,2)+(2,0)+(1,3)+(3,1)+(4,6)+(6,4)+(5,7)+(7,5)+(8,10)+(10,8)+(9,11)+(11,9)+(12,14)+(14,12)+(13,15)+(15,13)

03 type

(l,l′)=(0,3)+(3,0)+(2,5)+(5,2)+(4,7)+(7,4)+(6,9)+(9,6)+(8,11)+(11,8)+(10,13)+(13,10)+(12,15)+(15,12)+(14,1)+(1,14)

04 type

(l,l′)=(0,4)+(4,0)+(1,5)+(5,1)+(2,6)+(6,2)+(3,7)+(7,3)+(8,12)+(12,8)+(9,13)+(13,9)+(10,14)+(14,10)+(11,15)+(15,11)

05 type

(l,l′)=(0,5)+(5,0)+(2,7)+(7,2)+(4,9)+(9,4)+(6,11)+(11,6)+(8,13)+(13,8)+(10,15)+(15,10)+(12,1)+(1,12)+(14,3)+(3,14)

06 type

(l,l′)=(0,6)+(6,0)+(1,7)+(7,1)+(4,10)+(10,4)+(5,11)+(11,5)+(8,14)+(14,8)+(9,15)+(15,9)+(12,2)+(2,12)+(13,3)+(3,13)

07 type

(l,l′)=(0,7)+(7,0)+(2,9)+(9,2)+(4,11)+(11,4)+(6,13)+(13,6)+(8,15)+(15,8)+(10,1)+(1,10)+(12,3)+(3,12)+(14,5)+(5,14)

08 type

(l,l′)=(0,8)+(8,0)+(1,9)+(9,1)+(2,10)+(10,2)+(3,11)+(11,3)+(4,12)+(12,4)+(5,13)+(13,5)+(6,14)+(14,6)+(7,15)+(15,7)

09 type

(l,l′)=(0,9)+(9,0)+(2,11)+(11,2)+(4,13)+(13,4)+(6,15)+(15,6)+(8,1)+(1,8)+(10,3)+(3,10)+(12,5)+(5,12)+(14,7)+(7,14)

10 type

(l,l′)=(0,10)+(10,0)+(1,11)+(11,1)+(4,14)+(14,4)+(5,15)+(15,5)+(8,2)+(2,8)+(9,3)+(3,9)+(12,6)+(6,12)+(13,7)+(7,13)

11 type

(l,l¹)=(0,11)+(11,0)+(2,13)+(13,2)+(4,15)+(15,4)+(6,1)+(1,6)+(8,3)+(3,8)+(10,5)+(5,10)+(12,7)+(7,12)+(14,9)+(9,14)

12 type

(l,l′)=(0,12)+(12,0)+(1,13)+(13,1)+(2,14)+(14,2)+(3,15)+(15,3)+(4,8)+(8,4)+(5,9)+(9,5)+(6,10)+(10,6)+(7,11)+(11,7)

13 type

(l,l′)=(0,13)+(13,0)+(2,15)+(15,2)+(4,1)+(1,4)+(6,3)+(3,6)+(8,5)+(5,8)+(10,7)+(7,10)+(12,9)+(9,12)+(14,11)+(11,14)

14 type

(l,l′)=(0,14)+(14,0)+(1,15)+(15,1)+(4,2)+(2,4)+(5,3)+(3,5)+(8,6)+(6,8)+(9,7)+(7,9)+(12,10)+(10,12)+(13,11)+(11,13)

15 type

(l,l′)=(0,15)+(15,0)+(2,1)+(1,2)+(4,3)+(3,4)+(6,5)+(5,6)+(8,7)+(7,8)+(10,9)+(9,10)+(12,11)+(11,12)+(14,13)+(13,14)

6-6. Calculation of temperature at subsystem

The procedure is similar to that in 4-6 of the sixth embodiment.

6-7. Calculation of free energy of subsystem

The procedure is similar to that in 4-7 of the sixth embodiment.

7. Preparation of low-order invariant of two-dimensional color distribution

Sometimes a symbol H, is used with respect to the invariant in order to distinguish the subsystems from each other.

7-1. Preparation of distribution function of low-order system

When the multiple resolution transform is performed using the wavelet transform in the second embodiment, the low-frequency component of the original image, namely, the image corresponding to the reduced image is generated by the series of LL components. Because the number of multiple resolution stages is separated to an extent in which the minimum resolution falls within the image range of about 40×30 to about 80×60, the LL component having about 320×240 pixels located in the resolution higher than the minimum resolution by about three stages is taken out as the color plane of the reduced image. The LL component is taken out with respect to each of the color planes H, V, and C, and the signal planes are expressed as H(x,y), V(x,y), and C(x,y). The hue plane used herein is the color plane in which the neutral separation is not performed. That is, the image is described only by all the values of the hue circle.

The image distribution of the color plane is considered as the rigid-body plane, and the two-dimensional distribution function is defined as follows in order to investigate the characteristic related to the spatial factor possessed by the rigid body.

Rigid-body distribution function

$${f}^{( H )} ( x , y ) = \frac{H ( x , y )}{\int \int H ( x , y ) d x d y} \\ {f}^{( V )} ( x , y ) = \frac{V ( x , y )}{\int \int V ( x , y ) d x d y} \\ {f}^{( C )} ( x , y ) = \frac{C ( x , y )}{\int \int C ( x , y ) d x d y} \qquad \{ Math . 147 \}$$

The two-dimensional system is based on the three distribution functions. However, the intersection distribution function between the color planes is exceptionally defined in order to calculate the intersection inertia tensor that intersectionally defines between the color planes.

$${f}^{( HV )} ( x , y ) = \frac{{f}^{( H )} ( x , y ) {f}^{( V )} ( x , y )}{\int \int {f}^{( H )} ( x , y ) {f}^{( V )} ( x , y ) d x d y} \\ {f}^{( V )} ( x , y ) = \frac{{f}^{( V )} ( x , y ) {f}^{( C )} ( x , y )}{\int \int {f}^{( V )} ( x , y ) {f}^{( C )} ( x , y ) d x d y} \\ {f}^{( C )} ( x , y ) = \frac{{f}^{( C )} ( x , y ) {f}^{( H )} ( x , y )}{\int \int {f}^{( C )} ( x , y ) {f}^{( H )} ( x , y ) d x d y} \qquad \{ Math . 148 \}$$

7-2. Calculation of entropy

The entropy S is calculated from the distribution function f(x,y) on the color plane. The distribution function having the value of 0 is excluded from the integration interval because the state of the value of 0 does not exist. When expressing the color planes of the distribution function differentiated by (α), the entropy is calculated from the distribution function of each of the color planes H, V, and C, and the sum of the entropies expresses the entropy of the subsystem projected to the low-order system of the two-dimensional color distribution.

S^{(α)}=−∫∫_{f}_{^{(α)}}_{(x,y)≠0}f^{(α)}(x,y)ln(f^{(α)}(x,y))dxdy

S=S^{(H)}+S^{(V)}+S^{(C)} {Math. 149}

The value is set to S_{Ho}.

7-3. Calculation of momentum element pₙ

First the characteristic related to the spatial shape factor of the rigid-body plane is investigated. That is, the centroid which is the first moment mean of the color planes and the inertia tensor expressing the second moment mean are obtained using the distribution function. The centroid expresses the spatial mean, and the inertia tensor is the index expressing the spatial spread. Although the H plane is described by way of example, the same holds true for the V plane and C plane.

$$Centroid of rigid body \\ 〈 {x}_{H} 〉 = \int \int {xf}^{( H )} ( x , y ) d x d y \\ 〈 {y}_{H} 〉 = \int \int {yf}^{( H )} ( x , y ) d x d y \\ Inertia tensor of rigid body \\ {I}_{ik}^{( H )} = ( \begin{matrix}{I}_{11}^{( H )} & {I}_{12}^{( H )} \\ {I}_{21}^{( H )} & {I}_{22}^{( H )}\end{matrix} ) \\ {I}_{11}^{( H )} = \int \int {( y - 〈 {y}_{H} 〉 )}^{2} {f}^{( H )} ( x , y ) d x d y \\ {I}_{12}^{( H )} = - \int \int ( x - 〈 {x}_{H} 〉 ) ( y - 〈 {y}_{H} 〉 ) {f}^{( H )} ( x , y ) d x d y \\ {I}_{21}^{( H )} = - \int \int ( y - 〈 {y}_{H} 〉 ) ( x - 〈 {x}_{H} 〉 ) {f}^{( H )} ( x , y ) d x d y \\ {I}_{22}^{( H )} = \int \int {( x - 〈 {x}_{H} 〉 )}^{2} {f}^{( H )} ( x , y ) d x d y \qquad \{ Math . 150 \}$$

The centroid and the inertia tensor are similarly obtained with respect to the intersection distribution between the two color planes. Although the intersection distribution between the H and V planes is described by way of example, the same holds true for the intersection distribution between the V and C planes and the intersection distribution between C and H planes.

$$Centroid of rigid body \\ 〈 {x}_{HV} 〉 = \int \int {xf}^{( HV )} ( x , y ) d x d y \\ 〈 {y}_{HV} 〉 = \int \int {yf}^{( HV )} ( x , y ) d x d y \\ Inertia tensor of rigid body \\ {I}_{ik}^{( HV )} = ( \begin{matrix}{I}_{11}^{( HV )} & {I}_{12}^{( HV )} \\ {I}_{21}^{( HV )} & {I}_{22}^{( HV )}\end{matrix} ) \\ {I}_{11}^{( HV )} = \int \int {( y - 〈 {y}_{HV} 〉 )}^{2} {f}^{( HV )} ( x , y ) d x d y \\ {I}_{12}^{( HV )} = - \int \int ( x - 〈 {x}_{HV} 〉 ) ( y - 〈 {y}_{HV} 〉 ) {f}^{( HV )} ( x , y ) d x d y \\ {I}_{21}^{( HV )} = - \int \int ( y - 〈 {y}_{HV} 〉 ) ( x - 〈 {x}_{HV} 〉 ) {f}^{( HV )} ( x , y ) d x d y \\ {I}_{22}^{( HV )} = \int \int {( x - 〈 {x}_{HV} 〉 )}^{2} {f}^{( HV )} ( x , y ) d x d y \qquad \{ Math . 151 \}$$

The coordinate axis and the coordinate scale can arbitrarily be decided. When the center of the image is defined as an origin while the length of the long side of the image is set to 1, conveniently the values of the centroid and inertia tensor fall within the range of [−1,1].

Then the characteristic related to the brightness factor of the image having the dimension of the velocity or momentum is investigated. The characteristic is investigated in each case when a mean change of the brightness level of the image is projected to the x-axis side and when the mean change is projected to the y-axis side. At this point, only the case of the H plane is shown by way of example.

It is assumed that H(x) is the image projected to the x-axis by performing the average operation in the y-axis direction, and that H(y) is the image projected to the y-axis by performing the average operation in the x-axis direction. A mean value <H> of the whole color plane is also calculated.

H(x)=∫H(x,y)dy/∫dy

H(y)=∫H(x,y)dx/∫dx {Math. 152}

The mean value of the whole image and the fluctuation width on the projection axis to x and y are obtained with respect to the brightness factor. With respect to the rigid-body system calculated as the spatial factor, the brightness mean value acts as the translation velocity of the centroid system, the brightness fluctuation component acts as the rotation angular velocity of the rigid body, and the brightness factors describe the factor related to the motion velocity of the rigid body while the rigid body moves.

[symbol]

H [symbol] =∫∫H(x,y)dxdy/∫∫dxdy

(σ₁^{(H)})²=∫(H(x)− [symbol] H [symbol] )²dx/∫dx

(σ₁^{(H)})²=∫(H(x)− [symbol] H [symbol] )²dx/∫dx {Math. 153}

An angular velocity vector Ω is defined as follows. Because the brightness fluctuation component is permitted to take both the positive and negative values, the four states exist as the angular velocity vector.

$${\vec{Ω}}^{( H )} = ( {Ω}_{1}^{( H )} , {Ω}_{2}^{( H )} ) = \{ \begin{matrix}( \pm {σ}_{1}^{( H )} , \pm {σ}_{2}^{( H )} ) \\ ( \pm {σ}_{1}^{( H )} , ∓ {σ}_{2}^{( H )} )\end{matrix} = \pm ( {σ}_{1}^{( H )} , \pm {σ}_{2}^{( H )} ) \qquad \{ Math . 154 \}$$

The momentum is defined as follows using the spatial factor in the resting state of the obtained rigid body and the brightness factor expressing the motion of the rigid body.

[symbol]

\vec{p}_{H} [symbol] = [symbol] H [symbol] ·( [symbol] x_{H} [symbol] , [symbol] y_{H} [symbol] )

[symbol]

\vec{p}_{V} [symbol] = [symbol] V [symbol] ·( [symbol] x_{V} [symbol] , [symbol] y_{V} [symbol] )

[symbol]

\vec{p}_{C} [symbol] = [symbol] C [symbol] ·( [symbol] x_{C} [symbol] , [symbol] y_{C} [symbol] ) {Math. 155}

These provide the vector components, and are separated into individual scalar quantities as the momentum element pₙ. Accordingly, there are six independent momentum elements.

The physical picture in which the brightness factor expresses the motion velocity is based on the following idea. Assuming that a certain image is presented on paper, although the characteristic of the image on the paper does not change in a dark lighting environment, the human eyes recognize nothing. When the lamp is lit, the impression of the image is jumped off to the human eyes with the velocity depending on the color brightness of the image, and an attention region of the color is jumped off to the human eyes in each color plane with the brightness centroid of the image as the center. However, the human eyes recognize the surroundings as the rigid-body motion having different velocities. For the V plane, it is considered that the higher luminance portion is jumped off to the human eyes at higher velocity. For the C plane, it is considered that the higher saturation portion is jumped off to the human eyes at higher velocity.

7-4. Calculation of angular momentum element Mₙ

The angular momentum is defined as follows using the spatial factor in the resting state of the rigid body and the brightness factor expressing the motion of the rigid body. Although the four states exist as the angular velocity vector, only the angular momentum vector providing the independent element is left. That is, the state in which the positive and negative signs are added to the whole angular momentum vector is not regarded as the independent state. The tensor symbol means that the sum of all ks is calculated and contracted when the ith vector element is obtained.

$$\begin{matrix}{\vec{M}}_{H} = {I}_{ik}^{( H )} {Ω}_{k}^{( H )} \\ = ( {I}_{11}^{( H )} {Ω}_{1}^{( H )} + {I}_{12}^{( H )} {Ω}_{2}^{( H )} , {I}_{21}^{( H )} {Ω}_{1}^{( H )} + {I}_{22}^{( H )} {Ω}_{2}^{( H )} ) \\ = ( {I}_{11}^{( H )} {σ}_{1}^{( H )} \pm {I}_{12}^{( H )} {σ}_{2}^{( H )} , {I}_{21}^{( H )} {σ}_{1}^{( H )} \pm {I}_{22}^{( H )} {σ}_{2}^{( H )} )\end{matrix} \\ \begin{matrix}{\vec{M}}_{V} = {I}_{ik}^{( V )} {Ω}_{k}^{( V )} \\ = ( {I}_{11}^{( V )} {Ω}_{1}^{( V )} + {I}_{12}^{( V )} {Ω}_{2}^{( V )} , {I}_{21}^{( V )} {Ω}_{1}^{( V )} + {I}_{22}^{( V )} {Ω}_{2}^{( V )} ) \\ = ( {I}_{11}^{( V )} {σ}_{1}^{( V )} \pm {I}_{12}^{( V )} {σ}_{2}^{( V )} , {I}_{21}^{( V )} {σ}_{1}^{( V )} \pm {I}_{22}^{( V )} {σ}_{2}^{( V )} )\end{matrix} \\ \begin{matrix}{\vec{M}}_{C} = {I}_{ik}^{( C )} {Ω}_{k}^{( C )} \\ = ( {I}_{11}^{( C )} {Ω}_{1}^{( C )} + {I}_{12}^{( C )} {Ω}_{2}^{( C )} , {I}_{21}^{( C )} {Ω}_{1}^{( C )} + {I}_{22}^{( C )} {Ω}_{2}^{( C )} ) \\ = ( {I}_{11}^{( C )} {σ}_{1}^{( C )} \pm {I}_{12}^{( C )} {σ}_{2}^{( C )} , {I}_{21}^{( C )} {σ}_{1}^{( C )} \pm {I}_{22}^{( C )} {σ}_{2}^{( C )} )\end{matrix} \qquad \{ Math . 156 \}$$

These provide the vector components, and are separated into individual scalar quantities as the angular momentum element Mₙ. Accordingly, there are 12 independent momentum elements.

7-5. Calculation of energy element Eₙ

The angular momentum is defined as follows using the spatial factor in the resting state of the rigid body and the brightness factor expressing the motion of the rigid body. Although the four states exist as the angular velocity vector, only the angular momentum vector providing the independent element is left.

$${〈 {\vec{p}}_{H} 〉}^{2} = {〈 H 〉}^{2} \cdot ( {〈 {x}_{H} 〉}^{2} + {〈 {y}_{H} 〉}^{2} ) \\ {〈 {\vec{p}}_{V} 〉}^{2} = {〈 V 〉}^{2} \cdot ( {〈 {x}_{V} 〉}^{2} + {〈 {y}_{V} 〉}^{2} ) \\ {〈 {\vec{p}}_{C} 〉}^{2} = {〈 C 〉}^{2} \cdot ( {〈 {x}_{C} 〉}^{2} + {〈 {y}_{C} 〉}^{2} ) \\ {〈 {\vec{p}}_{H} 〉}^{2} \cdot 〈 {\vec{p}}_{V} 〉 = 〈 H 〉 〈 V 〉 \cdot ( {〈 {x}_{HV} 〉}^{2} + {〈 {y}_{HV} 〉}^{2} ) \\ {〈 {\vec{p}}_{V} 〉}^{2} \cdot 〈 {\vec{p}}_{C} 〉 = 〈 V 〉 〈 C 〉 \cdot ( {〈 {x}_{VC} 〉}^{2} + {〈 {y}_{VC} 〉}^{2} ) \\ {〈 {\vec{p}}_{C} 〉}^{2} \cdot 〈 {\vec{p}}_{H} 〉 = 〈 C 〉 〈 H 〉 \cdot ( {〈 {x}_{CH} 〉}^{2} + {〈 {y}_{CH} 〉}^{2} ) \\ \begin{matrix}{σ}_{{\vec{p}}_{H}} \cdot {σ}_{{\dot{p}}_{H}} = {I}_{ik}^{( H )} {Ω}_{i}^{( H )} {Ω}_{k}^{( H )} \\ = {I}_{11}^{( H )} {Ω}_{1}^{( H )} {Ω}_{1}^{( H )} + {I}_{12}^{( H )} {Ω}_{1}^{( H )} {Ω}_{2}^{( H )} + {I}_{21}^{( H )} {Ω}_{2}^{( H )} {Ω}_{1}^{( H )} + {I}_{22}^{( H )} {Ω}_{2}^{( H )} {Ω}_{2}^{( H )} \\ = {I}_{11}^{( H )} {σ}_{1}^{( H )} {σ}_{1}^{( H )} \pm {I}_{12}^{( H )} {σ}_{1}^{( H )} {σ}_{2}^{( H )} \pm {I}_{21}^{( H )} {σ}_{2}^{( H )} {σ}_{1}^{( H )} \pm {I}_{22}^{( H )} {σ}_{2}^{( H )} {σ}_{2}^{( H )}\end{matrix} \\ The same holds true for {σ}_{\vec{P} V} \cdot {σ}_{\vec{P} V} \\ The same holds true for {σ}_{\vec{P} C} \cdot {σ}_{\vec{P} C} \\ \begin{matrix} {σ}_{{\vec{p}}_{H}} \cdot {σ}_{{\dot{p}}_{V}} = {I}_{ik}^{( HV )} {Ω}_{i}^{( H )} {Ω}_{k}^{( V )} \\ = {I}_{11}^{( HV )} {Ω}_{1}^{( H )} {Ω}_{1}^{( V )} + {I}_{12}^{( HV )} {Ω}_{1}^{( H )} {Ω}_{2}^{( V )} + {I}_{21}^{( HV )} {Ω}_{2}^{( H )} {Ω}_{1}^{( V )} \\ + {I}_{22}^{( HV )} {Ω}_{2}^{( H )} {Ω}_{2}^{( V )} \\ = \{ \begin{matrix}{I}_{11}^{( HV )} {σ}_{1}^{( H )} {σ}_{1}^{( V )} + {I}_{12}^{( HV )} {σ}_{1}^{( H )} {σ}_{2}^{( V )} + \\ {I}_{21}^{( HV )} {σ}_{2}^{( H )} {σ}_{1}^{( V )} + {I}_{22}^{( HV )} {σ}_{2}^{( H )} {σ}_{2}^{( V )} \\ {I}_{11}^{( HV )} {σ}_{1}^{( H )} {σ}_{1}^{( V )} + {I}_{12}^{( HV )} {σ}_{1}^{( H )} {σ}_{2}^{( V )} - \\ {I}_{21}^{( HV )} {σ}_{2}^{( H )} {σ}_{1}^{( V )} - {I}_{22}^{( HV )} {σ}_{2}^{( H )} {σ}_{2}^{( V )} \\ {I}_{11}^{( HV )} {σ}_{1}^{( H )} {σ}_{1}^{( V )} - {I}_{12}^{( HV )} {σ}_{1}^{( H )} {σ}_{2}^{( V )} + \\ {I}_{21}^{( HV )} {σ}_{2}^{( H )} {σ}_{1}^{( V )} - {I}_{22}^{( HV )} {σ}_{2}^{( H )} {σ}_{2}^{( V )} \\ {I}_{11}^{( HV )} {σ}_{1}^{( H )} {σ}_{1}^{( V )} - {I}_{12}^{( HV )} {σ}_{1}^{( H )} {σ}_{2}^{( V )} - \\ {I}_{21}^{( HV )} {σ}_{2}^{( H )} {σ}_{1}^{( V )} + {I}_{22}^{( HV )} {σ}_{2}^{( H )} {σ}_{2}^{( V )}\end{matrix}\end{matrix} \\ The same holds true for {σ}_{\vec{P} V} \cdot {σ}_{\vec{P} C} \\ The same holds true for {σ}_{\vec{P} C} \cdot {σ}_{\vec{P} H} \qquad \{ Math . 157 \}$$

The number of independent energy elements Eₙ becomes the total of 24 including the 6 independent energy elements Eₙ from the portion expressing the translation energy and the 18 independent energy elements Eₙ from the portion expressing the rotation energy.

In the term including the product of the (α) plane and the (β) plane, in which the double factors emerge as the number of states when the expansion is performed by deriving the model Hamiltonian in the opening of the eighth embodiment, the number of states is considered when the value is doubled with respect to the definitions.

That the physical quantities have the characteristic that becomes the invariant is correlated with the description of the characteristic of the image. For the landscape photograph, frequently mountains and the blue sky are spread in the horizontal direction. Therefore, in the inertia tensor of the spatial factor, I₂₂ expressing the spread in the x-axis direction tends to have the large value while I₁₁ expressing the spread in the y-axis direction tends to have the small value. On the other hand, the fluctuation width σ₂ in the direction projected to the y-axis tends to have the large value because there is the large difference of the signal between the blue sky and the mountain with respect to the fluctuation width of the brightness factor, and the fluctuation width σ₁ in the direction projected to the x-axis tends to have the small value because the fluctuation width σ₁ is constructed by the homogeneous image regions. Accordingly, in the landscape photograph, the combination of I₂₂ and σ₂ tends to have the large value, and the combination of Iₙ and σ₁ tends to have the small value. The tendency is described as the term of the rotation energy or the angular momentum element. In the person system, the combinations of I₂₂ and σ₂ and the combination of I₁₁ and σ₁ exert the different tendency of the values. Accordingly, the low-order invariant of the composition of the two-dimensional color distribution becomes the good features that distinguish the scenes.

7-6. Calculation of temperature at subsystem

The procedure is similar to that in 3-6 of the sixth embodiment.

7-7. Calculation of free energy of subsystem

The procedure is similar to that in 3-7 of the sixth embodiment.

The Boltzmann constant of the subsystem is measured by an inverse number of the statistical mean of any image of the entropy in the subsystem.

$${k}_{{H}_{a}} = \frac{1}{〈 {S}_{{H}_{a}} 〉}$$

The entropy used to define the free energy, free momentum, and free angular momentum is used to measure the number of states on the common phase space. Therefore, the entropy common to the free energy, free momentum, and free angular momentum is used commonly to the above definitions. Besides, intersection distribution function between the color planes, which exceptionally introduced to calculate the energy element, does not involve the entropy.

8. Preparation of high-order invariant of two-dimensional color distribution

Sometimes a symbol H is used with respect to the invariant in order to distinguish the subsystems from each other.

8-0. Hilbert space expression of distribution function of low-order system

The two-dimensional distribution function on each of the color planes H, V, and C is positioned as the distribution function of the color low-order system. This is the rigid-body distribution function obtained through the procedure 7-1. The distribution function of the low-order system can be interpreted as the coordinate space q that can be measured in the original coordinate system. The distribution function of the low-order system is transformed using the associated Legendre function to perform the frequency expression, and projected to the momentum space p. This is the equivalent expression in which the original distribution function is viewed from another aspect. The base function of the complete orthogonal system that constitutes the Hilbert space is selected such that the expressing is performed as compact as possible in consideration of the characteristic of the distribution function of the low-order system. However, because of the uncertainty principle of the coordinate space and momentum space of

ΔpΔq≧ [symbol] , {Math. 159}

one of the coordinate space and the momentum space is expressed compact while the other is expressed broad. Therefore, the function system is suitably selected such that the uncertainty becomes the minimum.

In the eighth embodiment, not the associated Legendre function providing the double series expansion but the Legendre function dealing only with the minimum degree (magnetic quantum number m=0) to provide the single series expansion will be described for the sake of convenience. The associated Legendre function is described in a ninth embodiment while extended.

8-0-1. Variable transform

Assuming that [xa,xb] is the coordinate range of the x-axis of the two-dimensional distribution function, that [ya,yb] is the coordinate range of the y-axis, and that [fa,fb] is the range of the value (assumed to be the z-axis) of the distribution function, the variable transform is performed within the intervals of [−1,1] of the x-axis, [−1,1] of the y-axis, and [−1,1] of the z-axis. In this section, for the sake of convenience, the variable of the x-axis is transformed from X into x, the variable of the y-axis is transformed from Y into y, and the variable of the z-axis is transformed from fZ to fz. Therefore, the transform equation is expressed as follows.

Variable transform of x-axis:x={X−(xb+xa)/2}/{(xb−xa)/2}

Variable transform of y-axis:y={Y−(yb+ya)/2}/{(yb−ya)/2}

Variable transform of z-axis:fz={fZ−(fb+fa)/2}/{(fb−fa)/2}

8-0-2. Series expansion with Legendre function

The two-dimensional distribution function on each of the color planes H, V, and C is equivalently expressed by performing the expansion using the Legendre function with respect to the N×N coefficients.

$${f}^{( α )} ( x , y ) = {{\sum }^{N - 1}}_{l = 0} {\sum }_{{l}^{′} = 0}^{N - 1} {c}_{{ll}^{′}}^{I ( α )} {P}_{l} ( y ) {P}_{{l}^{′}} ( x ) \\ ( α ) = H , V , {C}_{∘} \qquad \{ Math . 160 \}$$

The expansion coefficient c_{11′} is obtained as follows using the orthogonality of the base function. That is, the image is prepared by obtaining the expansion coefficient in which the two-dimensional distribution function is orthogonally transformed in each row with respect to the one-dimensional direction, the similar transform is repeated in each column of the one-dimensional direction orthogonal to the plane, and the obtained plane becomes the two-dimensional expansion coefficient plane c_{11′}. The expansion of the one-dimensional direction is performed in each row and each column using the following relational expression.

$$f ( x ) = {\sum }_{l = 0}^{N - 1} {c}_{l} {P}_{l} ( x ) \\ {c}_{l} = \frac{2 l + 1}{2} {\int }_{- 1}^{1} f ( x ) {P}_{l} ( x ) d x \qquad \{ Math . 161 \}$$

All the values of the expansion coefficients fall within the range of [−1,1] by the variable transform. The number of expansion coefficients may be set to N=about 50 when the image on the color plane has the number of pixels of about 360×about 240. The expansion coefficients form the square matrix because the numbers of expansions of the x-axis and y-axis are set to the identical number.

8-1. Preparation of distribution function of high-order system

A power spectrum of the coefficient to which the Legendre expansion is performed is defined as the distribution function of the high-order system related to the composition color. The distribution function of the high-order system can be defined with respect to the three H, V, and C planes. The normalization is performed such that the probability density is expressed.

$${f}^{( α )} ( l , {l}^{′} ) = \frac{{( {c}_{{ll}^{′}}^{( α )} )}^{2}}{{\sum }_{l , {l}^{′}} {( {c}_{{ll}^{′}}^{( α )} )}^{2}} ( α ) = H , V , {C}_{∘} \qquad \{ Math . 162 \}$$

8-2. Calculation of entropy

The entropy S is calculated from the distribution function f(1,1′). When expressing the color planes of the distribution function differentiated by (α), the entropy is calculated from the distribution function of each of the color planes H, V, and C, and the sum of the entropies expresses the entropy of the subsystem projected to the high-order system of the two-dimensional color distribution.

S^{(α)}=−∫∫_{f}_{^{(α)}}_{(l,l)≠0}f^{(α)}(l,l)ln(f^{(α)}(l,l))dldl′

S=S^{(H)}+S^{(V)}+S^{(C)} {Math. 163}

The value is set to S_{H}.

8-3. Calculation of momentum element pₙ

The expansion coefficient of the Legendre function can be considered to be the momentum in the Hilbert space. Accordingly, the momentum element pₙ is the expansion coefficient of

c_{ll′}^{(α)}. {Math. 164}

Assuming that [ ] expresses the array, the number of momentum elements becomes [the number of α plane] [the number of l][the number of l′]=3×50×50. The number of momentum elements is collectively expressed by pₙ in order.

8-4. Calculation of angular momentum element Mₙ

The diagonal component of the expansion coefficient provides the characteristic of the centrally symmetric shape. Because the azimuthal quantum numbers 1 and l′ of the Legendre function define the Hilbert space coordinate, angular momentum M=r×p is defined as the product of the Hilbert space coordinate and the momentum.

$${M}^{( α )} = {\sum }_{l , {l}^{′}} {δ}_{l , {l}^{′}} , {lc}_{{ll}^{′}}^{( α )} = {\sum }_{l} {lc}_{ll}^{( α )} \\ ( α ) = H , V , {C}_{∘} \qquad \{ Math . 165 \}$$

The Legendre function has the next axial invertibility.

Pₗ(−x)=(−1)^{l}Pₗ(x)

Although the four cases exist as the axial inversion, only (α)(x,y) and (α′)(x,−y) provide the independent element. (α″)(−x,y) describes the state identical to (α′)(x,−y), and (α′″)(−x,−y) describes the state identical to (α)(x,y). The other independent element in which the y-axis is inverted is written by the following equation.

$${M}^{( {α}^{′} )} = {\sum }_{l} {( - 1 )}^{l} {lc}_{ll}^{( α )} \\ ( α ) = H , V , {C}_{∘} \qquad \{ Math . 166 \}$$

Assuming that [ ] expresses the array, the number of angular momentum elements becomes [the number of α planes][the number of pieces of axial invertibility]=3×2. The number of angular momentum elements is collectively expressed by Mₙ in order.

8-5. Calculation of energy element Eₙ

It is assumed that the one-dimensional array in which the two-dimensional expansion coefficient of

c_{ll′}^{(α)}{Math. 167}

is rearranged in the 12 directions is schematically expressed by

c_{ll′}^{(α)}(\vec{k}ᵢ^{(α)}). {Math. 168}

The vector k expresses the starting point and direction of the rearrangement, the coefficients are sequentially rearranged from the defined starting point positions of the rearrangement, and the ith expansion coefficient of the expansion coefficients of 0 to N×N−1 is expressed by i. The ith expansion coefficient cᵢ on the (α) plane and the jth expansion coefficient cⱼ on the (β) plane are exchanged to produce the symmetric product and the antisymmetric product, and the element value of the energy level Eₙ is produced by calculating the sum of all the expansion coefficients between the expansion coefficients having a given quantum number difference of j−i=n.

$${E}_{n = j - i}^{( α ) ( β ) \pm } ( {\vec{k}}_{i}^{( α )} \cdot {\vec{k}}_{j}^{( β )} ) = \frac{\frac{1}{2} {\sum }_{j - i = n , i = 0}^{N \times N - 1} \{ {c}_{{ll}^{′}}^{( α )} ( {\vec{k}}_{i}^{( α )} ) {c}_{{ll}^{′}}^{( β )} ( {\vec{k}}_{j}^{( β )} ) \pm {c}_{{ll}^{′}}^{( α )} ( {\vec{k}}_{j}^{( α )} ) {c}_{{ll}^{′}}^{( β )} ( {\vec{k}}_{i}^{( β )} ) \}}{\sqrt{{\sum }_{l , {l}^{′}} {( {c}_{{ll}^{′}}^{( α )} )}^{2}} \sqrt{{\sum }_{l , {l}^{′}} {( {c}_{{ll}^{′}}^{( β )} )}^{2}}} \qquad \{ Math . 169 \}$$

When the value of cⱼ is overflown from the definition regions of 0 to N×N−1 like c_{N×N-1+i}, if the head and tail of the one-dimensional expansion coefficient are connected to form a ring, and the definition is performed again by returning to the initial point. That is, c_{N×N-1+i}=cᵢ is obtained.

Because the number of energy levels n investigates only the characteristic on the line of the two-dimensional expansion coefficient, the energy levels n are used with respect to the quantum number differences of n=0, 1, . . . , N−1.

Eₙ₌ⱼ₋ᵢ^{(α)(β)±}(\vec{k}ᵢ^{(α)}·\vec{k}ⱼ^{(β)}) {Math. 170}

describes the energy dispersion relationship among the combinations of 12×12 ways, namely, the relational expression indicating what energy value is taken on the point k at the point n=j−i on the k-space expressing the combination of ki and kj.

In combinations of 12 ways in which the combinations in the 12×12 directions become the identical direction with respect to the definition of the symmetric product of the (α) plane and the (α) plane, because the numerator and the denominator become the identical value only at the point of n=j−i=0, only the numerator is exceptionally defined. That is,

$${E}_{n = 0}^{( α ) ( α ) +} ( {\vert {\vec{k}}_{0}^{( α )} \vert}^{2} ) = {\sum }_{l , {l}^{′}} {( {c}_{{ll}^{′}}^{( α )} )}^{2} - {ɛ}_{0} \qquad \{ Math . 171 \}$$

is obtained.

Although the offset of zero-point energy is included, actually an autocorrelation value may directly be used without performing the offset correction in the sense that the number of states is directly described even if the value exceeds 1. The similar idea can also be applied to the energy prepared from the Chebyshev expansion coefficient or the spherical Bessel expansion coefficient.

As to the axial invertibility, the expansion coefficients are rearranged as follows with respect to the four states of each of the α plane and the β plane, so that the energy dispersion relationships of 4×4 times can independently be defined in the energy dispersion relationship of the above definition.

$$\begin{matrix} ( α ) ( x , y ) & {c}_{{ll}^{′ }}^{( α )} \\ ( α ) ( x , - y ) = ( {α}^{′} ) ( x , y ) & {( - 1 )}^{l} {c}_{{ll}^{′}}^{( α )} \\ ( α ) ( - x , y ) = ( {α}^{″} ) ( x , y ) & {( - 1 )}^{{l}^{′}} {c}_{{ll}^{′}}^{( α )} \\ ( α ) ( - x , - y ) = ( {α}^{′′′} ) ( x , y ) & {( - 1 )}^{l + {l}^{′}} {c}_{{ll}^{′}}^{( α )} \\ ( β ) ( x , y ) & {c}_{{ll}^{′}}^{( β )} \\ ( β ) ( x , - y ) = ( {β}^{′} ) ( x , y ) & {( - 1 )}^{l} {c}_{{ll}^{′}}^{( β )} \\ ( β ) ( - x , y ) = ( {β}^{″} ) ( x , y ) & {( - 1 )}^{l} {c}_{{ll}^{′}}^{( β )} \\ ( β ) ( - x , - y ) = ( {β}^{′′′} ) ( x , y ) & {( - 1 )}^{l + {l}^{′}} {c}_{{ll}^{′}}^{( β )}\end{matrix} \qquad \{ Math . 172 \}$$

Assuming that [ ] expresses the array, the number of energy elements becomes [the number of combinations of α planes and β planes][the number of pieces of α-plane axial invertibility][the number of pieces of β-plane axial invertibility][the number of rearrangement ways of α planes][the number of rearrangement ways of β planes][type of symmetric product or antisymmetric product][the number of energy levels]=6×4×4×12×2×50. The number of energy elements is collectively expressed by Eₙ in order.

The six ways HH, VV, CC, HV, VC, and CH exist as the combination of the α plane and the β plane. Because the combinations HV, VC, CH are common to the combinations VH, CV, and HC, the combinations HV, VC, CH are not the independent element. However, because the (α)(β) exists double (α)(α) as the number of states, the energy value is doubled later with respect to the defined value.

The energy elements may directly be used. However, sometimes the contracted energy dispersion relationship is practical. The method for contracting the energy dispersion relationship will be described below.

Eₙ₌ⱼ₋ᵢ^{(α)(β)±}(\vec{k}ᵢ^{(α)}·\vec{k}ⱼ^{(β)}) {Math. 173}

derives the energy dispersion relationship among the combinations of 12×12 ways, and the mean energy dispersion relationship between the identical energy levels Eₙ is obtained with respect to the direction combinations. When the operation is performed, the mean energy dispersion relationship of the antisymmetric product always becomes zero. Accordingly, only the energy dispersion relationship on the symmetric product side is left.

[symbol]

Eₙ₌ⱼ₋ᵢ^{(α)(β)+}(\vec{k}ᵢ^{(α)}·\vec{k}ⱼ^{(β)}) [symbol] _{12×12}≠0

[symbol]

Eₙ₌ⱼ₋ᵢ^{(α)(β)-}(\vec{k}ᵢ^{(α)}·\vec{k}ⱼ^{(β)}) [symbol] _{12×12}=0 {Math. 174}

Therefore, the number of energy elements becomes [the number of combinations of α planes and β planes][the number of pieces of α-plane axial invertibility][the number of pieces of β-plane axial invertibility][the number of energy levels]=6×4×4×50. The number of energy elements is collectively expressed by Eₙ in order.

By way of example, which image can be distinguished is investigated by image alignment with respect to the energy element near the energy level n=0 of the symmetric product of the VV planes. The classification ability is exerted such that the photographic images of structure systems such as a temple and a shrine are easily collected in some images, and such that the photographic images of natural landscapes such as a lake are easily collected in other images. The axial inversion provides the ability to sort the images having the different characteristics.

8-6. Calculation of temperature at subsystem

The procedure is similar to that in 4-6 of the sixth embodiment.

8-7. Calculation of free energy of subsystem

The procedure is similar to that in 4-7 of the sixth embodiment.

The Boltzmann constant of the subsystem is measured by the inverse number of the statistical mean of any image of the entropy in the subsystem.

$${k}_{H} = \frac{1}{〈 {S}_{H} 〉} \qquad \{ Math . 175 \}$$

9. Preparation of low-order invariant of two-dimensional edge distribution

Sometimes a symbol Iₒ is used with respect to the invariant in order to distinguish the subsystems from each other.

9-1. Preparation of distribution function of low-order system

In the second embodiment, the high-frequency subband of the multiple resolution is produced using the wavelet transform, and the inverse wavelet transform is performed only to the high-frequency subband with the minimum resolution to combine the edges. Because the number of multiple resolution stages is separated to the extent in which the minimum resolution falls within the image range of about 40×30 to about 80×60, the combined edge image having the 320×240 pixels located in the resolution higher than the minimum resolution by about three stages is taken out as the edge plane. The combined edge image is taken out with respect to each of the color planes H, V, and C, and the signal planes are expressed as ΔH(x,y), ΔV(x,y), and ΔC(x,y). The hue plane used herein is the color plane in which the neutral separation is not performed.

Because the images on the edge planes have the positive and negative values, the images are not called the distribution function. The value in which the edge plane is raised to the second power is defined as the two-dimensional distribution function of the edge plane, and the distribution is considered as the rigid-body plane and used to investigate the characteristic related to the spatial factor possessed by the rigid body. The rigid body plane is a skelton image having the intensity only on an outline unlike the two-dimensional color distribution.

$$Distribution function of rigid body \\ {f}^{( H )} ( x , y ) = \frac{{[ Δ H ( x , y ) ]}^{2}}{\int \int {[ Δ H ( x , y ) ]}^{2} d x d y} \\ {f}^{( H )} ( x , y ) = \frac{{[ Δ H ( x , y ) ]}^{2}}{\int \int {[ Δ H ( x , y ) ]}^{2} d x d y} \\ {f}^{( C )} ( x , y ) = \frac{{[ Δ C ( x , y ) ]}^{2}}{\int \int {[ Δ C ( x , y ) ]}^{2} d x d y} \qquad \{ Math . 176 \}$$

The intersection distribution functions f^{(Hv)}(x,y), f^{(VC)}(x,y), and f^{(CH)}(x,y) between the color planes are defined similarly to the procedure 7-1.

9-2. Calculation of entropy

The entropy S is calculated from the distribution function f(x,y) on the edge plane. The distribution function having the value of 0 is excluded from the integration interval because the state of the value of 0 does not exist. When expressing the color planes of the distribution function on the edge plane differentiated by (α), the entropy is calculated from the distribution function of each of the color planes H, V, and C, and the sum of the entropies expresses the entropy of the subsystem projected to the low-order system of the two-dimensional edge distribution.

S^{(α)}=−∫∫_{f}_{^{(α)}}_{(x,y)≠0}f^{(α)}(x,y)ln(f^{(α)}(x,y))dxdy

S=S^{(H)}+S^{(V)}+S^{(C)} {Math. 177}

The value is set to S_{Io}.

9-3. Calculation of momentum element pₙ

The spatial shape factor is calculated using the plane in which the combined edge plane is raised to the second power, and the brightness factor is calculated using the value of the combined edge plane. The positive and negative values have the meaning for the brightness factor. The recognition, in which the region having the positive edge intensity is jumped off to the eyes at the positive velocity while the region having the negative edge intensity is retreated in the opposite direction at the negative velocity, is matched with the perceptual description.

Although the centroid of the spatial shape provides the attention region as the edge plane, the attention region differs from the centroid of the color plane. The color differs from the edge in which region it pays attention to.

The corresponding equations are listed for the edge plane. The calculation is continuously performed to the procedure 9-5.

Spatial Shape Factor

Description of centroid and inertia tensor related to distribution in one color plane

$$Centroid of rigid body \\ 〈 {x}_{{( Δ H )}^{2}} 〉 = \int \int {xf}^{( H )} ( x , y ) d x d y \\ 〈 {y}_{{( Δ H )}^{2}} 〉 = \int \int {yf}^{( H )} ( x , y ) d x d y \\ Inertia tensor of rigid body \\ {I}_{ik}^{( H )} = ( \begin{matrix}{I}_{11}^{( H )} & {I}_{12}^{( H )} \\ {I}_{21}^{( H )} & {I}_{22}^{( H )}\end{matrix} ) \\ {I}_{11}^{( H )} = \int \int {( y - 〈 {y}_{{( Δ H )}^{2}} 〉 )}^{2} {f}^{( H )} ( x , y ) d x d y \\ {I}_{12}^{( H )} = - \int \int ( x - 〈 {x}_{{( Δ H )}^{2}} 〉 ) ( y - 〈 {y}_{{( Δ H )}^{2}} 〉 ) {f}^{( H )} ( x , y ) d x d y \\ {I}_{21}^{( H )} = - \int \int ( y - 〈 {y}_{{( Δ H )}^{2}} 〉 ) ( x - 〈 {x}_{{( Δ H )}^{2}} 〉 ) {f}^{( H )} ( x , y ) d x d y \\ {I}_{22}^{( H )} = \int \int {( x - 〈 {x}_{{( Δ H )}^{2}} 〉 )}^{2} {f}^{( H )} ( x , y ) d x d y \qquad \{ Math . 178 \}$$

Description of Centroid and Inertia Tensor Related to Intersection Distribution Between Two Color Planes

$$Centroid of ridid body \\ 〈 {x}_{{( Δ H )}^{2} {( Δ V )}^{2}} 〉 = \int \int {xf}^{( HV )} ( x , y ) d x d y \\ 〈 {y}_{{( Δ H )}^{2} {( Δ V )}^{2}} 〉 = \int \int {yf}^{( HV )} ( x , y ) d x d y \\ Inertia tensor of rigid body \\ {I}_{ik}^{( HV )} = ( \begin{matrix}{I}_{11}^{( HV )} & {I}_{12}^{( HV )} \\ {I}_{21}^{( HV )} & {I}_{22}^{( HV )}\end{matrix} ) \\ {I}_{11}^{( HV )} = \int \int {( y - 〈 {y}_{{( Δ H )}^{2} {( Δ V )}^{2}} 〉 )}^{2} {f}^{( HV )} ( x , y ) d x d y \\ {I}_{12}^{( HV )} = - \int \int ( x - 〈 {x}_{{( Δ H )}^{2} {( Δ V )}^{2}} 〉 ) ( y - 〈 {y}_{{( Δ H )}^{2} {( Δ V )}^{2}} 〉 ) {f}^{( HV )} ( x , y ) d x d y \\ {I}_{21}^{( HV )} = - \int \int ( y - 〈 {y}_{{( Δ H )}^{2} {( Δ V )}^{2}} 〉 ) ( x - 〈 {x}_{{( Δ H )}^{2} {( Δ V )}^{2}} 〉 ) {f}^{( HV )} ( x , y ) d x d y \\ {I}_{22}^{( HV )} = \int \int {( x - 〈 {x}_{{( Δ H )}^{2} {( Δ V )}^{2}} 〉 )}^{2} {f}^{( HV )} ( x , y ) d x d y \qquad \{ Math . 179 \}$$

Brightness Factor

It is assumed that ΔH(x) is the image projected to the x-axis by performing the average operation in the y-axis direction, and that ΔH(y) is the image projected to the y-axis by performing the average operation in the x-axis direction. The mean value <ΔH> of the whole ΔH plane is also calculated.

$$[ Δ H ] ( x ) = \int Δ H ( x , y ) d y / \int d y \\ [ Δ H ] ( y ) = \int Δ H ( x , y ) d x / \int d x \\ 〈 Δ H 〉 = \int \int Δ H ( x , y ) d x d y / \int \int d x d {y \\ ( {σ}_{1}^{( H )} )}^{2} = \int {( [ Δ H ] ( x ) - 〈 Δ H 〉 )}^{2} d x / \int d {x \\ ( {σ}_{2}^{( H )} )}^{2} = \int {( [ Δ H ] ( y ) - 〈 Δ H 〉 )}^{2} d y / \int d y \\ Angular velocity vector Ω \\ {\vec{Ω}}^{( H )} = ( {Ω}_{1}^{( H )} , {Ω}_{2}^{( H )} ) = \{ \begin{matrix}( \pm {σ}_{1}^{( H )} , \pm {σ}_{2}^{( H )} ) \\ ( \pm {σ}_{1}^{( H )} , ∓ {σ}_{2}^{( H )} )\end{matrix} = \pm ( {σ}_{1}^{( H )} , \pm {σ}_{2}^{( H )} ) \qquad \{ Math . 180 \}$$

Calculation of Momentum Element

[symbol]

\vec{p}_{ΔH} [symbol] = [symbol] ΔH [symbol] ·( [symbol] x_{(ΔH)}_{²} [symbol] , [symbol] y_{(ΔH)}_{²} [symbol] )

[symbol]

\vec{p}_{ΔV} [symbol] = [symbol] ΔV [symbol] ·( [symbol] x_{(ΔV)}_{²} [symbol] , [symbol] y_{(ΔV)}_{²} [symbol] )

[symbol]

\vec{p}_{ΔC} [symbol] = [symbol] ΔC [symbol] ·( [symbol] x_{(ΔC)}_{²} [symbol] , [symbol] y_{(ΔC)}_{²} [symbol] ) {Math. 181}

9-4. Calculation of angular momentum element Mₙ

$$\begin{matrix}\begin{matrix}{\vec{M}}_{H} = {I}_{ik}^{( H )} {Ω}_{k}^{( H )} \\ = ( {I}_{11}^{( H )} {Ω}_{1}^{( H )} + {I}_{12}^{( H )} {Ω}_{2}^{( H )} , {I}_{21}^{( H )} {Ω}_{1}^{( H )} + {I}_{22}^{( H )} {Ω}_{2}^{( H )} ) \\ = ( {I}_{11}^{( H )} {σ}_{1}^{( H )} \pm {I}_{12}^{( H )} {σ}_{2}^{( H )} , {I}_{21}^{( H )} {σ}_{1}^{( H )} \pm {I}_{22}^{( H )} {σ}_{2}^{( H )} )\end{matrix} & \{ Math . 182 \} \\ \begin{matrix}{\vec{M}}_{V} = {I}_{ik}^{( V )} {Ω}_{k}^{( V )} \\ = ( {I}_{11}^{( V )} {Ω}_{1}^{( V )} + {I}_{12}^{( V )} {Ω}_{2}^{( V )} , {I}_{21}^{( V )} {Ω}_{1}^{( V )} + {I}_{22}^{( V )} {Ω}_{2}^{( V )} ) \\ = ( {I}_{11}^{( V )} {σ}_{1}^{( V )} \pm {I}_{12}^{( V )} {σ}_{2}^{( V )} , {I}_{21}^{( V )} {σ}_{1}^{( V )} \pm {I}_{22}^{( V )} {σ}_{2}^{( V )} )\end{matrix} & \\ \begin{matrix}{\vec{M}}_{C } = {I}_{ik}^{( C )} {Ω}_{k}^{( C )} \\ = ( {I}_{11}^{( C )} {Ω}_{1}^{( C )} + {I}_{12}^{( C )} {Ω}_{2}^{( C )} , {I}_{21}^{( C )} {Ω}_{1}^{( C )} + {I}_{22}^{( C )} {Ω}_{2}^{( C )} ) \\ = ( {I}_{11}^{( C )} {σ}_{1}^{( C )} \pm {I}_{12}^{( C )} {σ}_{2}^{( C )} , {I}_{21}^{( C )} {σ}_{1}^{( C )} \pm {I}_{22}^{( C )} {σ}_{2}^{( C )} )\end{matrix} & \end{matrix}$$

9-5. Calculation of energy element Eₙ

$$\begin{matrix} {〈 {\vec{p}}_{Δ H} 〉}^{2} = {〈 Δ H 〉}^{2} \cdot ( {〈 {x}_{( Δ H )} 〉}^{2} + {〈 {y}_{{( Δ H )}^{2}} 〉}^{2} ) \\ {〈 {\vec{p}}_{Δ V} 〉}^{2} = {〈 Δ V 〉}^{2} \cdot ( {〈 {x}_{( Δ V )} 〉}^{2} + {〈 {y}_{{( Δ V )}^{2}} 〉}^{2} ) \\ {〈 {\vec{p}}_{Δ C} 〉}^{2} = {〈 Δ C 〉}^{2} \cdot ( {〈 {x}_{{( Δ C )}^{2}} 〉}^{2} + {〈 {y}_{{( Δ C )}^{2}} 〉}^{2} ) & \{ Math . 183 \} \\ 〈 {\vec{p}}_{Δ H} 〉 \cdot 〈 {\vec{p}}_{Δ V} 〉 = 〈 Δ H 〉 〈 Δ V 〉 \cdot ( {〈 {x}_{{( Δ H )}^{2} {( Δ V )}^{2}} 〉}^{2} + {〈 {y}_{{( Δ H )}^{2} {( Δ V )}^{2}} 〉}^{2} ) \\ 〈 {\vec{p}}_{Δ V} 〉 \cdot 〈 {\vec{p}}_{Δ C} 〉 = 〈 Δ V 〉 〈 Δ C 〉 \cdot ( {〈 {x}_{{( Δ V )}^{2} {( Δ C )}^{2}} 〉}^{2} + {〈 {y}_{{( Δ V )}^{2} {( Δ C )}^{2}} 〉}^{2} ) \\ 〈 {\vec{p}}_{Δ C} 〉 \cdot 〈 {\vec{p}}_{Δ H} 〉 = 〈 Δ C 〉 〈 Δ H 〉 \cdot ( {〈 {x}_{{( Δ C )}^{2} {( Δ H )}^{2}} 〉}^{2} + {〈 {y}_{{( Δ C )}^{2} {( Δ H )}^{2}} 〉}^{2} ) & \\ \begin{matrix}{σ}_{{\vec{p}}_{Δ H}} \cdot {σ}_{{\vec{p}}_{Δ H}} = {I}_{ik}^{( H )} {Ω}_{i}^{( H )} {Ω}_{k}^{( H )} \\ = {I}_{11}^{( H )} {Ω}_{1}^{( H )} {Ω}_{1}^{( H )} + {I}_{12}^{( H )} {Ω}_{1}^{( H )} {Ω}_{2}^{( H )} + \\ {I}_{21}^{( H )} {Ω}_{2}^{( H )} {Ω}_{1}^{( H )} + {I}_{22}^{( H )} {Ω}_{2}^{( H )} {Ω}_{2}^{( H )} \\ = {I}_{11}^{( H )} {σ}_{1}^{( H )} {σ}_{1}^{( H )} \pm {I}_{12}^{( H )} {σ}_{1}^{( H )} {σ}_{2}^{( H )} \pm \\ {I}_{21}^{( H )} {σ}_{2}^{( H )} {σ}_{1}^{( H )} + {I}_{22}^{( H )} {σ}_{2}^{( H )} {σ}_{2}^{( H )}\end{matrix} & \\ The same holds true for {σ}_{\vec{P} Δ V} \cdot {σ}_{\vec{P} Δ V} \\ The same holds true for {σ}_{\vec{P} Δ C} \cdot {σ}_{\vec{P} Δ C} & \\ \begin{matrix} {σ}_{{\vec{p}}_{Δ H}} \cdot {σ}_{{\vec{p}}_{Δ V}} = {I}_{ik}^{( HV )} {Ω}_{i}^{( H )} {Ω}_{k}^{( V )} \\ = {I}_{11}^{( HV )} {Ω}_{1}^{( H )} {Ω}_{1}^{( V )} + {I}_{12}^{( H )} {Ω}_{1}^{( H )} {Ω}_{2}^{( V )} + \\ {I}_{21}^{( HV )} {Ω}_{2}^{( H )} {Ω}_{1}^{( V )} + {I}_{22}^{( H )} {Ω}_{2}^{( H )} {Ω}_{2}^{( V )} \\ = \{ \begin{matrix}{I}_{11}^{( HV )} {σ}_{1}^{( H )} {σ}_{1}^{( V )} + {I}_{12}^{( H )} {σ}_{1}^{( H )} {σ}_{2}^{( V )} + \\ {I}_{21}^{( HV )} {σ}_{2}^{( H )} {σ}_{1}^{( V )} + {I}_{22}^{( H )} {σ}_{2}^{( H )} {σ}_{2}^{( V )} \\ {I}_{11}^{( HV )} {σ}_{1}^{( H )} {σ}_{1}^{( V )} + {I}_{12}^{( H )} {σ}_{1}^{( H )} {σ}_{2}^{( V )} - \\ {I}_{21}^{( HV )} {σ}_{2}^{( H )} {σ}_{1}^{( V )} - {I}_{22}^{( H )} {σ}_{2}^{( H )} {σ}_{2}^{( V )} \\ {I}_{11}^{( HV )} {σ}_{1}^{( H )} {σ}_{1}^{( V )} - {I}_{12}^{( H )} {σ}_{1}^{( H )} {σ}_{2}^{( V )} + \\ {I}_{21}^{( HV )} {σ}_{2}^{( H )} {σ}_{1}^{( V )} - {I}_{22}^{( H )} {σ}_{2}^{( H )} {σ}_{2}^{( V )} \\ {I}_{11}^{( HV )} {σ}_{1}^{( H )} {σ}_{1}^{( V )} - {I}_{12}^{( H )} {σ}_{1}^{( H )} {σ}_{2}^{( V )} - \\ {I}_{21}^{( HV )} {σ}_{2}^{( H )} {σ}_{1}^{( V )} + {I}_{22}^{( H )} {σ}_{2}^{( H )} {σ}_{2}^{( V )}\end{matrix}\end{matrix} & \\ The same holds true for {σ}_{\vec{P} Δ V} \cdot {σ}_{\vec{P} Δ C} \\ The same holds true for {σ}_{\vec{P} Δ C} \cdot {σ}_{\vec{P} Δ H} & \end{matrix}$$

9-6. Calculation of temperature at subsystem

The procedure is similar to that in 5 of the sixth embodiment.

9-7. Calculation of free energy of subsystem

The procedure is similar to that in 5 of the sixth embodiment.

The Boltzmann constant of the subsystem is measured by the inverse number of the statistical mean of any image of the entropy in the subsystem.

$${k}_{{I}_{o}} = \frac{1}{〈 {S}_{{I}_{o}} 〉} \qquad \{ Math . 184 \}$$

10. Preparation of high-order invariant of two-dimensional edge distribution

Sometimes a symbol I is used with respect to the invariant in order to distinguish the subsystems from each other.

10-0. Hilbert space expression of distribution function of low-order system

The two-dimensional distribution function of the edge plane on each of the planes H, V, and C is positioned as the distribution function of the edge low-order system. This is the rigid-body distribution function obtained through the procedure 9-1. The distribution function of the low-order system can be interpreted as the coordinate space q that can be measured in the original coordinate system. The distribution function of the low-order system is transformed using the Fourier function to perform the frequency expression, and projected to the momentum space p. This is the equivalent expression in which the original distribution function is viewed from another aspect. The base function of the complete orthogonal system that constitutes the Hilbert space is selected such that the expressing is performed as compact as possible in consideration of the characteristic of the distribution function of the low-order system. However, because of the uncertainty principle of the coordinate space and momentum space of

ΔpΔq≧ [symbol] , {Math. 185}

one of the coordinate space and the momentum space is expressed compact while the other is expressed broad. Therefore, the function system is suitably selected such that the uncertainty becomes the minimum.

10-0-1. Variable transform

Assuming that [xa,xb] is the coordinate range of the x-axis of the two-dimensional distribution function, that [ya,yb] is the coordinate range of the y-axis, and that [fa,fb] is the range of the value (assumed to be the z-axis) of the distribution function, the variable transform is performed within the intervals of [−π, π] of the x-axis, [−π, π] of the y-axis, and [0,1] of the z-axis. In this section, for the sake of convenience, the variable of the x-axis is transformed from X into x, the variable of the y-axis is transformed from Y into y, and the variable of the z-axis is transformed from fZ to fz. Therefore, the transform equation is expressed as follows.

Variable transform of x-axis:

x=π{X−(xb+xa)/2}/{(xb−xa)/2}

Variable transform of y-axis:

y=π{Y−(yb+ya)/2}/{(yb−ya)/2}

Variable transform of z-axis:

fz=(fZ−fa)/(fb−fa)

Usually the value of fa=0 is obtained.

10-0-2. Series expansion with Fourier function

The two-dimensional distribution function on each of the color planes H, V, and C is equivalently expressed by performing the expansion with respect to the (2M+2)×(2M+2) coefficients using the Fourier function including a set of a cosine function and a sine function.

$${f}^{( α )} ( x , y ) = {\sum }_{m = 0}^{M} {\sum }_{{m}^{′} = 0}^{M} ( \begin{matrix}{A}_{m {m}^{′}}^{( α )} cos my cos {m}^{′} x + {B}_{m {m}^{′}}^{( α )} cos my sin {m}^{′} x + \\ {C}_{m {m}^{′}}^{( α )} sin my cos {m}^{′} x + {D}_{m {m}^{′}}^{( α )} sin my sin {m}^{′} x\end{matrix} ) \\ ( α ) = H , V , {C}_{∘} \qquad \{ Math . 186 \}$$

The expansion coefficients A_{mm′}, B_{mm′}, C_{mm′}, and D_{mm′} are obtained as follows using the orthogonality of the base function. That is, the image is prepared by obtaining the expansion coefficient in which the two-dimensional distribution function is orthogonally transformed in each row with respect to the one-dimensional direction, the similar transform is repeated in each column of the one-dimensional direction orthogonal to the plane, and the obtained planes become the two-dimensional expansion coefficient planes A_{mm′}, B_{mm′}, C_{mm′}, and D_{mm′}. The expansion of the one-dimensional direction is performed in each row and each column using the following relational expression.

$$f ( x ) = {\sum }_{m = 0}^{M} {a}_{m} cos mx + {\sum }_{m = 0}^{M} {b}_{m} sin mx \\ {a}_{m} = \frac{1}{π} {\int }_{- π}^{π} f ( x ) cos mx d x , m = 0 , 1 , … , M \\ {b}_{m} = \frac{1}{π} {\int }_{- π}^{π} f ( x ) sin mx d x , m = 0 , 1 , … , M \qquad \{ Math . 187 \}$$

Where a₀=a₀/2, and b₀=0. Accordingly, Bₘ₀=0, C_{0m′}, =0, Dₘ₀=D_{0m′}=0 are obtained.

All the values of the expansion coefficients fall within the range of [−1,1] by the variable transform. The number of expansion coefficients may be set to M=about 25 when the image on the edge plane has the number of pixels of about 360×about 240. The expansion coefficients form the square matrix because the numbers of expansions of the x-axis and y-axis are set to the identical number.

Conveniently the matrices A_{mm′}, B_{mm′}, C_{mm′}, and D_{mm′}, of the four expansion coefficients are grouped into one matrix a_{mm′}. For example, the following grouping method can be cited as the rearrangement method including the characteristic of the Brillouin zone in the k-space where the highest frequency of each of the x-axis and the y-axis is connected to the lowest frequency to express the identical characteristic. In the eighth embodiment, the following grouping method is usually used.

$${a}_{m {m}^{′}} = ( \begin{matrix}{A}_{m {m}^{′}} & {B}_{m {m}^{′}} \\ {C}_{m {m}^{′}} & {D}_{m {m}^{′}}\end{matrix} ) = ( \begin{matrix}[ \begin{matrix}{A}_{00} & … & {A}_{0 M} \\ ⋮ & ⋱ & ⋮ \\ {A}_{M 0} & … & {A}_{MM}\end{matrix} ] & [ \begin{matrix}{B}_{0 M} & … & {B}_{00} \\ ⋮ & ⋱ & ⋮ \\ {B}_{MM} & … & {B}_{M 0}\end{matrix} ] \\ [ \begin{matrix}{C}_{M 0} & … & {C}_{MM} \\ ⋮ & ⋱ & ⋮ \\ {C}_{00} & … & {C}_{0 M}\end{matrix} ] & [ \begin{matrix}{D}_{MM} & … & {D}_{M 0} \\ ⋮ & ⋱ & ⋮ \\ {D}_{0 M} & … & {D}_{00}\end{matrix} ]\end{matrix} ) \qquad \{ Math . 188 \}$$

Alternatively, in another arrangement method, D₀₀ is disposed in the uppermost left, B₀₀ is disposed to the immediate right, c₀₀ is disposed below D₀₀, A₀₀ is disposed below the B₀₀, the number moves forward by one in the vertical direction and the horizontal direction while the four matrices are used as a basic unit, and the matrices are increased by the two rows and two columns. This arrangement method also has the characteristic in which the minimum frequency and the maximum frequency are connected to each other.

In both the methods, the matrices expressed on the k-space expressed by the positive quantum number are folded back at the half point, and the equivalent expression can be obtained even if the overflown portion is described as the negative region. This is the characteristic of the Brillouin zone.

10-1. Preparation of distribution function of high-order system

A power spectrum of the coefficient to which the Fourier expansion is performed is defined as the distribution function of the high-order system related to the composition edge. The distribution function of the high-order system can be defined with respect to the three H, V, and C planes. The normalization is performed such that the probability density is expressed.

$${f}^{( α )} ( m , {m}^{′} ) = \frac{{( {c}_{m {m}^{′}}^{( α )} )}^{2}}{{\sum }_{ m , {m}^{′}} {( {c}_{m {m}^{′}}^{( α )} )}^{2}} \\ ( α ) = H , V , {C}_{∘} \qquad \{ Math . 189 \}$$

10-2. Calculation of entropy

The entropy S is calculated from the distribution function f(m,m′). When expressing the color planes of the distribution function differentiated by (α), the entropy is calculated from the distribution function of each of the color planes H, V, and C, and the sum of the entropies expresses the entropy of the subsystem projected to the high-order system of the two-dimensional edge distribution.

S^{(α)}=−∫∫_{f}_{^{(α)}}_{(m,m)≠0}f^{(α)}(m,m′)ln(f^{(α)}(m,m′))dmdm′

S=S^{(H)}+S^{(V)}+S^{(C){Math.} 190}

The value is set to S_{I}.

10-3. Calculation of momentum element pₙ

The expansion coefficient of the Fourier expansion can be considered to be the momentum in the Hilbert space. Accordingly, the momentum element pₙ is the expansion coefficients of A_{mm′}, B_{mm′}, C_{mm′}, and D_{mm′}.

Assuming that [ ] expresses the array, the number of momentum elements becomes [the number of α planes][type of A, B, C, or D][the number of m][the number of m′]=3×4×26×26. The number of momentum elements is collectively expressed by pₙ in order.

10-4. Calculation of angular momentum element Mₙ

The diagonal component of the expansion coefficient a_{mm′} provides the characteristic of the centrally symmetric shape. Because the magnetic quantum numbers m and m′ of the Fourier expansion define the Hilbert space coordinate, angular momentum M=r×p is defined as the product of the Hilbert space coordinate and the momentum.

$${M}^{( α )} = {\sum }_{m , {m}^{′}} {δ}_{m , {m}^{′}} m ( {A}_{m {m}^{′}}^{( α )} + {D}_{m {m}^{′}}^{( α )} ) = {\sum }_{m} m ( {A}_{m m}^{( α )} + {D}_{m m}^{( α )} ) \\ ( α ) = H , V , {C}_{∘} \qquad \{ Math . 191 \}$$

The Fourier expansion has the next axial invertibility.

cos(−mx)=cos(mx)

sin(−mx)=−sin(mx) {Math. 192}

Although the four cases exist as the axial inversion, only (α)(x,y) and (α′)(x,−y) provide the independent element. (α″)(−x,y) describes the state identical to (α′)(x,−y), and (α′″)(−x,−y) describes the state identical to (α)(x,y). The other independent element in which the y-axis is inverted is written by the following equation.

$${M}^{( α )} = {\sum }_{m , {m}^{′}} {δ}_{m , {m}^{′}} m ( {A}_{m {m}^{′}}^{( α )} + {D}_{m {m}^{′}}^{( α )} ) = {\sum }_{m} m ( {A}_{m m}^{( α )} + {D}_{m m}^{( α )} ) \\ ( α ) = H , V , {C}_{∘} \qquad \{ Math . 193 \}$$

Assuming that [ ] expresses the array, the number of angular momentum elements becomes [the number of α planes][the number of pieces of axial invertibility]=3×2. The number of angular momentum elements is collectively expressed by Mₙ in order.

10-5. Calculation of energy element Eₙ

It is assumed that the one-dimensional array in which the two-dimensional expansion coefficient of

a_{mm′}^{(α)} {Math. 194}

is rearranged in the 12 directions is schematically expressed by

a_{mm′}^{(α)}(\vec{k}ᵢ^{(α)}). {Math. 195}

The vector k expresses the starting point and direction of the rearrangement, the coefficients are sequentially rearranged from the defined starting point positions of the rearrangement, and the ith expansion coefficient of the expansion coefficients of 0 to (2M+2)×(2M+2)−1 is expressed by i. The ith expansion coefficient aᵢ on the (α) plane and the jth expansion coefficient aⱼ on the (β) plane are exchanged to produce the symmetric product and the antisymmetric product, and the element value of the energy level Eₙ is produced by calculating the sum of all the expansion coefficients between the expansion coefficients having a given quantum number difference of j−i=n.

$${E}_{n = j - i}^{( α ) ( β ) \pm } ( {\vec{k}}_{i}^{( α )} \cdot {\vec{k}}_{j}^{( β )} ) = \frac{\frac{1}{2} {\sum }_{j \cdot i = n , i = 0}^{N \times N - 1} \{ \begin{matrix}{a}_{m {m}^{′}}^{( α )} ( {\vec{k}}_{i}^{( α )} ) {a}_{m {m}^{′}}^{( β )} ( {\vec{k}}_{j}^{( β )} ) \pm \\ {a}_{m {m}^{′}}^{( α )} ( {\vec{k}}_{j}^{( α )} ) {a}_{m {m}^{′}}^{( β )} ( {\vec{k}}_{i}^{( β )} )\end{matrix} \}}{\sqrt{{\sum }_{m , {m}^{′}} {( {a}_{m {m}^{′}}^{( α )} )}^{2}} \sqrt{{\sum }_{m , {m}^{′}} {( {a}_{m {m}^{′}}^{( β )} )}^{2}}} \qquad \{ Math . 196 \}$$

When the value of aⱼ is overflown from the definition regions of 0 to (2M+2)×(2M+2)−1 like a_{(2m+2)×(2m+2)-1+i}, the head and tail of the one-dimensional expansion coefficient are connected to form a ring, and the definition is performed again by returning to the initial point. That is, a_{(2m+2)×(2m+2)-1+i}=aᵢ is obtained.

Because the number of energy levels n investigates only the characteristic on the line of the two-dimensional expansion coefficient, the energy levels n are used with respect to the quantum number differences of n=0, 1, . . . , (2M+2)−1.

Eₙ₌ⱼ₋ᵢ^{(α)(β)±}(\vec{k}ᵢ^{(α)}·\vec{k}ⱼ^{(β)}) {Math. 197}

describes the energy dispersion relationship among the combinations of 12×12 ways, namely, the relational expression indicating what energy value is taken on the point k at the point n=j−i on the k-space expressing the combination of ki and kj.

In combinations of 12 ways in which the combinations in the 12×12 directions become the identical direction with respect to the definition of the symmetric product of the (α) plane and the (α) plane, because the numerator and the denominator become the identical value only at the point of n=j−i=0, only the numerator is exceptionally defined. That is,

$${E}_{n = 0}^{( α ) ( α ) +} ( {\vert {\vec{k}}_{0 }^{( α )} \vert}^{2} ) = {\sum }_{m , {m}^{′}} {( {a}_{m {m}^{′}}^{( α )} )}^{2} - {ɛ}_{0} \qquad \{ Math . 198 \}$$

is obtained.

Although the offset of zero-point energy is included, actually an autocorrelation value may directly be used without performing the offset correction in the sense that the number of states is directly described even if the value exceeds 1.

As to the axial invertibility, the expansion coefficients of

a_{mm′}^{(α)} {Math. 199}

are rearranged as follows with respect to the four states of each of the α plane and the β plane, so that the energy dispersion relationships of 4×4 times can independently be defined in the energy dispersion relationship of the above definition.

$$( α ) ( x , y ) ( \begin{matrix}{A}_{m {m}^{′}}^{( α )} & {B}_{m {m}^{′}}^{( α )} \\ {C}_{m {m}^{′}}^{( α )} & {D}_{m {m}^{′}}^{( α )}\end{matrix} ) \\ ( α ) ( x , - y ) = ( {α}^{′} ) ( x , y ) ( \begin{matrix}{A}_{m {m}^{′}}^{( α )} & {B}_{m {m}^{′}}^{( α )} \\ - {C}_{m {m}^{′}}^{( α )} & - {D}_{m {m}^{′}}^{( α )}\end{matrix} ) \\ ( α ) ( - x , y ) = ( {α}^{″} ) ( x , y ) ( \begin{matrix}{A}_{m {m}^{′}}^{( α )} & - {B}_{m {m}^{′}}^{( α )} \\ {C}_{m {m}^{′}}^{( α )} & - {D}_{m {m}^{′}}^{( α )}\end{matrix} ) \\ ( α ) ( - x , - y ) = ( {α}^{′′′} ) ( x , y ) ( \begin{matrix}{A}_{m {m}^{′}}^{( α )} & - {B}_{m {m}^{′}}^{( α )} \\ - {C}_{m {m}^{′}}^{( α )} & {D}_{m {m}^{′}}^{( α )}\end{matrix} ) \\ ( β ) ( x , y ) ( \begin{matrix}{A}_{m {m}^{′}}^{( β )} & {B}_{m {m}^{′}}^{( β )} \\ {C}_{m {m}^{′}}^{( β )} & {D}_{m {m}^{′}}^{( β )}\end{matrix} ) \\ ( β ) ( x , - y ) = ( {β}^{′} ) ( x , y ) ( \begin{matrix}{A}_{m {m}^{′}}^{( β )} & {B}_{m {m}^{′}}^{( β )} \\ - {C}_{m {m}^{′}}^{( β )} & - {D}_{m {m}^{′}}^{( β )}\end{matrix} ) \\ ( β ) ( - x , y ) = ( {β}^{″} ) ( x , y ) ( \begin{matrix}{A}_{m {m}^{′}}^{( β )} & - {B}_{m {m}^{′}}^{( β )} \\ {C}_{m {m}^{′}}^{( β )} & - {D}_{m {m}^{′}}^{( β )}\end{matrix} ) \\ ( β ) ( - x , - y ) = ( {β}^{′′′} ) ( x , y ) ( \begin{matrix}{A}_{m {m}^{′}}^{( β )} & - {B}_{m {m}^{′}}^{( β )} \\ - {C}_{m {m}^{′}}^{( β )} & {D}_{m {m}^{′}}^{( β )}\end{matrix} ) \qquad \{ Math . 200 \}$$

Assuming that [ ] expresses the array, the number of energy elements becomes [the number of combinations of α planes and β planes][the number of pieces of α-plane axial invertibility][the number of pieces of β-plane axial invertibility][the number of rearrangement ways of α planes][the number of rearrangement ways of β planes][type of symmetric product or antisymmetric product][the number of energy levels]=6×4×4×12×12×2×52. The number of energy elements is collectively expressed by Eₙ in order.

In this case, the further contracted energy dispersion relationship is obtained.

Eₙ₌ⱼ₋ᵢ^{(α)(β)±}(\vec{k}ᵢ^{(α)}·\vec{k}ⱼ^{(β)}) {Math. 201}

derives the energy dispersion relationship among the combinations of 12×12 ways, and the mean energy dispersion relationship between the identical energy levels Eₙ is obtained with respect to the direction combinations. When the operation is performed, the mean energy dispersion relationship of the antisymmetric product always becomes zero. Accordingly, only the energy dispersion relationship on the symmetric product side is left.

[symbol]

Eₙ₌ⱼ₋ᵢ^{(α)(β)+}(\vec{k}ᵢ^{(α)}·\vec{k}ⱼ^{(β)}) [symbol] _{12×12}≠0

[symbol]

Eₙ₌ⱼ₋ᵢ^{(α)(β)-}(\vec{k}ᵢ^{(α)}·\vec{k}ⱼ^{(β)}) [symbol] _{12×12}=0 {Math. 202}

Therefore, the number of energy elements becomes [the number of combinations of α planes and β planes][the number of pieces of α-plane axial invertibility][the number of pieces of β-plane axial invertibility][the number of energy levels]=6×4×4×52. The number of energy elements is collectively expressed by Eₙ in order.

By way of example, which image can be distinguished is investigated by image alignment with respect to the energy element near the energy level n=0 of the symmetric product of the VV planes. The classification ability is exerted such that the photographic images of natural systems such as the landscapes are easily collected in some images, such that the photographic images of crowd systems such as a person are easily collected in other images. The axial inversion provides the ability to sort the images having the different characteristics.

10-6. Calculation of temperature at subsystem

The procedure is similar to that in 4-6 of the sixth embodiment.

10-7. Calculation of free energy of subsystem

The procedure is similar to that in 4-7 of the sixth embodiment.

The Boltzmann constant of the subsystem is measured by the inverse number of the statistical mean of any image of the entropy in the subsystem.

$${k}_{I} = \frac{1}{ 〈 {S}_{I } 〉} \qquad \{ Math . 203 \}$$

11. Combination of mechanical invariant unit in subsystem

11-1. Setting of adjective

11-2. Construction of general image model

11-3. Construction of adjective model image

11-4. Calculation of deviation value in distribution in element

11-5. Calculation of partial energy of mechanical invariant unit, partial momentum, partial angular momentum of subsystem

12. Combination of subsystem to adjective energy

13. Combination of whole system to adjective energy

14. Adjective search processing

The procedures 11 to 14 are completely identical to those of the sixth embodiment.

Thus, the perception invariants derived from the one-dimensional distributions related to the color and edge gradations and the two-dimensional distributions related to the color and edge compositions or the invariants related to the image recognition are described as the additional features in the common field. In the case that a certain feature deeply involves the recognition of a certain adjective, the features are described with the large deviation with respect to the general image. Because of the idea of the projection space expression, the recognition structure and perception structure of the human can be visualized. In the frequency description, the energy band diagram partially illustrates the comparison of the two adjectives.

### Ninth Embodiment

An example of the case that the associated Legendre function expansion is m=0, 1, 2, and 3 is indicated when the invariant of the high-order system of the two-dimensional color distribution function is described in the eighth embodiment.

8. Preparation of two-dimensional color distribution of high-order invariant

8-0. Hilbert space expression of distribution function of low-order system

8-0-1. Variable transform

8-0-2. Series expansion with associated Legendre function

The two-dimensional distribution function of each of the color planes H, V, and C is equivalently expressed by performing the double series expansion of the associated Legendre function with N×N coefficients.

$${f}^{( α )} ( x , y ) = {{\sum }_{m = 0}}^{3} {\sum }_{{m}^{′} = 0}^{3} {\sum }_{l = 0}^{N - 1} {\sum }_{{l}^{′} = 0}^{N - 1} {c}_{m {m}^{′} ll}^{( α )} {P}_{l}^{m} ( y ) {P}_{{l}^{′}}^{{m}^{′}} ( x ) = {\sum }_{m = 0}^{3} {\sum }_{{m}^{′} = 0}^{3} {\sum }_{l = 0}^{N - 1} {\sum }_{{l}^{′} = 0}^{N - 1} {a}_{m {m}^{′}}^{( α )} {c}_{{ll}^{′}}^{m {m}^{′} ( α )} {P}_{l}^{m} ( y ) {P}_{{l}^{′}}^{{m}^{′}} ( x ) \\ ( α ) = H , V , {C}_{∘} \qquad \{ Math . 204 \}$$

The equivalent expression is performed by the single series expansions of the m×m′ ways with respect to the magnetic quantum number.

$${f}^{( α )} ( x , y ) = {\sum }_{l = 0}^{N - 1} {\sum }_{{l}^{′} = 0}^{N - 1} {c}_{{ll}^{′}}^{m {m}^{′} ( α )} {P}_{l}^{m} ( y ) {P}_{{l}^{′}}^{{m}^{′}} ( x ) \\ m , {m}^{′} = 0 , 1 , 2 , 3 ( α ) = H , V , {C}_{∘} \qquad \{ Math . 205 \}$$

The expansion coefficient c^{mm}_{11′} is obtained suing the orthogonality of the base function. The expansion of the one-dimensional direction is performed in each row and each column using the following relational expression.

$$f ( x ) = {\sum }_{l = 0}^{N - 1} {c}_{l}^{m} {P}_{l}^{m} ( x ) \\ m = 0 , 1 , 2 , 3 \\ {c}_{l}^{m} = \frac{2 l + 1}{2} \cdot \frac{( l - m ) !}{( l + m ) !} {\int }_{- 1}^{1} f ( x ) {P}_{l}^{m} ( x ) d x \qquad \{ Math . 206 \}$$

A weight a_{mm′} between the magnetic quantum numbers is equally set to 1 when the double series expansion is performed.

The orthogonality between the magnetic quantum numbers m is guaranteed by the orthogonality of the Fourier function of the two-dimensional distribution function on the edge plane when the two-dimensional distribution function of

f₀^{(α)}(x,y) {Math. 207}

on the color plane and the two-dimensional distribution function of

f_{φ}^{(α)}(x,y) {Math. 208}

on the edge plane are simultaneously expanded by the product of the two distribution functions.

The expansion coefficient c_{mm′11′} used to calculate the invariant of the subsystem is equal to the expansion coefficient c^{mm}_{11′} obtained by the single series expansion. Thus, the square matrices of m×m′ ways, namely, 4×4 ways are generated with respect to the magnetic quantum number.

8-1. Preparation of distribution function of high-order system

$${f}^{( α )} ( m , {m}^{′} l , {l}^{′} ) = \frac{{( {c}_{{ll}^{′}}^{m {m}^{′} ( α )} )}^{2}}{{\sum }_{m , {m}^{′} , l , {l}^{′}} {( {c}_{{ll}^{′}}^{m {m}^{′} ( α )} )}^{2}} \\ ( α ) = H , V , {C}_{∘} \qquad \{ Math . 209 \}$$

8-2. Calculation of entropy

S^{(α)}=−∫∫∫∫_{f}_{^{(α)}}_{(l,l′)≠0}f^{(α)}(m,m′,l,l′)ln(f^{(α)}(m,m′,l,l′))dmdm′dldl′

S=S^{(H)}+S^{(V)}+S^{(C)} {Math. 210}

8-3. Calculation of momentum element pₙ

The momentum element pₙ is the expansion coefficient.

c_{ll′}^{mm′(α)}{Math. 211}

Assuming that [ ] expresses the array, the number of momentum elements becomes [the number of α plane][the number of m][the number of m′][the number of l][the number of l′]=3×4×4×50×50. The number of momentum elements is collectively expressed by pₙ in order.

8-4. Calculation of angular momentum element Mₙ

It is assumed that, in the expansion coefficient of the associated Legendre function, the diagonal component of the expansion coefficient related to the azimuthal quantum numbers l and l′ in the set of magnetic quantum numbers m and m′ equal to each other provides the characteristic having the centrally symmetric shape. Assuming that the azimuthal quantum numbers l and l′ of the associated Legendre function defines the Hilbert space coordinate, the angular momentum M=r×p is defined as the product of the Hilbert space coordinate and the momentum.

$${M}^{( α )} = {\sum }_{m , {m}^{′}} {δ}_{ m {m}^{′}} {\sum }_{l , {l}^{′}} {δ}_{l , {l}^{′}} {lc}_{{ll}^{′}}^{m {m}^{′} ( α )} = {\sum }_{m} {\sum }_{l} {lc}_{ll}^{m m ( α )} \\ ( α ) = H , V , {C}_{∘} \qquad \{ Math . 212 \}$$

The associated Legendre function includes the following axial invertibility.

Pₗ^{m}(−x)=(−1)^{l+m}Pₗ^{m}(x){Math. 213}

Although the four cases exist as the axial inversion, only (α)(x,y) and (α′)(x,−y) provide the independent element. (α″)(−x,y) describes the state identical to (α′)(x,−y), and (α′″)(−x,−y) describes the state identical to (α)(x,y). The other independent element in which the y-axis is inverted is written by the following equation.

$${M}^{( α )} = {\sum }_{m} {\sum }_{l} {( - 1 )}^{l + m} {lc}_{ll}^{m m ( α )} \\ ( α ) = H , V , {C}_{∘} \qquad \{ Math . 214 \}$$

Assuming that [ ] expresses the array, the number of angular momentum elements becomes [the number of α planes][the number of pieces of axial invertibility]=3×2. The number of angular momentum elements is collectively expressed by Mₙ in order.

8-5. Calculation of energy element Eₙ

It is assumed that the one-dimensional array in which the two-dimensional expansion coefficient of

c_{ll′}^{mm′(α)} {Math. 215}

is rearranged in the 12 directions on the m and m′ planes
with respect to l and l′ is schematically expressed by

c_{ll′}^{mm′(α)}(\vec{k}ᵢ^{(α)}). {Math. 216}

Similarly the value of level Eₙ of the energy dispersion relationship is produced on the m and m′ planes. However, the normalization factor is used when the element of the final energy level is produced.

$${E}_{n = j - i}^{m {m}^{′} ( α ) ( β ) \pm } ( {\vec{k}}_{i}^{( α )} \cdot {\vec{k}}_{j}^{( β )} ) = \frac{1}{2} {\sum }_{j - i = n , i = 0}^{N \times N - 1} \{ \begin{matrix}{c}_{{ll}^{′}}^{m {m}^{′} ( α )} ( {\vec{k}}_{i}^{( α )} ) {c}_{{ll}^{′}}^{m {m}^{′} ( β )} ( {\vec{k}}_{j}^{( β )} ) \pm \\ {c}_{{ll}^{′}}^{m {m}^{′} ( α )} ( {\vec{k}}_{j}^{( α )} ) {c}_{{ll}^{′}}^{m {m}^{′} ( β )} ( {\vec{k}}_{i}^{( β )} )\end{matrix} \} \qquad \{ Math . 217 \}$$

The sum of the energy dispersion relationships on the four planes is calculated such that each of m and m′ slides on complete system, and it is considered that the energy level defined in the eighth embodiment is split into four. That is, the element of the final energy level is split into the four levels when each of the magnetic quantum numbers m and m′ takes the number up to 4.

$${E}_{n = j - i}^{Δ m = 00 Type ( α ) ( β ) \pm } ( {\vec{k}}_{i}^{( α )} \cdot {\vec{k}}_{j}^{( β )} ) = \frac{\begin{matrix}{E}_{n = j - i}^{00 ( α ) ( β ) \pm } ( {\vec{k}}_{i}^{( α )} \cdot {\vec{k}}_{j}^{( β )} ) + {E}_{n = j - i}^{11 ( α ) ( β ) \pm } ( {\vec{k}}_{i}^{( α )} \cdot {\vec{k}}_{j}^{( β )} ) + \\ {E}_{n = j - i}^{22 ( α ) ( β ) \pm } ( {\vec{k}}_{i}^{( α )} \cdot {\vec{k}}_{j}^{( β )} ) + {E}_{n = j - i}^{33 ( α ) ( β ) \pm } ( {\vec{k}}_{i}^{( α )} \cdot {\vec{k}}_{j}^{( β )} )\end{matrix}}{\begin{matrix}\begin{matrix}\begin{matrix}\sqrt{{\sum }_{l , {l}^{′}} {( {c}_{{ll}^{′}}^{00 ( α )} )}^{2}} \sqrt{{\sum }_{l , {l}^{′}} {( {c}_{{ll}^{′}}^{00 ( β )} )}^{2}} + \\ \sqrt{{\sum }_{l , {l}^{′}} {( {c}_{{ll}^{′}}^{11 ( α )} )}^{2}} \sqrt{{\sum }_{l , {l}^{′}} {( {c}_{{ll}^{′}}^{11 ( β )} )}^{2}} +\end{matrix} \\ \sqrt{{\sum }_{l , {l}^{′}} {( {c}_{{ll}^{′}}^{22 ( α )} )}^{2}} \sqrt{{\sum }_{l , {l}^{′}} {( {c}_{{ll}^{′}}^{22 ( β )} )}^{2}} +\end{matrix} \\ \sqrt{{\sum }_{l , {l}^{′}} {( {c}_{{ll}^{′}}^{33 ( α )} )}^{2}} \sqrt{{\sum }_{l , {l}^{′}} {( {c}_{{ll}^{′}}^{33 ( β )} )}^{2}}\end{matrix}} \\ {E}_{n = j - i}^{Δ m = 01 Type ( α ) ( β ) \pm } ( {\vec{k}}_{i}^{( α )} \cdot {\vec{k}}_{j}^{( β )} ) = \frac{\begin{matrix}{E}_{n = j - i}^{01 ( α ) ( β ) \pm } ( {\vec{k}}_{i}^{( α )} \cdot {\vec{k}}_{j}^{( β )} ) + {E}_{n = j - i}^{10 ( α ) ( β ) \pm } ( {\vec{k}}_{i}^{( α )} \cdot {\vec{k}}_{j}^{( β )} ) + \\ {E}_{n = j - i}^{23 ( α ) ( β ) \pm } ( {\vec{k}}_{i}^{( α )} \cdot {\vec{k}}_{j}^{( β )} ) + {E}_{n = j - i}^{32 ( α ) ( β ) \pm } ( {\vec{k}}_{i}^{( α )} \cdot {\vec{k}}_{j}^{( β )} )\end{matrix}}{\begin{matrix}\begin{matrix}\begin{matrix}\sqrt{{\sum }_{l , {l}^{′}} {( {c}_{{ll}^{′}}^{01 ( α )} )}^{2}} \sqrt{{\sum }_{l , {l}^{′}} {( {c}_{{ll}^{′}}^{01 ( β )} )}^{2}} + \\ \sqrt{{\sum }_{l , {l}^{′}} {( {c}_{{ll}^{′}}^{10 ( α )} )}^{2}} \sqrt{{\sum }_{l , {l}^{′}} {( {c}_{{ll}^{′}}^{10 ( β )} )}^{2}} +\end{matrix} \\ \sqrt{{\sum }_{l , {l}^{′}} {( {c}_{{ll}^{′}}^{23 ( α )} )}^{2}} \sqrt{{\sum }_{l , {l}^{′}} {( {c}_{{ll}^{′}}^{23 ( β )} )}^{2}} +\end{matrix} \\ \sqrt{{\sum }_{l , {l}^{′}} {( {c}_{{ll}^{′}}^{32 ( α )} )}^{2}} \sqrt{{\sum }_{l , {l}^{′}} {( {c}_{{ll}^{′}}^{32 ( β )} )}^{2}}\end{matrix}} \\ {E}_{n = j - i}^{Δ m = 02 Type ( α ) ( β ) \pm } ( {\vec{k}}_{i}^{( α )} \cdot {\vec{k}}_{j}^{( β )} ) = \frac{\begin{matrix}{E}_{n = j - i}^{02 ( α ) ( β ) \pm } ( {\vec{k}}_{i}^{( α )} \cdot {\vec{k}}_{j}^{( β )} ) + {E}_{n = j - i}^{20 ( α ) ( β ) \pm } ( {\vec{k}}_{i}^{( α )} \cdot {\vec{k}}_{j}^{( β )} ) + \\ {E}_{n = j - i}^{13 ( α ) ( β ) \pm } ( {\vec{k}}_{i}^{( α )} \cdot {\vec{k}}_{j}^{( β )} ) + {E}_{n = j - i}^{31 ( α ) ( β ) \pm } ( {\vec{k}}_{i}^{( α )} \cdot {\vec{k}}_{j}^{( β )} )\end{matrix}}{\begin{matrix}\begin{matrix}\begin{matrix}\sqrt{{\sum }_{l , {l}^{′}} {( {c}_{{ll}^{′}}^{02 ( α )} )}^{2}} \sqrt{{\sum }_{l , {l}^{′}} {( {c}_{{ll}^{′}}^{02 ( β )} )}^{2}} + \\ \sqrt{{\sum }_{l , {l}^{′}} {( {c}_{{ll}^{′}}^{20 ( α )} )}^{2}} \sqrt{{\sum }_{l , {l}^{′}} {( {c}_{{ll}^{′}}^{20 ( β )} )}^{2}} +\end{matrix} \\ \sqrt{{\sum }_{l , {l}^{′}} {( {c}_{{ll}^{′}}^{13 ( α )} )}^{2}} \sqrt{{\sum }_{l , {l}^{′}} {( {c}_{{ll}^{′}}^{13 ( β )} )}^{2}} +\end{matrix} \\ \sqrt{{\sum }_{l , {l}^{′}} {( {c}_{{ll}^{′}}^{31 ( α )} )}^{2}} \sqrt{{\sum }_{l , {l}^{′}} {( {c}_{{ll}^{′}}^{31 ( β )} )}^{2}}\end{matrix}} \\ {E}_{n = j - i}^{Δ m = 03 Type ( α ) ( β ) \pm } ( {\vec{k}}_{i}^{( α )} \cdot {\vec{k}}_{j}^{( β )} ) = \frac{\begin{matrix}{E}_{n = j - i}^{03 ( α ) ( β ) \pm } ( {\vec{k}}_{i}^{( α )} \cdot {\vec{k}}_{j}^{( β )} ) + {E}_{n = j - i}^{30 ( α ) ( β ) \pm } ( {\vec{k}}_{i}^{( α )} \cdot {\vec{k}}_{j}^{( β )} ) + \\ {E}_{n = j - i}^{12 ( α ) ( β ) \pm } ( {\vec{k}}_{i}^{( α )} \cdot {\vec{k}}_{j}^{( β )} ) + {E}_{n = j - i}^{21 ( α ) ( β ) \pm } ( {\vec{k}}_{i}^{( α )} \cdot {\vec{k}}_{j}^{( β )} )\end{matrix}}{\begin{matrix}\begin{matrix}\begin{matrix}\sqrt{{\sum }_{l , {l}^{′}} {( {c}_{{ll}^{′}}^{03 ( α )} )}^{2}} \sqrt{{\sum }_{l , {l}^{′}} {( {c}_{{ll}^{′}}^{03 ( β )} )}^{2}} + \\ \sqrt{{\sum }_{l , {l}^{′}} {( {c}_{{ll}^{′}}^{30 ( α )} )}^{2}} \sqrt{{\sum }_{l , {l}^{′}} {( {c}_{{ll}^{′}}^{30 ( β )} )}^{2}} +\end{matrix} \\ \sqrt{{\sum }_{l , {l}^{′}} {( {c}_{{ll}^{′}}^{12 ( α )} )}^{2}} \sqrt{{\sum }_{l , {l}^{′}} {( {c}_{{ll}^{′}}^{12 ( β )} )}^{2}} +\end{matrix} \\ \sqrt{{\sum }_{l , {l}^{′}} {( {c}_{{ll}^{′}}^{21 ( α )} )}^{2}} \sqrt{{\sum }_{l , {l}^{′}} {( {c}_{{ll}^{′}}^{21 ( β )} )}^{2}}\end{matrix}} \qquad \{ Math . 218 \}$$

The following exception definition is obtained when the numerator becomes an autocorrelation.

$${E}_{n = 0}^{Δ m = 00 Type ( α ) ( α ) +} ( {\vert {\vec{k}}_{0}^{( α )} \vert}^{2} ) = {\sum }_{l , {l}^{′}} {( {c}_{{ll}^{′}}^{00 ( α )} )}^{2} + {\sum }_{l , {l}^{′}} {( {c}_{{ll}^{′}}^{11 ( α )} )}^{2} + {\sum }_{l , {l}^{′}} {( {c}_{{ll}^{′}}^{22 ( α )} )}^{2} + {\sum }_{l , {l}^{′}} {( {c}_{{ll}^{′}}^{33 ( α )} )}^{2} \\ {E}_{n = 0}^{Δ m = 01 Type ( α ) ( α ) +} ( {\vert {\vec{k}}_{0}^{( α )} \vert}^{2} ) = {\sum }_{l , {l}^{′}} {( {c}_{{ll}^{′}}^{01 ( α )} )}^{2} + {\sum }_{l , {l}^{′}} {( {c}_{{ll}^{′}}^{10 ( α )} )}^{2} + {\sum }_{l , {l}^{′}} {( {c}_{{ll}^{′}}^{23 ( α )} )}^{2} + {\sum }_{l , {l}^{′}} {( {c}_{{ll}^{′}}^{32 ( α )} )}^{2} \\ {E}_{n = 0}^{Δ m = 02 Type ( α ) ( α ) +} ( {\vert {\vec{k}}_{0}^{( α )} \vert}^{2} ) = {\sum }_{l , {l}^{′}} {( {c}_{{ll}^{′}}^{02 ( α )} )}^{2} + {\sum }_{l , {l}^{′}} {( {c}_{{ll}^{′}}^{20 ( α )} )}^{2} + {\sum }_{l , {l}^{′}} {( {c}_{{ll}^{′}}^{13 ( α )} )}^{2} + {\sum }_{l , {l}^{′}} {( {c}_{{ll}^{′}}^{31 ( α )} )}^{2} \\ {E}_{n = 0}^{Δ m = 03 Type ( α ) ( α ) +} ( {\vert {\vec{k}}_{0}^{( α )} \vert}^{2} ) = {\sum }_{l , {l}^{′}} {( {c}_{{ll}^{′}}^{03 ( α )} )}^{2} + {\sum }_{l , {l}^{′}} {( {c}_{{ll}^{′}}^{30 ( α )} )}^{2} + {\sum }_{l , {l}^{′}} {( {c}_{{ll}^{′}}^{12 ( α )} )}^{2} + {\sum }_{l , {l}^{′}} {( {c}_{{ll}^{′}}^{21 ( α )} )}^{2} \qquad \{ Math . 219 \}$$

As to the axial invertibility, because the expansion coefficients are rearranged as follows with respect to the four state of each of the α plane and the β plane, the 4×4-time energy dispersion relationships can independently be defined.

{Math. 220}

(X, Y) C_{ll′}^{mm′(α)} (α)

(X, −Y)=(α′) (X, Y) (−1)^{l+m}C_{ll′}^{mm′(α)} (α)

(−X, Y)=(α″) (X, Y) (−1)^{l′+m′}C_{ll′}^{mm′(α)} (α)

(−X, Y)=(α″′) (X, Y) (−1)^{l+m+l′+m′}C_{ll′}^{mm′(α)} (α)

(X, Y) C_{ll′}^{mm′(β)} (β)

(X, −Y)=(β′) (X, Y) (−1)^{l+m}C_{ll′}^{mm′(β)} (β)

(X, Y)=(β″) (X, Y) (−1)^{l′+m′}C_{ll′}^{mm′(β)} (β)

(−X, −Y)=(β″′) (X, Y) (−1)^{l+m+l′+m′}C_{ll′}^{mm′(β)} (β)

Assuming that [ ] expresses the array, the number of energy elements becomes [the number of combinations of α planes and β planes][the number of types of Δm][the number of pieces of α-plane axial invertibility][the number of pieces of β-plane axial invertibility][the number of rearrangement ways of α planes][the number of rearrangement ways of β planes][type of symmetric product or antisymmetric product][the number of energy levels]=6×4×4×4×12×12×2×50.

The similar idea holds for the degeneration of the mean energy dispersion relationship with respect to the direction combination. At this point, the number of energy elements becomes [the number of combinations of α planes and β planes][the number of types of Δm][the number of pieces of α-plane axial invertibility][the number of pieces of β-plane axial invertibility][the number of energy levels]=6×4×4×4×50.

### Tenth Embodiment

The case that both the symmetric product and the antisymmetric product are left by the direction combination mean in the combinations in 6×6 directions

In the procedure 8-5 of the eighth embodiment and the procedure 9-5 of the ninth embodiment, when the energy element is produced from the two-dimensional expansion coefficient, the rearrangement into the one-dimensional array is performed in the 12 directions, and the energy dispersion relationship of

Eₙ₌ⱼ₋ᵢ^{(α)(β)±}(\vec{k}ᵢ^{(α)}·\vec{k}ⱼ^{(β)}) {Math. 221}

is derived from the product of the (α) plane and the (β) plane with respect to the combinations in the 12×12 directions. However, the two types of the positive and the negative directions are calculated in the rearrangements in the 12 directions, there is the idea that the rearrangements in the 6 directions are selected only for the positive direction.

Only the procedure 8-5 of the eighth embodiment will be described by way of example.

8-5. Calculation of energy element Eₙ

It is assumed that

Eₙ₌ⱼ₋ᵢ^{(α)(β)±}(\vec{k}ᵢ^{(α)}·\vec{k}ⱼ^{(β)}) {Math. 222}

describes the energy dispersion relationship among the combinations of the 6×6 ways.

Assuming that [ ] expresses the array, the number of energy elements becomes [the number of combinations of α planes and β planes][the number of pieces of α-plane axial invertibility][the number of pieces of β-plane axial invertibility][the number of rearrangement ways of α planes][the number of rearrangement ways of β planes][type of symmetric product or antisymmetric product][the number of energy levels]=6×4×4×6×6×2×50.

When the mean energy dispersion relationship is obtained with respect to the combinations in the 6×6 directions, the mean energy dispersion relationship of the antisymmetric product is left unlike the combinations in the 12×12 directions.

[symbol]

Eₙ₌ⱼ₋ᵢ^{(α)(β)+}(\vec{k}ᵢ^{(α)}·\vec{k}ⱼ^{(β)}) [symbol] _{6×6}≠0

[symbol]

Eₙ₌ⱼ₋ᵢ^{(α)(β)-}(\vec{k}ᵢ^{(α)}·\vec{k}ⱼ^{(β)}) [symbol] _{6×6}≠0 {Math. 223}

The number of momentum elements becomes [the number of combinations of α planes and β planes][the number of pieces of α-plane axial invertibility][the number of pieces of β-plane axial invertibility][type of symmetric product or antisymmetric product][the number of energy levels]=6×4×4×2×50.

As a result of the experiment, in the case that the energy element is defined using the mean energy dispersion relationship, the eighth embodiment and the tenth embodiment are substantially equal to each other in the ability to catch the feature. Accordingly, both the eighth embodiment and the tenth embodiment may be used.

In the above embodiments, the expansion coefficient in which the distribution function is expanded with respect to the base function is defined as the momentum in the frequency description. Accordingly, the momentum elements having the identical number of expansion coefficients exist. Alternatively, when the momentum elements are further degenerated, the whole momentum in which the sum of all the expansion coefficients is calculated in the color plane unit in each subsystem may be defined as the momentum. Alternatively, the mean momentum in the color plane unit may be obtained by performing the division with the number of expansion coefficient. Unless the axial invertibility is considered, one momentum element is derived from one color plane in the definition of the momentum. However, because the axial invertibility has the meaning, the number of elements has the relationship similar to the number of elements degenerated by the derivation of the angular momentum.

In the case that the momentum is typified by the whole momentum, another independent typical value can be derived by the axial invertibility. For the subsystem of the one-dimensional distribution, the independent element becomes double because only the uniaxial inversion can be performed. For the subsystem of the two-dimensional distribution, the independent elements are generated four times from the combinations because the biaxial inversion can be performed.

Thus, when the momentum in the frequency description is described by the mean value, the mean value is used as the typical value in the momentum used in the real-space description like the derivation from the idea of the mean field approximation of the model Hamiltonian.

According to the above embodiments, the following image sorting methods are provided.

(1) The image sorting method includes: the distribution function input step of inputting each of the two-dimensional distribution functions f^{(α)}(x,y) and f^{(β)}(x,y) of the image related to at least the two color planes α and β (including the case of α=β); the description step of performing the two-dimensional series expansion to each of the two distribution functions

f^{(α)}(x,y)=c₀₀^{(α)}ψ₀(y)ψ₀(x)+ . . . +c_{0,n-1}^{(α)}ψ₀(y)ψₙ₋₁(x)+ . . . +c_{n-1,0}^{(α)}ψₙ₋₁(y)ψ₀(x)+ . . . αc_{n-1,n-1}^{(α)}ψₙ₋₁(y)ψₙ₋₁(x) and

f^{(β)}(x,y)=c₀₀^{(β)}ψ₀(y)ψ₀(x)+ . . . +c_{0,n-1}^{(β)}ψ₀(y)ψₙ₋₁(x)+ . . . +c_{n-1,0}^{(β)}ψₙ₋₁(y)ψ₀(x)+ . . . αc_{n-1,n-1}^{(β)}ψₙ₋₁(y)ψₙ₋₁(x)

using n base functions ψₙ (n: quantum number) that are orthogonal to each other while becoming the complete system in each of the distribution ranges in the x-direction and y-direction, and describing each of the two distribution functions by the two-dimensional expansion coefficients cᵢⱼ^{(α)} and cᵢⱼ^{(β)} (i=0, 1, . . . , n−1 and j=0, 1, . . . , n−1); the rearrangement step of rearranging each of the two-dimensional expansion coefficient cᵢⱼ^{(α)},cᵢⱼ^{(β)} into expansion coefficients cᵢ^{(α)} and cᵢ^{(β)} (i=0, 1, . . . , n×n−1) of 12 ways of the one-dimensional array in the order of

1) +k_{y}-direction with (kₓ,k_{y})=(0,0) as the starting point,

2) +kₓ-direction with (kₓ,k_{y})=(0,0) as the starting point,

3) +k_{d}-direction with (kₓ,k_{y})=(0,0) as the starting point,

4) +k_{d′}-direction with (kₓ,k_{y})=(2π/a,0) as the starting point,

5) +k_{y}-direction with (kₓ,k_{y}) (π/a,0) as the starting point,

6) +kₓ-direction with (kₓ,k_{y})=(0,π/a) as the starting point,

7) −k_{y}-direction with (kₓ,k_{y}) (2π/a,2π/a) as the starting point,

8) −kₓ-direction with (kₓ,k_{y})=(2π/a,2π/a) as the starting point,

9) −k_{d}-direction with (kₓ,k_{y})=(2π/a,2π/a) as the starting point,

10) −k_{d′}-direction with (kₓ,k_{y})=(0,2π/a) as the starting point,

11) −k_{y}-direction with (kₓ,k_{y})=(π/a,2π/a) as the starting point, and

12) −kₓ-direction with (kₓ,k_{y}) (2π/a,π/a) as the starting point

when the direction in which i increases in the two-dimensional plane of the expansion coefficient is defined as the +k_{y}-direction, when the direction in which j increases is defined as the +kₓ-direction, when the direction in which i and j increase simultaneously is defined as the +k_{d}-direction, when the direction in which i increases while j decreases is defined as the +k_{d′}-direction, when the coordinate point of (i,j)=(0,0) is defined as (kₓ,k_{y})=(0,0), when the coordinate point of (i,j)=(n−1,0) is defined as (kₓ,k_{y})=(0,2π/a), when the coordinate point of (i,j)=(0,n−1) is defined as (kₓ,k_{y})=(2π/a,0), and when the coordinate point of (i,j)=(n−1,n−1) is defined as (kₓ,k_{y})=(2π/a,2π/a); the element generation step of generating elements cᵢ^{(α)}cₖ^{(β)}+cₖ^{(α)}cᵢ^{(β)} in the quadratic form expressed by the symmetric product with respect to each of the combinations of the rearrangement directions of 12×12 ways by multiplying ith and kth expansion coefficients of each of the two distribution functions rearranged into 12 ways by each other; the physical quantity generation step of generating the physical quantity Eₘ₌ᵢ₋ₖ^{(α)(β)+}, which is the sum of all the elements having the given difference m=i−k between the quantum numbers, with respect to the difference between the plural quantum numbers with respect to each of the generated quadratic-form elements of 144 ways; the evaluation step of evaluating the shape feature of the two-dimensional distribution function of the image based on at least one of the generated physical quantities; and the sorting step of sorting the image into the images of at least two categories based on the evaluation result.

(2) In the image sorting method described in (1), the physical quantity calculation step generates the physical quantity Eₘ₌ᵢ₋ₖ^{(α)(β)+} with respect to the n quantum numbers (m=0, 1, . . . , n−1).

(3) In the image sorting method described in (1), the physical quantity generation step generates the physical quantity <Eₘ₌ᵢ₋ₖ^{(α)(β)+}> which the physical quantities Eₘ₌ᵢ₋ₖ^{(α)(β)+} generated with respect to the direction combinations of the 144 ways, are averaged with respect to the direction combinations of the 144 ways between the elements having the given difference between the quantum numbers.

(4) In the image sorting method described in (1), the element generation step further generates the 4×4-times quadratic-form element with respect to the α-plane expansion coefficients in the total of four cases including the expansion coefficient of the two-dimensional distribution function f^{(α)} (x,y) on the α plane, the expansion coefficient of the two-dimensional distribution function f^{(α)}=(x,−y)=f^{(α′)}(x,y) in which the y-axis is inverted, the expansion coefficient of the two-dimensional distribution function f^{(α)}(−x, y)=f^{(α″)}(x,y) in which the x-axis is inverted, and the expansion coefficient of the two-dimensional distribution function f^{(α)}(−x,−y)=f^{(α′″)}(x,y) in which both the x-axis and the y-axis are inverted and the β-plane expansion coefficients in the total of four cases including the expansion coefficient of two-dimensional distribution function f^{(β)}(x,y) of the β plane, the expansion coefficient of the two-dimensional distribution function f^{(β)}(x,−y)=f^{(β′)}(x,y) in which the y-axis is inverted, the expansion coefficient of the two-dimensional distribution function f^{(β)}(−x,y)=f^{(β″)}(x,y) in which the x-axis is inverted, and the expansion coefficient of the two-dimensional distribution function f^{(β)}(−x,−y)=f^{(β′″)}(x,y) in which both the x-axis and the y-axis are inverted, and the physical quantity generation step generates the physical quantity Eₘ₌ᵢ₋ₖ^{(α)(-β)+} with respect to each of the direction combination of the 144 ways in the case of the 4×4-times quadratic-form element increasing in association with the axis inversion.

(5) The image sorting method includes: the distribution function input step of inputting each of the two-dimensional distribution functions f^{(α)}(x,y) and) f^{(β)}(x,y) of the image related to at least the two color planes α and β (including the case of α=β); the description step of performing the two-dimensional series expansion to each of the two distribution functions

f^{(α)}(x,y)=c₀₀^{(α)}ψ₀(y)ψ₀(x)+ . . . +c_{0,n-1}^{(α)}ψ₀(y)ψₙ₋₁(x)+ . . . +c_{n-1,0}^{(α)}ψₙ₋₁(y)ψ₀(x)+ . . . αc_{n-1,n-1}^{(α)}ψₙ₋₁(y)ψₙ₋₁(x) and

f^{(β)}(x,y)=c₀₀^{(β)}ψ₀(y)ψ₀(x)+ . . . +c_{0,n-1}^{(β)}ψ₀(y)ψₙ₋₁(x)+ . . . +c_{n-1,0}^{(β)}ψₙ₋₁(y)ψ₀(x)+ . . . αc_{n-1,n-1}^{(β)}ψₙ₋₁(y)ψₙ₋₁(x)

using n base functions ψₙ (n: quantum number) that are orthogonal to each other while becoming the complete system in each of the distribution ranges in the x-direction and y-direction, and describing each of the two distribution functions by the two-dimensional expansion coefficients cᵢⱼ^{(α)} and cᵢⱼ^{(β)} (i=0, 1, . . . , n−1 and j=0, 1, . . . , n−1); the rearrangement step of rearranging each of the two-dimensional expansion coefficient cᵢⱼ^{(α)},cᵢⱼ^{(β)} into expansion coefficients cᵢ^{(α)} and cᵢ^{(β)} (i=0, 1, . . . , n×n−1) of 6 ways of the one-dimensional array in the order of

1) +k_{y}-direction with (kₓ,k_{y})=(0,0) as the starting point,

2) +kₓ-direction with (kₓ,k_{y})=(0,0) as the starting point,

3) +k_{d}-direction with (kₓ,k_{y})=(0,0) as the starting point,

4) +k_{d′}-direction with (kₓ,k_{y})=(2π/a,0) as the starting point,

5) +k_{y}-direction with (kₓ,k_{y})=(π/a,0) as the starting point,

6) +kₓ-direction with (kₓ,k_{y})=(0,π/a) as the starting point,

when the direction in which i increases in the two-dimensional plane of the expansion coefficient is defined as the +k_{y}-direction, when the direction in which j increases is defined as the +kₓ-direction, when the direction in which i and j increase simultaneously is defined as the +k_{d}-direction, when the direction in which i increases while j decreases is defined as the +k_{d′}-direction, when the coordinate point of (i,j)=(0,0) is defined as (kₓ,k_{y})=(0,0), when the coordinate point of (i,j)=(n−1,0) is defined as (kₓ,k_{y})=(0,2π/a), when the coordinate point of (i,j)=(0,n−1) is defined as (kₓ,k_{y})=(2π/a,0), and when the coordinate point of (i,j)=(n−1, n−1) is defined as (kₓ,k_{y})=(2π/a,2π/a); the element generation step of generating two types of elements cᵢ^{(α)}cₖ^{(β)}+cₖ^{(α)}cᵢ^{(β)} and cᵢ^{(α)}cₖ^{(β)}−cₖ^{(α)}cᵢ^{(β)} in the quadratic form expressed by the symmetric product and the asymmetric product with respect to each of the combinations of the rearrangement directions of 6×6 ways by multiplying ith and kth expansion coefficients of each of the two distribution functions rearranged into 6 ways by each other; the physical quantity generation step of generating the physical quantities Eₘ₌ᵢ₋ₖ^{(α)(β)+} and Eₘ₌ᵢ₋ₖ^{(α)(β)-}, which are the sum of all the elements having the given difference m=i−k between the quantum numbers with respect to the difference between the plural quantum numbers with respect to each of the generated two types of quadratic-form elements of 36 ways; the evaluation step of evaluating the shape feature of the two-dimensional distribution function of the image based on at least one of the generated physical quantities; and the sorting step of sorting the image into the images of at least two categories based on the evaluation result.

(6) In the image sorting method described in (5), the physical quantity calculation step generates the physical quantities Eₘ₌ᵢ₋ₖ^{(α)(β)+} and Eₘ₌ᵢ₋ₖ^{(α)(β)-} with respect to the n quantum numbers (m=0, 1, . . . , n−1).

(7) In the image sorting method described in (5), the physical quantity generation step generates the physical quantities <Eₘ₌ᵢ₋ₖ^{(α)(β)+}+> and <Eₘ₌ᵢ₋ₖ^{(α)(β)-}>, in which the physical quantities Eₘ₌ᵢ₋ₖ^{(α)(β)+} and Eₘ₌ᵢ₋ₖ^{(α)(β)-} generated with respect to the direction combinations of the 36 ways are averaged with respect to the direction combinations of the 36 ways between the elements having the given difference between the quantum numbers.

(8) In the image sorting method described in (5), the element generation step further generates the 4×4-times quadratic-form element with respect to the α-plane expansion coefficients in the total of four cases including the expansion coefficient of the two-dimensional distribution function f^{(α)}(x,y) on the α plane, the expansion coefficient of the two-dimensional distribution function f^{(α)} (x,−y)=f^{(α′)}(x,y) in which the y-axis is inverted, the expansion coefficient of the two-dimensional distribution function f^{(α)}(−x,y)=f^{(α″)}(x,y) in which the x-axis is inverted, and the expansion coefficient of the two-dimensional distribution function f^{(α)}(−x,−y)=f^{(α′″)}(x,y) in which both the x-axis and the y-axis are inverted and the β-plane expansion coefficients in the total of four cases including the expansion coefficient of two-dimensional distribution function f^{(β)}(x,y) of the β plane, the expansion coefficient of the two-dimensional distribution function f^{(β)}(x,−y)=f^{(β′)}(x,y) in which the y-axis is inverted, the expansion coefficient of the two-dimensional distribution function f^{(β)}(−x, y)=f^{(β″)}(x,y) in which the x-axis is inverted, and the expansion coefficient of the two-dimensional distribution function f^{(β)}(−x,−y)=f^{(β′″)}(x,y) in which both the x-axis and the y-axis are inverted, and the physical quantity generation step generates the physical quantities Eₘ₌ᵢ₋ₖ^{(α)(-β)+} and Eₘ₌ᵢ₋ₖ^{(α)(-β)-} with respect to each of the direction combination of the 36 ways in the case of the 4×4-times quadratic-form element increasing in association with the axis inversion.

(9) In the image sorting method described in (1) or (5), the evaluation step evaluates the shape feature of the two-dimensional distribution function of the image based on the one linear-sum physical quantity that is expressed by the linear combination of all the generated physical quantities.

(10) The image sorting method includes: the distribution function input step of inputting each of the two-dimensional distribution function f^{(α)}(x,y) of the image related to at least the one color plane α; the description step of performing the two-dimensional series expansion to each of the distribution function

f^{(α)}(x,y)=c₀₀^{(α)}ψ₀(y)ψ₀(x)+ . . . +c_{0,n-1}^{(α)}ψ₀(y)ψₙ₋₁(x)+ . . . +c_{n-1,0}^{(α)}ψₙ₋₁(y)ψ₀(x)+ . . . αc_{n-1,n-1}^{(α)}ψₙ₋₁(y)ψₙ₋₁(x)

using n base functions ψₙ (n: quantum number) that are orthogonal to each other while becoming the complete system in each of the distribution ranges in the x-direction and y-direction, and describing the distribution function by the two-dimensional expansion coefficients cᵢⱼ^{(α)} (i=0, 1, . . . , n−1 and j=0, 1, . . . , n−1); the physical quantity generation step of generating the physical quantity corresponding to the diagonal sum which is the product of the quantum number i of the corresponding base function and the expansion coefficient cᵢᵢ^{(α)} with respect to all the diagonal components satisfying i=j of the two-dimensional expansion coefficient cᵢⱼ^{(α)}; the evaluation step of evaluating the shape feature of the two-dimensional distribution function of the image based on the generated physical quantity; and the sorting step of sorting the image into the images of at least two categories based on the evaluation result.

(11) In the image sorting method described in (10), the physical quantity generation step also generates the physical quantity corresponding to the diagonal sum with respect to the two-dimensional expansion coefficient Cᵢⱼ^{(α′)} of the two-dimensional distribution function f^{(α)}(x,−y)=f^{(α′)}(x,y) in which the y-axis of the two-dimensional distribution function on the α plane is inverted.

(12) In the image sorting method described in (1), (5), or (10), the description step uses the associated Legendre function as the base function when the distribution function input step inputs the image distribution function on the color plane.

(13) In the image sorting method described in (1), (5), or (10), the description step uses the Fourier function as the base function when the distribution function inputs step inputs the distribution function of the edge image related to the edge component on the color plane.

(14) In the image sorting method described in (13), the edge image distribution function is the image distribution function on the edge plane. The image distribution function on the edge plane defined by the value of zero or more, which is obtained by sequentially generating the plural resolutions by filtering the image, generating the single combined high-frequency image by sequentially combining the high-frequency subband image in the ascending order of the resolutions, and raising each pixel value of the single combined high-frequency image to the second power.

According to the image sorting method in (1) to (14), after the frequency expression projected to the uniform recognition space where the shape is equally recognized is performed by performing the series expansion of the two-dimensional distribution function using the orthogonal base function suitable for the characteristic of the signal distribution, the irreducible expression of the characteristic of the coefficient distribution of the frequency plane is performed as the quadratic-form features of the expansion coefficient. Therefore, the two-dimensional distribution function can be transformed into the most compact information content in which the scale is invariable. The information content includes the invariability related to the directionality, and is retained between the images evoking the identical perception or images in which the object structure having the common recognition is photographed. The information content is not deleted by the statistical mean between the identical perception images. The guarantee of the additional characteristic of the features enables the description that facilitates the resolution of the psychological structure about which element of the features of the image strongly evokes the action of the psychological impression.

Additionally, according to the above embodiments, the following image sorting methods are also provided.

(15) The image sorting method includes: the image input step of inputting the image A(x,y) related to at least the one color plane α; the distribution function preparation step of preparing the distribution function f^{(α)}(x,y) in which the pixel value of the image on the α plane is normalized by the sum of all the pixel values; the space factor description step of describing the spatial shape factor by obtaining the centroid (<x_{A}>,<y_{A}>) of the space distribution and the inertia tensors I₁₁^{(α)}, I₁₂^{(α)}, I₂₁^{(α)}, and I₂₂^{(α)} expressing the second moment mean spread widths <(y−<y_{A}>)²>, −<(x−<x_{A}>) (y−<y_{A}>)>, −<(y−<y_{A}>)(x−<x_{A}>)>, and <(x−<x_{A}>)²> related to the space direction from the centroid using the distribution function; the one-dimensional image preparation step of calculating the one-dimensional image A(x), in which the image A(x,y) on the α plane is projected to the x-axis while the pixel values are averaged with respect to the y-axis direction, and the one-dimensional image A(y), in which the image A(x,y) on the α plane is projected to the y-axis while the pixel values are averaged with respect to the x-axis direction; the brightness factor description step of calculating the brightness mean value <A> of the pixel value of the whole image, calculating the brightness spread width σᵢ^{(α)} of the x-axis projection viewed from the brightness mean value <A> using the image A(x) of the x-axis projection, calculating the brightness spread width σ₂^{(α)} of the y-axis projection viewed from the brightness mean value <A> using the image A(y) of the y-axis projection, and therefore describing the factor of the pixel value in the brightness direction; the physical quantity calculation step of calculating each of the quadratic-form physical quantities related to the brightness factor

(<x_{A}>²+<y_{A}>²)<A><A>,

I₁₁^{(α)}σ₁^{(α)}σ₁^{(α)}+I₁₂^{(α)}σ₁^{(α)}σ₂^{(α)}+I₂₁^{(α)}σ₂^{(α)}σ₁^{(α)}+I₂₂^{(α)}σ₂^{(α)}σ₂^{(α)},

I₁₁^{(α)}σ₁^{(α)}σ₁^{(α)}+I₁₂^{(α)}σ₁^{(α)}σ₂^{(α)}−I₂₁^{(α)}σ₂^{(α)}σ₁^{(α)}−I₂₂^{(α)}σ₂^{(α)}σ₂^{(α)},

I₁₁^{(α)}σ₁^{(α)}σ₁^{(α)}−I₁₂^{(α)}σ₁^{(α)}σ₂^{(α)}+I₂₁^{(α)}σ₂^{(α)}σ₁^{(α)}−I₂₂^{(α)}σ₂^{(α)}σ₂^{(α)}, and

I₁₁^{(α)}σ₁^{(α)}σ₁^{(α)}−I₁₂^{(α)}σ₁^{(α)}σ₂^{(α)}−I₂₁^{(α)}σ₂^{(α)}σ₁^{(α)}+I₂₂^{(α)}σ₂^{(α)}σ₂^{(α)}

from the quantities obtained in the space factor description step and the brightness factor description step; and the sorting step of sorting the image into the images of at least two categories based on at least one of the calculated physical quantities.

(16) In the image sorting method described in (15), the physical quantity calculation step further calculates one linear-sum physical quantity that is expressed by the linear combination of the calculated quadratic-form physical quantities, the sorting step sorts the image into the images of at least two categories based on the calculated one linear-sum physical quantities.

(17) In the image sorting method described in (15), when the image input step inputs the image having the positive and negative values related to the edge component on the color plane, the distribution function preparation step transforms the image related to the edge component into the distribution of the pixel value, which is defined within the range of zero or more by raising the pixel value of the image related to the edge component to the second power, and prepares the distribution function normalized by the sum of all the pixel values.

(18) In the image sorting method described in (17), the image related to the edge component is the single combined high-frequency image. The image is filtered to sequentially generate the high-frequency subband images including the plural resolutions, and the high-frequency subband images are sequentially combined from the ascending order of the resolution, thereby forming the single combined high-frequency image.

(19) The image sorting method includes: the image input step of inputting the images A(x,y) and B(x,y) related to at least the two color planes α and β (α≠β); the distribution function preparation step of preparing the α-plane distribution function f^{(α)}(x,y) in which the pixel value of the image on the α plane is normalized by sum of all the pixel values and the β-plane distribution function f^{(β)}(x,y) in which the pixel value of the image on the β plane is normalized by sum of all the pixel values; the combined distribution function preparation step of preparing the combined distribution function f^{(αβ)}(x,y) of the α plane and the β plane, in which the value expressed by the product of the α-plane distribution function and the β-plane distribution function is normalized by the sum of all the pixel values; the combined-plane space factor description step of describing the spatial shape factor of the combined plane by obtaining the centroid (<x_{AB}>,<y_{AB}>) of the space distribution and the inertia tensors I₁₁^{(αβ)}, I₁₂^{(αβ)}, I₂₁^{(αβ)}, and I₂₂^{(αβ)} expressing the mean spread widths <(y−<y_{AB}>)²>, −<(x−<x_{AB}>) (y−<y_{AB}>)>, −<(y−<y_{AB}>)(x−<x_{AB}>) and <(x−<x_{AB}>)²> related to the space direction from the centroid using the combined distribution function; the α-plane one-dimensional image preparation step of calculating the one-dimensional image A(x), in which the image A(x,y) on the α plane is projected to the x-axis while the pixel values are averaged with respect to the y-axis direction, and the one-dimensional image A(y), in which the image A(x,y) on the α plane is projected to the y-axis while the pixel values are averaged with respect to the x-axis direction; the β-plane one-dimensional image preparation step of calculating the one-dimensional image B(x), in which the image B(x,y) on the β plane is projected to the x-axis while the pixel values are averaged with respect to the y-axis direction, and the one-dimensional image B(y), in which the image B(x,y) on the β plane is projected to the y-axis while the pixel values are averaged with respect to the x-axis direction; the α-plane brightness factor description step of calculating the brightness mean value <A> of the pixel value of the whole α-plane image, calculating the brightness spread width σ₁^{(α)} of the x-axis projection viewed from the brightness mean value <A> using the α-plane image A(x) of the x-axis projection, calculating the brightness spread width σ₂^{(α)} of the y-axis projection viewed from the brightness mean value <A> using the α-plane image A(y) of the y-axis projection, and therefore describing the factor of the α-plane pixel value in the brightness direction; the β-plane brightness factor description step of calculating the brightness mean value <B> of the pixel value of the whole β-plane image, calculating the brightness spread width σ₁^{(β)} of the x-axis projection viewed from the brightness mean value <B> using the β-plane image B(x) of the x-axis projection, calculating the brightness spread width σ₂^{(β)} of the y-axis projection viewed from the brightness mean value <B> using the β-plane image B(y) of the y-axis projection, and therefore describing the factor of the β-plane pixel value in the brightness direction; the physical quantity calculation step of calculating each of the quadratic-form physical quantities related to the brightness factor

(<x_{AB}>²+<y_{AB}>²)<A><B>,

I₁₁^{(αβ)}σ₁^{(α)}σ₁^{(β)}+I₁₂^{(αβ)}σ₁^{(α)}σ₂^{(β)}+I₂₁^{(αβ)}σ₂^{(α)}σ₁^{(β)}+I₂₂^{(αβ)}σ₂^{(α)}σ₂^{(β)},

I₁₁^{(αβ)}σ₁^{(α)}σ₁^{(β)}+I₁₂^{(αβ)}σ₁^{(α)}σ₂^{(β)}−I₂₁^{(αβ)}σ₂^{(α)}σ₁^{(β)}−I₂₂^{(αβ)}σ₂^{(α)}σ₂^{(β)},

I₁₁^{(αβ)}σ₁^{(α)}σ₁^{(β)}−I₁₂^{(αβ)}σ₁^{(α)}σ₂^{(β)}+I₂₁^{(αβ)}σ₂^{(α)}σ₁^{(β)}−I₂₂^{(αβ)}σ₂^{(α)}σ₂^{(β)}, and

I₁₁^{(αβ)}σ₁^{(α)}σ₁^{(β)}−I₁₂^{(αβ)}σ₁^{(α)}σ₂^{(β)}−I₂₁^{(αβ)}σ₂^{(α)}σ₁^{(β)}+I₂₂^{(αβ)}σ₂^{(α)}σ₂^{(β)}

from the combined-plane space factor description step, the α-plane brightness factor description step, and the β-plane brightness factor description step; and the sorting step of sorting the image into the images of at least two categories based on at least one of the calculated physical quantities.

(20) In the image sorting method described in (19), the physical quantity calculation step further calculates one linear-sum physical quantity that is expressed by the linear combination of the calculated quadratic-form physical quantities, the sorting step sorts the image into the images of at least two categories based on the calculated one linear-sum physical quantities.

(21) In the image sorting method described in (19), when the image input step inputs the image having the positive and negative values related to the edge component on the color plane, the distribution function preparation step transforms the image related to the edge component into the distribution of the pixel value, which is defined within the range of zero or more by raising the pixel value of the image related to the edge component to the second power, and prepares the distribution function normalized by the sum of all the pixel values.

(22) In the image sorting method described in (21), the image related to the edge component is the single combined high-frequency image. The image is filtered to sequentially generate the high-frequency subband images including the plural resolutions, and the high-frequency subband images are sequentially combined from the ascending order of the resolution, thereby forming the single combined high-frequency image.

(23) The image sorting method includes: the image input step of inputting the image A(x,y) related to at least the one color plane α; the distribution function preparation step of preparing the distribution function f^{(α)}(x,y) in which the pixel value of the image on the α plane is normalized by the sum of all the pixel values; the space factor description step of describing the spatial shape factor by obtaining the centroid (<x_{A}>,<y_{A}>) of the space distribution and the inertia tensors I₁₁^{(α)}, I₁₂^{(α)}, I₂₁^{(α)}, and I₂₂^{(α)} expressing the second moment mean spread widths <(y−<y_{A}>)²>, −<(x−<x_{A}>) (y−<y_{A}>)>, −<(y−<y_{A}>) (x−<x_{A}>)>, and <(x−<x_{A}>)²> related to the space direction from the centroid using the distribution function; the one-dimensional image preparation step of calculating the one-dimensional image A(x), in which the image A(x,y) on the α plane is projected to the x-axis while the pixel values are averaged with respect to the y-axis direction, and the one-dimensional image A(y), in which the image A(x,y) on the α plane is projected to the y-axis while the pixel values are averaged with respect to the x-axis direction; the brightness factor description step of calculating the brightness mean value <A> of the pixel value of the whole image, calculating the brightness spread width σ₁^{(α)} of the x-axis projection viewed from the brightness mean value <A> using the image A(x) of the x-axis projection, calculating the brightness spread width σ₂^{(α)} of the y-axis projection viewed from the brightness mean value <A> using the image A(y) of the y-axis projection, and therefore describing the factor of the pixel value in the brightness direction; the physical quantity calculation step of calculating each of the linear-form physical quantities related to the brightness factor

I₁₁^{(α)}σ₁^{(α)}+I₁₂^{(α)}σ₂^{(α)},

I₂₁^{(α)}σ₁^{(α)}+I₂₂^{(α)}σ₂^{(α)},

I₁₁^{(α)}σ₁^{(α)}−I₁₂^{(α)}σ₂^{(α)}, and

I₂₁^{(α)}σ₁^{(α)}−I₁₂^{(α)}σ₂^{(α)}

from the quantities obtained in the space factor description step and the brightness factor description step; and the sorting step of sorting the image into the images of at least two categories based on at least one of the calculated physical quantities.

(24) In the image sorting method described in (23), the physical quantity calculation step further calculates one linear-sum physical quantity that is expressed by the linear combination of the calculated linear-form physical quantities, sorting step sorts the image into the images of at least two categories based on the calculated one linear-sum physical quantities.

(25) In the image sorting method described in (24), when the image input step inputs the image having the positive and negative values related to the edge component on the color plane, the distribution function preparation step transforms the image related to the edge component into the distribution of the pixel value, which is defined within the range of zero or more by raising the pixel value of the image related to the edge component to the second power, and prepares the distribution function normalized by the sum of all the pixel values.

(26) In the image sorting method described in (25), the image related to the edge component is the single combined high-frequency image. The image is filtered to sequentially generate the high-frequency subband images including the plural resolutions, and the high-frequency subband images are sequentially combined from the ascending order of the resolution, thereby forming the single combined high-frequency image.

(27) In the image sorting method described in (16), the entropy S in which the value including −f^{(α)}(x,y)log(f^{(α)}(x,y)) is integrated with respect to the pixel position (x,y) in which the distribution function has the positive value is calculated from the distribution function f^{(α)}(x,y), the quantity T corresponding to the norm in which the calculated quadratic-form physical quantities are collectively expressed by one vector is calculated, the product TS is generated, and the physical quantity calculation step calculates the one linear sum by adding the linear combination of the generated product TS to the calculated one linear sum.

(28) In the image sorting method described in (24), the entropy S in which the value including −f^{(α)}(x,y)log(f^{(α)}(x,y)) is integrated with respect to the pixel position (x,y) in which the distribution function has the positive value is calculated from the distribution function f^{(α)}(x,y), the quantity T corresponding to the norm in which the calculated linear-form physical quantities are collectively expressed by one vector is calculated, the product TS is generated, and the physical quantity calculation step calculates the one linear sum by adding the linear combination of the generated product TS to the calculated one linear sum.

According to the image sorting method in (15) to (28), in the perceptual recognition related to the color or edge of the signal distribution of the image, the characteristic related to the attention region or spread can quantitatively be described as the features in the form in which the physical picture is extremely clear. The features is not deleted even if the statistical mean is calculated between the images generating the common perception or the common recognition. The guarantee of the additional characteristic of the features enables the description that facilitates the resolution of the psychological structure about which element of the features of the image strongly evokes the action of the psychological impression.

1. An image sorting method comprising:
a two-dimensional color distribution function input step of inputting a two-dimensional distribution function of a color plane image;
a two-dimensional edge distribution function preparation step of sequentially generating a high-frequency subband image from a plurality of resolutions by filtering the color plane image, generating a single combined high-frequency image by sequentially combining the high-frequency subband images from the low resolution, and preparing a two-dimensional distribution function of an edge plane image, the edge plane image being defined as a distribution of values of at least zero by raising each pixel value of the single combined high-frequency image to a second power;
a description step of expanding the two-dimensional distribution function of the color plane image into a two-dimensional Legendre series, in which an associated Legendre function is used as an orthogonal base function in an x-direction and a y-direction, describing the two-dimensional color distribution of the color plane image by a Legendre expansion coefficient, expanding the two-dimensional distribution function of the edge plane image into a two-dimensional Fourier series in which a cosine function and a sine function are used as the orthogonal base function in the x-direction and the y-direction, and describing the two-dimensional edge distribution of the edge plane image by a Fourier expansion coefficient;
an evaluation step of evaluating a feature of the distribution of the color plane image based on the Legendre expansion coefficient and the Fourier expansion coefficient; and
a sorting step of sorting the color plane image into images of at least two categories based on the evaluation result.

2. The image sorting method according to claim 1, further comprising:
a one-dimensional edge distribution function preparation step of preparing a one-dimensional distribution function related to a value of an edge intensity using the single combined high-frequency image; and
a description step of expanding a one-dimensional distribution function related to the edge intensity into a spherical Bessel series, in which a spherical Bessel function is used as the orthogonal base function, and describing the one-dimensional distribution of the edge intensity by a spherical Bessel expansion coefficient,
wherein, in the evaluation step, the feature of the distribution of the color plane image is evaluated using the spherical Bessel expansion coefficient in addition to the Legendre expansion coefficient and the Fourier expansion coefficient.

3. The image sorting method according to claim 2, further comprising:
a one-dimensional color distribution function preparation step of preparing a one-dimensional distribution function related to the pixel value using the color plane image; and
a description step of expanding the one-dimensional distribution function related to the pixel value into a Chebyshev series, in which a Chebyshev function is used as the orthogonal base function, and describing the one-dimensional distribution function of the pixel value by a Chebyshev expansion coefficient,
wherein, in the evaluation step, the feature of the distribution of the color plane image is evaluated using the Chebyshev expansion coefficient in addition to the Legendre expansion coefficient, the Fourier expansion coefficient, and the spherical Bessel expansion coefficient.

4. The image sorting method according to claim 1, wherein, in the evaluation step, a features expressed in a quadratic form of the Legendre expansion coefficient is generated from the Legendre expansion coefficient, a features expressed in a quadratic form of the Fourier expansion coefficient is generated from the Fourier expansion coefficient, one features expressed by a linear sum of the features is generated, and the feature of the distribution of the color plane image is evaluated based on the one features expressed by the linear sum.

5. The image sorting method according to claim 2, wherein, in the evaluation step, a features expressed in a quadratic form of the Legendre expansion coefficient is generated from the Legendre expansion coefficient, a features expressed in a quadratic form of the Fourier expansion coefficient is generated from the Fourier expansion coefficient, a features expressed in a quadratic form of the spherical Bessel expansion coefficient is generated from the spherical Bessel expansion coefficient, one features expressed by a linear sum of the features is generated, and the feature of the distribution of the color plane image is evaluated based on the one features expressed by the linear sum.

6. The image sorting method according to claim 3, wherein, in the evaluation step, a features expressed in a quadratic form of the Legendre expansion coefficient is generated from the Legendre expansion coefficient, a features expressed in a quadratic form of the Fourier expansion coefficient is generated from the Fourier expansion coefficient, a features expressed in a quadratic form of the spherical Bessel expansion coefficient is generated from the spherical Bessel expansion coefficient, a features expressed in a quadratic form of the Chebyshev expansion coefficient is generated from the Chebyshev expansion coefficient, one features expressed by a linear sum of the features is generated, and the feature of the distribution of the color plane image is evaluated based on the one features expressed by the linear sum.

7. An image sorting method comprising:
an input step of inputting an image;
an extraction step of extracting color information and edge information from the input image;
an evaluation step of evaluating the image based on the extracted color information and edge information;
a sorting step of sorting the image based on the evaluation result.
